(19) United States
(12) Patent Application Publication
(10) Pub. No.: US 2026/0113527 A1
(43) Pub. Date: Apr. 23, 2026

(54) CAMERA DEVICE AND OPTICAL DEVICE

(71) Applicant: LG INNOTEK CO., LTD., Seoul (KR)

(72) Inventors: Sang Yeon HAN, Seoul (KR); Dong Hyun KIM, Seoul (KR)

(21) Appl. No.: 19/116,207

(22) PCT Filed: Sep. 27, 2023
(86) PCT No.: PCT/KR2023/014997

§ 371 Date: Mar. 27, 2025

(30) Foreign Application Priority Data
Sep. 27, 2022 (KR) 10-2022-0122459
Nov. 24, 2022 (KR) 10-2022-0159183

(51) Int. Cl. H04N 23/55; H04N 23/52; H04N 23/54; H04N 23/57; H04N 23/68

(52) U.S. Cl. CPC H04N 23/55; H04N 23/52; H04N 23/54; H04N 23/57; H04N 23/687

(57) ABSTRACT

An embodiment comprises: a stationary part including a lens module; a moving part including a circuit board, a circuit element disposed on the circuit board, a filter holder disposed on the circuit board, a filter opposite to the lens module in the optical axis direction and disposed on the filter holder, and an image sensor opposite to the filter; and a support part supporting the moving part with respect to the stationary part, wherein: the filter holder includes a first portion overlapping the lens module and not overlapping the circuit element in the optical axis direction, and a second portion overlapping the circuit element and not overlapping the lens module in the optical axis direction; and the second portion is positioned higher than the circuit element and lower than the lens module.

### CROSS-REFERENCE TO RELATED APPLICATIONS

This application is the U.S. national stage application of International Patent Application No. PCT/KR2023/014997, filed Sep. 27, 2023, which claims the benefit under 35 U.S.C. § 119 of Korean Application Nos. 10-2022-0122459, filed Sep. 27, 2022; and 10-2022-0159183, filed Nov. 24, 2022, the disclosures of each of which are incorporated herein by reference in their entirety.

### TECHNICAL FIELD

Embodiments relate to an actuator, a camera device and an optical instrument including the same.

### BACKGROUND ART

It is difficult to apply technology of a voice coil motor (VCM) used in existing general camera devices to a subminiature, low-power camera device, and therefore research related thereto has been actively conducted.

Demand for and production of electronic products, such as smartphones and mobile phones equipped with cameras have increased. Cameras for mobile phones are trending toward increased resolution and miniaturization. As a result, an actuator has also been miniaturized, increased in diameter, and been made multifunctional. In order to realize a high-resolution camera for mobile phones, improvement in performance of the camera for mobile phones and addition of functions thereto, such as autofocus, hand tremor correction, and zoom, are required.

### DISCLOSURE

### Technical Problem

Embodiments provide camera devices and optical instruments including the same, which are capable of inhibiting breakage or damage to a filter holder accommodating a filter therein caused by impact.

Furthermore, embodiments provide camera devices and optical instruments including the same, which are capable of inhibiting defective electrical connection caused by impact and of inhibiting generation of foreign substances and electrical short between terminals caused by a soldering process.

### Technical Solution

A camera device according to an embodiment includes a stationary unit including a lens module, a moving unit including a circuit board, a circuit element disposed on the circuit board, a filter holder disposed on the circuit board, a filter opposed to the lens module in an optical axis direction, and an image sensor opposite the filter, and a support unit configured to support the moving unit with respect to the stationary unit, wherein the filter holder includes a first portion, which overlaps the lens module but does not overlap the circuit element in the optical axis direction, and a second portion, which overlaps the circuit element but does not overlap the lens module in the optical axis direction, wherein the second portion is positioned higher than the circuit element but lower than the lens module.

The filter holder may include a third portion which is positioned between the first portion and the second portion and does not overlap the lens module and the circuit element in the optical axis direction. The third portion may be positioned between the first portion and the second portion.

The first portion may have an upper surface positioned higher than an upper surface of the filter.

The circuit board may include a first circuit board having a bore and a second circuit board disposed below the first circuit board, and at least a portion of the circuit element and at least a portion of the filter holder may be disposed in the bore in the first circuit board.

The second portion may be disposed in the bore in the first circuit board and may not overlap the first circuit board in the optical axis direction.

The filter holder may include a fourth portion which does not overlap the lens module and the circuit element in the optical axis direction and is disposed between the second portion and the first circuit board.

The filter holder may include a side portion including first and second side portions, which are positioned opposite each other in a first direction, and third and fourth side portions, which are positioned opposite each other in a second direction perpendicular to the first direction, and a seating portion including a bottom surface positioned lower than an upper surface of the side portion of the filter holder in the optical axis direction, the filter being disposed in the seating portion. The length of the first side portion in the first direction may be 15% to 20% of the length of the filter in the first direction.

The length of the third side portion in the second direction may be 7% to 12% of the length of the filter in the second direction.

The distance between the upper surface of the filter and the upper surface of the side portion of the filter holder may be 19% to 50% of the length of the filter in the optical axis direction.

A camera device according to another embodiment may include a stationary unit, a moving unit including a circuit board, a circuit element disposed on the circuit board, a filter holder disposed on the circuit board, a filter disposed on the filter holder, and an image sensor opposite the filter, and
a support unit configured to support the moving unit with respect to the stationary unit, wherein the filter holder includes a reception portion in which at least a portion of the circuit element is disposed, and the circuit element overlaps at least a portion of the filter holder in the optical axis direction.

A camera device according to another embodiment includes a lens module spaced apart from the filter in the optical axis direction and disposed on the filter. The circuit element may not overlap the lens module in the optical axis direction. The filter holder may include a seating portion having a bottom surface which defines a height difference with respect to the upper surface of the filter holder in the optical axis direction, and the filter may be disposed on the bottom surface of the seating portion. The upper surface of the filter may be positioned lower than the upper surface of the filter holder.

The reception portion may include a groove depressed from the lower surface of the filter holder, and at least a portion of the circuit element may be disposed in the groove. The filter holder may include a first region coupled to the circuit board and a second region positioned outside the first region, and the reception portion may be disposed in the second region.

The circuit board may include a frit circuit board having a bore and a second circuit board disposed below the first circuit board, the circuit element and the filter holder may be disposed on the second circuit board, and at least a portion of the circuit element and at least a portion of the filter holder may be disposed in the bore in the first circuit board. The upper surface of the filter holder may be positioned higher than the upper surface of the first circuit board. A camera device according to another embodiment may include a damper disposed on the upper surface of the filter holder. The damper may overlap the lens module in the optical axis direction. The damper may be made of a material having lower stiffness than the filter holder. The end of the side portion of the filter holder adjacent to the corner of the filter holder may include a portion having an increased width.

A camera device according to an embodiment includes a stationary unit, and a moving unit including a first circuit board including a first terminal, a second circuit board disposed below the first circuit board and including a second terminal and an image sensor, and being movable relative to the stationary unit in a direction perpendicular to an optical axis direction, wherein the moving unit includes a conduction path portion which includes a wire which is disposed between the first terminal and the second terminal and which contacts the first terminal at one end thereof and the second terminal at the other end thereof and an insulating portion enveloping the wire.

The wire may include a plurality of wires which are disposed so as to be spaced apart from each other. The second circuit board may include a groove which is depressed from the upper surface thereof and in which the conduction path portion is disposed.

The conduction path portion may include a first portion in which the wire is disposed and a second portion connected to the first portion and coupled to the second circuit board via an adhesive. The wire may not be disposed on the second portion.

The second terminal may include a plurality of second terminals which are spaced apart from each other, and the distance between two adjacent wires among the plurality of wires may be less than the distance between two adjacent second terminals among the plurality of second terminals.

The image sensor may be disposed on the second circuit board.

The camera device may include a heat radiating member disposed below the second circuit board, and the heat radiating member may overlap the conduction path portion in the optical axis direction.

A conductive adhesive or solder may not be disposed between the one end of the wire and the first terminal and between the other end of the wire and the second terminal.

The groove may have an opening at the outer surface of the second circuit board.

The first circuit board may include a groove depressed from the lower surface of the first circuit board, and the conduction path portion may be disposed in the groove in the first circuit board.

The second circuit board may include a first groove depressed from the upper surface of the second circuit board, the first circuit board may include a second groove depressed from the lower surface of the first circuit board, and a portion of the conduction path portion may be disposed in the first groove and another portion of the conduction path portion may be disposed in the second groove.

A camera device according to another embodiment may include a stationary unit, and a moving unit including a first circuit board including a first terminal, a second circuit board disposed below the first circuit board and including a second terminal and an image sensor, and being movable relative to the stationary unit in a direction perpendicular to the optical axis direction, wherein the second circuit board includes a plurality of conductive layers disposed in the optical axis direction, and wherein the moving unit includes a conduction path portion including a first wire which contacts the first terminal at one end thereof and the second terminal at the other end thereof and an insulating portion enveloping the first wire, the other end of the first wire being positioned lower than the uppermost conductive layer among the plurality of conductive layers of the second circuit board.

The one end of the first wire may be positioned higher than the uppermost conductive layer of the second circuit board. The second terminal may be formed at a conductive layer positioned below the uppermost conductive layer of the second circuit board.

The first circuit board may include a plurality of conductive layers disposed in the optical axis direction, and the first terminal may be formed at the lowermost conductive layer among the plurality of conductive layers of the first circuit board.

The first wire may include a plurality of first wires which are spaced apart from each other, and the plurality of first wires may overlap the first terminal and the second terminal in the optical axis direction.

The conduction path portion may include a second wire which overlaps the first terminal but does not overlap the second terminal in the optical axis direction.

The conduction path portion may include a third wire which overlaps the second terminal but does not overlap the first terminal in the optical axis direction.

The conduction path portion may include a fourth wire which does not overlap the first and second terminals in the optical axis direction.

One of the first circuit board and the second circuit board may include a groove in which at least a portion of the conduction path portion is received.

### Advantageous Effects

The embodiments are able to inhibit the filter holder accommodating the filter therein from breaking or being damaged by impact.

According to the embodiments, since the conductive portion of the conduction path portion is enveloped or sealed by the insulating portion, the insulating portion is capable of protecting the conductive portion from external impact and thus of inhibiting defective electrical connection caused by the external impact.

Furthermore, according to the embodiments, there is no generation of foreign substances caused by a soldering process.

Furthermore, according to the embodiments, since the conductive portion is enveloped or sealed and thus insulated by the insulating portion, it is possible to inhibit electrical short between the terminals.

Furthermore, according to the embodiments, since the conduction path portion is attached to the first circuit board and the second circuit board via an adhesive rather than through a soldering process, it is possible to realize a simplified process and reduction of process time.

### DESCRIPTION OF DRAWINGS

FIG. 1 is a perspective view of a camera device according to an embodiment;

FIG. 2 is a perspective view of the camera device from which a cover member is removed;

FIG. 3 is an exploded perspective view of the camera device shown in FIG. 1;

FIG. 4A is a cross-sectional view of the camera device taken along line A-B in FIG. 1;

FIG. 4B is a cross-sectional view of the camera device taken along line C-D in FIG. 1;

FIG. 4C is a cross-sectional view of the camera device taken along line E-F in FIG. 1;

FIG. 5 is an exploded perspective view of the AF operation unit shown in FIG. 3;

FIG. 6 is a perspective view of a bobbin, a sensing magnet, a balancing magnet, a first coil, a circuit board, a first position sensor, and a capacitor;

FIG. 7 is a perspective view of the bobbin, a housing, the circuit board, an upper elastic member, the sensing magnet, the balancing magnet, a wire, and a damper;

FIG. 8 is a bottom perspective view of the housing, the bobbin, a lower elastic member, a magnet, and the circuit board;

FIG. 9 is a perspective view of an image sensor unit;

FIG. 10A is a first exploded perspective view of the image sensor unit shown in FIG. 9;

FIG. 10B is a second exploded perspective view of the image sensor unit shown in FIG. 9;

FIG. 11 is a bottom perspective view of the holder, the terminal member, the first board unit, the support board, the base, and the second board unit shown in FIG. 10A;

FIG. 12 is a plan view of the holder, the first board unit, the image sensor, the second coil, and the OIS position sensor;

FIG. 13 is a rear perspective view of the holder and the first board unit;

FIG. 14 is a perspective view of the base, the terminal member and the wire;

FIG. 15 is a bottom view of the first board unit, the support board, and the heat radiating member;

FIG. 16 is a perspective view of the first board unit, the support board, and the radiating member;

FIG. 17A is a first perspective view of the support board coupled to the holder and the base;

FIG. 17B is a second perspective view of the holder and the base;

FIG. 18A illustrates movement of the OIS moving unit in the x-axis direction;

FIG. 18B illustrates movement of the OIS moving unit in the y-axis direction;

FIG. 18C illustrates clockwise rotation of the OIS moving unit in the case of driving through four channels;

FIG. 18D illustrates counterclockwise rotation of the OIS moving unit in the case of driving through four channels;

FIG. 19A illustrates an embodiment of the magnet shown in FIG. 5;

FIG. 19B illustrates another embodiment of the magnet shown in FIG. 5;

FIG. 20A illustrates disposition of the first to third regions of the second board unit, the extension region, the AF moving unit, the OIS moving unit, and the controller according to an embodiment;

FIG. 20B is a schematic cross-sectional view of the lens module, the first board unit, the image sensor, the first board unit, and the heat radiating member;

FIG. 21 is a block diagram illustrating the configuration of the controller and first to third sensors;

FIG. 22 is a perspective view of the filter, the filter holder, and the first board unit;

FIG. 23 is a perspective view of the filter holder;

FIG. 24 is a bottom perspective view of the filter holder shown in FIG. 23;

FIG. 25 is a fragmentary enlarged view of the camera device shown in FIG. 4B;

FIG. 26 is a schematic cross-sectional view of the camera device shown in FIGS. 1 to 25;

FIG. 27A is a cross-sectional view of a camera device according to a comparative example;

FIG. 27B is a schematic cross-sectional view of the camera device according to the comparative example shown in FIG. 27A;

FIG. 28A is a perspective view of the filter holder and a damper;

FIG. 28B is a fragmentary cross-sectional view of the camera device including the damper shown in FIG. 28A;

FIG. 29A is a plan view of the filter holder, the filter and a shield member;

FIG. 29B is an enlarged view of the dotted portion in FIG. 29A;

FIG. 30 is a perspective view of the filter holder, the filer and the shield member according to another embodiment;

FIG. 31 is a plan view of the filter holder, the filter, the shield member and the lens module shown in FIG. 30;

FIG. 32 is a cross-sectional view of the filter holder, the filter and the lens module in the dotted portion in FIG. 30;

FIG. 33 is a perspective view of the camera device according to an embodiment;

FIG. 34 is a perspective view of the camera device shown in FIG. 33 from which the cover member is removed;

FIG. 35 is an exploded perspective view of the camera device shown in FIG. 33;

FIG. 36A is a cross-sectional view of the camera device taken along line A-B in FIG. 33;

FIG. 36B is a cross-sectional view of the camera device taken along line C-D in FIG. 33;

FIG. 36C is a cross-sectional view of the camera device taken along line E-F in FIG. 33;

FIG. 37 is an exploded perspective view of the AF operation unit shown in FIG. 35;

FIG. 38 is a perspective view of the bobbin, the sensing magnet, the balancing magnet, the first coil, the circuit board, the first position sensor, and the capacitor;

FIG. 39A is a perspective view of the bobbin, the housing, the circuit board, the upper elastic member, the sensing magnet, and the balancing magnet;

FIG. 39B is a perspective view of the structure shown in FIG. 39A to which the wire is additionally provided;

FIG. 40 is a bottom perspective view of the housing, the bobbin, the lower elastic member, the magnet, and the circuit board;

FIG. 41 is a perspective view of the image sensor unit shown in FIG. 35;

FIG. 42A is a first exploded perspective view of the image sensor unit shown in FIG. 41;

FIG. 42B is a second exploded perspective view of the image sensor unit shown in FIG. 41;

FIG. 42C is an enlarged view of the hole in the holder in 42A;

FIG. 42D is an enlarged view of the terminal member shown in FIG. 42A;

FIG. 42E is an enlarged view of the groove in the base shown in FIG. 42A;

FIG. 42F is an enlarged view of the groove in the groove in the holder in which the terminal member shown in FIG. 42B is disposed;

FIG. 43 is a bottom perspective view of the holder, the terminal member, the first board unit, the support board, the heat radiating member, the base, and the second board unit, which are shown in FIG. 42A;

FIG. 44 is a plan view of the holder, the first board unit, the image sensor, the second coil, and the OIS position sensor;

FIG. 45 is a rear perspective view of the holder and the first board unit;

FIG. 46 is a perspective view of the base, the terminal member, and the wire;

FIG. 47 is a bottom view of the first board unit, the support board, and the heat radiating member;

FIG. 48 is a perspective view of the first board unit, the support board, and the heat radiating member;

FIG. 49A is a first perspective view of the support board coupled to the holder and the base;

FIG. 49B is a second perspective view of the support board coupled to the holder and the base;

FIG. 50A is an exploded perspective view of the first circuit board, the second circuit board, and the conduction path portion;

FIG. 50B is a cross-sectional view the terminal of the first circuit board, the terminal of the second circuit board, and the conduction path portion in the optical axis direction;

FIG. 51 is an enlarged view of the dotted portion in FIG. 50A;

FIG. 52 illustrates the conduction path portion disposed in the reception portion of the second circuit board;

FIG. 53A is a cross-sectional view of the first circuit board, the second circuit board, and the conduction path portion in the optical axis direction;

FIG. 53B is a cross-sectional view illustrating the reception portion of the second circuit board according to another embodiment;

FIG. 54A is a plan view of the conduction path portion;

FIG. 54B illustrates the conduction path portion and the terminal of the second circuit board;

FIG. 54C is an enlarged view of the dotted portion in FIG. 54B;

FIG. 55 is a cross-sectional view illustrating the layered structure of the first circuit board, the second circuit board and the conduction path portion;

FIG. 56A is a cross-sectional view of the terminal of the first circuit board, the terminal of the second circuit board, and the conduction path portion according to another embodiment;

FIG. 56B is a cross-sectional view of the terminal of the first circuit board, the terminal of the second circuit board, and the conduction path portion according to a further embodiment;

FIG. 57 illustrates the heat radiating member according to another embodiment;

FIG. 58A is a perspective view illustrating an optical instrument according to an embodiment;

FIG. 58B is a perspective view of an optical instrument according to another embodiment;

FIG. 58C is a perspective view of an optical instrument according to a further embodiment;

FIG. 59 is a view illustrating the configuration of the optical instrument illustrated in FIGS. 58A to 58C.

### BEST MODE

Hereinafter, embodiments of the present invention will be described in detail with reference to the accompanying drawings.

The technical idea of the present invention may be embodied in many different forms, and should not be construed as being limited to the following embodiments set forth herein. One or more of components of the embodiments may be selectively combined with each other or replaced without departing from the technical spirit and scope of the present invention.

Unless otherwise particularly defined, terms (including technical and scientific terms) used in the embodiments of the present invention have the same meanings as those commonly understood by one of ordinary skill in the art to which this invention belongs. It will be further understood that commonly used terms, such as those defined in dictionaries, should be interpreted as having meanings consistent with their meanings in the context of the relevant art.

The terminology used in the embodiments of the present invention is for the purpose of describing particular embodiments only, and is not intended to limit the present invention. As used in the disclosure and the appended claims, the singular forms are intended to include the plural forms as well, unless the context clearly indicates otherwise. The phrase “at least one of A, B or C” or “one or more of A, B and C” may be interpreted as including one or more of all combinations of A, B and C.

Furthermore, when describing the components of the present invention, terms such as “first”, “second”, “A”, “B”, “(a)” or “(b)” may be used. Since these terms are provided merely for the purpose of distinguishing the components from each other, they do not limit the nature, sequence or order of the components.

It should be understood that, when an element is referred to as being “linked”, “coupled” or “connected” to another element, the element may be directly “linked”, “coupled” or “connected” to the other element, or may be “linked”, “coupled” or “connected” to the other element via a further element interposed therebetween. Furthermore, it will be understood that, when an element is referred to as being formed “on” or “under” another element, it can be directly “on” or “under” the other element, or can be indirectly disposed with regard thereto, with one or more intervening elements therebetween. In addition, it will also be understood that “on” or “under” the element may mean an upward direction or a downward direction based on the element.

Hereinafter, an AF operation unit may alternatively be referred to as a “lens moving apparatus”, a “lens moving unit”, a “VCM (Voice Coil Motor)”, an “actuator” or a “lens moving device”. Hereinafter, the term “coil” may be interchangeably used with “coil unit”, and the term “elastic member” may be interchangeably used with “elastic unit” or “spring”.

In the follow description, the “terminal” may alternatively be referred to as a “pad”, “electrode”, “conductive layer” or “bonding portion”.

In the following description, the terms “board portion”, “printed circuit board”, “circuit board”, and “board” may be used interchangeably with one another.

For convenience of description, although the camera module according to an embodiment is described using an orthogonal coordinate system (x, y, z), the lens moving apparatus may be described using some other coordinate systems, and the embodiments are not limited thereto. In the respective drawings, the X-axis direction and the Y-axis direction mean directions perpendicular to an optical axis, i.e. the Z-axis. The Z-axis direction, which is the direction of the optical axis OA, may be referred to as a “first direction”, the X-axis direction may be referred to as a “second direction”, and the Y-axis direction may be referred to as a “third direction”. Furthermore, for example, the x-axis direction may be represented as “one of a first horizontal direction and a second horizontal direction”, and the y-axis direction may be represented as “the other of the first horizontal direction and the second horizontal direction”.

For example, the optical axis may be the optical axis of a lens mounted on a lens barrel. Alternatively, for example, the optical axis may be an axis which is perpendicular to the imaging area of an image sensor and extends through the center of the imaging area.

The first direction may be a direction perpendicular to an imaging area of an image sensor. Furthermore, the optical axis direction may be a direction parallel to the optical axis.

The camera device according to an embodiment of the present invention is capable of performing an “autofocus function”. Here, the “autofocus function” serves to automatically focus an image of a subject on an image sensor surface.

Hereinafter, the camera device may alternatively be referred to as a “camera module”, a “camera assembly”, a “camera unit”, a “camera”, an “imaging device”, or a “lens moving apparatus”.

In addition, the camera device according to the embodiment may perform a function of “hand tremor correction”. Here, the function of “hand tremor correction” may serve to inhibit blurring of the contour line of a captured image due to vibration caused by shaking of the user's hand when capturing a still image.

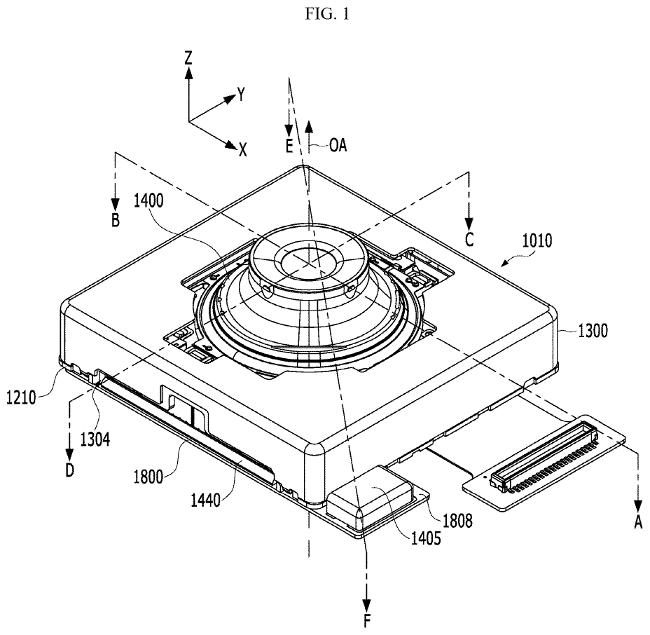

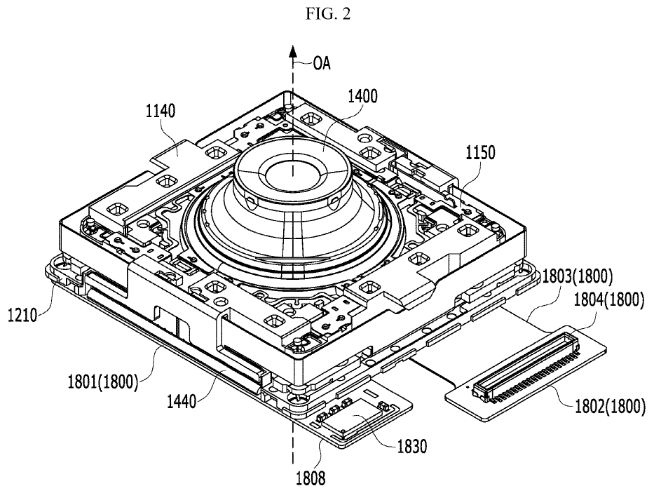

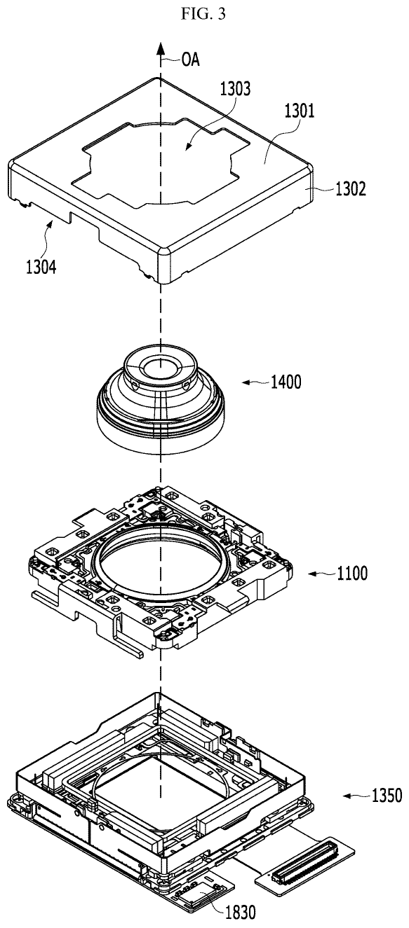

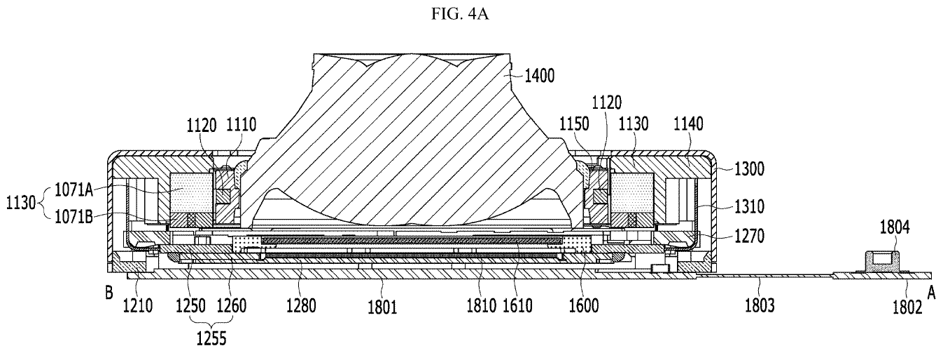

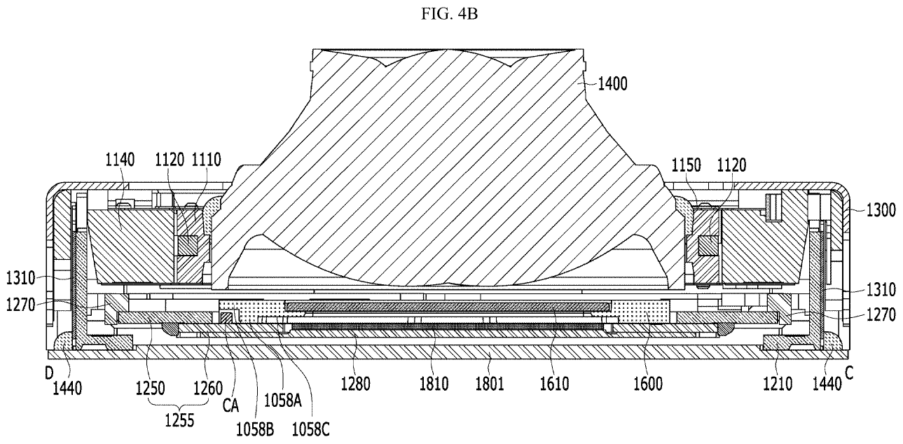

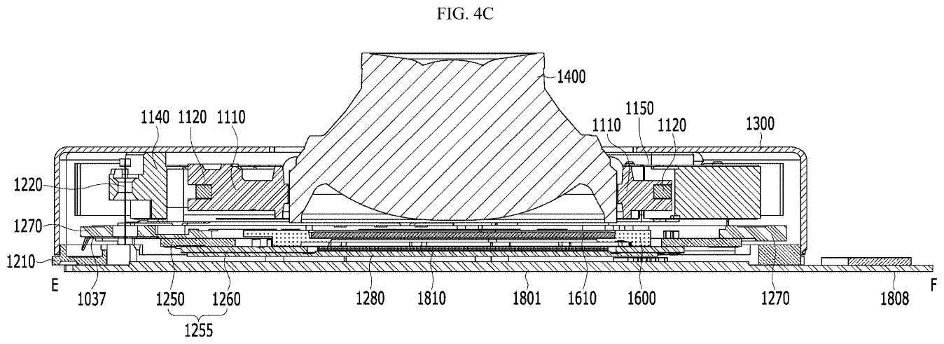

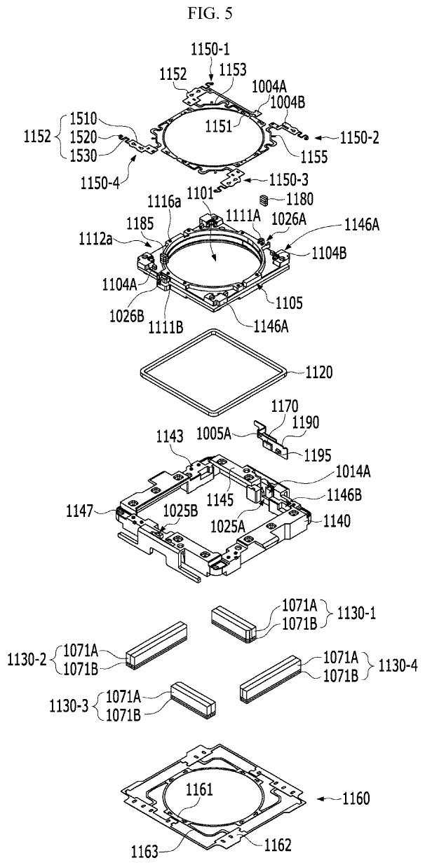

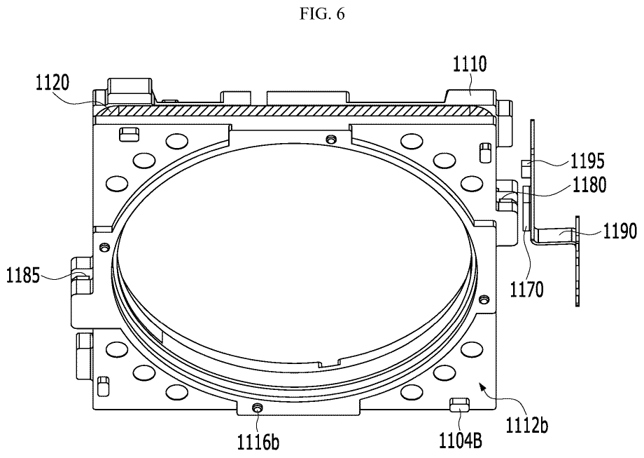

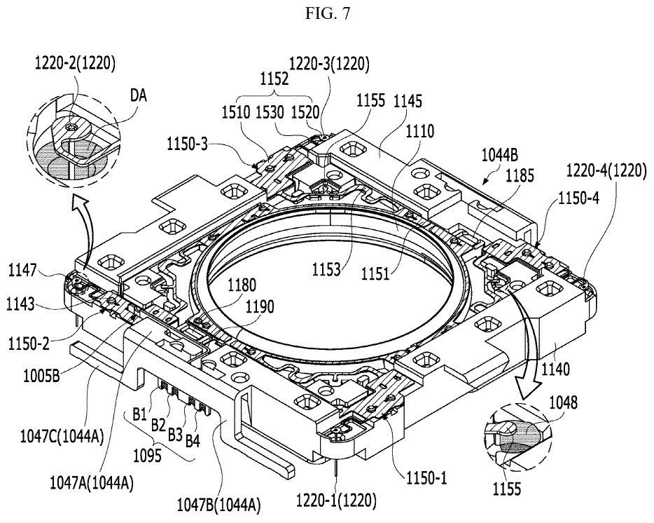

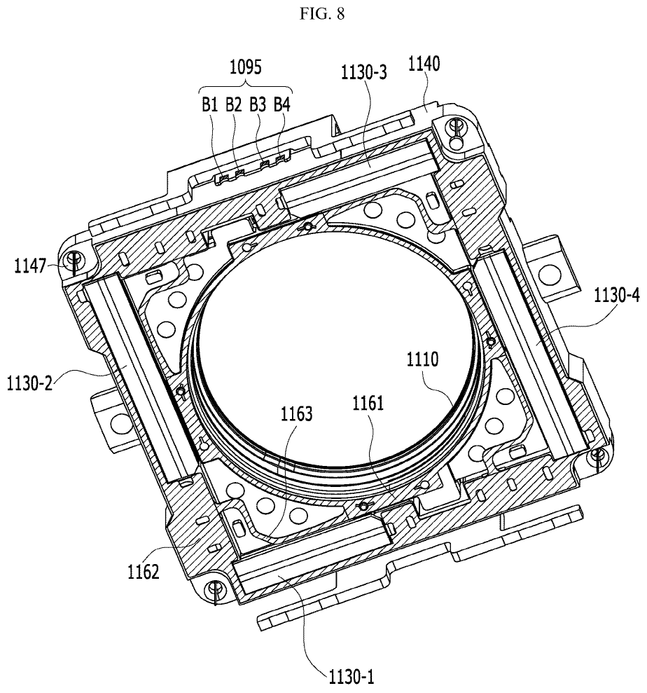

FIG. 1 is a perspective view of a camera device 1010 according to an embodiment. FIG. 2 is a perspective view of the camera device 1010 from which a cover member 1300 is removed. FIG. 3 is an exploded perspective view of the camera device 1010 shown in FIG. 1. FIG. 4A is a cross-sectional view of the camera device 1010 taken along line A-B in FIG. 1. FIG. 4B is a cross-sectional view of the camera device 1010 taken along line C-D in FIG. 1. FIG. 4C is a cross-sectional view of the camera device 1010 taken along line E-F in FIG. 1. FIG. 5 is an exploded perspective view of the AF operation unit 1100 shown in FIG. 3. FIG. 6 is a perspective view of a bobbin 1110, a sensing magnet 1180, a balancing magnet 1185, a first coil 1120, a circuit board 1190, a first position sensor 1170, and a capacitor 1195. FIG. 7 is a perspective view of the bobbin 1110, a housing 1140, the circuit board 1190, an upper elastic member 1150, the sensing magnet 1180, the balancing magnet 1185, a wire 1220, and a damper 1048 or DA. FIG. 8 is a bottom perspective view of the housing 1140, the bobbin 1110, a lower elastic member 1160, a magnet 1130, and the circuit board 1190.

Referring to FIGS. 1 to 8, the camera device 1010 may include the AF operation unit 1100 and the image sensor unit 1350. The AF operation unit 1100 may include an AF moving unit. The image sensor unit 1350 may include an OIS operation unit. The OIS operation unit may include an OIS moving unit. One of the AF moving unit and the OIS moving unit may be a first moving unit, and the other of the AF moving unit and the OIS moving unit may be a second moving unit.

The camera device 1010 may further include at least one of the cover member 1300 or a lens module 1400. The cover member 1300 and a base 1210, which will be described later, may constitute the case.

The AF operation unit 1100 may be coupled to the lens module 1400 so as to move the lens module in the direction of the optical axis OA or in a direction parallel to the optical axis, and may perform the autofocus function of the camera device 1010.

The image sensor unit 1350 may include an image sensor 1810. For example, the image sensor unit 1350 (or the OIS operation unit) may include the OIS operation unit including the image sensor 1810. For example, the image sensor unit 1350 may move the OIS moving unit (for example, the image sensor 1810) in a direction perpendicular to the optical axis. Furthermore, the image sensor unit 1350 may cause tilting or rotation (or rolling) of the OIS moving unit (for example, the image sensor 1810) relative to or about the optical axis. By virtue of the image sensor unit 1350, the camera device 1010 may perform hand tremor correction.

For example, the image sensor 1810 may include an imaging area configured to sense the light passing through the lens module 1400. Here, the imaging area may alternatively be referred to as an “effective area”, a “light-receiving area”, an “active area”, or a “pixel area”. For example, the imaging area of the image sensor 1810 may be an area on which the light passing through a filter 1610 is incident and thus the image included in the light is formed, and may include at least one unit pixel. For example, the imaging area may include a plurality of unit pixels.

The AF operation unit 1100 may alternatively be referred to a “lens moving unit” or a “lens moving apparatus”. Alternatively, the AF operation unit 1100 may alternatively be referred to as a “first moving unit (or a second moving unit)”, a “first actuator (or a second actuator)” or “AF operation unit”.

Furthermore, the image sensor unit 1350 may alternatively be referred to as an “image sensor moving unit”, an “image sensor shift unit”, a “sensor moving unit”, or a “sensor shift unit”. Furthermore, the image sensor unit 1350 may alternatively be referred to as a “second moving unit” (or “first moving unit”) or a “second actuator” (or “first actuator”).

Referring to FIGS. 5 and 6, the AF operation unit 1100 may move the lens module 1400 in the optical axis direction. For example, the AF operation 1100 may move the bobbin 1110 in the optical axis direction. For example, the AF operation unit 1100 may include the bobbin 1100, the first coil 1120, the magnet 1130, and the housing 1140. The AF operation unit 1100 may further include the upper elastic member 1150 and the lower elastic member 1160.

The AF operation unit 1100 may further include the first position sensor 1170, the circuit board 1190 and the sensing magnet 1180 for the purpose of AF feedback operation. Furthermore, the AF operation unit 1100 may further include at least one of the balancing magnet 1185 or the capacitor 1195.

The bobbin 1110 may be disposed in the housing 1140, and may be moved in the direction of the optical axis OA or in the first direction (for example, in the Z-axis direction) by virtue of the electromagnetic interaction between the first coil 1120 and the magnet 1130.

The bobbin 1110 may include a bore to which the lens module 1400 is coupled or the lens module 1400 is mounted. For example, the bore in the bobbin 1110 may be a through hole formed through the bobbin 1110 in the optical axis direction. Although the bore in the bobbin 1110 may have a circular shape, an elliptical shape or a polygonal shape, the present disclosure is not limited thereto.

For example, the lens module 1400 may include at least one lens. For example, the lens module 1400 may include a lens barrel. For example, the lens module 1400 may include a lens barrel and one or more lenses mounted or coupled to the lens barrel. However, a component of the lens module is not limited to the lens barrel, and may be any other component as long as the component has a holder structure capable of supporting the one or more lenses.

For example, the lens module 1400 may be threadedly coupled to the bobbin 1110. Alternatively, for example, the lens module 1400 may be coupled to the bobbin 1110 by means of an adhesive (not shown). The lens module 1400 may be spaced apart from the filter 1610 in the optical axis direction. The light passing through the lens module 1400 may be radiated to the image sensor 1810 through the filter 1610.

The bobbin 1110 may include one or more projections 1111A and 1111B provided on the outer surface thereof. For example, although the one or more projections 1111A and 1111B may project in a direction parallel to a line perpendicular to the optical axis OA, the present disclosure is not limited thereto. For example, the bobbin 1110 may include two projections 1111A and 1111B which are positioned opposite each other.

The projections 1111A and 1111B of the bobbin 1110 may correspond to grooves 1025A and 1205B in the housing 1140 and may be inserted into or disposed in the grooves 1025A and 1025B in the housing 1140 so as to suppress or inhibit the bobbin 1110 from being rotated about the optical axis beyond a predetermined range.

The bobbin 1110 may include a projection 1146A projecting in a direction perpendicular to the optical axis. For example, the projection 1146A of the bobbin 1110 may be disposed on a corner of the bobbin 1110.

The housing 1140 may include a groove 146B which corresponds to, faces or overlaps the projection 1146A of the bobbin 1110. At least a portion of the projection 1146A may be disposed in the groove 146B in the housing 1140.

The projection 1146A of the bobbin 1110 may serve as a stopper configured to permit the bobbin 1110 to be moved within a predetermined range in the optical axis direction (for example, in a direction toward the lower elastic member 1160 from the upper elastic member 1150).

The upper surface of the bobbin 1110 may be provided therein with a first escape groove 1113a for avoidance of spatial interference with a first frame connector 1153 of the upper elastic member 1150. Furthermore, the lower surface of the bobbin 1110 may be provided therein with a second escape groove 1112b for avoidance of spatial interference with a second frame connector 1163 of the lower elastic member 1160.

The bobbin 1110 may include a first coupler 1116a which is coupled or fixed to the upper elastic member 1150. For example, although the first coupler 1116a of the bobbin 1110 may have the form of a protrusion, the present disclosure is not limited thereto. In another embodiment, the first coupler 1116a may have the form of a flat surface or a groove. Furthermore, the bobbin 1110 may include a second coupler 1116b which is coupled or fixed to the lower elastic member 1160. For example, although the second coupler 1116b may have the form of a protrusion, the present disclosure is not limited thereto. In another embodiment, the second coupler 1116b may have the form of a flat surface or a groove.

Referring to FIG. 5, the outer surface of the bobbin 1110 may be provided with a groove 1105 in which the first coil 1120 is seated, inserted or disposed. For example, the groove 1105 in the bobbin 1110 may have a shape, that is, a closed curve shape (for example, a ring shape) which coincides with the shape of the first coil 1120.

Furthermore, the bobbin 1110 may be provided with a first seating groove 1026a in which the sensing magnet 1180 is seated, inserted, fixed or disposed. Furthermore, the outer surface of the bobbin 1110 may be provided therein with a second seating groove 1026b in which the balancing magnet 1185 is seated, inserted, fixed or disposed.

For example, the first and second seating grooves 1026A and 1026B in the bobbin 1110 may be formed in outer surfaces of the bobbin 1110 which are opposed to each other. For example, the first seating groove 1026A may be formed in a first projection 1111A of the bobbin 1110, and the second seating groove 1026B may be formed in a second projection 1111B of the bobbin 1110.

The bobbin 1110 may include a guide protrusion 1104A configured to guide a portion of the first frame connector 1153 of the upper elastic member 1150. For example, the guide protrusion 1104A may project from the bottom surface of an escape portion 1112a of the bobbin 1110. Furthermore, for example, the bobbin 1110 may include a guide protrusion 1103 configured to guide a portion of the second frame connector 1163 of the lower elastic member 1160. For example, the guide protrusion 1103 may project from the bottom surface of the escape portion 1112b of the bobbin 1110.

Referring to FIGS. 5 and 7, the damper 1048 may be disposed between the bobbin 1110 and the upper elastic member 1150. For example, the damper 1048 may be disposed between the bobbin 1110 and the first frame connector 1153 of the upper elastic member 1150, and may be in contact with, coupled or attached to both the bobbin 1110 and the first frame connector 1153.

For example, the upper elastic member 1150 may include an extension (or a projection) which extends from the first frame connector 1153. The extension 1155 may be spaced apart from each of an outer frame 1152 and an inner frame 1151. The extension 1155 may be spaced apart both from one end of the first frame connector 1153 connected to the inner frame 1151 and from the other end of the first frame connector 1153 connected to the outer frame 1152. The extension 1155 may extend toward the upper surface of the bobbin 1110.

For example, a portion (or the end) of the extension 1155 may be disposed on the damper 1048 disposed on the upper surface of the bobbin 1110, and may overlap the damper 1048. For example, the bobbin 1110 may include a reception portion 1104B in which the damper 1048 is received or disposed. For example, the reception portion 1104B may be a groove. The reception portion 1104B may be depressed from the bottom surface of the escape portion 1112a of the bobbin 1110.

For example, the damper 1048 may be disposed between the reception portion 1104B of the bobbin 1110 and the extension 1155 of the upper elastic member 1150, and may be in contact with, coupled or attached to both the reception portion 1104B and the extension 1155. Because the damper 1048 is in contact with or attached to both the extension 1155 and the reception portion 1104B, the damper 1048 may serve to damper or absorb vibration of the bobbin 1110. For example, the damper 1048 may be made of a damping member (for example, silicone).

The first coil 1120 may be disposed or coupled to the bobbin 1110. For example, the first coil 1120 may be disposed or coupled to the outer surface of the bobbin 1110. For example, although the first coil 1120 may surround the outer surface of the bobbin 1110 in a rotational direction about the optical axis OA, the present disclosure is not limited thereto.

Although the first coil 1120 may be directly wound around the outer surface of the bobbin 1110, the present disclosure is not limited thereto. In another embodiment, the first coil 1120 may be provided as a coil ring wound around the bobbin 1110, or may be provided as an angled coil block.

Power or a drive signal may be supplied to the first coil 1120. The power or drive signal supplied to the first coil 1120 may be a DC signal, an AC signal, or a signal containing both DC and AC components, and may be of a voltage type or a current type.

When a drive signal (for example, a drive current) is supplied to the first coil 1120, electromagnetic force may be created by the electromagnetic interaction between the first coil 1120 and the magnet 1130, and the bobbin 1110 may be moved in the optical axis direction OA by the created electromagnetic force.

At the initial position of the AF operation unit, the bobbin 1110 may be moved upwards or downwards from the initial position of the AF operation unit, which is referred to as bidirectional driving of the AF operation unit. Alternatively, at the initial position of the AF operation unit, the bobbin 1110 may be moved upwards, which is referred to as unidirectional driving of the AF operation unit.

At the initial position of the AF operation unit, the first coil 1120 may correspond to or overlap the magnet 1130 disposed on the housing 1140 in a direction parallel to a line that is perpendicular to the optical axis OA and extends along the optical axis.

For example, the AF operation unit may include the bobbin 1110 and the components (for example, the first coil 1120, the sensing magnet 1180, and the balancing magnet 1185) coupled to the bobbin 1110. The AF operation unit may further include the lens module 1400.

The initial position of the AF operation unit may be the original position of the AF operation unit in the state in which no electric power is applied to the coil 120 or the position at which the AF operation unit is located as the result of the upper and lower elastic members 150 and 160 being elastically deformed due only to the weight of the AF operation unit. In addition, the initial position of the bobbin 110 may be the position at which the AF operation unit is located when gravity acts in the direction from the bobbin 110 to the base 210 or when gravity acts in the direction from the base 210 to the bobbin 110.

The sensing magnet 180 may provide a magnetic field, which is detected by the first position sensor 1170, and the balancing magnet 1185 may serve to cancel out the influence of the magnetic field of the sensing magnet 1180 and to establish weight equilibrium with respect to the sensing magnet 1180.

The sensing magnet 1180 may alternatively be referred to as a “sensor magnet” or a “second magnet”. The sensing magnet 1180 may be disposed on the bobbin 1110 or may be coupled to the bobbin 1110. The sensing magnet 1180 may be disposed so as to face the first position sensor 1170. The balancing magnet 1185 may be disposed on the bobbin 1110 or may be coupled to the bobbin 1110. For example, the balancing magnet 1185 may be disposed opposite the sensing magnet 1180. The balancing magnet 1185 may alternatively be referred to as a “balancing member” or a “weight member”. In another embodiment, the balancing member may be a non-magnetic body.

For example, although each of the sensing magnet and the balancing magnet 1180 and 1185 may be a monopolar magnetized magnet having one N pole and one S pole, the disclosure is not limited thereto. In another embodiment, each of the sensing magnet and the balancing magnet 1180 and 1185 may be a bipolar magnetized magnet, which has two N poles and two S poles, or a tetrapolar magnetized magnet.

The sensing magnet 1180 may be moved together with the bobbin 1110 in the optical axis direction, and the first position sensor 1170 may detect the intensity or magnetic force of the magnetic field of the sensing magnet 1180, which is moved in the optical axis direction, and may output an output signal corresponding to the result of the detection.

For example, in accordance with displacement of the bobbin 1110 in the optical axis direction, the intensity or magnetic force of the magnetic field detected by the first position sensor 1170 may vary. Consequently, the first position sensor 1170 may output an output signal proportional to the detected intensity of the magnetic field, and the displacement of the bobbin 1110 in the optical axis direction may be detected using the output signal from the first position sensor 1170.

The housing 1140 may be disposed in the cover member 1300. For example, the housing 1140 may be disposed on the image sensor unit 1350.

The housing 1140 may receive therein the bobbin 1110, and may support the magnet 1130, the first position sensor 1170, and the circuit board 1190.

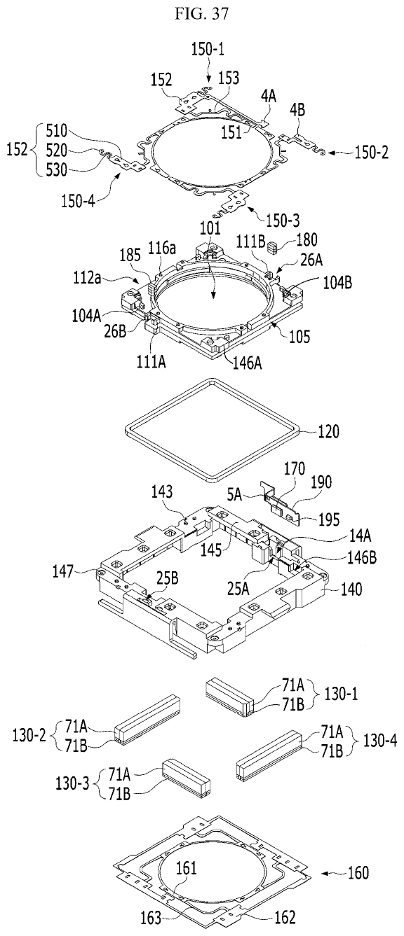

Referring to FIGS. 37, 38 and 40, the housing 1140 may have a hollow columnar shape. For example, the housing 1140 may have a polygonal (for example, a rectangular or octagonal) or circular bore, and the bore in the housing 1140 may be a through hole, which is formed through the housing 1140 in the optical axis direction.

The housing 1140 may include side portions, which correspond to or face the side plate 1302 of the cover member 1300, and corners, which correspond to or face the corners of the cover member 1300.

In order to inhibit direct collision with the inner surface of the upper plate 1301 of the cover member 1300, the housing 1140 may include a stopper 145 provided at the upper portion, the upper surface or the upper end thereof.

Referring to FIG. 5, the housing 1140 may have a mounting groove (or a groove) 1014a configured to receive the circuit board 1190 therein. The mounting groove 1014a may have a shape corresponding to the shape of the circuit board 1190.

Referring to FIG. 7, the housing 1140 may include projections 1044A and 1044B surrounding at least one of the circuit board 1190 or the support board 1310. For example, the projections 1044A and 1044B may be disposed or formed on the outer surface of the housing 1140. For example, the projections 1044A and 1044B may be disposed or formed on the outer surface of the side portion of the housing 1140. The projections 1044A and 1044B may alternatively be referred to as “protectors”, “supports”, “extensions”, or “guides”.

The projections 1044A and 1044B of the housing 1140 may surround at least a portion of the circuit board 1190 and at least a portion of the support board 1310. For example, the housing 1140 may include a first projection 1044A disposed on the first side portion of the housing, and a second projection 1044B disposed on the second side portion of the housing 1140. The first projection 1044A and the second projection 1044B may be positioned opposite to each other based on the optical axis OA or the bobbin 1110. In another embodiment, the second projection 1044B may be omitted.

For example, the circuit board 1190 may be disposed in the first projection 1044A. For example, the mounting groove 1014A may be formed in the first projection 1044A.

For example, each of the first projection 1044A and the second projection 1044B may include a first portion 1047A connected to the upper surface of the housing 1140, and a second portion 1047B which is connected to the first portion 1047A and is spaced apart from the side portion of the housing 1140. For example, the first portion 1047A of the first projection 1044A may be connected to the upper surface of the first side portion of the housing 1140, and the first portion 1047A of the second projection 1044B may be connected to the upper surface of the second side portion of the housing 1140. For example, the first portion 1047A may project from the upper surface of the housing 1140 in the optical axis direction or in a direction toward the inner surface of the upper plate 1301 of the cover member 1300.

For example, at least a portion of the circuit board 1190 may be positioned between the first portion 1047A and the second portion 1047B of the first projection 1044A. Furthermore, for example, at least a portion of the support board 1310 may be positioned between the first portion 1047A and the second portion 1047B of the first projection 1044A.

The housing 1140 may include an opening through which the terminals B1 to B4 of a terminal member 1095 of the circuit board 1190 are exposed. The opening may be formed in the side portion of the housing 1140.

Each of the first projection 1044A and the second projection 1044B of the housing 1140 may include a third portion 1047C extending from the second portion 1047B. For example, the third portion 1047C may extend or project from the lower portion or the lower end of the second portion 1047B in a direction (for example, in a second horizontal direction) parallel to the outer surface of the first side portion (or the second side portion) of the housing 1140.

For example, the third portion 1047C may include a first of third portion extending from one end of the second portion 1047B, and a second of third portion extending from another end of the second portion 1047B. The first of third portion and the second of third portions may extend or project in opposite directions.

An adhesive or a sealing member may be disposed between the projections 1044A and 1044B of the housing 1140 and the cover member 1300. For example, the adhesive (or the sealing member) may be disposed between the projections 1044A and 1044B of the housing 1140 and the side plate 1302 of the cover member 1300 for bonding therebetween. The projections 1044A and 1044B may increase the coupling area between the projections and the side plate of the cover member 1300, and may stably couple the housing 1140 to the cover member 1300 without interference with the support board 1310.

The upper portion, the upper end or the upper surface of the housing 1140 may be provided with at least one first coupler, which is to be coupled to a first outer frame 1152 of the upper elastic member 1150. The lower portion, the lower end or the lower surface of the housing 1140 may be provided with a second coupler, which is to be coupled and fixed to a second outer frame 1162 of the lower elastic member 1160. For example, each of the first and second couplers of the housing 1140 may have the shape of a flat surface, a protrusion, or a groove.

A corner of the housing 1140 may be provided therethrough with a hole 1147 which is a path through which the wire 1220 extends. The hole 1147 may be a through hole which is formed through the housing 1140 in the optical axis direction. In another embodiment, the hole may be a structure depressed from the outer surface of the corner portion of the housing 1140, and at least a portion of the hole may be open at the outer surface of the corner portion. The number of holes 1147 in the housing 1140 may be equal to the number of support members.

The magnet 1130 may be disposed, coupled or fixed to the housing 1140 which is the stationary unit. For example, the magnet 1130 may be disposed, coupled or fixed to the side portion of the housing 1140. The magnet 1130 may include an AF operation magnet 1071A for AF operation. Furthermore, the magnet 1130 may include an OIS operation magnet 1071B for OIS operation. Hereinafter, the AF operation magnet 1071A may be represented as one of a first magnet and a second magnet, and the OIS operation magnet 1071B may be represented as the other of the first magnet and the second magnet.

In another embodiment, the magnet 1130 may be disposed, coupled or fixed to the corner portion of the housing.

For example, the magnet 1130 may include a plurality of magnet units. For example, the magnet 1130 may include first to fourth magnet units 1130-1 to 1130-4 disposed on the housing 1140. In another embodiment, the magnet 1130 may include two or more magnet units.

The magnet 1130 may be disposed on at least one of the side portion or the corner portion of the housing 1140. For example, at least a portion of the magnet 1130 may be disposed on the side portion or the corner portion of the housing 1140. Alternatively, for example, at least a portion of the magnet 1130 may be disposed on the side portion of the housing 1140, and the remaining portion of the magnet 1130 may be disposed at the corner portion of the housing 1140.

For example, each of the magnet units 1130-1 to 1130-4 may include a first portion disposed at a corresponding one of the four corners of the housing 140. Furthermore, each of the magnet units 1130-1 to 1130-4 may include a second portion disposed at a side portion of the housing 1140 adjacent to the corresponding corner of the housing 1140.

For example, the first magnet unit 1130-1 and the third magnet unit 1130-3 may be positioned opposite to each other in the first horizontal direction (for example, in the Y-axis direction) based on the housing 1140. For example, the second magnet unit 1130-2 and the fourth magnet unit 1130-4 may be positioned opposite to each other in the second horizontal direction (for example, in the X-axis direction) based on the housing 1140.

For example, the first magnet unit 130-1 and the third magnet unit 1130-3 may be disposed parallel to each other in the second horizontal direction (for example, in the X-axis direction), and the second magnet unit 1130-2 and the fourth magnet unit 1130-4 may be disposed parallel to each other in the first horizontal direction (for example, in the Y-axis direction).

At the initial position of the AF operation unit, the magnet 1130 may be disposed on the housing 1140 so as to partially overlap the first coil 1120 in a direction parallel to a line which is perpendicular to the optical axis OA and extends through the optical axis OA.

The magnet 1130 may include a monopolar magnetized magnet or a dipole magnet, which includes one N pole and one S pole. In another embodiment, the magnet 1130 may include a bipolar magnetized magnet or a quadrupole magnet, which includes two N poles and two S poles. In a further embodiment, the magnet 1130 may include both a monopolar magnetized magnet and a bipolar magnetized magnet.

For example, the magnet 1130 may include an AF magnet (or an AF operation magnet) for AF operation and an OIS magnet (or an OIS operation magnet) for OIS operation. In another embodiment, for example, the magnet 1130 may be a common magnet for AF operation and OIS operation.

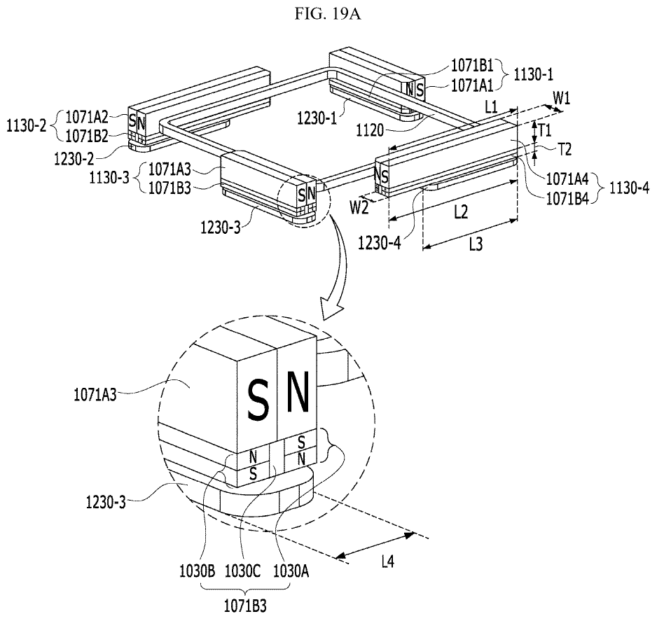

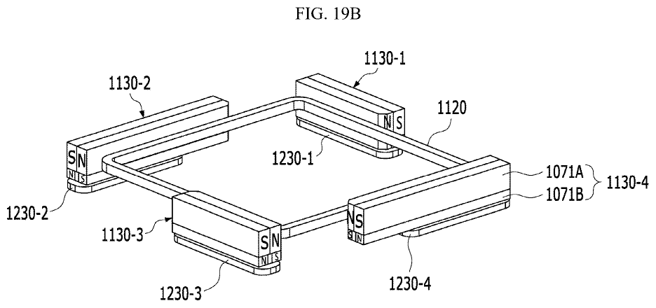

FIG. 19A illustrates an embodiment of the magnet 1130 shown in FIG. 5.

Referring to FIG. 19A, the magnet 1130 may include the first magnet 1071A, which is an AF operation magnet, and the second magnet 1071B disposed below the first magnet 1071A.

The first magnet 1071A may be a dipole magnet including one N pole and one S pole. For example, the N pole and the S pole of the first magnet 1071A may be disposed so as to face or be opposed to each other in a direction perpendicular to the optical axis. In another embodiment, the first magnet 1071A may be a quadrupole magnet including two N poles and two S poles.

The first magnet 1071A may include a plurality of magnet units 1071A1 to 1071A4. As mentioned above, each of the plurality of magnet units 1071A1 to 1071A4 may be a dipole magnet or a quadrupole magnet. For example, the magnet units 1071A1 to 1071A4 may have the same size and shape. For example, two magnet units 1071A1 and 1071A3, which are opposed to each other in a first diagonal direction, may have the same size and shape, and the two remaining magnet units 1071A2 and 1071A4, which are opposed to each other in a second diagonal direction, may have the same size and shape.

In another embodiment, the size and the shape of each of the two magnet units 1071A1 and 1071A3 may be different from the size and the shape of each of the two remaining magnet units 1071A2 and 1072A4. For example, the length of the long side of each of the two magnet units 1071A1 and 1071A3 may be greater than the length of the long side of each of the two remaining magnet units 1071A2 and 1071A4. For example, the length of the short side of each of the two magnet units 1071A and 1071A3 may be equal to the length of the short side of each of the two remaining magnet units 1071A2 and 1071A4.

The second magnet 1071B may be a quadrupole magnet including two N poles and two S poles. For example, the second magnet 1071B may include a first magnet portion 1030A, a second magnet portion 1030B, and a partition wall 1030C disposed between the first magnet portion 1030A and the second magnet portion 1030B. Here, the partition wall 1030C may be a non-magnetic material or air, and may be referred to as a “neutral zone”. In another embodiment, the second magnet 1071B may be a dipole magnet including one N pole and one S pole.

For example, the first magnet portion 1030A and the second magnet portion 1030B may be spaced apart from each other in a direction perpendicular to the first direction (or the optical axis direction). For example, the first magnet portion 1030A may include a first N pole and a first S pole which are opposed to or face each other in the optical axis direction. The second magnet portion 1030B may include a second N pole and a second S pole which are opposed to or face each other in the optical axis direction. Furthermore, the first N pole (or the first S pole) of the first magnet portion 1030A and the second S pole (or the second N pole) of the second magnet portion 1030B may be opposed to or face each other in a direction perpendicular to the optical axis.

The second magnet 1071B may include a plurality of magnet units 1071B1 to 1071B4. As mentioned above, each of the plurality of magnet units 1071B1 to 1071B4 may be a quadrupole magnet. In another embodiment, each of the magnet units 1071B1 to 1071B4 may be a dipole magnet. Each of the magnet units 1071B1 to 1071B4 may face or overlap a corresponding one of the second coil units 1230-1 to 1230-4.

For example, the magnet units 1071B1 to 1071B4 may have the same size and shape. For example, two magnet units 1071B1 and 1071B3, which are opposed to each other in the first diagonal direction, may have the same size and shape, and the two remaining magnet units 1071B2 and 1071B4, which are opposed to each other in the second diagonal direction, may have the same size and shape.

In another embodiment, the size and shape of each of the two magnet units 1071B1 and 1071B3 may be different from the size and shape of each of the two remaining magnet units 1071B2 and 1071B4. For example, the length of the long side of each of the two magnet units 1071B1 and 1071B3 may be greater than the length of the long side of each of the two remaining magnet units 1071B2 and 1071B4. For example, the length of the short side of each of the two magnet units 1071B1 and 1071B3 may be equal to the length of the short side of each of the two remaining magnet units 1071B2 and 1071B4.

The second magnet 1071B may be disposed below the first magnet 1071A. The second magnet 1071B may be disposed on the lower surface of the first magnet 1071A. For example, the upper surface of the second magnet 1071B may be in contact with the lower surface of the first magnet 1071A or may be fixed or coupled to the lower surface of the first magnet 1071A by means of an adhesive. For example, at least a portion of the first magnet 1071A may overlap at least a portion of the second magnet 1071B in the first direction (or in the optical axis direction).

In another embodiment, the second magnet may be spaced apart from the first magnet. Here, a portion of the housing 1140 may be disposed between the first magnet and the second magnet. In another embodiment, a partition wall or a Yoke may be disposed between the first magnet and the second magnet. Here, the description of the partition wall 1030C may be applied to the partition wall with or without modification.

For example, the length T2 of the second magnet 1071B in the optical axis direction may be less than the length T1 of the first magnet 1071A in the optical axis direction (T2<T1). In another embodiment, the length T2 may be equal to the length T1.

The length L2 of the long side of the second magnet 1071B may be equal to or less than the length L1 of the long side of the first magnet 1071A (L2≤L1). In another embodiment, the length L2 may be greater than the length L1.

Furthermore, the width W2 (or the length of the short side) of the second magnet 1071B may be equal to or less than the width W1 (or the length of the short side) of the first magnet 1071A (W2≤W1). In another embodiment, the width W2 may be greater than the width W1.

At the initial position of the AF moving unit, the first coil 1120 may face or overlap the first magnet 1071A in a direction perpendicular to the first direction (or the optical axis direction). Although the N pole of the first magnet 1071A may be disposed so as to face the first coil 1120 or may be positioned closer to the first coil 1120 than the S pole in FIG. 19A, the disposition may be reversed in another embodiment.

For example, at the initial position of the OIS moving unit, at least a portion of the first magnet 1130 may overlap at least a portion of the second coil 1230 in the first direction (or in the optical axis direction). For example, at the initial position of the OIS moving unit, at least a portion of the second magnet 1071B may overlap at least a portion of the second coil 1230 in the first direction (or in the optical axis direction).

The length L2 of the long side of the second magnet 1071B may be greater than the length L3 of the long side of the second coil 1230 (L2>L3). In another embodiment, the length of the long side of the second magnet 1071B may be equal to or less than the length of the long side of the second coil 1230.

The width W2 (or the length of the short side) of the second magnet 1071B may be greater than the length LA of the short side of the second coil 1230 (W2>L4). In another embodiment, the length of the long side of the second magnet 1071B may be equal to or less than the length of the long side of the second coil 1230.

For example, the length of the long side of each of two magnet units 1081B1 and 1071B3 of the second magnet 1071B may be less than the length of the long side of each of the coil units 1230-1 and 1230-3 of the second coil 1230. In another embodiment, the length of the long side of each of the two magnet units 1071B1 and 1071B3 may be equal to or greater than the length of the long side of each of the coil units 1230-1 and 1230-3.

Furthermore, the length of the long side of each of the two remaining magnet units 1071B2 and 1071B4 of the second magnet 1071B may be greater than the length of the long side of each of the coil units 1230-2 and 1230-4 of the second coil 1230. In another embodiment, the length of the long side of each of the magnet units 1071B2 and 1071B4 may be equal to or less than the length of the long side of each of the coil units 1230-2 and 1230-4 of the second coil 1230.

For example, the length of the short side of each of the first to fourth magnet units 1071B1 to 1071B4 of the second magnet 1071B may be less than the length of the short side of each of the first to fourth coil units 1230-1 to 1230-4 of the second coil 1230. In another embodiment, the length of the short side of each of the first to fourth magnet units 1071B to 1071B4 may be greater than the length of the short side of each of the first to fourth coil units 1230-1 to 1230-4.

FIG. 19B illustrates another embodiment of the magnet 1130 shown in FIG. 5.

Referring to FIG. 19B, the second magnet 1071BB shown in FIG. 19B may be a dipole magnet including one N pole and one S pole. The description of the lengths T2, L2 and W2 of the second magnet 1071B shown in FIG. 19A may be applied to the second magnet 1071BB shown in FIG. 19B with or without modification.

The circuit board 1190 may be disposed on the housing 1140, and the first position sensor 1170 may be disposed or mounted on the circuit board 1190 and may be electrically connected to the circuit board 1190. For example, the circuit board 1190 may be disposed in the mounting groove 1014A in the housing 1140, and the terminal member 1095 of the circuit board 1190 may be exposed to the outside of the housing 1140.

The circuit board 1190 may include the terminal member (or terminal unit) 1095 including a plurality of terminals B1 to B4 electrically connected to an external terminal or an external device. The plurality of terminals B1 to B4 of the circuit board 1190 may be electrically connected to the first position sensor 1170.

The first position sensor 1170 may be disposed on the housing 1140 and/or the circuit board 1190. For example, the first position sensor 1170 may be disposed on the first surface of the circuit board 1190, and the plurality of terminals B1 to B4 may be disposed on the second surface of the circuit board 1190. Here, the second surface of the circuit board 1190 may be the opposite surface of the first surface of the circuit board 1190. For example, the first surface of the circuit board 1190 may be a surface of the circuit board 1190 which faces the bobbin 1110 or the sensing magnet 1180. For example, the circuit board 1190 may be a printed circuit board or a flexible printed circuit board.

The first position sensor 1170 may be electrically connected to the circuit board 1190. For example, the first position sensor 1170 may be electrically connected to the first to fourth terminals B1 to B4 of the circuit board 1190. For example, the circuit board 1190 may include a circuit pattern or a wire (not shown) configured to electrically connect the first to fourth terminals B1 to B4 to the first position sensor 1170.

For example, at the initial position of the AF operation unit, at least a portion of the first position sensor 1170 may face or overlap the sensing magnet 1180 in a direction parallel to a line which is perpendicular to the optical axis OA and extends through the optical axis OA. In another embodiment, at the initial position of the AF operation unit, the first position sensor may not face or overlap the sensing magnet.

The first position sensor 1170 may serve to detect movement, displacement or position of the bobbin 1110 in the optical axis direction. In other words, the first position sensor 1170 may detect a magnetic field or intensity of a magnetic field of the sensing magnet 1180 mounted on the bobbin 1110 caused by movement of the bobbin 1110, and may output an output signal corresponding to the result of detection. Accordingly, movement, displacement or position of the bobbin 1110 may be detected using the output of the first position sensor 1170.

The first position sensor 1170 may be a driver IC including a Hall sensor and a driver. The position sensor 1170 may include first to fourth terminals for transmitting and receiving data to and from an external device through data communication using a protocol, such as I2C communication, and fifth and sixth terminals for directly supplying a drive signal to the coil 1120.

For example, each of the first to fourth terminals of the first position sensor 1170 may be electrically connected to a corresponding one of the first to fourth terminals B1 to B4 of the circuit board 1190 using solder or a conductive adhesive.

For example, the fifth and sixth terminals of the first position sensor 1170 may be electrically connected to the first coil 1120. For example, the first position sensor 1170 may be electrically connected to the first coil 1120 via at least one of the upper elastic member 1150 and the lower elastic member 1160 so as to supply a drive signal to the first coil 1120.

For example, a portion of the first upper elastic unit 1150-1 may be connected to one end of the first coil 1120, and another portion of the first upper elastic unit 1150-1 may be electrically connected to the circuit board 1190. A portion of the second upper elastic unit 1150-2 may be connected to the other end of the first coil 1120, and another portion of the second upper elastic unit 1150-2 may be electrically connected to the circuit board 1190. The circuit board 1190 may include a first pad 1005A electrically connected to another portion of the first upper elastic unit 1150-1, and a second pad 1005B electrically connected to another portion of the second upper elastic unit 1150-2. Each of the fifth and sixth terminals of the first position sensor 1170 may be electrically connected to a corresponding one of the first and second pads 1005A and 1005B of the circuit board 1190.

In another embodiment, the first coil 1120 may be electrically connected to the circuit board 1190 and the fifth and sixth terminals of the first position sensor 1170 via two lower elastic members.

For example, in an embodiment in which the first position sensor 1170 is a driver IC, the first and second terminals B1 and B2 of the circuit board 1190 may be power terminals for supplying power, the third terminal B3 may be a terminal for transmitting and receiving a clock signal, and the fourth terminal B4 may be a terminal for transmitting and receiving a data signal.

In another embodiment, the first position sensor 1170 may be a Hall sensor. Here, the first position sensor 1170 may include two input terminals, to which drive signals or power are supplied, and two output terminals, through which a sensing voltage (or an output voltage) is output. For example, drive signals may be supplied to the first position sensor 1170 through the first and second terminals B1 and B2 of the circuit board 1190, and the output of the first position sensor 1170 may be output to the outside through the third and fourth terminals B3 and B4. Furthermore, the first coil 1120 may be electrically connected to the circuit board 1190. The circuit board 1190 may further include two additional terminals in addition to the first to fourth terminals B1 to B4 such that an external drive signal may be supplied to the first coil 1120 via the two additional terminals.

For example, a ground terminal among the power terminals of the first position sensor 1170 may be electrically connected to the cover member 1300.

The capacitor 1195 may be disposed or mounted on the first surface of the circuit board 1190. The capacitor 1195 may be configured to have a chip shape. Here, the chip may include a first terminal, which corresponds to one end of the capacitor 1195, and a second terminal, which corresponds to the other end of the capacitor 1195. The capacitor 1195 may alternatively be referred to as a “capacitive element” or “condenser”.

The capacitor 1195 may be electrically connected in parallel to first and second terminals B1 and B2 of the circuit board 1190 through which power (or a drive signal) is supplied to the first position sensor 1170 from the outside. Alternatively, the capacitor 1195 may be electrically connected in parallel to the terminals of the first position sensor 1170, which is electrically connected to the first and second terminals B1 and B2 of the circuit board 1190.

Since the capacitor 1195 is electrically connected in parallel to the first and second terminals B1 and B2 of the circuit board 1190, the capacitor 1195 is capable of serving as a smoothing circuit for eliminating ripple components included in the power signals GND and VDD, which are supplied to the first position sensor 1170 from the outside, and is thus capable of supplying stable and consistent power signals to the first position sensor 1170.

In another embodiment, the sensing magnet 1180 may be disposed on the housing 1140, and the first position sensor 1170 may be disposed on the bobbin 1110. In another embodiment, the balancing magnet 1185 may be omitted.

The upper elastic member 1150 and the lower elastic member 1160 may be coupled to the bobbin 1110 and the housing 1140. For example, the upper elastic member 1150 may be coupled to the upper portion, the upper end or the upper surface of the bobbin 1110 and the upper portion, the upper end or the upper surface of the housing 1140, and the lower elastic member 1160 may be coupled to the lower portion, the lower end or the lower surface of the bobbin 1110 or the upper portion, the upper end or the upper surface of the housing 1140. The upper elastic member 1150 and the lower elastic member 1160 may elastically support the bobbin 1110 with respect to the housing 1140.

The upper elastic member 1150 may include a plurality of upper elastic units (for example, 150-1 to 150-4) which are electrically separated or spaced apart from each other. Although the lower elastic member 1160 is embodied as a single elastic unit, the lower elastic member 1160 may include a plurality of lower elastic units which are electrically separated or spaced apart from each other in another embodiment. In another embodiment, at least one of the upper elastic member or the lower elastic member may be embodied as a single unit or a single structure.

The upper elastic member 1150 may further include a first inner frame 1151 coupled or fixed to the upper portion, the upper surface or the upper end of the bobbin 1110, a second inner frame 1152 coupled or fixed to the upper portion, the upper surface or the upper end of the housing 1140, and a first frame connector 1153 connecting the first inner frame 1151 to the first outer frame 1152. Furthermore, the upper elastic member 1150 may include the above-mentioned extension 1155.

The lower elastic member 1160 may include a second inner frame 161 coupled or fixed to the lower portion, the lower surface or the lower end of the bobbin 1110, a second outer frames 162-1 to 162-3 coupled or fixed to the lower portion, the lower surface or the lower end of the housing 1140, and a second frame connector 1163 connecting the second inner frame 161 to the second outer frame 1162. The inner frame may alternatively be referred to as an inner portion, the outer frame may alternatively be referred to as an outer portion, and the frame connector may alternatively be referred to as a connector.

Each of the first and second frame connectors 1153 and 1163 may be bent or curved (or may be formed into a curved line) at least once so as to define a predetermined pattern.

Each of the upper elastic member 1150 and the lower elastic member 1160 may be made of a conductive material, for example, a metal material. Furthermore, each of the upper elastic member 1150 and the lower elastic member 1160 may be made of an elastic member, for example, a leaf spring or the like.

Referring to FIGS. 5 and 7, for example, the second outer frame 1152 of the first upper elastic unit 1150-1 may include a first bonding portion 1004A coupled or electrically connected to the first pad 1005A of the circuit board 1190, and the second outer frame 1152 of the second upper elastic unit 1150-2 may include a second bonding portion 1004B electrically connected to the second pad 1005B of the circuit board 1190.

In another embodiment, at least one of the upper elastic member 1150 or the lower elastic member 1160 may include two elastic members. For example, each of two elastic members of one of the upper elastic member 1150 and the lower elastic member 1160 may be coupled or electrically connected to a corresponding one of the first and second pads of the circuit board 1190. The first coil 1120 may be electrically connected to the two elastic members.

The first outer frame 1152 of the upper elastic member 1150 may include a first coupler 1510 coupled to the housing 1140, a second coupler 1520 coupled to the wire 1220, and a connector 1530 connecting the first coupler 1510 to the second coupler 1520. The first coupler 1510 may have a through hole or a hole to be coupled to the first coupler 1143 of the housing 1140. The second coupler 1520 may have a through hole or a hole to be coupled to the wire 1220. For example, the second coupler 1520 may be coupled to the wire 1220 using a conductive adhesive or solder. For example, although the connector 1530 may include a bent portion, which is bent at least once, or a curved portion, which is curved at least once, the disclosure is not limited thereto. In another embodiment, the connector 1530 may have a linear shape.

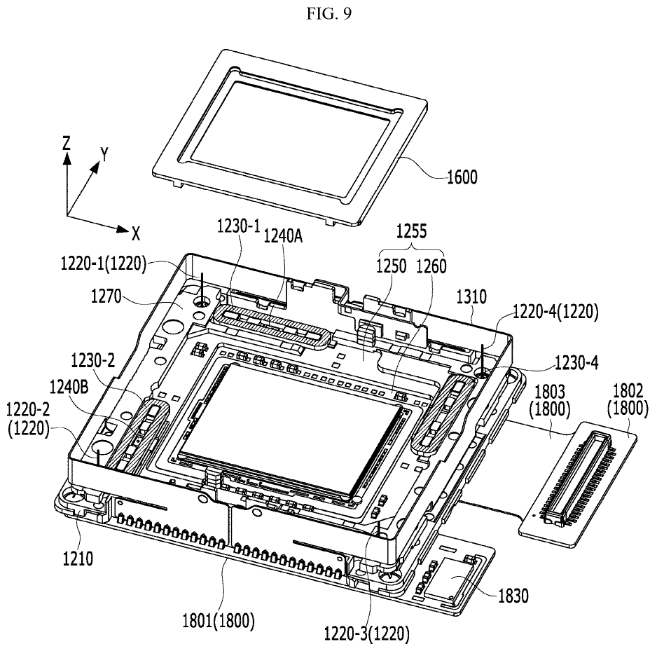

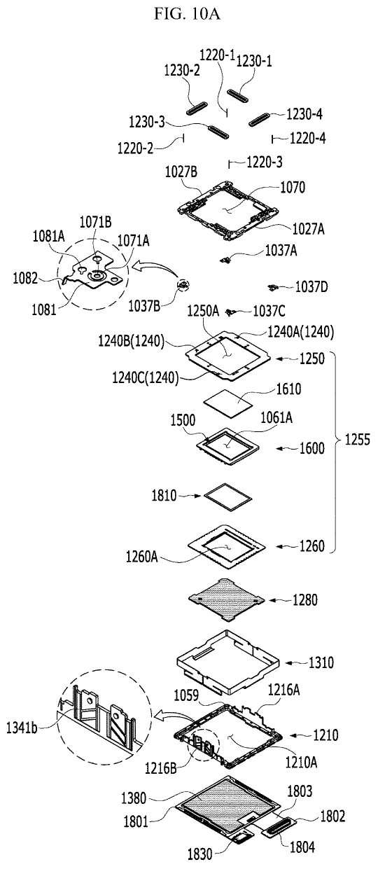

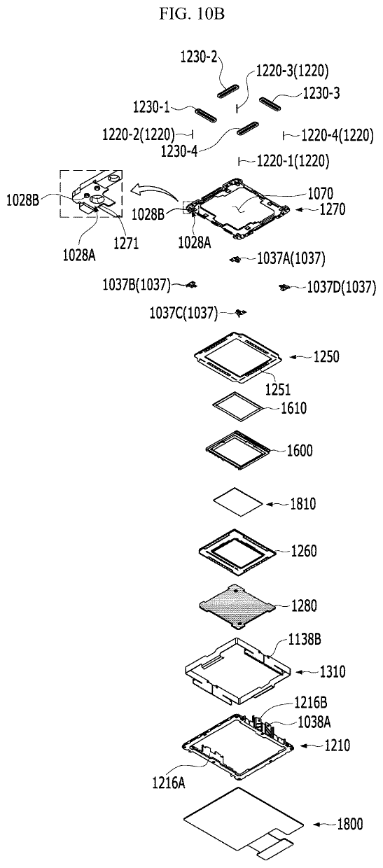

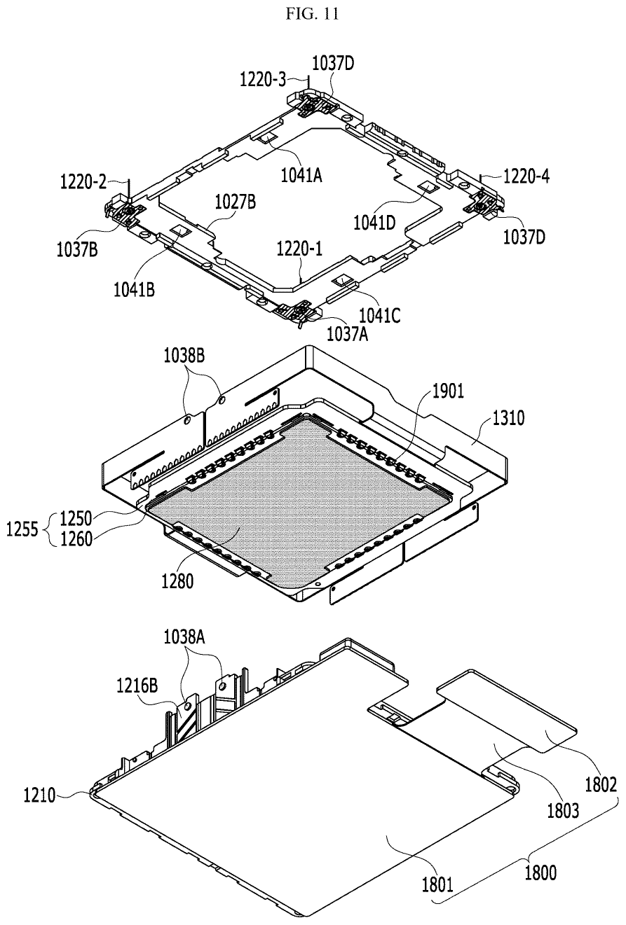

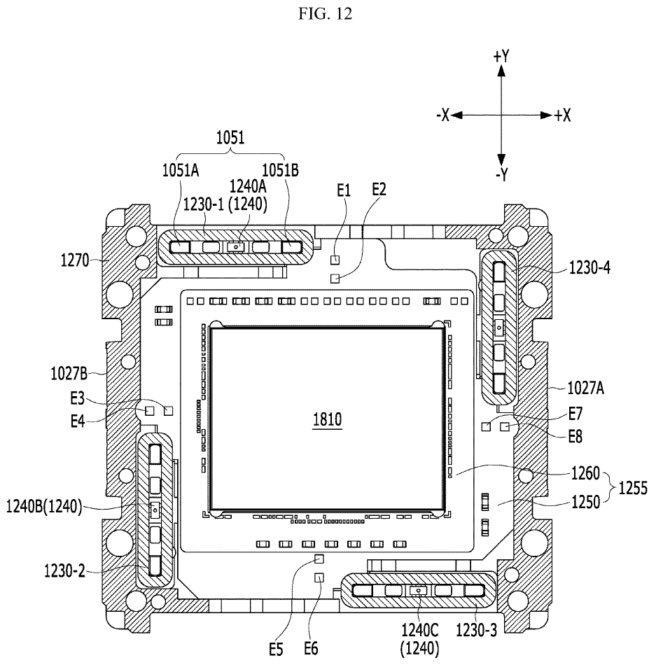

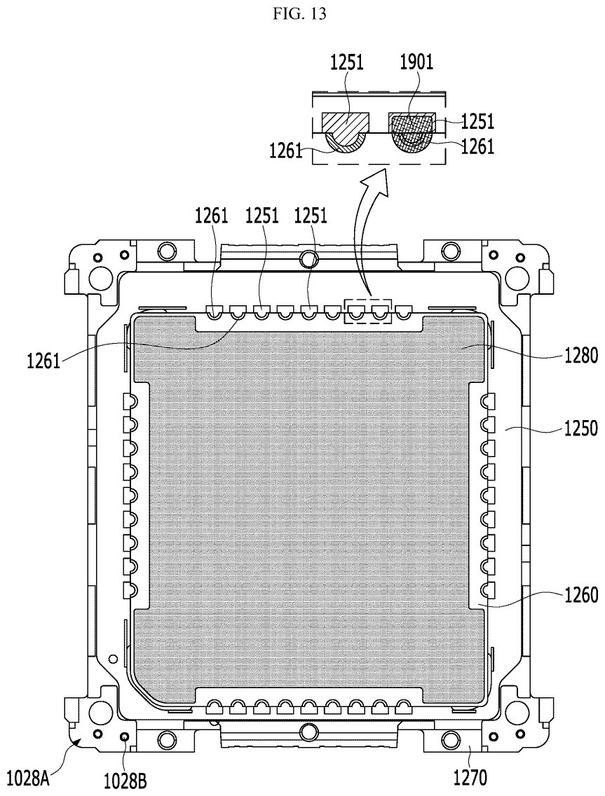

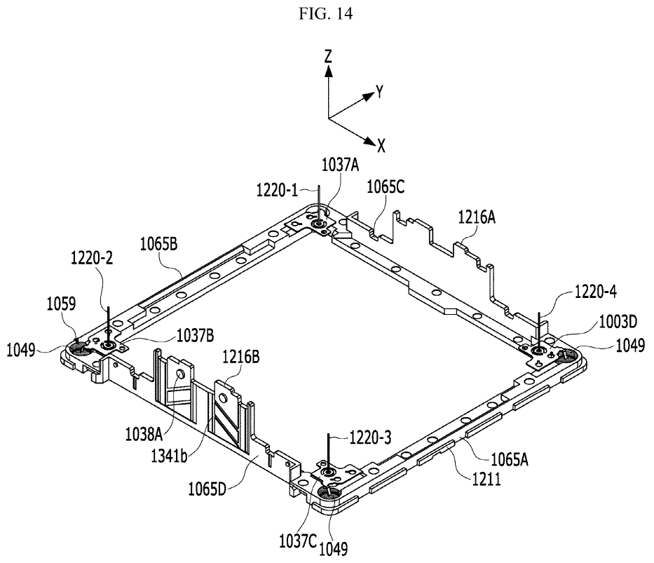

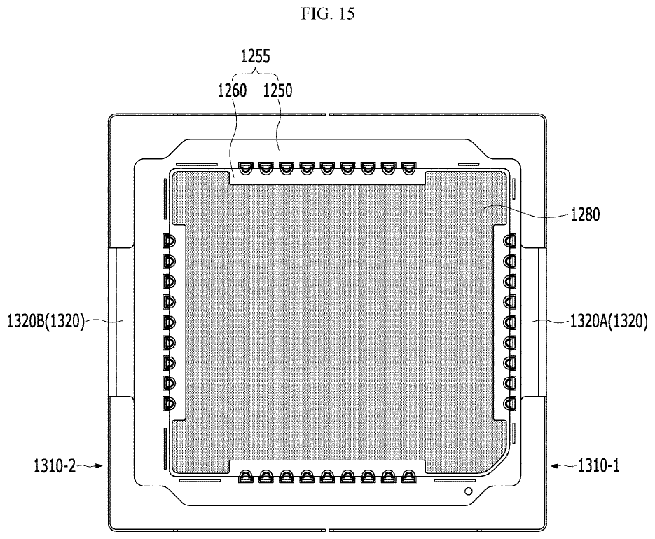

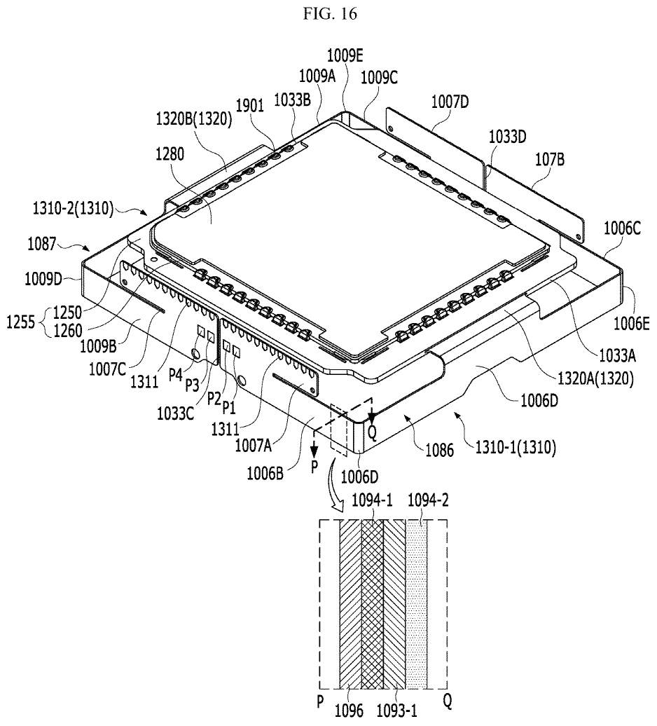

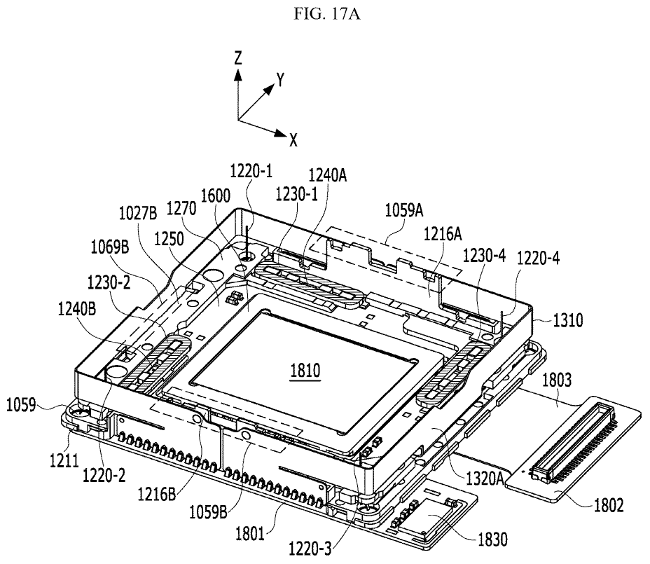

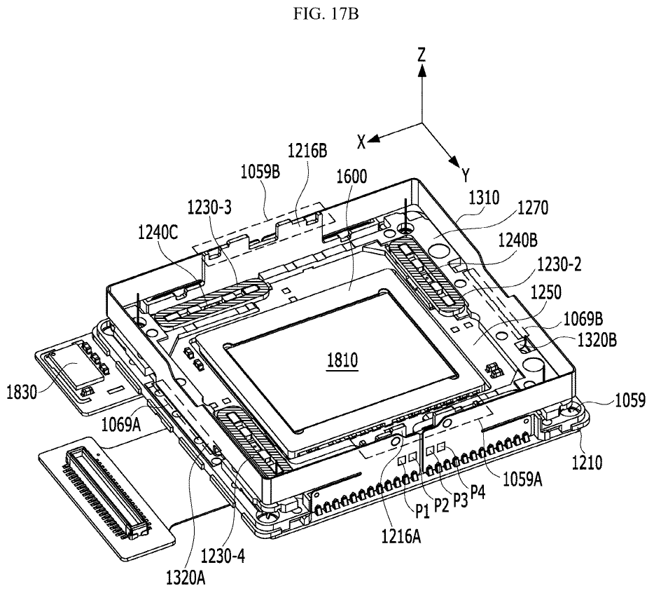

FIG. 9 is a perspective view of the image sensor unit 1350. FIG. 10A is a first exploded perspective view of the image sensor unit 1350 shown in FIG. 9. FIG. 10B is a second exploded perspective view of the image sensor unit 1350 shown in FIG. 9. FIG. 11 is a bottom perspective view of the holder 1270, the terminal member 1037, the first board unit 1255, the support board 1310, the heat radiating member 1280, the base 1210, and the second board unit 1800, which are shown in FIG. 10A. FIG. 12 is a plan view of the holder 1270, the first board unit 1255, the image sensor 1810, the second coil 1230, and the OIS position sensor 1240. FIG. 13 is a rear perspective view of the holder 1270 and the first board unit 1255. FIG. 14 is a perspective view of the base 1210, the terminal member 1037, and the wire 1220. FIG. 15 is a bottom view of the first board unit 1255, the support board 1310, and the heat radiating member 1280. FIG. 16 is a perspective view of the first board unit 1255, the support board 1310, and the heat radiating member 1280. FIG. 17A is a first perspective view of the support board 1310 coupled to the holder 1270 and the base 1210. FIG. 17B is a second perspective view of the support board 1310 coupled to the holder 1270 and the base 1210.

Referring to FIGS. 9 to 17B, the image sensor unit 1350 may include a stationary unit and the OIS moving unit which is disposed so as to be spaced apart from the stationary unit. The image sensor unit 1350 may include a support unit connecting the stationary unit to the OIS moving unit.

For example, the support unit may include the support board 1310. Alternatively, for example, the support unit may be the support board 1310. In another embodiment, the support unit may include an elastic member, for example, a leaf spring or a suspension wire in place of the support board 1310.

The stationary unit may be a portion of the camera device 1010 which is immovable during OIS operation. For example, the stationary unit may include the board unit 1800. For example, the stationary unit may include a component coupled to the second board unit 1800. The board unit 255 or 800 may alternatively be referred to as a “board” or a “circuit board”.

For example, the stationary unit may include the base 1210 coupled to the second board unit 1800. For example, the stationary unit may include the housing 1140 of the AF operation unit, and components disposed on the housing 1140, for example, the magnet 1130, the first position sensor 1170 and the circuit board 1190. Furthermore, the stationary unit may include the cover member 1300 coupled to the base 1210. The OIS moving unit may be disposed in the cover member 1300. For example, the cover member 1300 may accommodate therein the OIS moving unit and the support board 1310.

The OIS moving unit may include the image sensor 1810. The OIS moving unit may further include the first board unit 1255, which is spaced apart from the second board unit 1800 and is electrically connected to the second board unit 1800. For example, the OIS moving unit may include components disposed on the first board unit 1255, for example, at least one of the heat radiating member 1280, the holder 1270, the second coil 1230, and the second position sensor 1240. The holder 1270 may alternatively be referred to as a “spacer member”. In another embodiment, the holder 1270 may be omitted, and the second coil 1230 may be disposed on the first board unit 1255, for example, the first circuit board 1250.

For example, the camera device 1010 may include the stationary unit, the moving unit including the first heat radiating member 1280 disposed on the stationary unit and the image sensor 1810 disposed in the first heat radiating member 1280, and the support unit (for example, 310) configured to support the moving unit while allowing the moving unit to be movable in a direction perpendicular to the optical axis direction. The support unit (for example, 310) may be connected between the moving unit and the stationary unit.

The moving unit may include the first board unit 1255 on which the image sensor 1810 is disposed, the stationary unit may include the second board unit 1800 which is disposed so as to be spaced apart from the first board unit 1255, and the support unit may connect the first board unit 255 to the second board unit 1800.

The support unit may include a conductive layer 1093-1, a first insulating layer 1094-1 disposed below the conductive layer 1093-1, and a second insulating layer 1094-2 disposed on the conductive layer 1093-1. The support unit may be constructed such that a portion of the first insulating layer 1094-1 is removed so as to expose an area of the conductive layer 1093-1 through the removed portion.

The first board unit 1255 may include the first circuit board 1250, a second circuit board 1260 electrically connected to the image sensor 1810, and a solder 1901 electrically connecting the first circuit board 1250 to the second circuit board 1260.

The camera device 1010 may include an elastic member 220 (referred to hereinafter as a “wire”) configured to flexibly support the OIS moving unit. The elastic member 220 may have the form of a wire or a spring.

For example, one end of the wire 1220 may be coupled to the upper elastic member 1150 (or the housing 1140), and the other end of the wire 1220 may be coupled to the holder 1270. For example, one end of the wire 1220 may be coupled to the first outer frame 1152 (for example, the second coupler 1520) of the upper elastic member 1150 using solder or a conductive adhesive. For example, the other end of the wire 1220 may be coupled to the terminal member 1037, and the terminal member 1037 may be disposed on or coupled to the holder 1270 using solder or a conductive adhesive.

Referring to FIG. 7, a damper DA may be disposed between one end of the wire 1220, which extends through the hole 1147 in the housing 1140, and the hole 1147 in the housing 1140. For example, at least a portion of the damper DA may be disposed in the hole 1147 in the housing 1140, and may be coupled or attached both to at least a portion of the wire 1220 and to the housing 1140.

For example, the wire 1220 may be disposed parallel to the optical axis direction. For example, the wire 1220 may be disposed at the corner of the housing 1140 and/or the corner of the holder 1270. For example, the wire 1220 may include four wires 1220-1 to 1220-4. Each of the four wires 1220-1 to 1220-4 may be disposed on a corresponding one of the four corners of the housing 1140 and/or the four corners of the holder 1270.

Referring to FIGS. 10A to 10B, the holder 1270 may have formed therein a hole 1271 through which at least a portion of the wire 1220 extends. For example, the corner of the holder 1270 may have formed therethrough the hole 1271 through which the other end of the wire 1220 extends. For example, each of the four corners of the holder 1270 may have formed therein the hole 1271. For example, although the hole 1271 may be a through hole which is formed through the holder 1270 in the optical axis direction, the hole 1271 may have the form of an escape groove in another embodiment.

For example, the terminal member 1037 may be disposed on or coupled to the upper surface or the lower surface of the holder 1270. For example, the terminal member 1037 may be disposed on or coupled to the lower surface of the corner of the holder 1270. The holder 1270 may have formed therein a groove 1028A in which the terminal member 1037 is disposed. For example, the groove 1028A may be formed in the lower surface of the corner of the holder 1270.

The holder 1270 may include at least one protrusion 1028B, and the terminal member 1037 may have at least one hole 1081A to be coupled to the at least one protrusion 1028B of the holder 1270. The terminal member 1037 and the holder 1270 may be coupled to each other using an adhesive or through heat fusion. The terminal member 1037 may have a hole 1071B to which the other end of the wire 1220 is inserted or coupled. For example, each of the holes 1081A and 1071B may be a through hole.

For example, the terminal member 1037 may include a body 1081 coupled to the holder 1270. The body 1081 may include a coupler 1071 coupled to the wire 1220. The coupler 1071 may include a coupling region 1071A coupled to the wire 1220 and a hole 1071B formed in the first coupling region 1071A. The coupling region 1071A may be a region of the body 1081 which is coupled to the wire 1220 using solder or a conductive adhesive. For example, the other end of the wire 1220 that has passed through the hole 1071B may be coupled to the lower portion or the lower surface of the coupling region 1071A using solder or a conductive adhesive.

For example, the body 1081 may have at least one hole 10 1071C formed around the coupling region 1071A. For example, the body 1081 may have a plurality of holes 1071C surrounding the coupling region 1071A. For example, the plurality of holes 1071C may be spaced apart from the hole 1071B.

The body 1081 may include a support portion which is positioned between the plurality of holes 1071C so as to support the coupling region 1071A. The support portion 1071D may alternatively be referred as a “connector” or a “bridge”. The support portion 1071D may include a plurality of support portions which are spaced apart from each other. The support portion 1071D may be connected to the coupling region 1071A.

The at least one hole 1071C may serve to enable solder to be mainly formed only in the coupling region 1071A by virtue of interfacial tension (for example, surface tension) at the peripheral area of the coupling region 1071A during soldering.

The coupling region 1071A must be heated in order to perform soldering. Here, the at least one hole 1071C may suppress or block transmission of heat of the coupling region 1071A to another region while inhibiting a soldered portion from being formed in the remaining region of the body 1081. In other words, the at least one hole 1071C is able to improve soldering efficiency.

The terminal member 1037 may include an extension 1082 which extends from the body 1081. The extension 1082 may be bent downwards at the body 1081 and may extend downwards. For example, the extension 1082 may extend toward a hole 1059 in the base 1210. The extension 82 may alternatively be referred to as a “bent portion”.

For example, the terminal member 1037 may include four terminals 1037A to 1037D corresponding to the four wires 1220-1 to 1220-4 of the terminal member 1037. Each of the terminals 1037A to 1037D may be disposed on a corresponding one of the corners of the holder 1270, and may be coupled to a corresponding one of the wires 1220-1 to 1220-4. The description of FIG. 10A may be applied to the structure of each of the terminals 1037A to 1037D with or without modification. The terminal member 1037 may be made of a conductive material, for example, metal. In another embodiment, the terminal member 1037 may be omitted, and the wire 1220 may be directly coupled to the holder 1270.

Referring to FIG. 14, a damper or adhesive 1049 may be disposed between the terminal member 1037 and the base 1210, and may be in contact with or coupled or attached both to the terminal member 1037 and to the base 1210. For example, the base 1210 may have the hole 1059 (or the groove) formed at a location which corresponds to or faces the terminal member 1037. For example, the hole 1059 (or the groove) may be formed in the corner of the base 1210.

For example, the damper 1049 may be disposed in the hole 1059 in the base 1210. Alternatively, at least a portion of the extension 1082 of the terminal member 1037 may be disposed in the hole 1059 in the base 1210, and the damper 1049 may be in contact with or coupled or attached to the extension 1082. The damper 1049 may serve to absorb or mitigate vibration of the OIS moving unit, thereby inhibiting or suppressing oscillation of the OIS moving unit during OIS operation.

In another embodiment, the extension 1082 may be omitted from the terminal member 1037, and the camera device 1010 may not include the damper 1049 shown in FIG. 14.

The support board 1310 may support the OIS moving unit with regard to the stationary unit such that the OIS moving unit is moved in a direction perpendicular to the optical axis, is tilted relative to the optical axis, or is rotated within a predetermined range.

For example, one end of the support board 1310 may be connected or coupled to the first board unit 1255, and another end of the support board 1310 may be connected or coupled to the second board unit 1800.

The holder 1270 may be disposed below the AF operation unit. For example, the holder 1270 may be made of a non-conductive member. For example, the holder 1270 may be made of an injectable material which is easily shaped through an injection molding process. Furthermore, the holder 1270 may be made of an insulative material. Furthermore, for example, the holder 1270 may be made of resin or plastic.

Referring to FIGS. 10A, 10B, and 12, the holder 1270 may include an upper surface, a lower surface which is opposed to the upper surface, and a side surface (for example, an outer surface) connecting the upper surface to the lower surface. For example, the lower surface of the holder 1270 may be opposed to or face the second board unit 1800.

The holder 1270 may support the first board unit 1255, and may be coupled to the first board unit 1255. For example, the first board unit 1255 may be disposed below the holder 1270. The lower portion, the lower surface or the lower end of the holder 1270 may be coupled to the upper portion, the upper surface or the upper end of the first board unit 1255. For example, the holder 1270 may be coupled to the first board unit 1255 using an adhesive. In another embodiment, for example, the first board unit 1255 may be disposed above the holder 1270.

The holder 1270 may accommodate or support the second coil 1230. The holder 1270 may support the second coil 1230 in the state of being spaced apart from the first board unit 1255. For example, at least a portion of the holder 1270 may be disposed between the second coil 1230 and the first board unit 1255.

The holder 1270 may have a bore 1070 corresponding to one area of the first board unit 1255. For example, the bore 1070 in the holder 1270 may be a through hole which is formed through the holder 1270 in the optical axis direction. For example, the bore 1270 in the holder 1270 may correspond to, face or overlap the image sensor 1810 in the optical axis direction.

Although the bore 1070 in the holder 1270 may have a polygonal shape, for example, a quadrangular shape, a circular shape, or an elliptical shape when viewed from above, the disclosure is not limited thereto. The bore 1070 may have any of various shapes.

For example, the bore 1070 in the holder 1270 may be configured to have such a shape or a size as to expose the image sensor 1810, a portion of the upper surface of the first circuit board 1250, a portion of the upper surface of the second circuit board 1260, and the elements. For example, the surface area of the bore 1070 in the holder 1270 may be larger than the surface area of the image sensor 1810, and may be smaller than the surface area of the bore 1250A in the first circuit board 1250.

Referring to FIG. 11, the holder 1270 may have therein the holes 1041A, 1041B and 1041C corresponding to the second position sensors 1240. For example, the holder 1270 may have therein the holes 1041A, 1041B and 1041C, which are formed at positions respectively corresponding to the first to third sensors 1240A, 1240B and 1240C.

For example, the holes 1041A, 1041B and 1041C may be positioned adjacent to the corners of the holder 1270. The holder 1270 may further have a dummy hole 1041D formed adjacent to the corner of the holder 1270, which does not correspond to any of the second position sensors 1240. The dummy hole 1041D may be intended to achieve weight equilibrium of the OIS moving unit during OIS operation. The dummy hole 1041D may be a through hole. In another embodiment, the dummy hole 1041D may not be formed. The holes 1041A, 1041B and 1041C may be formed through the holder 1270 in the optical axis direction. In another embodiment, the holes 1041A, 1041B and 1041C in the holder 1270 may be omitted.

The upper surface of the holder 1270 may be provided with at least one coupling protrusion 1051, configured to be coupled to the second coil 1230. The coupling protrusion 1051 may project from the upper surface of the holder 1270 in an upward direction or in a direction toward the AF operation unit. For example, the coupling protrusion 1051 may be formed adjacent to each of the holes 1041A to 1041D in the holder 1270.

For example, two coupling protrusions 1051A and 1051B may be disposed or arranged at the holder 1270 so as to correspond to each of the holes 1041A to 1041D in the holder 1270. For example, each of the holes 1041A, 1041B, 1041C and 1041D in the holder 1270 may be positioned between the two coupling protrusions 1051A and 1051B.

The holder 1270 may include one or more couplers 1027A and 1027B to which at least a portion of the support board is coupled. The couplers 1027A and 1027B may be coupled to the connectors 1320A and 1320B of the support board 1310. For example, a first coupler 1027A may be coupled to the first connector 1320A, and the second coupler 1027B may be coupled to the second connector 1320B.

Referring to FIGS. 12, 17A and 17B, the couplers 1027A and 1027B may be provided at the side portion of the holder 1270. Although the couplers 1027A and 1027B may be flat portions of the side portion of the holder 1270 in the embodiment shown in FIG. 12, the couplers of the holder 1270 may be projections projecting from the upper surface of the holder 1270 in another embodiment. For example, the couplers of the holder 1270 may project from the outer surface of the holder 1270 in the optical axis direction or in an upward direction.

For example, the holder 1270 may include the two projections 1027A and 1027B which face or overlap each other or are opposed to each other in the second horizontal direction (for example, in the x-axis direction).

For example, the holder 1270 may include four side portions (or side plates), and the couplers 1027A and 1027B may be respectively formed at two side portions among the four side portions. For example, each of the couplers 1027A and 1027B may be disposed or positioned in the center of a corresponding side portion (or side plate) of the holder 1270. In another embodiment, the couplers of the holder 1270 may be provided therein with grooves in which an adhesive is received or disposed.

The first board unit 1255 may include the first circuit board 1250 and the second circuit board 1260 which are electrically connected to each other. The second circuit board 1260 may alternatively be referred to as a “sensor board”. In another embodiment, the heat radiating member 1280 may be included in the first board unit 1255.

The first board unit 1255 may be disposed on the lower surface of the holder 1270. For example, the first board unit 1255 may be coupled to the lower surface of the holder 1270. For example, the first circuit board 1250 may be disposed on and/or coupled to the lower surface of the holder 1270. For example, a first surface of the first circuit board 1250 may be coupled or attached to the lower surface of the holder 1270 using an adhesive member.

Here, the first surface of the first circuit board 1250 may be opposed to or face the AF operation unit, and may be a surface on which the second position sensor 1240 is disposed. The second surface of the first circuit board 1250 may be a surface opposite the first surface of the first circuit board 1250.

The first circuit board 1250 may alternatively be referred to as “a sensor board”, a “main board”, a “main circuit board”, a “sensor circuit board”, a “moving circuit board” or the like. In all the embodiments, the first circuit board 1250 may alternatively be referred to as a “second board” or a “second circuit board”, and the second circuit board 1260 may alternatively be referred to as a “first board” or a “first circuit board”.

The second position sensor 1240 (1240A, 1240B and 1240C) may be disposed on the first circuit board 1250 in order to detect movement of the OIS moving unit in a direction perpendicular to the optical axis and/or rotation, tilting or rolling of the OIS moving unit relative to the optical axis. Furthermore, a controller 1830 and/or a circuit element (for example, a capacitor) may be disposed on the first circuit board 1250.

The first circuit board 1250 may include first terminals E1 to E8 to be electrically connected to the second coil 1230. Here, the first terminals E1 to E8 may alternatively be referred to as “first pads” or “first bonding portions”. The first terminals E1 to E8 of the first circuit board 1250 may be disposed or arranged on a first surface 60A of the first circuit board 1250. For example, the first circuit board 1250 may be a printed circuit board or a flexible printed circuit board (FPCB).

The first circuit board 1250 may have the bore 1250A which corresponds to or faces the bores of the lens module 1400 and the bobbin 1110. For example, the bore 1250A in the first circuit board 1250 may be a through hole or a cavity which is formed through the first circuit board 250 in the optical axis direction, and may be formed in the center of the first circuit board 1250.

When viewed from above, the shape of the first circuit board 1250, for example, the outer peripheral shape of the first circuit board 1250 may be a shape which coincides with or corresponds to the holder 1270, for example, a quadrilateral shape. When viewed from above, the bore 1250A in the first circuit board 1250 may have a polygonal shape, for example, a quadrilateral shape, a circular shape or an elliptical shape. For example, the bore 1250a in the first circuit board 1250 may open or expose the image sensor 1810 and/or the bore 1260A in the second circuit board 1260.

The first circuit board 1250 may include at least one terminal 1251 to be electrically connected to the second circuit board 1260. The terminal 1251 of the first circuit board 1250 may alternatively be referred to as a “pad” or a “bonding portion”. The terminal 1251 of the first circuit board 1250 may be disposed or arranged on the lower surface of the first circuit board 1250.

For example, the terminal 1251 may include a plurality of terminals, and the plurality of terminals 1251 may be disposed and arranged in a region between the bore 1250A in the first circuit board 1250 and one side of the first circuit board 1250 in a direction parallel to the one side. For example, the plurality of terminals 1251 may be arranged so as to surround the bore 1250A.

The second circuit board 1260 may be disposed below the first circuit board 1250. The second circuit board 1260 may be electrically connected to the image sensor 1810.

When viewed from above, although the second circuit board 1260 may have a polygonal shape (for example, a quadrilateral shape, a square shape, or a rectangular shape), the disclosure is not limited thereto. In another embodiment, the second circuit board 1260 may have a circular shape or an elliptical shape.

For example, the surface area of the outer periphery of the second circuit board 1260 may be larger than the surface area of the bore 1250A in the first circuit board 1250. For example, the lower side of the bore 1250A in the first circuit board 1250 may be shielded or blocked by means of the second circuit board 1260.

For example, when viewed from above or underneath, the outer surface (or outer side) of the second circuit board 1260 may be positioned between the outer surface (or side) of the first circuit board 1250 and the bore 1250A in the first circuit board 1250.

For example, the second circuit board 1260 may have the bore 1260A corresponding to the bore 1250A in the first circuit board 1250 and/or the image sensor 1810. The bore 1260A in the second circuit board 1260 may be a hole or a cavity which is formed through the second circuit board 1260, and may be formed in the center of the second circuit board 1260.

For example, the bore 1260A in the second circuit board 1260 may open or expose the image sensor 1810. For example, the image sensor 1810 may be disposed in the bore 1260A in the second circuit board 1260, and may be electrically connected to the second circuit board 1260. For example, the image sensor 1810 may be electrically connected to the second circuit board 1260 via a wire.

In another embodiment, the bore 1260A may not be formed in the second circuit board 1260, and the image sensor 1810 may be disposed on the upper surface of the second circuit board 1260.

In another embodiment, the heat radiating member 1280 may be omitted. In the embodiment in which the heat radiating member 1280 is omitted, the bore 1260A may not be formed in the second circuit board 1260 and the image sensor 1810 may be disposed on the upper surface of the second circuit board 1260.

In the embodiment in which the heat radiating member 1280 is omitted, for example, the image sensor 1810 may be disposed on the upper surface of a single board in which the first circuit board and the second circuit board are integrally formed.

The second circuit board 1260 may include at least one terminal 1261 which is electrically connected to the at least one terminal 1251 of the first circuit board 1250. For example, the terminal 1261 of the second circuit board 1260 may include a plurality of terminals.

For example, at least one terminal 1261 of the second circuit board 1260 may be formed on the side surface or the outer surface of the second circuit board 1260 which connects the upper surface and the lower surface of the second circuit board 1260 to each other. The upper surface of the second circuit board 1260 may be a surface that faces the first circuit boar 1250, and the lower surface of the second circuit board 1260 may be a surface opposite the upper surface of the second circuit board. For example, the terminal 1261 may have the form of a groove having a structure that is depressed from the side surface of the second circuit board 1260. Alternatively, for example, the terminal 1261 may have the form of a circular or semielliptical via formed in the side surface of the second circuit board 1260. In another embodiment, at least one terminal of the second circuit board 1260 that is electrically connected to the second terminal 1251 of the first circuit board 1250 may be formed on the upper surface of the second circuit board 1260.

For example, the terminal 1261 of the second circuit board 1260 may be coupled to the terminal 1251 of the first circuit board 1250 using the solder or conduction path portion 1901 (see FIG. 11). Although the enlarged dotted line portion in FIG. 13 illustrates only one terminal of the second circuit board 1260 and one terminal 1251 of the first circuit board, a solder configured to couple another terminal of the second circuit board 1260 to a corresponding terminal of the first circuit board 1250 may be provided.

For example, each of the first and second circuit boards 1250 and 1260 may be a printed circuit board or a flexible printed circuit board (FPCB). At least one of the first and second circuit boards 1250 and 1260 may be an organic substrate or a ceramic board.

The heat radiating member 1280 may be disposed on or coupled to the first board unit 1255. For example, the heat radiating member 1280 may be disposed on or coupled to the second circuit board 1260. For example, the heat radiating member 1280 may be disposed below the second circuit board 1260. For example, the heat radiating member 1280 may be coupled or fixed to the lower surface of the second circuit board 1260. For example, at least a portion of the upper surface of the heat radiating member 1280 may be coupled or fixed to the lower surface of the second circuit board 1260.

The term “heat radiating member” may be used interchangeably with “heat radiating sheet”, “heat radiating tape”, “heat radiating layer”, “heat radiating film”, “heat radiating board”, “heat radiating plate”, or “heat radiating body”.

In another embodiment, the heat radiating member 1280 may be included in the first board unit 1255, and the image sensor 1810 may be disposed on the first board unit 1255.

The bore 1260A in the second circuit board 1260 may open or expose at least a portion of the heat radiating member 1280. The image sensor 1810 may be disposed on or attached or coupled to at least a portion of the heat radiating member 1280 that is exposed through the bore 1260A. For example, the image sensor 1810 may be fixed, attached or coupled to the heat radiating member 1280 using an adhesive. For example, the image sensor 1810 may be disposed on the first board unit 1255.

For example, at least an area of the upper surface of the heat radiating member 1280 may be exposed through the bore 1260A, and the image sensor 1810 may be disposed on or attached or coupled to the at least an area of the upper surface of the heat radiating member 1280 that is exposed through the bore 1260A.

In another embodiment, the second circuit board 1260 may include a groove formed in the lower surface thereof in order to receive or dispose the heat radiating member 1280 therein.

In another embodiment, the second circuit board 1260 may not have formed therein the bore 1260A, and the heat radiating member 1280 may be fixed, attached or coupled to the lower surface of the second circuit board 1260. In a further embodiment, the heat radiating member 1280 may be omitted.

For example, the heat radiating member 280 may be a plate-shaped member having predetermined thickness and hardness. The heat radiating member 1280 may improve an effect of radiating heat, generated from the heat source of the first board unit 1255, toward the outside. Here, the heat source of the first board unit 1255 may be an electronic element (or a circuit element) disposed on the first board unit 1255, for example, the image sensor 1810, the controller 1830, the second position sensor 1240 and/or the capacitor.

For example, the heat radiating member 1280 may include a metal material which has high thermal conductivity and high heat radiation efficiency, for example, at least one of stainless steel, aluminum, nickel, phosphorus, bronze, or copper.

The heat radiating member 1280 may serve to stably support the image sensor 1810, and may serve as a reinforcing material for suppressing breakage of the image sensor 1810 attributable to external shock or contact.

In another embodiment, the heat radiating member 1280 may be made of a heat radiating member having high thermal conductivity, for example, exothermic epoxy, exothermic plastic (for example, polyimide), or exothermic synthetic resin.

In an embodiment, for example, the term “heat radiating member” may be used interchangeably with “heat radiating body”, “heatsink”, “heat radiating plate”, “heat radiating sheet”, “plate”, “metal plate”, “reinforcing material”, or “stiffener”.

In order to improve heat radiation efficiency, the heat radiating member 1280 may include a predetermined pattern having at least one groove or at least one unevenness. For example, a groove or an unevenness having a predetermined pattern may be formed in the lower surface of the heat radiating member 1280.

For example, the predetermined pattern may include a plurality of grooves which are spaced apart from each other at a predetermined interval. For example, the predetermined pattern may have the shape of a stripe. In another embodiment, the predetermined pattern may have the shape of a net or a mesh. In a further embodiment, the predetermined pattern may have a shape having dots which are spaced apart from each other. For example, each of the dots may have a circular shape, an elliptical shape or a polygonal shape (for example, a quadrilateral shape).

In another embodiment, the predetermined pattern may be formed on at least one of the upper surface, the lower surface or the outer surface of the heat radiating member 1280. In a further embodiment, the radiating member 1280 may include a hole or a through hole in place of the groove or the unevenness. Because the heat radiating member 1280 moves together with the OIS moving unit, the heat radiating member 1280 may be spaced apart from the stationary unit, for example, the second board unit 1800. The heat radiating member 1280 may include at least one escape groove 281 (see FIG. 10A) for avoidance of spatial interference with the solder 1901.

Although the first circuit board 1250 and the second circuit board 1260 are electrically coupled to each other using the conduction path portion 1901 in FIG. 13, the first board and the second board may be embodied as a single integrated circuit board in another embodiment.

The second coil 1230 may be disposed on or coupled to the OIS moving unit. For example, the second coil 1230 may be disposed on the holder 1270. The second coil 1230 may be disposed on the upper surface of the holder 1270. The second coil 1230 may be disposed below the magnet 1130.

The second coil 1230 may be coupled to the holder 1270. For example, the second coil 1230 may be coupled or attached to the upper surface of the holder 1270. For example, the second coil 1230 may be coupled to the coupling protrusion 1251 of the holder 1270. The second coil 1230 may move the OIS moving unit by virtue of the interaction with the magnet 1130.

For example, the second coil 1230 may correspond to, face or overlap the magnet 1130 disposed on the stationary unit in the direction of the optical axis OA. In another embodiment, the stationary unit may include a dedicated OIS magnet independent of the magnet of the AF operation unit, and the second coil may correspond to, face or overlap the dedicated OIS magnet. Here, the OIS magnet may include the same number of OIS magnets as the number of coil units included in the second coil 1230.

In a further embodiment, the OIS magnet may be disposed on the stationary unit of the second coil 1230, and the OIS magnet 1071B of the magnet 1130 may be disposed on the OIS moving unit. Here, the second coil 1230 may be electrically connected to the support board 1310 and/or the second board unit 1800 via a conductive member.

For example, the second coil 1230 may include a plurality of coil units 1230-1 to 1230-4. For example, the second coil 1230 may include four coil units 1230-1 to 1230-4 disposed on the four corners of the holder 1270. For example, at least a portion of each of the coil units 1230-1 to 1230-4 may be disposed on a corresponding one of the corners of the holder 1270. A portion of each of the coil units 1230-1 to 1230-4 may be disposed on a side portion adjacent to a corresponding one of the corners of the holder 1270.

Each of the coil units 1230-1 to 1230-4 may have the form of a coil block having a closed loop or ring shape. For example, each of the coil units may have a cavity or a hole. For example, each of the coli units may be composed of a fine pattern (FP) coil, a wound coil or a coil block. For example, the cavity or the hole in each of the coil units 1230-1 to 1230-4 may be fitted over or coupled to the protrusion 1251 of the holder 1270.

In another embodiment, the second coil 1230 may be disposed on the first circuit board 1250, and may be coupled to the first circuit board 1250.

The second coil 1230 may be electrically connected to the first circuit board 1250. For example, the first coil unit 1230-1 may be conductively connected to two terminals E1 and E2 of the first circuit board 1250, and the second coil unit 1230-2 may be electrically connected to two other terminals E3 and E4. Furthermore, the third coil unit 1230-2 may be electrically connected to two other terminals E5 and E6 of the first circuit board 250, and the fourth coil unit 1230-4 may be electrically connected to the two other terminals E7 and E8 of the first circuit board 1250.

Power or drive signals may be supplied to the first to fourth coil units 1230-1 to 1230-4 through the first circuit board 1250. The power or drive signal supplied to the second coil 1230 may be a DC signal, an AC signal or a signal containing both DC and AC components, and may be of a voltage type or a current type.

By virtue of the interaction between the first to fourth magnet units 1130-1 to 1130-4 and the first to fourth coil units 1230-1 to 1230-4, the OIS moving unit may be moved in the first horizontal direction or in the second horizontal direction or may be rolled relative to the optical axis.

For example, current may be independently applied to at least three coil units among the four coil units 1230-1 to 1230-4. In another embodiment, current may be independently applied to at least two coil units among the four coil units 1230-1 to 1230-4.

For example, an independent drive signal, for example, independent drive current may be supplied to each of the four coil units 1230-1 to 1230-4.

The controller 1830 and 780 may supply at least one drive signal to at least one of the first to fourth coil units 1230-1 to 1230-4, and may move the OIS moving unit in the x-axis direction and/or in the y-axis direction or may rotate the OIS moving unit within a predetermined angle range about the optical axis by controlling the at least one drive signal. Hereinafter, the “controller” may be at least one of the controller 1830 of the camera device 1010 or the controller 780 of the optical instrument 200A.

When the second coil 1230 is driven through three channels, three independent drive signals may be supplied to the second coil 1230. For example, among the four coil units, two coil units (for example, 1230-2 and 1230-4 or 1230-1 and 1230-3), which are diagonally opposed to each other, may be connected to each other in series, and one drive signal may be supplied to the two coil units, which are connected to each other in series. Independent drive signals may be respectively supplied to the two other coil units among the four coil units.

Alternatively, when the second coil 1230 is driven through four channels, independent drive signals may be respectively supplied to the four coil units 1230-1 to 1230-4, which are separated from each other.

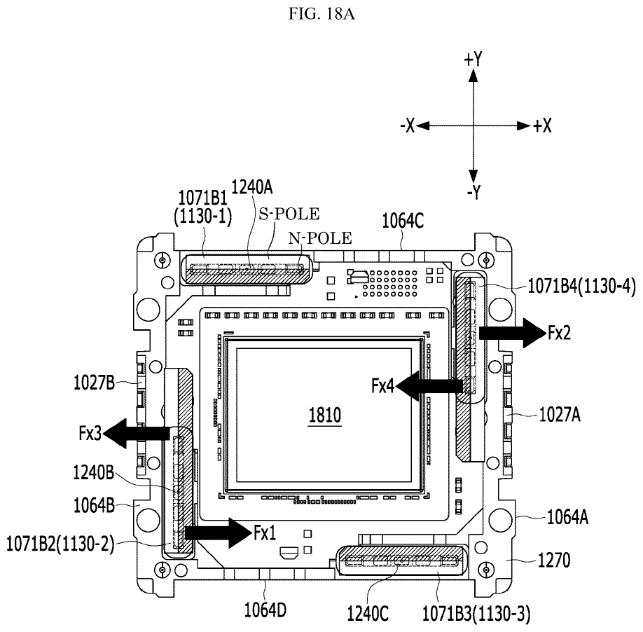

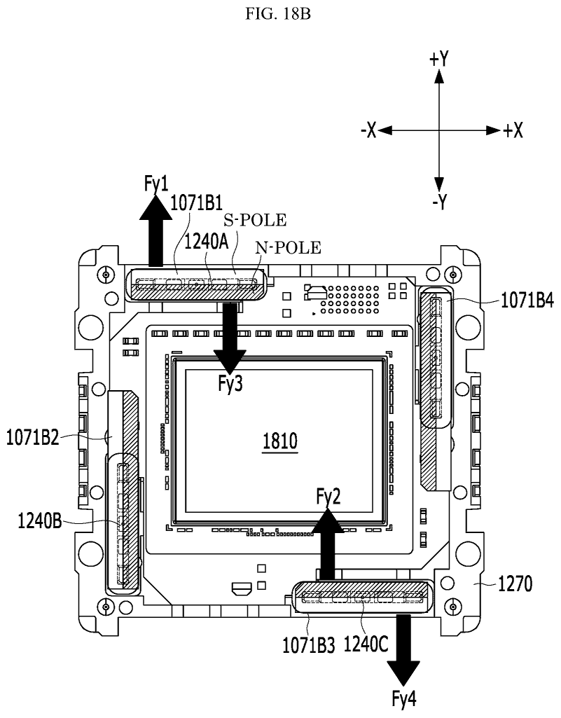

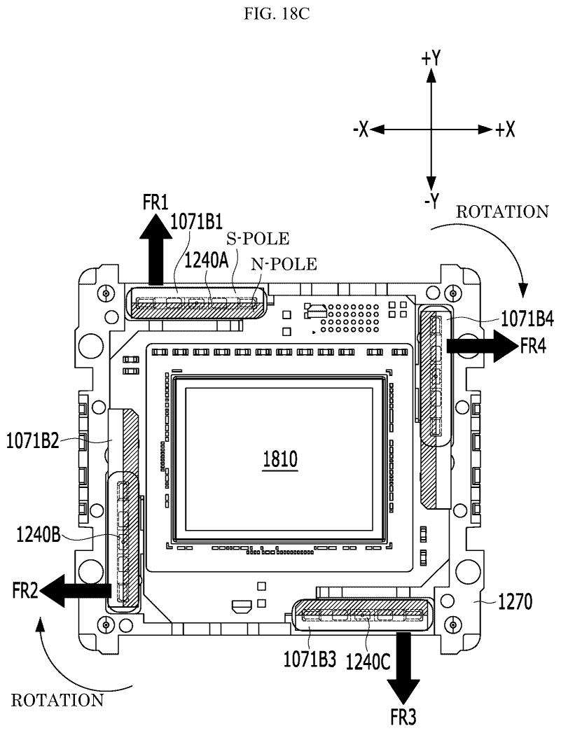

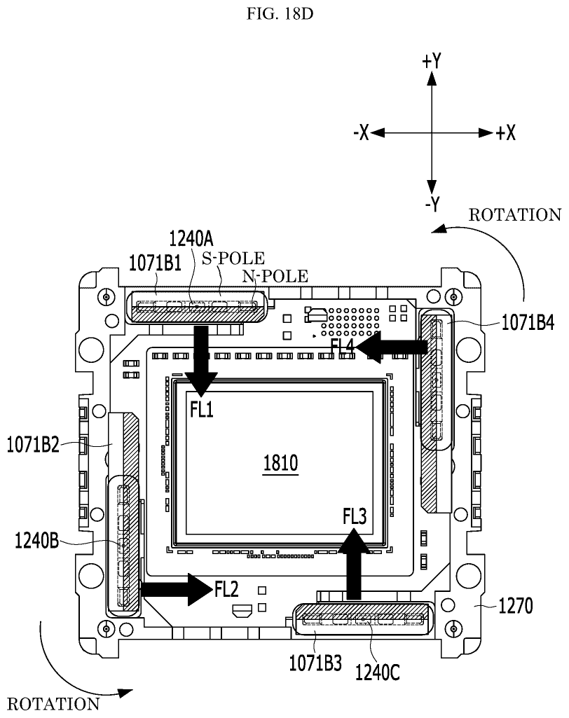

FIG. 18A is a view explaining movement of the OIS moving unit in the x-axis direction. FIG. 18B is a view explaining movement of the OIS moving unit in the y-axis direction.

The N pole and the S pole of each of the first and third magnet units 1071B1 and 1071B3, which face each other in the first diagonal direction, may be disposed so as to face each other in the first horizontal direction (for example, in the y-axis direction). Furthermore, the N pole and the S pole of each of the second and fourth magnet units 1071B2 and 1071B4, which face each other in the second diagonal direction perpendicular to the first diagonal direction, may be disposed so as to face each other in the second horizontal direction (for example, in the x-axis direction).

In other words, the direction in which the N pole and the S pole of the first magnet unit 1071B1 may be identical or parallel to the direction in which the N pole and S pole of the fourth magnet unit 1071B4 face each other.

In another embodiment in which the second magnet 1071B is a dipole magnet, the N pole of each of the first to fourth magnet units 1071B1 to 1071B4 may be positioned at an inner side, and the S pole may be positioned at an outer side, based on the boundary line (or the boundary plane) between the N pole and the S pole. In another embodiment, the S pole of each of the first to fourth magnet units 1071B1 to 1071B4 may be positioned at an inner side, and the N pole may be positioned at an outer side, based on the boundary line between the N pole and the S pole. The boundary line (or the boundary plane) may be a portion that is almost completely non-magnetic and has almost no polarity.

Referring to FIG. 18A, the OIS moving unit may be moved or shifted in the x-axis direction by virtue of the first electromagnetic force Fx1 (or Fx3) resulting from the interaction between the second coil unit 1230-2 and the second magnet unit 1071B2 and the second electromagnetic force Fx2 (or Fx4) resulting from the interaction between the fourth coil unit 1230-4 and the fourth magnet unit 1071B4. For example, the directions of the first electromagnetic force Fx1 (or Fx3) and the second electromagnetic force Fx2 (or Fx4) may be the same.

Referring to FIG. 18B, the OIS moving unit may be moved or shifted in the y-axis direction by virtue of the third electromagnetic force Fy1 (or Fy3) resulting from the interaction between the first coil unit 1230-1 and the first magnet unit 1071B1 and the fourth electromagnetic force (Fy2 (Fy4) resulting from the interaction between the third coil unit 1230-3 and the third magnet unit 1071B3. For example, the directions of the third electromagnetic force Fy1 (or Fy3) and the fourth electromagnetic force Fy2 (or Fy4) may be the same.

FIG. 18C illustrates clockwise rotation of the OIS moving unit in the case of driving through four channels. FIG. 18D illustrates counterclockwise rotation of the OIS moving unit in the case of driving through four channels.

Referring to FIG. 18C, by virtue of the first electromagnetic force FR1 resulting from the interaction between the first coil unit 1230-1 and the first magnet unit 1071B1, the second electromagnetic force FR2 resulting from the second coil unit 1230-2 and the second magnet unit 1071B2, the third electromagnetic force FR3 resulting from the interaction between the third coil unit 1230-3 and the third magnet unit 1071B3, and the fourth electromagnetic force FR4 resulting from the interaction between the fourth coil unit 1230-4 and the fourth magnet unit 1071B4, the OIS moving unit may be rotated clockwise about the optical axis or may be tilted or rolled relative to the optical axis.

Referring to FIG. 18D, by virtue of the first electromagnetic force FL1 resulting from the interaction between the first coil unit 1230-1 and the first magnet unit 1071B1, the second electromagnetic force FL2 resulting from the second coil unit 1230-2 and the second magnet unit 1071B2, the third electromagnetic force FL3 resulting from the interaction between the third coil unit 1230-3 and the third magnet unit 1071B3, and the fourth electromagnetic force FL4 resulting from the interaction between the fourth coil unit 1230-4 and the fourth magnet unit 1071B4, the OIS moving unit may be rotated counterclockwise about the optical axis or may be tilted or rolled relative to the optical axis.

For example, the direction of the first electromagnetic force FR1 (or FL1) and the direction of the third electromagnetic force FR3 (or FL3) may be opposite each other. Furthermore, for example, the direction of the second electromagnetic force FR2 (or FL2) and the direction of the fourth electromagnetic force FR4 (or FL4) may be opposite each other. Furthermore, for example, the direction of the first electromagnetic force RF1 (or FL1) and the direction of the second electromagnetic force FR2 (or FL2) may be perpendicular to each other.

In the case of driving through three channels, a drive signal may not be supplied to two coil units (for example, 1130-1 and 1130-3 or 1130-2 and 1130-4), which are connected to each other in series, and thus the electromagnetic force caused by the two coil units, which are connected to each other in series, may not be generated. For example, in the case of driving through three channels, the electromagnetic forces FR2 and FR4 may be omitted, and the electromagnetic forces FR1 and FR3 may be present in FIG. 18C. Alternatively, in the case of driving through three channels, the electromagnetic forces R2 and FR4 may be present and the electromagnetic forces FR1 and FR3 may be omitted in FIG. 18C. Furthermore, in the case of driving through three channels, the electromagnetic forces FL2 and FL4 may be omitted and the electromagnetic forces FL1 and FL3 may be present in FIG. 18D. Alternatively, in the case of driving through three channels, the electromagnetic forces FL2 and FL4 may be present and the electromagnets FL1 and FL3 may be omitted in FIG. 18D.

In comparison with the driving through three channels, according to the driving through four channels shown in FIGS. 18C and 18D, it is possible to increase the electromagnetic force required for rotation of the OIS moving unit and thus to reduce drive current required to drive the first to fourth coil units 1230-1 to 1230-4, thereby reducing power consumption.

Although OIS operation for hand tremor correction is performed using the second magnet 1071B and the second coil 1230 in the embodiment shown in FIG. 2, the OIS operation for hand tremor correction may be performed using a shape-memory alloy member in another embodiment. For example, the shape-memory alloy member may be coupled to the stationary unit and the OIS moving unit and may be electrically connected to the first board unit 1255. The controller 1830 and 780 may supply a drive signal to the shape-memory alloy member, and may move the OIS moving unit in a direction perpendicular to the optical axis or may cause rotation, tilting or rolling of the OIS moving unit relative to the optical axis by virtue of the shape-memory alloy member.

In another embodiment, the OIS operation may be performed using the second magnet 1071B and the second coil 1230, and the camera device 1010 may include a ball member (not shown) disposed between the base 1210 and the holder 1270 in order to support the OIS moving unit. Here, the ball member may support the OIS moving unit such that the OIS moving unit is moved in a direction perpendicular to the optical axis or is rotated, tilted or rolled relative to the optical axis using the frictional force and/or rolling force between the base 1210 and the holder 1270. In an embodiment, for example, the ball member may be disposed in the hole 1059 in the base 210 and may be in contact therewith. In another embodiment, the ball member may be provided, and the terminal member 1037 and the wire 1220 may be omitted.

The second position sensor 1240 may be disposed, coupled or mounted to the first surface (for example, the upper surface) of the first board unit 1255. The second position sensor 1240 may detect movement or displacement of the OIS moving unit in a direction perpendicular to the optical axis direction, for example, shift or movement of the OIS moving unit in a direction perpendicular to the optical axis direction. Furthermore, the second position sensor 1240 may detect rotation, rolling or tilting of the OIS moving unit relative to or about the optical axis within a predetermined range. The first position sensor 1170 may alternatively be referred to as an “AF position sensor”, and the second position sensor 1240 may alternatively be referred to as an “OIS position sensor”.

The second position sensor 1240 may face or overlap the magnet 1130 in the optical axis direction. For example, the second position sensor 1240 may include three or more sensors (for example, 240A to 240C), which correspond to or overlap three or more magnet units among the first to fourth magnet units 1130-1 to 1130-4 in the optical axis direction, in order to detect movement of the OIS moving unit.

For example, the second position sensor 1240 may be disposed under the second coil 1230.

For example, the second position sensor 1240 may not overlap the second coil 1230 in a direction perpendicular to the optical axis. For example, a sensing element of the second position sensor 1240 may not overlap the second coil 1230 in a direction perpendicular to the optical axis. The sensing element may be an element configured to detect a magnetic field.

For example, the center of the second position sensor 1240 may not overlap the second coil 1230 in a direction perpendicular to the optical axis. For example, the center of the second position sensor 1240 may be the spatial center in x-axis and y-axis directions on the x-y coordinate plane perpendicular to the optical axis. Alternatively, the center of the second position sensor 240 may be the spatial center in x-axis, y-axis and z-axis directions.

In another embodiment, at least a portion of the second position sensor 1240 may overlap the second coil 1230 in a direction perpendicular to the optical axis.

For example, the second position sensor 1240 may overlap the holes 1041A to 1041C in the holder 1270 in the optical axis direction. For example, the second position sensor 1240 may overlap the cavity in the second coil 1230 in the optical axis direction. For example, at least a portion of the holes 1041A to 1041C in the holder 1270 may overlap the cavity in the second coil 1230 in the optical axis direction.

For example, at least a portion of the second position sensor 1240, for example, the center of the second position sensor 1240 may not overlap the second coil 1230.

For example, the second position sensor 1240 may include the first sensor 1240A, the second sensor 1240B, and the third sensor 1240C, which are disposed so as to be spaced apart from one another.

For example, each of the first to third sensors 1240A, 1240B and 1240C may be a Hall sensor. In another embodiment, each of the first to third sensors 1240A, 1240B and 1240C may be a driver IC including a Hall sensor and a driver. The description of the first position sensor 1170 may be applied to the first to third sensors 1240A, 1240B and 1240C with or without modification. For example, each of the first to third sensors 1240A, 1240B and 1240C may be a displacement-detecting sensor in which output voltage thereof varies according to the relative position or the relationship with respect to a corresponding magnet unit.

Each of the first sensor 1240A, the second sensor 1240B and the third sensor 1240C may be electrically connected to the first circuit board 1250.

The second position sensor 1240 may be disposed below the cavity in the second coil 1230. In another embodiment, the second position sensor 1240 may be disposed outside the second coil 1230 when viewed in the optical axis direction or from above.

The second position sensor 1240 may not overlap the second coil 1230 in a direction perpendicular to the optical axis direction. For example, the second position sensor 1240 may overlap the holder 1270 in a direction perpendicular to the optical axis direction.

For example, the first sensor 1240A may be disposed below the cavity in the first coil unit 1230-1. The first sensor 1240A may be disposed in a corresponding one 1041A among the holes 1041A to 1041C in the holder 1270. The second sensor 1240B may be disposed below the cavity in the second coil unit 1230-2. The second sensor 1240B may be disposed in another hole 1041B among the holes 1041A to 1041C in the holder 1270. The third sensor 1240C may be disposed below the cavity in the third coil unit 1230-3. The third sensor 1240C may be disposed in the other hole 1041C among the holes 1041A to 1041C in the holder 1270.

For example, each of the first to third sensors 1240A, 1240B and 1240C may not overlap a corresponding one of the coil units 1230-1 to 1230-3 in a direction perpendicular to the optical axis. The first to third sensors 1240A, 1240B and 1240C may overlap the holder 1270 in a direction perpendicular to the optical axis.

By disposing the first to third sensors 1240A, 1240B and 1240C so as not to overlap the OIS coil 230 in a direction perpendicular to the optical axis, it is possible to reduce influence of the magnetic field of the OIS coil 230 on the output of the OIS position sensor 1240 and thus to perform accurate OIS feedback operation, thereby assuring reliability of OIS operation.

The second position sensor 1240 may face, correspond to or overlap the magnet 1130 in the optical axis direction. For example, at the initial position of the OIS moving unit, at least a portion of the first sensor 1240A may overlap the first magnet unit 1071B1 of the second magnet 1071B in the optical axis direction. The first sensor 1240A may output a first output signal (for example, a first output voltage) corresponding to the result of detection of the magnetic field of the first magnet unit 1071B1.

For example, at the initial position of the OIS moving unit, at least a portion of the second sensor 1240B may overlap the second magnet unit 1071B2 of the second magnet 1071B in the optical axis direction, and the second sensor 1240B may output a second output signal (for example, a second output voltage) corresponding to the result of detection of the magnetic field of the second magnet unit 1071B2.

For example, at the initial position of the OIS moving unit, at least a portion of the third sensor 1240C may overlap the third magnet unit 1071B3 of the second magnet 1071B in the optical axis direction, and the third sensor 1240C may output a third output signal (for example, a third output voltage) corresponding to the result of detection of the magnetic field of the third magnet unit 1071B3.

The initial position of the OIS moving unit may be the original position of the OIS moving unit in the state in which no power or drive signal is applied to the second coil 1230 from the controllers 1830 and 780 or the position at which the OIS moving unit is positioned as the result of the support board being elastically deformed due only to the weight of the OIS moving unit. In addition, the initial position of the OIS moving unit may be the position at which the OIS moving unit is positioned when gravity acts in the direction from the first board unit 1255 to the second board unit 1800 or when gravity acts in the direction from the second board unit 1800 to the first board unit 1255.

In order to improve the linearity of the relationship between displacement of the OIS moving unit and the output of the second position sensor 1240, each of the sensor units 1240A, 1240B and 1240C may overlap a corresponding one of the magnet units 1071B1, 1071B2 and 1072B3 in the optical axis direction within the stroke range of the OIS moving unit.

For example, the controllers 1830 and 780 may control rolling of the OIS moving unit using at least one of the first output voltage of the first sensor 1240A, the second output voltage of the second sensor 1240B and the third output voltage of the third sensor 1240C. For example, the controllers 1830 and 780 may control rolling of the OIS moving unit using the first output voltage and the third output voltage.

For example, the controller 1830 and 780 may control or adjust movement or displacement of the OIS moving unit in the first horizontal direction (for example, in the y-axis direction) or in the second horizontal direction (for example, in the x-axis direction) using at least one of the first to third output voltages. For example, the controllers 1830 and 780 may control or adjust movement or displacement of the OIS moving unit in the first horizontal direction (for example, in the y-axis direction) using the first output voltage of the first sensor 1240A, and may control or adjust movement or displacement of the OIS moving unit in the second horizontal direction using the second output voltage of the second sensor 1240B.

Each of the first to third sensors 1240A, 1240B and 1240C may be a Hall sensor. In another embodiment, each of the first to third sensors may be a driver IC including a Hall sensor. In a further embodiment, each of the first and second sensors 1240A and 1240B may be a Hall sensor, and the third sensor 1240C may be a tunnel magnetoresistance (TMR) sensor. Here, the tunnel magnetoresistance (TMR) sensor may be a TMR magnetic angle sensor.

In still a further embodiment, each of the first to third sensors 1240A, 1240B and 1240C may be a tunnel magnetoresistance (TMR) sensor. Here, the TMR sensor may be a TMR linear magnetic field sensor in which the output according to displacement (or stroke) of the OIS moving unit is linear.

The base 1210 may be disposed below the first board unit 1255. The base 1210 may be spaced apart from the first board unit 1255. The base 1210 may have a polygonal shape, for example, a quadrilateral shape, which coincides with or corresponds to the cover member 1300 or the first board unit 1255.

For example, the base 1210 may have the bore 1210A which corresponds to or faces the first board unit 1255. The bore 1210A in the base 1210 may be a through hole which is formed through the base 1210 in the optical axis direction. In another embodiment, the base may not have the bore.

For example, the base 1210 may be coupled to the side plate 1302 of the cover member 1300. The side portion or the outer surface of the base 1210 may include a step 1211 (see FIG. 14) to which an adhesive is applied when the side portion or the outer surface is bonded to the side plate 1302 of the cover member 1300. Here, the step 1211 may guide the side plate 1302 of the cover member 1300 which is coupled to the upper side thereof. The step 1211 of the base 1210 and the lower end of the side plate 1302 of the cover member 1300 may be bonded or fixed to each other using an adhesive or the like.

The base 1210 may include one or more projections 1216A and 1216B projecting from the upper surface thereof. For example, the projections 1216A and 1216B may project upwards from the outer surface of the base 1210. For example, the base 1210 may include two projections 1216A and 1216B which face or overlap each other in the first horizontal direction (for example, in the y-axis direction).

For example, the base 1210 may include four side portions (or side plates), and the projections 1216A and 1216B may be formed at two of the four side portions. For example, the projections 1216A and 1216B may be disposed or positioned in the center of the side portion (or the side plate) of the base 1210.

The base 210 may include a groove 341B. The groove 341b may be an adhesive-receiving groove. The groove 341b may be formed in the outer surface of a corresponding one of the projections 216A and 216B of the base 210. The groove 1341b may be formed in the upper surface of a corresponding one of the projections 1216A and 1216B of the base 1210. The groove 1341b may be formed from the upper surface to the lower surface of a corresponding one of the projections 1216A and 1216B. An adhesive may be disposed in the groove 1341b in order to bond the support board 1310 to the base 1210. The groove 1341b may include a plurality of grooves. For example, the groove 1341b may extend in the optical axis direction. In another embodiment, the groove formed in a corresponding one of the projections 1216A and 1216B of the base 1210 may extend in a direction perpendicular to the optical axis.

For example, the second board unit 1800 may be disposed below the base 1210. For example, the second board unit 1800 may be disposed so as to be spaced apart from the OIS moving unit, for example, the first board unit 1255 and the first heat radiating member 1280 in the optical axis direction.

For example, the second board unit 800 may be disposed below the lower surface of the base 1210. The second board unit 1800 may be coupled to the base 1210. For example, the second board unit 1800 may be coupled to the lower surface of the base 1210.

The second board unit 1800 may serve to supply a signal to the image sensor unit 1350 from the outside or to output the signal transmitted from the image sensor unit 1350 to the outside.

The second board unit 1800 may include a first region 1801 (or a first board), which corresponds to, faces or overlaps the AF operation unit 1100 or the image sensor 1810 in the optical axis direction, a second region 1802 (or a second board) on which a connector 1804 is disposed, and a third region 1803 (or a third board) connecting the first region 1801 to the second region 1802. The connector 1804 may include a port which is to be electrically connected both to the second region 1802 of the second board unit 1800 and to an external device (for example, the optical instrument 200A). The bore 1210A in the base 1210 may be closed or blocked by the first region 1801 of the second board unit 1800.

The first region 1801 of the second board unit 1800 may correspond to, face or overlap at least one of the cover member 1300 or the base 1210 in the optical axis direction. For example, the first region 1801 may overlap the upper plate 1301 and the side plate 1302 of the cover member 1300 in the optical axis direction.

Each of the first region 1801 and the second region 1802 of the second board unit 1800 may include a rigid substrate. The third region 1803 may include a flexible substrate. Each of the first region 1801 and the third region 1802 may further include a flexible substrate.

In another embodiment, at least one of the first to third regions 1801 to 1803 of the circuit board 1800 may include at least one of a rigid substrate or a flexible substrate.

The second board unit 1800 may be disposed behind the first board unit 1255. For example, the first board unit 1255 may be disposed between the AF operation unit 1100 and the second board unit 1800. In another embodiment, the second board unit may be disposed between the AF operation unit and the first board unit.

Although the first region 1801 of the second board unit 1800 may have a polygonal shape (for example, a quadrilateral shape, a square shape or a rectangular shape) when viewed from above, the disclosure is not limited thereto. In another embodiment, the first region 801 may have a circular shape or the like.

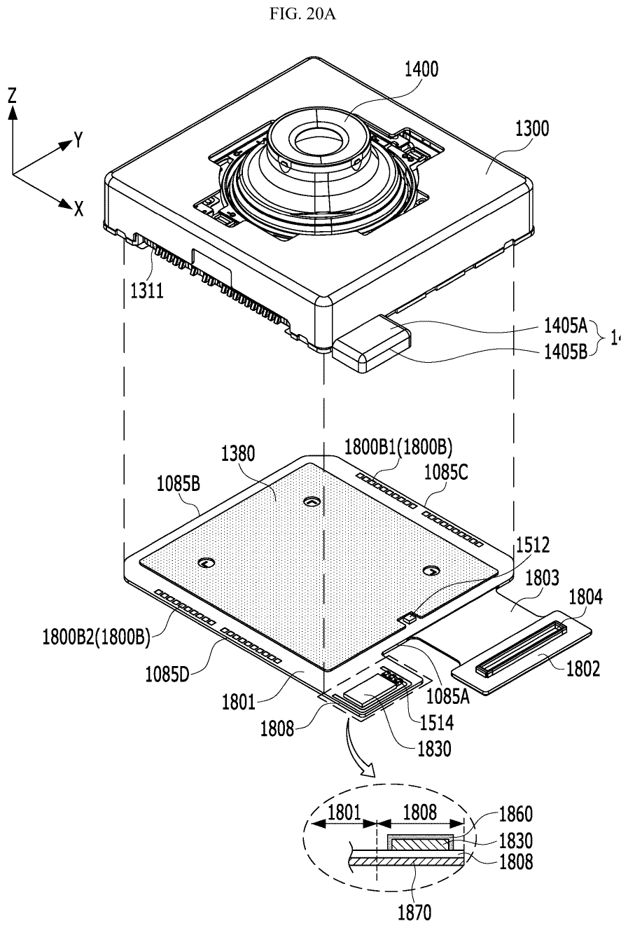

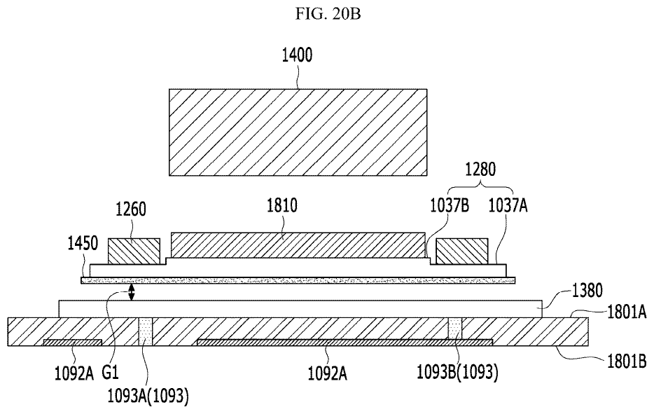

FIG. 20A illustrates disposition of the first to third regions 1801 to 1803 of the second board unit 1800, an extension region 1808, the AF moving unit, the OIS moving unit, and the controller 1830 according to an embodiment.

Referring to FIG. 20A, the first region 1801 may include four side portions 1085A to 1085D (or side surfaces). For example, the first region 1801 may include first and second side portions 1085A and 1085B, which face each other or are opposed to each other in the second horizontal direction (for example, in the x-axis direction), and third and fourth side portions 1085C and 1085D, which face each other or are opposed to each other in the first horizontal direction (for example, in the y-axis direction).

The second region 1802 may be disposed adjacent to the first side portion 1085A of the first region 1801, and the third region 1803 may be connected to the first side portion 1085A of the first region 1801. For example, the third region 1803 may extend from the first region 1801 and may be connected to one side of the second region 1802 that is opposed to the first side portion 1085A.

The second board unit 1800 may include a plurality of terminals 1800B corresponding to terminals 1311 of the support board 1310. The plurality of terminals 1800B may be formed in the first region 1801 of the second board unit 1800. For example, the second board unit 1800 may include first terminals 800B1, which are disposed or arranged so as to be spaced apart from each other along one side of the third side portion 1085C of the first region 1801 in the second horizontal direction (for example, in the x-axis direction), and second terminals 800B2, which are disposed or arranged so as to be spaced apart from each other along one side of the fourth side portion 1085D of the first region 1801 in the second horizontal direction.

For example, the plurality of terminals 1800B may be formed on a first surface (for example, the upper surface) of the second board unit 1800 (for example, the first region 1801) which faces the first board unit 1255.

For example, the controller 1830 may be disposed on the extension region which extends from one of the third and fourth side portions 1085C and 1085D of the first region 1801 of the second board unit 1800. In another embodiment, the controller may be disposed on the extension region which extends from the side portion of the first region 1801 of the second board unit 1800 on which the plurality of terminals are formed.

The first region 1801 may have formed therein a coupling hole (not shown), and the base 1210 may have formed thereon a coupling protrusion (not shown) to be coupled to the coupling hole in the first region 1801.

The camera device 1010 may further a heat radiating member 1380 which is disposed, coupled or fixed to the second board unit 1800. For example, the heat radiating member 1380 may be disposed on, coupled or fixed to the upper surface of the first region 1801 of the second board unit 1800. In another embodiment, the heat radiating member 1380 may be omitted.

The camera device 1010 may further include a third radiating member (not shown) which is disposed on, coupled or fixed to a second surface (for example, the lower surface) of the second board unit 1800.

For example, the heat radiating member 1380 may be a plate-shaped member having predetermined thickness and hardness. The heat radiating member 1380 may face or overlap the first heat radiating member 1280 in the optical axis direction.

Although the controller 1830 is disposed or coupled to the upper surface of the extension region 1808 in FIG. 20A, the controller may also be disposed or coupled to the lower surface of the extension region 1808 in another embodiment.

Although the controller 1830 is disposed on the extension region 1808 of the second board unit 1800 which is positioned outside the cover member 1300 in FIG. 20A, the controller may also be disposed in the first region of the second board unit 1800 which is positioned outside the base 1210 in another embodiment.

In a further embodiment, the controller may be disposed or mounted on the second circuit board 1260 which is a sensor board. In another embodiment, for example, the controller may be disposed or mounted on the upper surface of the second circuit board 1260. Because the heat radiating member 1280 is disposed on or coupled to the lower surface of the second circuit board 1260, when the controller is disposed on the second circuit board 1260, the heat generated by the controller may be easily radiated by means of the heat radiating member 1280, thereby improving heat radiation efficiency and radiation performance.

FIG. 20B is a schematic cross-sectional view of the lens module 1400, the first board unit 1255, the image sensor 1810, and the second board unit 1800.

Referring to FIG. 20B, the image sensor 1810 may be disposed in the bore 1260A (or the hole) in the second circuit board 1260, and may be coupled to the first heat radiating member 1280.

For example, the first heat radiating member 1280 may include a body 1037A, which is disposed below the second circuit board 1260, and a projection 1037B (or a projection region), which is disposed in the bore 1260A in the second circuit board 1260.

The camera device 101010 may include a heat radiating body 1450 connecting the heat radiating member 1280 to the support (for example, the support board 1310).

The second radiating body 1450 may include a body (or a first region) coupled to the lower surface of the radiating body 1280 and a connector (or a second region) connecting the body to the support (for example, the support board 1310). The radiating body 1450 may include a graphite sheet.

The image sensor 1810 may be disposed, coupled or fixed to the projection 1037B. For example, the image sensor 1810 may be disposed, coupled or attached to the upper surface of the projection 1037B. For example, the upper surface of the projection 1037B may be positioned lower than the upper surface of the second circuit board 1260. In another embodiment, the upper surface of the projection 1037B may be flush with the upper surface of the second circuit board 1260.

The heat radiating member 1380 may be disposed on the first surface 1801A (or the upper surface) of the first region 1801 of the second board unit 1800 which faces the first heat radiating member 1280 in the optical axis direction.

The distance G1 (or the gap) between the first board unit 1255 and the second board unit 1800 in the optical axis direction may be 0.05 mm to 0.7 mm. For example, the distance G1 may be the distance between the lower surface of the heat radiating member 1280 and the upper surface of the heat radiating member 1380.

In another embodiment, the distance G1 may be 0.15 mm to 0.5 mm. In a further embodiment, the distance G1 may be 0.15 mm to 0.3 mm. In still a further embodiment, the distance G1 may be 0.2 mm to 0.3 mm.

The second board unit 1800 may include a first conductive layer 1093 which is exposed from the first surface 1801A and is in contact with the second heat radiating member 1380, for example, the lower surface of the second heat radiating member 1380. For example, the first conductive layer 1093 may be heat-fused to the lower surface of the second heat radiating member 1380 or may be coupled to the lower surface of the second heat radiating member 1380 using a conductive adhesive, for example, solder or the like. For example, the first conductive layer 1093 may be electrically connected to the heat radiating member 1380.

The second board unit 1800 may include a second conductive layer 1092A which is connected to the first conductive layer 1093 and is exposed from the second surface 1801B (or the lower surface) of the second board unit 1800 that is the surface opposite the first surface 1801A of the second board unit 1800. For example, the second conductive layer 1092A may be electrically connected to the ground of the second board unit 1800.

The first conductive layer 1093 may be a via which is formed through at least a portion of the second board unit 1800. For example, the first conductive layer 1093 may include a first via 1093A which is formed through the second board unit 1800 and is open or exposed at the second surface 1801B of the second board unit 1800. Furthermore, the first conductive layer 1093 may include a second via 1093B one end of which is in contact with the lower surface of the heat radiating member 1380 and the other end of which is in contact with or coupled or connected to the second conductive layer 1092A.

In FIG. 20B, the second conductive layer 1092A may be disposed in or coupled or attached to a groove formed in the second surface 1801B of the second board unit 1800. In another embodiment, the second conductive layer may be disposed in or coupled or attached to the second surface 1801B of the second board unit 1800 without the groove formed in the second surface 1801B.

The first conductive layer 1093 and the second conductive layer 1092A may serve as radiating patterns or radiating pads for heat radiation of the second board unit 1800. In other words, because the first conductive layer 1093 and the second conductive layer 1092A are merely intended to radiate heat, they need not be electrically connected to other wires of the second board unit 1800 except for the ground of the second board unit 1800. Here, the other wires may be wires electrically connected to an electronic element (or a circuit element), such as the image sensor 1810, or the support board 1310.

The second conductive layer 1092A may be electrically connected to the cover member 1300 (for example, the side plate 1302) via solder, a conductive adhesive or conductive tape. In another embodiment, the second conductive layer 1092A, which is connected to the ground of the second board unit 1800, may be electrically connected to the cover member 1300 by means of a bracket. The bracket may be a structure which receives or accommodates the camera device therein in order to protect the camera device. For example, the bracket may be made of a conductive member. Since the ground of the second board unit 1800 and the second heat radiating member 1380 are electrically connected to the cover member 1300, it is possible to protect the camera device 1010 from static electricity and to improve efficiency of heat radiation.

In another embodiment, the first conductive layer and the second conductive layer of the second board unit 1800 may be applied to the second circuit board 1260 with or without modification. For example, the second circuit board 1260 according to another embodiment may include at least one third conductive layer which is in contact with the first heat radiating member 1280, and at least a portion of the third conductive layer may be exposed from the second circuit board 1260.

Since the heat radiating member 1380 is disposed on the first surface of the second board unit 1800, it is possible to reduce the distance between the heat radiating member 1280 and the heat radiating member 1380 and thus to improve efficiency of heat radiation.

The heat radiated from the first heat radiating member 1280 may be transmitted to the second heat radiating member 1380 through convection or radiation, and the transmitted heat may be radiated to the outside through the second heat radiating member 1380, thereby improving efficiency of heat radiation. Since the upper surface of the second heat radiating member 1380 and the lower surface of the first heat radiating member 1280 are disposed so as to face or overlap each other in the optical axis direction, heat may be efficiently transmitted to the second heat radiating member 1380 from the first heat radiating member 1280.

For example, the heat radiating member 1280 and the second heat radiating member 1380 may be made of the same material. In another embodiment, the first heat radiating member 1280 and the second heat radiating member 1380 may be made of different materials. For example, the thermal conductivity of the first heat radiating member 1280 may be applied to the second heat radiating member 1380 with or without modification.

Furthermore, the heat radiating member 1380 may stably support the second board unit 1800, and may serve as a reinforcing member configured to suppress breakage of the second board unit 1800 attributable to external shock or contact.

In another embodiment, the second heat radiating member 1380 may be made of a radiating member having high thermal conductivity, for example, exothermic epoxy, exothermic plastic, or exothermic synthetic resin.

The second heat radiating member 1380 may include at least one groove or unevenness in order to improve efficiency of radiation. For example, a groove or unevenness having a predetermined pattern may be formed on at least one of the upper surface or the lower surface of the second heat radiating member 1380.

In another embodiment, the heat radiating member 1380 may have a hole or a through hole in place of the groove. For example, the heat radiating member 1380 according to another embodiment may have a plurality of through holes. The description of the predetermined pattern of the heat radiating member 1280 may be applied to the heat radiating member 1380 with or without modification.

The camera device according to another embodiment may include a heat radiating member disposed below the second board unit 1800. Here, the description of the material of the heat radiating member 1280 or 1380 may be applied to the heat radiating member with or without modification.

The support board 1310 may support the OIS moving unit such that the OIS moving unit is movable relative to the stationary unit in a direction perpendicular to the optical axis direction, and may electrically connect the first board unit 1255 to the second board unit 1800.

The support board 1310 may alternatively be referred to as a “support member”, a “connecting board”, or a “connecting portion”. Alternatively, the support board 1310 may alternatively be referred to as an “interposer”. Alternatively, the interposer may include the first circuit board 1250 and the support board 1310 which are integrally formed.

In another embodiment, in place of the support board 1310, a support unit, which is connected at one end thereof to the moving unit, for example, the first board unit 1255 and at the other end thereof to the stationary unit, for example, the second board unit 1800, may be provided. For example, the support unit may include at least one of a leaf spring or a suspension wire. For example, the support unit may electrically connect the first board unit 1255 to the second board unit 1800.

The support board 1310 may include a flexible substrate or may be a flexible board. For example, the support board 1310 may include a flexible printed circuit board (FPCB). At least a portion of the support board 1310 may be flexible. The first circuit board 1250 may be connected to the support board 1310.

Referring to FIG. 16, for example, the support board 1310 may include a connecting portion 1320 connected to the first circuit board 150. For example, the first circuit board 1250 and the support board 1310 may be integrally formed. In another embodiment, the first circuit board 1250 and the support board 1310 may not be integrally formed but may be separately formed. The first circuit board 1250 and the support board 1310 may be connected to each other via the connecting portion 1320, and may be electrically connected to each other. In another embodiment, the connecting portion 1320 may be integrally formed with at least one of the support board 1310 or the first circuit board 1250.

The support board 1310 may be electrically connected to the first circuit board 1250. The support board 1310 may be electrically connected to the second board unit 1800. For example, one end of the support board 1310 may be connected or coupled to the first board unit 1255 (for example, the second circuit board 1250). The other end of the support board 1310 may be connected or coupled to the second board unit 1800.

The support board 1310 may support the OIS moving unit with regard to the stationary unit. The support board 1310 may guide movement of the OIS moving unit. The support board 1310 may guide the OIS moving unit such that the OIS moving unit is movable in a direction perpendicular to the optical axis direction. The support board 1310 may guide the OIS moving unit such that the OIS moving unit is rotated, tilted or rolled relative to the optical axis. The support board 1310 may restrict movement of the OIS moving unit in the optical axis direction.

A portion of the support board 1310 may be coupled, attached or fixed to the base 1210 which is the stationary unit, and another portion of the support board 1310 may be coupled, attached or fixed to the holder 1270 which is the OIS moving unit.

For example, portions of the bodies 1086 and 1087 of the support board 1310 may be coupled to the base 1210 (for example, the projections 1216A and 1216B) which is the stationary unit, and other portions of the bodies 1086 and 1087 may be coupled to the holder 1270 (for example, the couplers 1027A and 1027B) which is the OIS moving unit.

The connecting portion 1320 of the support board 1310 may be connected to the first board unit 1255 (for example, the first circuit board 1250) and may be electrically connected thereto. Extensions 1007A to 1007D of the support board 1310 may be coupled to the second board unit 1800 (for example, the terminals 1800B) and may be electrically thereto.

The support board 1310 may include the circuit board and an elastic portion coupled to the circuit member. The elastic portion, which serves to flexibly support the OIS moving unit, may be embodied as an elastic body, for example, a spring. The elastic portion may include metal or may be made of an elastic material. The circuit member, which serves to electrically connect the first circuit board 1250 to the second board unit 1800, may be a flexible board or may include at least one of a flexible board or a rigid board. For example, the circuit member may be a flexible printed circuit board (FPCB).

For example, the support board 1310 may include one or more connectors 1320A and 1320B, which is connected to the first board unit 1255 (for example, the first circuit board 1250) and which is electrically connected to the first board unit 1255 (for example, the first circuit board 1250).

Furthermore, the support board 1310 may include one or more extensions 1007A to 1007D which are connected to the second board unit 1800 and which are electrically connected to the second board unit 1800. The one or more extensions 1007A to 1007D may include a plurality of terminals 1311.

For example, the support board 1310 may be disposed so as to surround the OIS moving unit, for example, the first board unit 1255. For example, the support board 1310 may be disposed so as to surround the four side portions 1033A to 1033D (see FIG. 16) of the first circuit board 1250 or to surround the outer surfaces thereof.

For example, the support board 1310 may not overlap the OIS moving unit, for example, the first board unit 1255 in the optical axis direction, and at least a portion of the support board 1310 may overlap the OIS moving unit, for example, the first board unit 1255 in a direction perpendicular to the optical axis direction.

For example, the support board 1310 may include a plurality of support boards which are separated or spaced apart from each other. In another embodiment, the support board 1310 may be formed to have a single integrated structure.

The support board 1310 may include the bodies 1086 and 1087. For example, the bodies 1086 and 1087 may be disposed so as to surround the OIS moving unit, for example, the first board unit 1255. For example, the bodies 1086 and 1087 may not overlap the OIS moving unit, for example, the first board unit 1255 in the optical axis direction, and at least a portion of each of the bodies 1086 and 1087 may overlap the OIS moving unit, for example, the first board unit 1255 in a direction perpendicular to the optical axis direction.

For example, each of the bodies 1086 and 1087 may have the form of a plate which is flat in the optical axis direction or in a direction parallel to the optical axis direction. When viewed from above, for example, each of the bodies 1086 and 1087 may have a contour having a polygonal shape, for example, a quadrilateral shape, or a circular shape.

For example, each of the bodies 1086 and 1087 may include a plurality of portions which are separated or spaced apart from each other. In another embodiment, each of the bodies may be formed to have an integrated structure.

The support board 1310 may include an extension which extends from each of the bodies 1086 and 1087 and is coupled to the second board unit 1800. For example, the extension of the support board 1310 may extend toward the second board unit 1800, and one end of the extension of the support board 1410 may be coupled to the second board unit 1800. One end of the extension of the support board 1310 may be provided with a plurality of terminals which are electrically connected to the second board unit 1800 using a solder or a conductive adhesive. For example, the extension of the support board 1310 may alternatively be referred to as a “terminal portion”, a “projecting portion” or a “leg portion”.

For example, each of extensions 1007A to 1007D of the support board 1310 may include a first portion, which extends from a corresponding one of the bodies 1086 and 1087 in the optical axis direction, and a second portion, which extends from the first portion in a direction perpendicular to the optical axis. For example, the extensions 1007A to 1007D of the support board 1310 may be fixed or coupled to the stationary unit (for example, the base 1210). For example, when the OIS moving unit moves, the bodies 1086 and 1087 of the support board 1310 is movable but the extensions 1007A to 1007D of the support board 1310 may be fixed so as to be immovable.

For example, the support board 1310 may include a first support board 1310-1 and a second support board 1310-2 which are spaced apart from each other. The first and second support boards 1310-1 and 1310-2 may be line-symmetrically formed. In another embodiment, the first support board 1310-1 and the second support board 1310-2 may be integrally formed into a single board. In a further embodiment, the support board 1310 may include three or more support boards.

For example, the first and second support boards 1310-1 and 1310-2 may be disposed so as to surround the four side portions 1033A to 1033D of the first circuit board 1250.

For example, the first support board 1310-1 may include the first body 1086 and two or more extensions 1007A and 1007B which extend from the fist body 1086. The two or more extensions 1007A and 1007B of the first support board 1310-1 may include a plurality of terminals 1311.

The second support board 1310-2 may include the second body 1087 and two or more extensions 1007C and 1007D which extend from the second body 1087. The two or more extensions 1007C and 1007D of the second support board 1310-2 may include a plurality of terminals 1311.

The first circuit board 1250 may include the first side portion 1033A and the second side portion 1033B, which are positioned opposite each other, and the third side portion 1033C and the fourth side portion 1033D, which are positioned between the first side portion 1033A and the second side portion 1033B and are positioned opposite each other.

For example, the first connector 1320A may connect the first body 1086 to the first side portion 1033A of the first circuit board 1250. The second connector 1320B may connect the second body 1087 to the second side portion 1033B of the first circuit board 1250.

The first body 1086 may include a first portion 1006A, which corresponds to or faces the first side portion 1033A of the first circuit board 1250, a second portion 1006B, which corresponds to a portion (or a side) of the third side portion 1033C of the first circuit board 1250, and a third portion 1006C, which corresponds to a portion (or a side) of the fourth side portion 1033D of the circuit board 1250. Furthermore, the first body 1086 may include a first bent portion 1006D, which connects one end of the first portion 1006A to the second portion 1006B and is bent at the one end of the first portion 1006A, and a second bent portion 1006E, which connects the other end of the first portion 1006A to the third portion 1006C and is bent at the other end of the first portion 1006A. For example, the first body 1086 may have a “U” shape.

For example, the first support board 1310-1 may include the extensions 1007A and 1007B. For example, the extension 1007A may be connected to one side of the first body 1086, and the extension 1007B may be connected to the other side of the first body 1086.

For example, the extension 1007A may extend or project toward the second board unit 1800 from the first portion 1006B of the first body 1086, and the extension 1007B may extend or project toward the second board unit 1800 from the third portion 1006C of the first body 1086. The extension 1007B may be positioned opposite the extension 1007A with the first board unit 1255 (for example, the first circuit board 1250) interposed therebetween.

For example, the first connector 1320A may connect the first portion 1006A of the first body 1086 to the first side portion 1033A of the first circuit board 1250. The first connector 1320A may include a bent portion. For example, the first connector 1320A may connect the central region of the first portion 1006A of the first body 1086 to the central region of the first side portion 1033A of the first circuit board 1250.

The second body 1087 may include a first portion 1009A, which corresponds to or faces the second side portion 1033B of the first circuit board 1250, a second portion 1009B, which corresponds to or faces another portion (or the other side) of the third side portion 1033C of the first circuit board 1250, and a third portion 1009C, which corresponds to or faces another portion (or the other side) of the fourth side portion 1033D of the first circuit board 1250. Furthermore, the second body 1087 may include a first bent portion 1009D, which connects one end of the first portion 1009A to the second portion 1009B and is bent at the one end of at the first portion 1009A, and a second bent portion 1009E, which connects the other end of the first portion 1009A to the third portion 1009C and is bent at the other end of the first portion 1009A. For example, the second body 1087 may have a “U” shape. For example, the second body 1087 may have a shape symmetrical with the first body 1086 based on the optical axis. For example, the second body 1087 may be symmetrical with the first body 1086 based on the optical axis.

For example, the second support board 1310-2 may include the extensions 1007C and 1007D. For example, the extension 1007C may be connected to one side of the second body 1087, and the extension 1007D may be connected to the other side of the second body 1086.

The extension 1007C may extend or project toward the second board unit 1800 from the second portion 1009B of the second body 1087, and the extension 1007D may extend or project toward the second board unit 1800 from the third portion 1009C of the second body 1087. The extension 1007D may be positioned opposite the extension 1007C with the first board unit 1255 (for example, the first circuit board 1250) interposed therebetween.

For example, the extension 1007A and the extension 1007C may be line-symmetrical with each other when viewed from the front. In another embodiment, the extension 1007A and the extension 1007C may not be line-symmetrical with each other.

For example, the extension 1007B and the extension 1007D may be line-symmetrical with each other when viewed from the front. In another embodiment, the extension 1007B and the extension 1007D may not be line-symmetrical with each other.

For example, the second connector 1320B may connect the first portion 1009A of the second body 1087 to the second side portion 1033B of the first circuit board 1250. The second connector 1320B may include a bent portion. For example, the second connector 1320B may connect the central region of the first portion 1009A of the second body 1087 to the central region of the second side portion 1033B of the first circuit board 1250.

Referring to FIG. 16, the terminal members (for example, 1007A and 1007C) of the support board 1310 may be provided with terminals P1 to P4 which are electrically connected to the terminals B1 to B4 of the terminal member 1095 of the circuit board 1190 of the AF operation unit 1100. The terminals B1 to B4 of the terminal member 1095 of the circuit board 1190 and the terminals P1 to P4 of the extensions 1007A and 1007C of the support board 1310 may be respectively connected to each other using a solder or a conductive adhesive. In other words, the circuit board 1190 of the AF operation unit 1100 may be electrically connected to the second board unit 1800 via the support board 1310.

Referring to FIG. 16, the support board 1310 may include the conductive layer 1093-1. Furthermore, the support board 1310 may include the first insulating layer 1094-1 disposed on one surface (or a first surface) or one side of the conductive layer 1093-1. Furthermore, the support board 1310 may include the second insulating layer 1094-2 disposed on the other surface (or a second surface) or the other side of the conductive 1093-1. In another embodiment, for example, the support board 1310 may include at least one of the first insulating layer 1094-1 or the second insulating layer 1094-2. The support board 1310 may include a protective layer 1096 disposed on the first insulating layer 1094-1. For example, the protective layer 1096 may be an EMI member (for example, an EMI tape). Alternatively, for example, the protective layer 1096 may be a heat radiating member, for example, graphite. Alternatively, for example, the protective layer 1096 may be an elastic material. Alternatively, for example, the projective layer 1096 may be a conductive member. Alternatively, for example, the protective layer 1096 may be an insulation member.

FIG. 17A is a first perspective view of the support board 1310 coupled to the holder 1270 and the base 1210. FIG. 17B is a second perspective view of the support board 1310 coupled to the holder 1270 and the base 1210.

Referring to FIGS. 17A and 17B, the holder 1270 may include first to fourth side portions 1064A to 1064D, which correspond to or face the first to fourth side portions 1033A to 1033D of the first circuit board 1250.

First and second side portions 1064A and 1064B of the holder 1270 may be disposed so as to face or be opposite to each other in the second horizontal direction (for example, in the x-axis direction). Third and fourth side portions 1064C and 1064D of the holder 1270 may be disposed so as to face or be opposite to each other in the first horizontal direction (for example, in the y-axis direction).

At least a portion of the support board 1310 may be attached or coupled to the holder 1270. For example, two or more connectors 1320A and 1320B of the support board 1310 may be coupled to two or more of the first to fourth side portions 1064A to 1064D of the holder 1270 using an adhesive. For example, the first connector 1320A may be coupled, attached or fixed to the first side portion 1064A of the holder 1270 using an adhesive, and the second connector 1320B may be coupled, attached or fixed to the second side portion 1064B of the holder 1270 using an adhesive.

The first coupler 1027A may be formed at the first side portion 1064A of the holder 1270, and the second coupler 1027B may be formed at the second side portion 1064B of the holder 1270. The support board 1310 may be coupled, attached or fixed to the couplers 1027a and 1027B of the holder 1270. The support board 1310 may be coupled, attached or fixed to the outer surfaces (or the inner surfaces) of the couplers 1027A and 1027B of the holder 1270. In another embodiment, each of the first coupler and the second coupler may have the form of a projection.

For example, a portion of the support board 1310 may be coupled, attached or fixed to the first coupler 1027A and the second coupler 1027B of the holder 1270. The bodies 1086 and 1087 of the support board 1310 may be coupled, attached or fixed to the first and second couplers 1027A and 1027B of the holder 1270.

For example, the first support board 1310-1 may be coupled, attached or fixed to the first coupler 1027a, and the second support board 1310-2 may be coupled, attached or fixed to the second coupler 1027B. For example, the first portion 1006A of the first body 1086 may be coupled, attached or fixed to the outer surface (or the inner surface) of the first coupler 1027A, and the first portion 1009A of the second body 1087 may be coupled, attached or fixed to the outer surface (or the inner surface) of the second coupler 1027B.

The base 1210 may include first to fourth side portions 1065A to 1065D (see FIG. 14) which correspond to or face the first to fourth side portions 1033A to 1033D of the first circuit board 1250. The first to fourth side portions 1065A to 1065D of the base 1210 may correspond to or face the first to fourth side portions 1064A to 1064D of the holder 1270.

The first and second side portions 1065A and 1065B of the base 1210 may be disposed so as to face or be opposite to each other in the first horizontal direction (for example, in the y-axis direction). Furthermore, the third and fourth side portions 1065C and 1065D of the base 1210 may be disposed so as to face or be opposite to each other in the second horizontal direction (for example, in the x-axis direction).

At least a portion of the support board 1310 may be coupled, attached or fixed to the base 1210. For example, the bodies 1086 and 1087 of the support board 1310 may be coupled to the base 1210 using an adhesive. For example, portions of the bodies 1086 and 1087 of the support board 1310 connected to the extensions 107A to 1007D may be coupled to the base 1210.

For example, at least a portion of the support board 1310 may be coupled, attached or fixed to the projections 1216A and 1216B formed at the base 1210. For example, the support board 1310 may be coupled, attached or fixed to the outer surfaces (or the inner surfaces) of the projections 1216A and 1216B of the base 1210. The first projection 1216A may be formed at the third side portion 1065C of the base 1210, and the second projection 1216B may be formed at the fourth side portion 1065D of the base 1210.

For example, the bodies 1086 and 1087 of the support board 1310 may be coupled, attached or fixed to the first and second projections 1216A and 1216B of the base 1210.

For example, one end (for example, the second portion 1006B) of the first support board 1310-1 may be coupled, attached or fixed to one region of the first projection 1216A of the base 1210, and the other end (for example, the third portion 1006C) of the first support board 1310-1 may be coupled, attached or fixed to one region of the second projection 1216B of the base 1210.

For example, one end (for example, the second portion 1009B) of the second support board 1310-2 may be coupled, attached or fixed to another region of the first projection 1216A of the base 1210, and the other end (for example, the third portion 1009C) of the second support board 1310-2 may be coupled, attached or fixed to another region of the second projection 1216B of the base 1210.

A first coupling region 1069A may be formed between the first body 1086 of the first support board 1310-1 and the first coupler 1027A of the holder 1270, and a second coupling region 1069B may be formed between the second body 1087 of the second support board 1310-2 and the second coupler 1027B of the holder 1270.

Furthermore, a third coupling region 1059A may be formed between one end of each of the first and second support boards 1310-1 and 1310-2 and the first projection 1216A of the base 1210. A fourth coupling region 1059B may be formed between the other end of each of the first and second support boards 1310-1 and 1310-2 and the second projection 1216B of the base 1210.

By virtue of the support board 1310 and the first to fourth coupling regions 1069A, 1069B, 1059A and 1059B, the OIS moving unit may be flexibly supported with respect to the stationary unit. The terminals 1311 of the support board 1310 may be coupled and electrically connected to the terminals 1800B of the second board unit 1800 using a solder 1902 (see FIGS. 17A and 17B) or a conductive adhesive.

Referring to FIGS. 1 and 4B, the camera device 1010 may include a shield member 1440 covering the solder 1902. The shield member 1440 may serve to protect the coupling between the terminals 1311 of the support board 1310 and the terminals 1800B of the second board unit 1800. The shield member 1440 may be disposed below a grove 1304 in the cover member 1300.

In another embodiment, for example, the support member may be an elastic member excluding the board, for example, a spring, a wire, shape-memory alloy or a ball member. For example, when the support member is made of a wire, a plurality of wires may be disposed on at least one of the corners and side portions of the base 1210 or the second board unit 1800 in order to connect the first board unit 1255 (for example, the second circuit board 1260) to the second board unit 1800 (or the base 1210). For example, one end of each of the plurality of wires may be coupled to the first board unit 1255 (for example, the second circuit board 1260), and the other end of each of the plurality of wires may be coupled to the second board unit 1800 (or the base 1210).

The image sensor unit 1350 may include at least one of the controller 1830, a memory 1512 or a capacitor 1514.

The controller 1830 may be disposed so as to be spaced apart from the first board unit 1255. For example, the controller 830 may be disposed on the second board unit 1800.

The memory 1512 may be disposed on one of the first board unit 1255 and the second board unit 1800. For example, the memory 1512 may be disposed or mounted on the first region 1801 of the second board unit 1800. For example, the memory 1512 may avoid spatial interference with the heat radiating member 1380 or may be spaced apart from the heat radiating member 1380. For example, the heat radiating member 1380 may include an escape groove or opening for avoiding spatial interference with the memory 1512, and the memory 1512 may be disposed in the escape groove or opening in the heat radiating member 1380. The capacitor 1514 may be disposed on at least one of the first board unit 1255 or the second board unit 1800.

The memory 1512 may store a first data value (or a code value) corresponding to the output of the second position sensor 1240 according to displacement (or stroke) of the OIS moving unit in a direction perpendicular to the optical axis (for example, in the x-axis direction or in the y-axis direction) for OIS feedback operation. Furthermore, the memory 1512 may store a first data value (or a code value) corresponding to the output of the first position sensor 1170 according to displacement (or stroke) of the bobbin 1110 in the first direction (for example, in the optical axis direction or in the z-axis direction) for AF feedback operation.

For example, each of the first and second data values may be stored in the memory 1512 as a look-up table. Furthermore, the memory 1512 may store a mathematical formula, an algorithm or a program for operation of the controller 1830. For example, memory 1512 may be a non-volatile memory, for example, an electrically erasable programmable read-only memory (EEPROM).

The controller 1830 may be positioned outside of the cover member 1300 or may be disposed on one region of the second board unit 1800 which is positioned outside the cover member 1300.

Referring to FIG. 20A, the second board unit 1800 may include the extension region 1808 which is connected to the first region 1801 and extends therefrom. The extension region 1808 may extend from the first side portion 1085A of the first region 1801. For example, the extension region 1808 may project from the outer surface of the first side portion 1085A of the first region. For example, the extension region 1808 may project from the outer surface of the first side portion 1085A of the first region. For example, the extension region 1808 may extend or project in the second horizontal direction (for example, in the x-axis direction).

The extension region 1808 may be positioned outside the cover member 1300 or may be positioned at an outer side of the cover member 1300.

The extension region 1808 may alternatively be referred to as a “fourth region”, a “projecting region”, an “extension portion”, or a “projecting portion”. The extension region 1808 may not overlap the AF moving unit and the OIS moving unit in the optical axis direction. For example, the extension region 1808 may extend in the same direction (for example, in the second horizontal direction) as the third region 1803.

The controller 1830 may be disposed in the extension region 1808 of the second board unit 1800. For example, the controller 1830 may be disposed or mounted on the upper surface of the extension region 1808 of the second board unit 1800. In another embodiment, the controller 1830 may be disposed or mounted on the lower surface of the extension region 1808. For example, the controller 1830 may not overlap the cover member 1300 in the optical axis direction. For example, the extension region 1808 may not overlap the cover member 1800 in the optical axis direction. For example, the surface area of the upper surface of the extension region 1808 may be equal to or larger than the surface area of the lower surface of the controller 1830.

Because the extension region 1808 and the third region 1803 are connected to the first side portion 1085A of the second board unit 1800, it is possible to reduce the surface area that is occupied by the camera device 1010 in a direction perpendicular to the optical axis. Therefore, the embodiment is able to reduce increase in the size of the camera device 1010 attributable to the extension region 1808.

In another embodiment, the extension region may be connected to one of second to fourth side portions 1085B, 1085C and 1085D of the first region 1801 of the second board unit 1800, and may project from one of the second to fourth side portions 1085B, 1085C and 1085D of the first region 1801.

The controller 1830 may be positioned outside the cover member 1300 or may be positioned at the outer side of the cover member 1300. For example, the controller 1830 may be positioned outside the space defined between the cover member 1300, the base 1210 and the first region 1801 of the second board unit 1800.

For example, the controller 1830 may not overlap the lens module 1400, the AF moving unit, the OIS moving unit, and the first region 1801 of the second board unit 1255 in the optical axis direction. At least one capacitor 1514 may be disposed or mounted on the upper surface of the extension region 1808.

Because the OIS moving unit including the image sensor and the first board unit is disposed so as to be spaced apart from the stationary unit including the second board unit in a sensor-shift-type camera device in which the image sensor is moved for hand tremor correction, it may be insufficient to radiate heat generated by the OIS moving unit to the outside through the stationary unit. In addition, the sensor-shift-type camera device may have a structure in which the AF operation unit and the OIS operation unit are confined in the cover member in order to inhibit malfunction caused by foreign substances, and thus it may not be easy to radiate heat to the outside of the camera device.

The image sensor, the second coil, and the controller may correspond to the heat-generating source. Here, the “controller” may be a driver IC configured to control AF operation and/or OIS operation.

The camera device 1010 may include a radiating member 1870 which is disposed, coupled or attached to the extension region 1808 in order to improve efficiency of heat radiation. The radiating member 1870 may be in contact with the extension region 1808. For example, the radiating member 1870 may be disposed below the extension region 1808. For example, the radiating member 1870 may be disposed, coupled or fixed to the lower surface of the extension region 1808. The radiating member 1870 may be a plate-shaped member, and the description of the material of the heat radiating member 1280 may be applied to the radiating member 1870 with or without modification. At least a portion of the radiating member 1870 may overlap the controller 1830 in the optical axis direction.

The camera device 1010 may include a cover can 1405 which is disposed in the extension region 1808 and accommodates the controller 1830 therein in order to protect the controller 1830 from external shock. The cover can 1405 may include an upper plate 1405A and a side plate 1405B which is connected to the upper plate 1405A and extends toward the extension region 1808 from the upper plate 1405A.

The cover can 1405 may be disposed, coupled or fixed to the upper surface of the extension region 1808. For example, the lower portion, the lower end or the lower surface of the side plate 1405B of the cover can 1405 may be coupled, attached or fixed to the upper surface of the extension region 1808.

Because the cover can 1405 accommodates the controller 1830 therein, it is possible to inhibit the heat generated by the controller 1830 from being radiated to the outside and being transmitted to the image sensor. The description of the material of the heat radiating member 1280 or the cover member 1300 may be applied to the cover can 1405 with or without modification.

The camera device 1010 may further include a heat radiating layer 1860 disposed on the controller 1830. The heat radiating layer 1860 may cover the surface of the controller 1830. For example, the heat radiating layer 1860 may be disposed so as to surround the surface of the controller 1830. For example, the heat radiating layer 1860 may be in contact with the upper surface and the side surface of the controller 1830 so as to surround the surfaces. The heat radiating layer 1860 may be made of exothermic plastic or radiating resin, for example, exothermic epoxy. The heat radiating layer 1860 may improve efficiency and performance of heat radiation of the controller 1830.

In another embodiment, the radiating layer may be disposed on at least one of the upper surface or the side surface of the controller 1830. For example, the radiating layer may expose at least a portion of the controller 1830.

The controller 1830 may be electrically connected to the second position sensor 1240. The controller 1830 may adjust or control the drive signal supplied to the second coil 1230 and may perform feedback OIS operation using the output signal received from the sensors 1240A, 1240B and 1240C of the second position sensor 1240 and the first data value stored in the memory 1512.

Furthermore, the controller 1830 may be electrically connected to the first position sensor 1170. For example, when the first position sensor 1170 is embodied as a Hall sensor alone, the first position sensor 1170 may be electrically connected to the controller 1830. Here, the controller 1830 may control the drive signal supplied to the first coil 1120 and thus perform feedback autofocusing operation using the output signal of the first position sensor 1170 and the second data value stored in the memory 1512.

Although the controller 1830 may be embodied as a driver IC, the disclosure is not limited thereto. For example, the controller 1830 may be electrically connected to the terminals 1800B of the second board unit 1800.

The controller 1830 may control the first position sensor, which is embodied as a Hall sensor alone, and the second position sensor, which is embodied as a Hall sensor alone. For example, the controller 1830 may supply a drive signal to the first position sensor, which is embodied as a Hall sensor alone, and/or the second position sensor, which is embodied as a Hall sensor alone, and may receive the output signal of the first position sensor and/or the output signal of the second position sensor.

In another embodiment, the first position sensor may be embodied as a Hall sensor alone, and the second position sensor may be embodied as a drive IC including a Hall sensor. Here, the controller 1830 may be electrically connected to the first position sensor, may supply a drive signal to the first position sensor, and may receive the output signal from the first position sensor.

For example, the controller 1830 may include a driver configured to drive at least one of the first position sensor or the second position sensor.

The image sensor unit 1350 may further include a motion sensor (not shown) which is disposed on one of the first board unit 1255 and the second board unit 1800. The motion sensor may be electrically connected to the controller 1830. The motion sensor may output rotational angular velocity information corresponding to movement of the camera device 1010. For example, the motion sensor may be embodied as a biaxial or triaxial gyro sensor or an angular velocity sensor. For example, the motion sensor may output information on amount of movement in the x-axis direction and the y-axis direction and an amount of rotation caused by movement of the camera device 1010.

In another embodiment, the motion sensor may be omitted from the camera device 1010. In the case in which the motion sensor is omitted from the camera device, the camera device 1010 may receive position information about movement of the camera device 1010 from the motion sensor provided at the optical instrument 200A.

The image sensor unit 1350 may further include the filter 1610 disposed between the lens module 1400 and the image sensor 1810. The image sensor unit 1350 may further include the filter holder 1600 in which the filter is disposed, seated or received. The filter holder 1600 may alternatively be referred to as a “holder” or a “sensor base”.

The filter 1610 may serve to inhibit light within a specific frequency band that passes through the lens barrel 400 from being introduced into the image sensor 1810. The filter 1610 may be, for example, an infrared-light-blocking filter. For example, the filter 1610 may be oriented parallel to the X-Y plane perpendicular to the optical axis OA. The filter 1610 may be disposed below the lens module 1400.

The filter holder 1600 may be disposed under the AF operation unit 1100. For example, the filter holder 1600 may be disposed on the first board portion 1255. For example, the filter holder 1600 may be disposed on the upper surface of the second circuit board 1260 of the first board unit 1255.

For example, at least a portion of the filter holder 1600 may be disposed in the bore 1250A in the first circuit board 1250. For example, at least a portion of the at least a portion of the circuit element CA may be disposed in the bore 1250A in the first circuit board 1250.

For example, the upper surface of the filter holder 1600 may be positioned higher than the upper surface of the first circuit board 1250. For example, the upper surface of the filter 1610 may be positioned higher than the upper surface of the first circuit board 1250. For example, the lower surface of the filter 1610 may be positioned higher than the upper surface of the first circuit board 1250. In another embodiment, the lower surface of the filter 1610 may be positioned at a level identical to or higher than the upper surface of the first circuit board 1250.

For example, the lower surface (or the bottom surface of the groove in a reception portion 1053) of the second region 1058B of the filter holder 1600 may be positioned higher than the upper surface of the first circuit board 1250. In another embodiment, the lower surface (or the bottom surface of the groove in the reception portion 1053) of the second region 1058B of the filter holder 1600 may be positioned at a level identical to or lower than the upper surface of the first circuit board 1250.

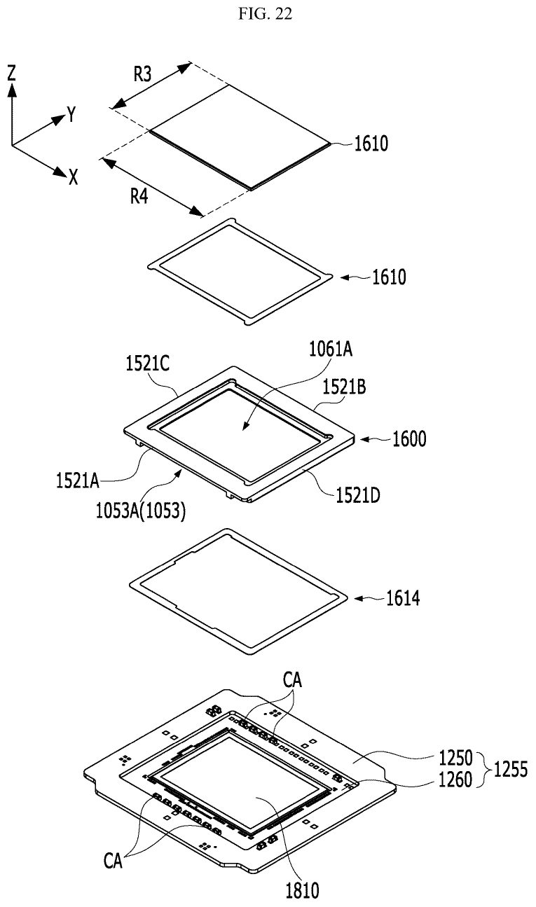

The filter holder 1600 may be coupled to one region (for example, one region of the second circuit board 1260) of the first circuit board 1255 around the image sensor 1810 using an adhesive 1614 (see FIG. 22). The filter holder 1600 may be exposed through the bore 1250A in the first circuit board 1250. For example, the bore 1250A in the circuit board 1250 may expose the filter holder 1600 disposed on the second circuit board 1260 and the filter 1610 disposed on the filter holder 1600 therethrough. The filter holder 1600 may have therein a bore 1061A, which is formed in a region thereof in which the filter 1610 is mounted or disposed, so as to allow the light that has passed through the filter 1610 to enter the image sensor 1810. The bore 1061A in the filter holder 1600 may be configured to have the form of a through hole, which is formed through the filter holder 1600 in the optical axis direction. For example, the bore 1061A in the filter holder 1600 may be formed through the center of the filter holder 1600, and may be disposed so as to correspond to or face the image sensor 1810. The bore 1061A in the filter holder 1600 may alternatively be referred to as a “hole”, a “cavity” or a “through hole”.

The filter holder 1600 may have a seating portion 1500, which is depressed from the upper surface thereof and in which the filter 1610 is seated. The filter 610 may be disposed, seated or mounted in the seating portion 1500. The seating portion 1500 may be formed so as to surround the bore 1061A. In another embodiment, the seating portion of the filter holder may be configured to have the form of a projection, which projects from the upper surface of the filter.

The camera device 1010 may further include an adhesive 1612 disposed between the filter 1610 and the seating portion 1500. By virtue of the adhesive 1612 (see FIG. 22), the filter 1610 may be coupled or attached to the filter holder 1600. For example, the adhesive 1612 may be epoxy, a thermohardening adhesive (for example, thermohardening epoxy), an ultraviolet hardening epoxy) or the like.

In another embodiment, the filter holder may be coupled to the holder 1270 or the AF operation unit 1100.

Referring to FIG. 3, the cover member 1300 may have the form of a box which is open at the lower portion thereof and includes the upper plate 1301 and the side plate 1302. The lower portion of the side plate 1302 of the cover member 1300 may be coupled to the base 1210. The upper plate 1301 of the cover member 1300 may have a polygonal shape, for example, a quadrilateral shape or an octagonal shape. For example, the side plate 1302 may include four side plates which are connected to each other. The upper plate 1301 of the cover member 1300 may have formed therein a bore 1303 through which the lens of the lens module 1400 coupled to the bobbin 1110 is exposed to external light.

Referring to FIGS. 1 and 3, the side plate 1302 of the cover member 1300 may have formed therein a groove 1304 through which the terminal 1095 of the circuit board 1190 and the terminal 800B of the second board unit corresponding to the terminal 1095 are exposed.

For example, the cover member 1300 may be made of metal. For example, the cover member 1300 may be made of SUS (steel use stainless, for example, SUS4 series). Furthermore, the cover member 1300 may be made of steel plate cold commercial (SPC). For example, the cover member 1300 may be made of SUS containing 50% or more of Fe. In order to inhibit oxidization, antioxidizing metal, for example, nickel may be plated on the surface of the cover member 1300. In another embodiment, for example, the cover member 1300 may be made of a magnetic material or magnetic metal.

In a further embodiment, the cover member 1300 may be injection molded from, for example, plastic or resin. Furthermore, the cover member 1300 may be made of an insulative material or a material capable of shielding electromagnetic waves.

The cover member 1300 and the base 1210 may accommodate therein the AF operation unit 1100 and the OIS moving unit. The cover member 1300 and the base 1210 may protect the AF operation unit 1100 and the OIS moving unit from external shock, and may inhibit introduction of foreign substances from the outside.

For example, at the initial position of the OIS moving unit, the outer surface of the holder 1270 may be spaced apart from the inner surface of the base 1210 by a predetermined distance. For example, at the initial position of the OIS moving unit, the lower surfaces of the holder 1270 and the first board unit 1255 may be spaced apart from the base 1210 by a predetermined distance.

The controller 1830 may supply at least one drive signal to at least one of the first to fourth coil units 1230-1 to 1230-4, and may control the at least one drive signal to move the OIS moving unit in the x-axis direction and/or in the y-axis direction or to rotate, tilt or roll the OIS moving unit relative to the optical axis within a predetermined angle range.

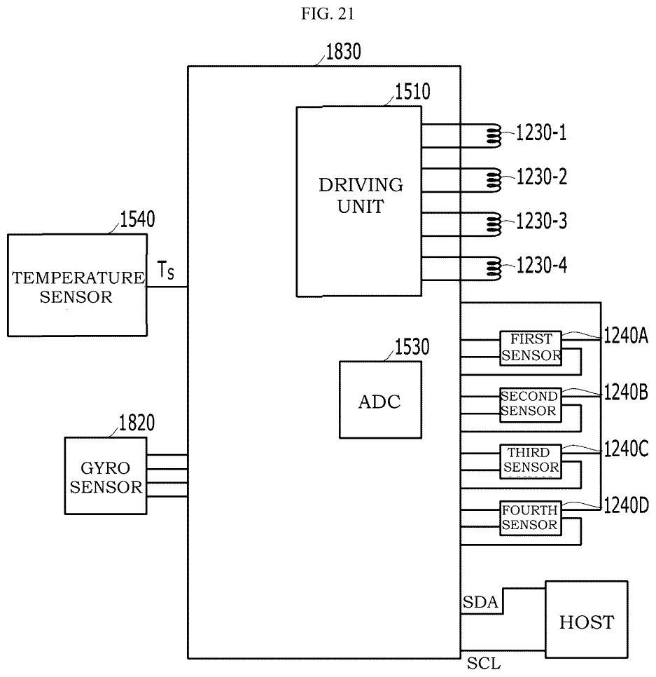

FIG. 21 is a block diagram illustrating the configuration of the controller 1830 and the first to third sensors 1240A, 1240B and 1240C. The controller 1830 may perform communication of transmitting and receiving data with respect to the host using a clock signal SCL and a data signal SDA, for example, I2C communication. For example, the host may be the controller 780 of the optical instrument 200A.

The controller 1830 may be electrically connected to the second coil 1230. The controller 1830 may include a driving unit 1510 configured to supply a drive signal for driving the first to fourth coil units 1230-1 to 1230-4. For example, the driving unit 1510 may include an H bridge circuit or an H bridge driver capable of changing the polarity of the drive signal. Here, the drive signal may be a PWM signal for reduction of current consumption, and the drive frequency of the PWM signal may be 20 kHz or higher which exceeds an audible frequency range. In another embodiment, the drive signal may be a DC signal.

Each of the first to third sensors 1240A, 1240B and 1240C may include two input terminals and two output terminals. The controller 1830 may supply power or a drive signal to the two input terminals of each of the first to third sensors 1240A to 1240C. For example, first input terminals of the first to third sensors 1240A to 1240C may be connected to one another in common. For example, the two input terminals may be a (+) input terminal and a (−) input terminal (for example, a ground terminal).

For example, the controller 1830 may receive the first output voltage of the first sensor 1240A, the second output voltage of the second sensor 1240B and the third output voltage of the third sensor 1240C, and may control movement (or displacement) of the OIS moving unit in the x-axis direction or in the y-axis direction using the received first to third output voltages. Furthermore, the controller 1830 may control rotation, tilting or rolling of the OIS moving unit relative to the optical axis using the received first to third output voltages.

Furthermore, the controller 1830 may include an analog-to-digital converter 1530 configured to receive the output voltages output from the two output terminals of each of the first to third sensors 1240A to 1240C and to output data values, digital values or code values corresponding to the results of analog-to-digital conversion of the received output voltages. The controller 1830 may control movement (or displacement) of the OIS moving unit in the x-axis direction or in the y-axis direction and rotation, tilting or rolling of the OIS moving unit relative to the optical axis.

A temperature sensor 1540 may measure an ambient temperature (for example, the temperatures of the first to third sensors 1240A, 1240B and 1240C), and may output a temperature detection signal Ts corresponding to the result of the measurement. For example, the temperature sensor 1540 may be a thermistor.

The resistance value of the resistor included in the temperature sensor 1540 may vary according to an ambient temperature, and thus the value of the temperature detection signal Ts may vary according to an ambient temperature. A mathematical formula or a look-up table relating to an ambient temperature and the temperature detection signal Ts, which is established through calibration, may be stored in the memory or the controllers 1830 and 1780.

Because the output values of the first to third sensors 1240A, 1240B and 1240C are also affected by temperature, it is necessary to compensate the output values of the first to third sensors 1240A, 1240B and 1240C according to an ambient temperature for the purpose of accurate and reliable OIS feedback operation.

To this end, for example, the controllers 1830 and 780 are able to compensate the output values (or data values corresponding to the output) of the first to third sensors 1240A, 1240B and 1240C using the ambient temperature measure by the temperature sensor 1540 and a temperature compensation algorithm or a compensation formula. The temperature compensation algorithm or the compensation formula may be stored in the controllers 1830 and 780 or the memory.

The camera device may further include a fourth sensor 1240D which corresponds to or faces the fourth magnet unit 1130-4 in the optical axis direction. The fourth sensor 1240D may be disposed on the first board unit 1255 (for example, the first circuit board 1250). For example, the fourth sensor 1240D may be disposed adjacent to one corner of the first circuit board 1250 on which the first to third sensors 1240A to 1240C are not disposed. The description of the dispositional relationship between the first sensor 1240A and the first coil unit 1230-1 may be applied to the dispositional relationship between the fourth sensor 1240D and the fourth coil unit 1230-4 with or without modification.

For example, the fourth sensor 1240D may be positioned so as to face the second sensor 1240B in a diagonal direction. For example, the output voltage of the fourth sensor 1240D may also be used in detection of movement of the OIS moving unit in the x-axis direction or in the y-axis direction.

In another embodiment, the fourth sensor 1240D may correspond to the first position sensor 1170 of the AF operation unit 1100.

The controller 1830 may be electrically connected to at least one of the first position sensor 1170, the second coil 1230 or the second position sensor 1240 via the second board unit 1800, the support board 1310 and the first board unit 1255.

In another embodiment, the controller 1830 may be disposed on the first board unit 1255. In another embodiment, for example, the controller 1830 may be disposed on the first circuit board 1250.

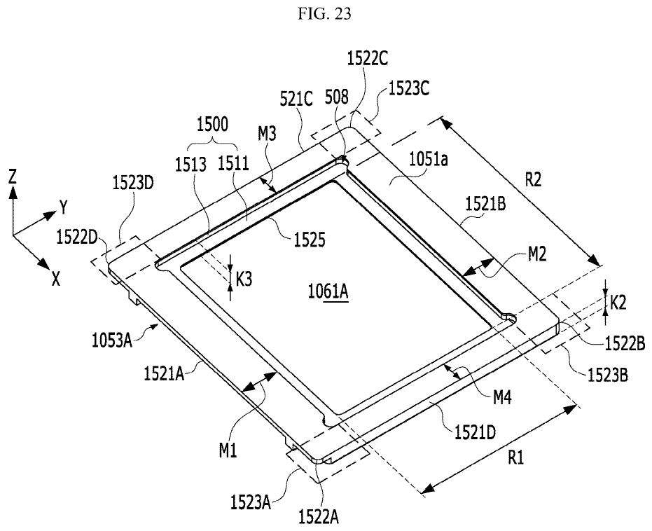

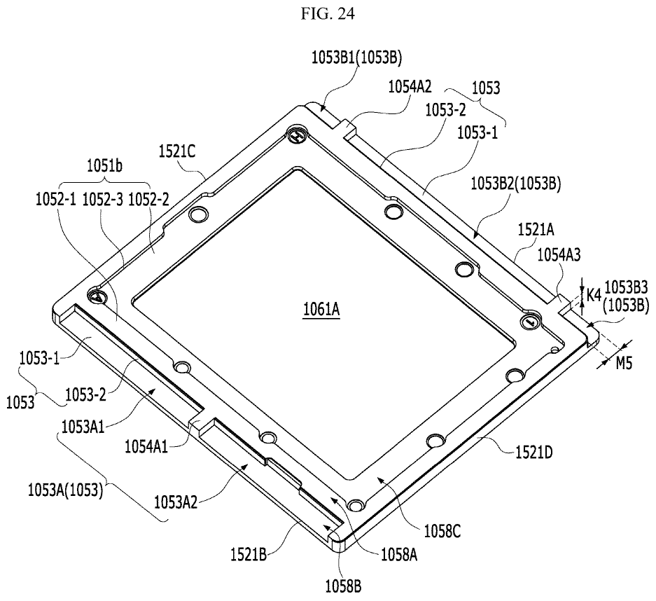

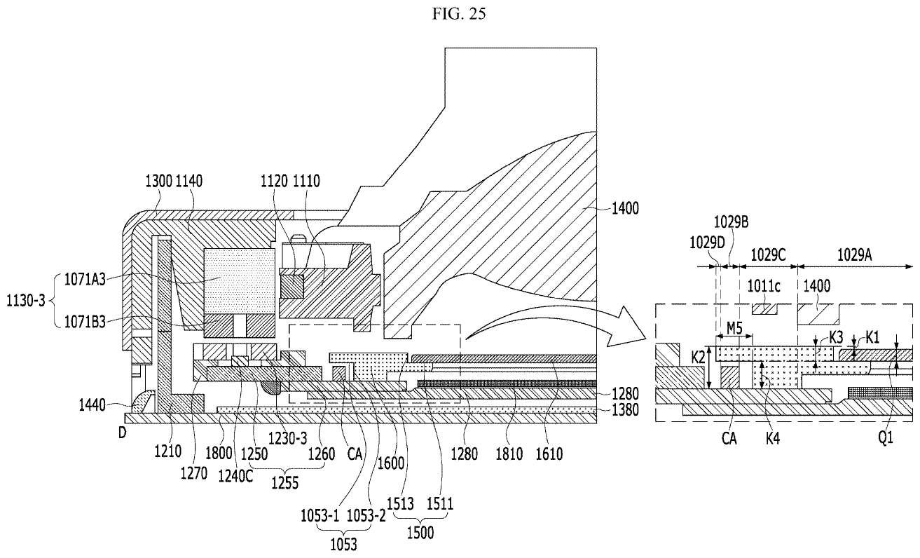

FIG. 22 is a perspective view of the filter 1610, the filter holder 1600, and the first board unit 1255. FIG. 23 is a perspective view of the filter holder 1600. FIG. 24 is a bottom perspective view of the filter holder 1600 shown in FIG. 23. FIG. 25 is a fragmentary enlarged view of the camera device 1010 shown in FIG. 4B.

Referring to FIGS. 22 to 25, the seating portion 1500 of the filter holder 1600 may include a bottom surface 1511 and an inner surface 1513, and the peripheral portion of the filter 1610 may be disposed on the bottom surface 1511 of the seating portion 1500 of the filter holder 1600.

For example, the filter holder 1600 may further include a side surface (or an inner circumferential surface) 1525 connecting the bottom surface 1511 of the seating portion 1500 to the lower surface 1051b of the filter holder 1600. For example, although the side surface 1525 is orthogonal to the lower surface 1051b of the filter holder 1600, the present disclosure is not limited thereto. In another embodiment, the included angle defined between the side surface 1525 and the lower surface 1051b of the filter holder 1600 may be an acute angle. In a further embodiment, the included angle defined between the side surface 1525 and the lower surface 1051b of the filter holder 1600 may be an obtuse angle. For example, in another embodiment, the side surface 1525 may be a chamfered surface.

For example, a height difference may be formed between the bottom surface 1511 and the upper surface 1051a of the holder 1600 in the optical axis direction. For example, the height difference or the distance in the optical axis direction between the upper surface 1051a and the bottom surface 1511 of the holder 1600 may be greater than the thickness of the filter 1610 (or the length of the filter 1610 in the optical axis direction).

For example, the bottom surface 1511 may be positioned lower than the upper surface 1051a of the filter holder 1600. For example, the bottom surface 1511 of the filter holder 1600 may be positioned lower than the upper surface 1051a of the filter holder 1600 but higher than the lower surface 1051b of the filter holder 1600.

For example, the inner surface 1513 may connect the upper surface 1051a and the bottom surface 1511 of the seating portion 1500 to each other. For example, although the included angle between the inner surface 1513 and the bottom surface 1511 may be a right angle, the present disclosure is not limited thereto. In another embodiment, the included angle between the inner surface 1513 and the bottom surface 1511 may be an acute angle or an obtuse angle. For example, the inner surface 1513 may be a chamfered surface.

For example, the bore 1061A may be formed in the bottom surface 1511 of the seating portion 1500 so as to be spaced apart from the inner surface 1513 of the seating portion 1500. The shape of the bore 1061A in the filter holder 1600 may coincide with the shape of the filter 1610 or the shape of the image sensor 1810 (for example, the shape of the active area of the image sensor 1810). For example, although the shape of bore 1061A in the filter holder 1600 when viewed from above may be a polygonal shape (for example, a quadrilateral shape), the present disclosure is not limited thereto. In another embodiment, the shape of the bore 1061A may be a circular shape, an octagonal shape or an elliptical shape.

The surface area of the bore 1061A may be smaller than the surface area of the filter 1610 defined by the crosswise length of the filter 1610 and the lengthwise length of the filter 1610 such that the filter 1610 is disposed on the bottom surface 1511 of the seating portion 1500 of the filter holder 1600.

For example, the peripheral portion of the lower surface of the filter 1610 may be opposed to the bottom surface 1511 of the seating portion 1500, and may be coupled or attached to the bottom surface 1511 using the adhesive 1612. For example, the inner surface 1513 of the seating portion 1500 of the filter holder 1600 may be opposed to or face the side surface of the filter 1610.

For example, although the inner surface 1513 of the seating portion 1500 may include four inner surfaces, the present disclosure is not limited thereto. In another embodiment, the number of the inner surfaces of the seating portion may be three or more.

Furthermore, the filter holder 1600 may include a recess 1508 formed in the corner region of the inner surface 1513 of the seating portion 1500. At least a portion of the recess 1508 may be depressed toward the edge region (or the corner) of the outer surface of the filter holder 1600. The recess 1508 may inhibit the adhesive 1612, such as UV epoxy, configured to attach the filter 1610 to the seating portion 1500, from overflowing beyond the seating portion 1500.

The filter 1610 may be disposed in the seating portion 1500. Although filter 1610 may have a plate shape or a flat quadrilateral shape, the present disclosure is not limited thereto.

For example, the filter 1610 may not project upwards beyond the upper surface 1051a of the filter holder 1600. For example, the upper surface of the filter 1610 may be positioned lower than the upper surface of the filter holder 1600.

In another embodiment, the upper surface of the filter 1610 may be positioned at a level identical to or higher than the upper surface of the filter holder 1600.

For example, the filter holder 1600 may include a plurality of side portions (or side surfaces) 1521A to 1521D. For example, the filter holder 1600 may include a plurality of corners 1522A to 1522D. For example, each of the corners of the filter holder 1600 may be a corner at which two adjacent side portions meet each other. Each of the corners of the filter holder 1600 may be disposed between two adjacent side portions and may connect the two adjacent side portions to each other.

Corner regions (or corner portions) 1523A to 1523D of the filter holder 1600 may be defined as follows. Referring to FIG. 23, for example, the filter holder 1600 may include four corner regions 1523A to 1523D.

For example, when viewed from above, a corner region (for example, 1523A) may be a region which includes the corner (for example, 1522A) and which is surrounded by extended lines of the inner surfaces 1513 of the two side portions 1521A and 1521D adjacent to the corner (for example, 1522A). The definition of the corner region may also be applied to definition of respective corner regions with or without modification.

In another embodiment, when viewed from above, each corner region of the filter holder 1600 may be a region which includes the corner (for example, 1522A) and which is surrounded by extended lines of the two side surfaces (or inner circumferential surfaces) 1525 of the filter holder corresponding to the two side portions 1521A and 1521D adjacent to the corner (for example, 1522A).

For example, the filter holder 1600 may include a first side portion (a first side surface) 1521A, a second side portion (a second side surface) 1521B, a third side portion (a third side surface) 1521C, and a fourth side portion (a fourth side surface) 1521D. The first side portion 1521A and the second side portion 1521B may be positioned opposite each other with the bore 1061A interposed therebetween, and the third side portion 1521C and the fourth side portion 1521D may be positioned opposite each other with the bore 1061A interposed therebetween.

For example, the length of the first side portion 1521A (or the second side portion 1521B) may be greater than the length of the third side portion 1521C (or the fourth side portion 1521D). For example, the length of the first side portion 1521A and the length of the second side portion 1521B may be identical to each other. Furthermore, for example, the length of the third side portion 1521C and the length of the fourth side portion 1521D may be identical to each other. In another embodiment, the length of the first side portion 1521A (or the second side portion 1521B) may be identical to the length of the third side portion 1521C (or the fourth side portion 1521D).

Referring to FIG. 24, the filter holder 1600 may include a first region 1058A coupled to the first board unit 1255 (for example, the second circuit board 1260), and a second region 1058B positioned outside the first region 1058A.

For example, the first region 1058A may be coupled to the upper surface of the second circuit board 1260. For example, at least a portion of the adhesive 1614 may be disposed between the first region 1058A and the upper surface of the second circuit board 1260 and may couple the first region 1058A to the upper surface of the second circuit board 1260.

Furthermore, the filter holder 1600 may include a third region 1058C positioned inside the first region 1058A. The bore 1061A may be formed in the third region 1058C.

For example, the second region 1058B may be positioned between the first region 1058A and the outer surface of the filter holder 1600. For example, the reception portion 1053 may be positioned in the second region 1058B of the filter holder 1600.

For example, the lower surface 1051b of the filter holder 1600 may include a first surface 1052-1 which is coupled to the first board unit 1255 (for example, the second circuit board 1260) using the adhesive 1614. For example, the lower surface 1051b of the filter holder 1600 may include a second surface 1052-2 which defines a height difference with respect to the first surface 1052-1 in the optical axis direction. The second surface 1052-2 may be positioned higher than the first surface 1052-1. For example, among the first surface 1052-1 and the second surface 1052-2, the second surface 1052-2 may be positioned closer to the upper surface 1051a of the filter holder 1600.

For example, the first region 1058A may include the first surface 1052-1, and the third region 1058C may include the second surface 1052-2. The second region 1058B may be positioned between the first region 1058A and the periphery (or the edge) of the lower 1051b of the filter holder 1600. For example, the second region 1058B may be positioned outside the first region 1058A. For example, the second region 1058B may be positioned between the first region 1058A and the outer surface of the holder 1600.

For example, at least a portion of the third region 1058C may overlap the bottom surface 1511 of the seating portion 1500 in the optical axis direction. For example, the first region 1058A may not overlap the bottom surface 1511 of the seating portion 1500 in the optical axis direction. In another embodiment, a portion of the first region 1058A may overlap the bottom surface 1511 of the seating portion 1500 in the optical axis direction.

For example, the third region 1058C may overlap the peripheral portion of the filter 1610 disposed on the bottom surface 1511 of the seating portion 1500. For example, the first region 1058A may not overlap the peripheral portion of the filter 1610 disposed on the bottom surface 1511 of the seating portion 1500. In another embodiment, the first region 1058A may overlap the peripheral portion of the filter 1610 disposed on the bottom surface of the seating portion 1500.

For example, the third region 1058C may be formed along the periphery of the bore 1061A in the filter holder 1600 adjacent to the bore 1061A. When viewed from below, for example, the third region 1058C may have a shape corresponding to the bore 1061A, for example, a polygonal shape (for example, a quadrilateral shape).

A circuit element may be disposed on the first board unit 1255. For example, the circuit element may be disposed on at least one of the first circuit board 1250 or the second circuit board 1260.

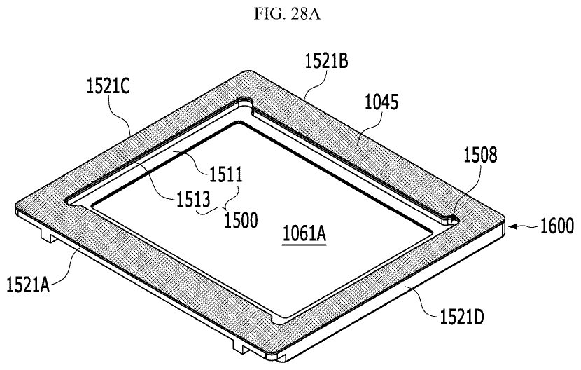

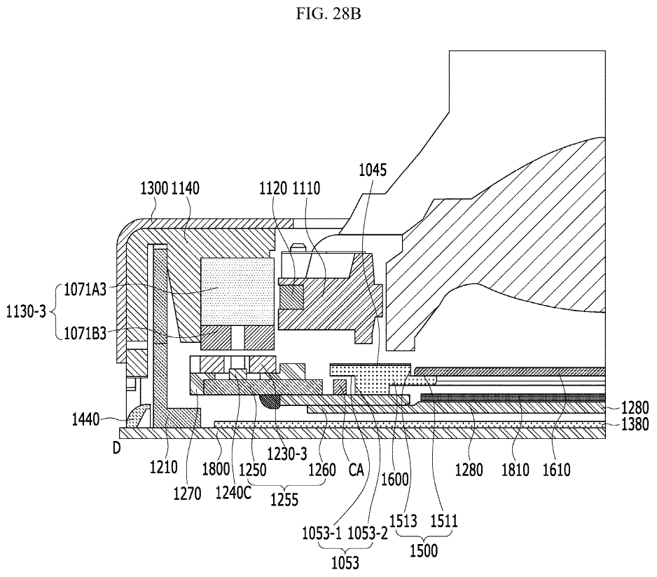

Referring to FIG. 28B, for example, the circuit element CA may be disposed on the upper surface of the second circuit board 1260. When viewed from above, for example, the circuit element CA may be disposed in the bore 1250A in the first circuit board 1250.

For example, the circuit element may include a passive element and an active element. For example, the circuit element may include at least one of a capacitor, a memory, a controller, a sensor (for example, a motion sensor), or an integrated circuit (IC).

The filter holder 1600 may include the reception portion 1053 configured to receive the circuit element disposed on the first board unit 1255. For example, the reception portion 1053 may be positioned below the upper surface 1051a of the filter holder 1600. For example, the reception portion 1053 may be formed in the lower surface 1051b of the filter holder 1600. For example, the reception portion 1053 may include a groove depressed from the lower surface of the filter holder 1600. For example, the reception portion 1053 may have the form of a pocket suitable for receiving therein at least a portion of the circuit element CA.

At least a portion of the circuit element CA disposed on the first board unit 1255 may be disposed in the reception portion 1053 of the filter holder 1600.

For example, at least a portion of the circuit element CA may be positioned below the filter holder 1600. Alternatively, at least a portion of the circuit element CA may be disposed at a position corresponding to the reception portion 1053 of the filter holder 1600.

The reception portion 1053 of the filter holder 1600 may overlap at least a portion of the circuit element (for example, CA) in the optical axis direction, and may serve to inhibit spatial interference between the filter holder 1600 and the circuit element.

Referring to FIG. 25, the circuit element CA may be disposed between the filter holder 1600 (for example, the upper surface of the filter holder 1600) and the first board unit 1255 (for example, the second circuit board 1260).

For example, the circuit element CA may be disposed between the inner surface (or the inner circumferential surface) of the first circuit board 1250 defined by the bore 1250A and the second surface 1053-2 of the reception portion 1053 of the filter holder 1600.

For example, the reception portion 1053 of the filter holder 1600 may not overlap the lens module 1400 in the optical axis direction. For example, the circuit element CA may not overlap the lens module 1400 in the optical axis direction. For example, the reception portion 1053 or the circuit element CA may not overlap the image sensor 1810 in the optical axis direction.

For example, the reception portion 1053 and the circuit element CA may overlap the bobbin 1110 of the AF moving unit. For example, at least a portion of the filter holder 1600 may overlap the circuit element CA in the optical axis direction. Although the entire circuit element CA may overlap the filter holder 1600 in the optical axis direction in FIG. 28B, a portion of the circuit element CA may overlap the filter holder 1600 while another portion of the circuit element CA may not overlap the filter holder 1600 in the optical axis direction in another embodiment. Here, the portion of the circuit element that overlaps the lens module 1400 may be positioned closer to the optical axis OA than the other portion of the circuit element that does not overlap the lens module 1400.

For example, the filter holder 1600 may include a first portion 1029A, which overlaps the lens module 1400 but does not overlap the circuit element CA in the optical axis direction, and a second portion 1029B, which overlaps the circuit element CA but does not overlap the lens module 1400 in the optical axis direction.

Furthermore, for example, the filter holder 1600 may include a third portion 1029C which does not overlap both the lens module 1400 and the circuit element CA in the optical axis direction. For example, the third portion 1029C may be positioned between the first portion 1029A and the second portion 1029B.

Furthermore, for example, the filter holder 1600 may include a fourth portion 1029D which does not overlap both the lens module 1400 and the circuit element CA in the optical axis direction and which is positioned outside the circuit element CA. For example, the outside of the circuit element CA may be a side at which the optical axis or the lens module 1400 is positioned based on the circuit element CA. For example, the fourth portion 1029D may be positioned between the second portion 1029B and the first circuit board 1250.

Because the filter holder 1600 includes the second portion 1029B which overlaps the circuit element CA which does not overlap the lens module 1400 in the optical axis direction, it is possible to increase the surface area of the upper surface of the filter holder 1600 in a direction perpendicular to the optical axis, and thus it is possible to disperse impact force caused by collision with the lens module 1400 and to inhibit breakage of the filter 1610.

In another embodiment, a portion of the circuit element may be disposed so as to overlap the lens module 1400.

For example, the reception portion 1053 may include a first surface 1053-1, which defines a height difference with respect to the lower surface 1051b of the filter holder 1600, and the second surface 1053-2 connecting the first surface 1053-1 to the lower surface 1051b. The first surface 1053-1 of the reception portion 1053 may alternatively be referred to as a “bottom surface”, and the second surface 1053b may alternatively be referred to as a “side surface”. For example, the second surface 1053-2 may be a sloping surface which is inclined with respect to the first 1053-1. For example, the second surface 1053a may be a chamfered surface.

The first surface 1053-1 of the reception portion 1053 may be positioned higher than the lower surface 1051b of the filter holder 1600. For example, among the first surface 1053-1 of the reception portion 1053 and the lower surface 1051b of the filter holder 1600, the first surface 1053-1 of the reception portion 1053 may be positioned closer to the upper surface 1051a of the holder 1600.

For example, at least a portion of the circuit element CA may be positioned below the first surface 1053-1 of the reception portion 1053 of the filter holder 1600, and spatial interference between the circuit element and the filter holder 1600 may be avoided by virtue of the reception portion 1053 of the filter holder 1600.

For example, the reception portion 1053 may not overlap the first region 1058A of the filter holder 1600 in the optical axis direction. For example, the reception portion 1053 may be formed in the second region 1058B of the filter holder 1600. The reason for this is to inhibit the height or the height difference of the bottom surface 1511 of the filter holder 1600 required to seat the filter 1610 thereon from being restricted by the formation of the reception portion 1053.

For example, the filter holder 1600 may include an extension disposed above the circuit element CA. For example, the extension of the filter holder 1600 may be the second region 1058B of the filter holder 1600. The extension of the filter holder 1600 may overlap the circuit element CA in the optical axis direction.

For example, the extension of the filter holder 1600 may be disposed in the bore 1250A in the first circuit board 1250. For example, the extension of the filter holder 1600 may not overlap the first circuit board 1250 in the optical axis direction. For example, the extension of the filter holder 1600 may be spaced apart from the first circuit board 1250. The circuit element CA may be spaced apart from the inner surface of the first circuit board 1250 that is defined by the bore 1250A.

Referring to FIG. 25, for example, the extension of the filter holder 1600 may project toward the first circuit board 1250 (or the inner surface of the first circuit board 1250) based on the circuit element CA.

Referring to FIG. 24, the first surface 1053-1 of the reception portion 1053 may be positioned higher than the bottom surface 1511 of the seating portion 1500. For example, the upper surface 1051a of the filter holder 1600 may be positioned closer to the first surface 1053-1 of the reception portion 1053 than the bottom surface 1511 of the seating portion 1500. For example, the lower surface 1051b of the filter holder 1600 may be positioned closer to the bottom surface 1511 of the seating portion 1500 than the first surface 1053-1 of the reception portion 1053.

In another embodiment, for example, the first surface 1053-1 of the reception portion 1053 and the bottom surface 1511 of the seating portion 1500 may be positioned at the same level. In a further embodiment, among the first surface of the reception portion 1053 and the bottom surface of the seating portion 1500, the bottom surface of the seating portion 1500 may be positioned closer to the upper surface of the filter holder 1600.

For example, the reception portion 1053 may include two reception portions respectively disposed on the first side portion 1521A and the second side portion 1521B of the filter holder 1600 which are opposed to each other. Referring to FIG. 24, for example, the reception portion 1053 may include a first reception portion 1053A disposed on the first side portion 1521A of the filter holder 1600 and a second reception portion 1053B disposed on the second side portion 1521B of the filter holder 1600.

In another embodiment, the reception portion 1053 may include at least one reception portion disposed on at least one of the first to fourth side portions 1521A to 1521D of the filter holder 1600.

For example, the reception portion 1053 may have an opening at the outer surface of the filter holder 1600. In another embodiment, the reception portion 1053 may not have an opening at the outer surface of the filter holder 1600 and may be closed by the outer surface of the filter holder 1600.

For example, the first reception portion 1053A may include at least one groove. The second reception portion 1053B may include at least one groove. For example, the first reception portion 1053A may include a plurality of grooves 1053A1 and 1053A2 which are spaced apart from each other, and the second reception portion 1053B may include a plurality of grooves 1053B1 to 1053B3 which are spaced apart from each other.

The filter holder 1600 may include partition walls 1054A to 1054A3 each of which is configured to isolate or separate two adjacent grooves from each other. For example, the filter holder 160 may include a partition wall 1054A1 disposed between the plurality of the grooves 1053A1 and 1053A2 of the first reception portion 1053A and partition walls 1054A2 and 1054A3 each of which is disposed between two adjacent ones among the plurality of grooves 1053B1 to 1053B3.

The camera device 1010 may include a circuit element, for example, a capacitor CA disposed in the two or more grooves 1053A1 and 1053A2 in the first reception portion 1053A. Furthermore, the camera device 1010 may include a circuit element, for example, a capacitor CA disposed in the two or more grooves 1053B1 to 1053B3 in the second reception portion 1053B.

In a sensor-shift-type camera device in which the image sensor is moved for OIS operation, when the distance or the gap between the lens module (or the lens barrel) and the filter holder is designed to be equal to that of a lens-shift-type camera device, the lens module (or the lens barrel) may directly collide with the filter, thus breaking, cracking or damaging the filter.

A lens-shift-type camera device designed to inhibit occurrence of contact between the lens and the filter holder, in basic consideration of a drooping amount of the lens according to design and erection toleration of individual components (for example, an injection-molded lens and an injection-molded filter holder) and simulation of instantaneous impact deformation of the lens and the filter holder. In order to design to inhibit occurrence of contact between the lens and the filter holder, a lens-shift-type camera device may be designed to minimize the height of individual components.

Reduction of a flange back length (FBL) advantageously assures increased performance of a lens. Accordingly, when the distance between the lens module and the filter holder in a sensor-shift-type camera device is increased as in a lens-shift-type camera device, the FBL may be increased, and thus performance of the lens may be lowered. In addition, the height of the lens in the optical axis direction may be increased and thus the length of the camera device in the optical axis direction may be increased, thereby increasing the size of the camera device.

The lens module may collide with the filter holder due to external impact. Therefore, the filter holder may be subjected to the impact and thus be deformed due to the collision with the lens holder. Due to the deformation of the filter holder, the lens module may collide with the filter and thus impact the filter, thus damaging, breaking or cracking the filter.

According to an embodiment, the distance K1 between the upper surface 1051a of the filter holder 1600 and the upper surface of the filter 1610 may be increased by increasing the thickness K2 of the filter holder 1600. By virtue of the increase in the K2, the stiffness of the filter holder 1600 may be increased, the lens module 1400 may not come into contact with the upper surface of the filter 1610 or impact force applied to the filter 1610 may be reduced even when the lens module 1400 collides with the filter holder 1600 and thus cause deformation of the filter holder 1600, thus inhibiting damage to or breakage of the filter 1610.

The filter holder 1600 may include the reception portion 1053 configured to receive the circuit element therein, and the surface area of the upper surface 1051a of the filter holder 1600 may be increased according to the embodiment. Since the surface area of the upper surface 1051a of the filter holder 1600 is increased, it is possible to increase contact area upon collision with the lens module 1400, to disperse impact or impact force applied to the filter holder 1600 by collision with the lens module 1400, and to suppress or reduce deformation of the filter holder 1600. Accordingly, it is possible to inhibit contact between the lens module 1400 and the filter 1610, or it is possible to inhibit damage to or breakage of the filter 1610 by virtue of attenuation of impact applied to the filter 1610 even when the lens module 1400 comes into contact with the filter 1610.

Furthermore, since the circuit element received in the reception portion 1053 is disposed so as to overlap the filter holder 1600 in the optical axis direction, the overall size of the filter holder 1600 may be designed so as not to be increased even when the surface area of the upper surface of the filter holder 1600 is increased, according to an embodiment.

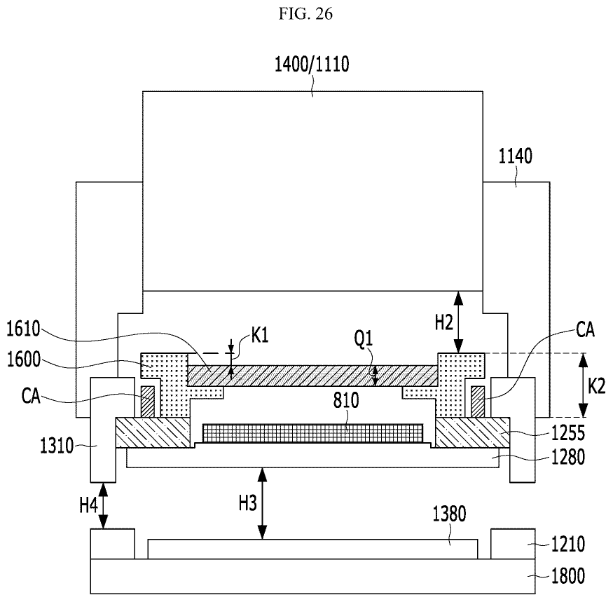

FIG. 26 is a schematic cross-sectional view of the camera device 1010 shown in FIGS. 1 to 25.

Referring to FIG. 26, the distance K1 between the upper surface 1051a of the filter holder 1600 and the upper surface of the filter 1610 may be 0.04 mm to 0.11 mm. In another embodiment, the distance K1 may be 0.06 mm to 0.08 mm. Alternatively, for example, the distance K1 may be 0.65 mm to 0.75 mm.

For example, the distance K2 between the lower surface 1051b (for example, 1052-1) of the filter holder 1600 and the upper surface 1051a of the filter holder 1600 may be 0.5 mm to 0.8 mm. In another embodiment, for example, the distance K2 may be 0.6 mm to 0.75 mm. In a further embodiment, for example, the distance K2 may be 0.6 mm to 0.65 mm.

For example, the length Q1 of the filter 1610 in the optical axis direction may be 0.18 mm to 0.26 mm. In another embodiment, the length Q1 may be 0.2 mm to 0.24 mm. In a further embodiment, the length Q1 may be 0.21 mm to 0.23 mm. For example, the length Q1 may be the thickness of the filter 1610. For example, the thickness of the adhesive 1612 may be 0.01 mm to 0.03 mm.

For example, the distance K3 between the upper surface 1051a of the filter holder 1600 and the bottom surface 1511 of the seating portion 150 may be 0.25 mm to 0.38 mm. In another embodiment, for example, the distance K3 may be 0.28 mm to 0.34 mm. In a further embodiment, the distance K3 may be 0.3 mm to 0.32 mm. For example, the distance K3 may be the minimum distance between the upper surface 1051a of the filter holder 1600 and the bottom surface 1511 of the seating portion 1500.

The distance K1 between the upper surface 1051a of the filter holder 1600 and the upper surface of the filter 1610 may be less than the length Q1 of the filter 1610 in the optical axis direction. For example, the distance K1 may be the minimum distance between the upper surface 1051a of the filter holder 1600 and the upper surface of the filter 1610.

For example, the divided value (Q1/K1) obtained by dividing Q1 by K1 may be 1.8 to 5.2. In another embodiment, the divided value (Q1/K1) may be 2.5 to 3.5.

When the divided value (Q1/K1) is less than 1.8, collision between the lens module 1400 and the filter 61 may be suppressed. However, because the distance K1 is increased, the length of the filter holder 1600 in the optical axis direction may be increased, and thus the size of the camera device may be increased.

When the divided value (Q1/K1) exceeds 0.2, the distance K1 may be overly decreased, and thus an effect of inhibiting collision between the lens module 1400 and the filter 1610 may be significantly lowered.

In order to stably assure prevention of increase in the size of the camera device and prevention of collision between the lens module 1400 and the filter 1610, the divided value (Q1/K1) may be 2.9 to 3.2.

The distance K1 may be 19% to 50% of the length Q1. In another embodiment, the distance K1 may be 25% to 40%. In a further embodiment, the distance K1 may be 30% to 35% of the length Q1.

When the distance K1 is less than 19% of the length Q1, the distance K1 may be excessively decreased, and thus an effect of inhibiting collision between the lens module 1440 and the filter 1610 may be significantly lowered. When the distance K1 exceeds 50% of the length Q1, the distance K1 may be excessively increased, and thus the overall length of the filter holder 1600 in the optical axis direction may be increased, thus increasing the size of the camera device.

In order to stably assure prevention of increase in the size of the camera device and prevention of collision between the lens module 1400 and the filter 1610, the distance K1 may be 30% to 35% of the length Q1.

For example, the distance K4 between the lower surface 1051b (for example, the first surface 1052-1) of the filter holder 1600 and the first surface 1053-1 of the reception portion 1053 may be 0.6 mm to 0.9 mm.

For example, the width M5 of the reception portion 1053 may be 0.4 mm to 0.8 mm. In another embodiment, for example, the width M5 may be 0.5 mm to 0.7 mm.

In FIGS. 23 and 26, the overall thickness or the height of the side portions 1521A to 1521D of the filter holder 1600 may be increased. For example, the upper surfaces of the side portions 1521A to 1521D of the filter holder 1600 may have the same height or may be positioned on the same plane.

In another embodiment, the upper surface of at least one side portion (for example, the projection or the projecting region) among the side portions 1521A to 1521D of the filter holder 1600 may be positioned higher than the upper surfaces of the corner regions 1523A to 1523D of the filter holder 1600. For example, at least one side portion (for example, the projection or the projecting region) among the side portions 1521A to 1521D of the filter holder 1600 may project upwards or in the optical axis direction beyond the upper surfaces of the corner regions 1523A to 1523D of the filter holder 1600. Here, the upper surface of the filter holder 1600, which is the reference for measurement of K1, K2 and H2, may be the upper surface of at least one side portion of the filter holder 1600.

In still another embodiment, one region (for example, the projecting region) of the upper surface of at least one of the side portions 1521A to 1521D of the filter holder 1600 may be positioned higher than the upper surface of another of the side portions 1521A to 1521D of the filter holder 1600. For example, one region (for example, the projecting region) of at least one of the side portions 1512A to 1521D of the filter holder 1600 may project in the optical axis direction or upwards beyond the upper surface of another region of at least one of the side portions 1521A to 1521D of the filter holder 1600.

In yet another embodiment, the upper surface of at least one of the corner regions 1523A to 1523D of the filter holder 1600 may be positioned higher than the upper surfaces of the side portions 1521A to 1521D of the filter holder 1600. For example, at least one of the corner regions 1523A to 1523D of the filter holder 1600 may project in the optical axis direction or upwards beyond the upper surfaces of the side portions 1521A to 1521D of the filter holder 1600.

In still yet another embodiment, one region (for example, the projecting region) of the upper surface of at least one of the corner regions 1523A to 1523D of the filter holder 1600 may be positioned higher than the upper surfaces of the side portions 1521A to 1521D of the filter holder 1600. For example, one region (for example, the projecting region) of at least one of the corner regions 1523A to 1523D of the filter holder 1600 may project in the optical axis direction or upwards beyond the upper surface of another region of at least one of the corner regions 1523A to 1523D of the filter holder 1600.

In the above various embodiments, the upper surface of the filter holder 1600, which is the reference for measurement of K1, K2 and H2, may be the upper surface of the projection or the projecting region of the filter holder 1600.

Referring to FIG. 25, when viewed from the front, the side portions 1521A and 1521B of the filter holder 1600 may project from the circuit element, for example, the capacitor CA in a direction perpendicular to the optical axis. For example, among the side portions 1521A and 1521B of the filter holder 1600 and the circuit element CA, the side portions 1521A and 1521B of the filter holder 1600 may be positioned closer to the first circuit board 1250. For example, the inner circumferential surface of the first circuit board 1250 may be positioned closer to the side portions 1521A and 1521B of the filter holder 1600 than the circuit element CA, for example, the capacitor. Consequently, the filter holder 1600 is able to more stably protect the circuit element CA from external impact.

For example, the circuit board CA may be positioned so as to be spaced apart from the reception portion 1053 of the filter holder 1600. For example, the circuit element CA may be positioned so as to be spaced apart from at least one of the first surface 1053-1 and the second surface 1053-2 of the reception portion 1053 of the filter holder 1600.

Referring to FIG. 22, the length R3 of the filter 1610 in the same direction as the direction of the width M1 of the first side portion 1521A of the filter holder 1600 may be 8 mm to 10 mm. In another embodiment, the length R3 may be 8 mm to 9 mm. In still another embodiment, for example, the length R3 may be 8.5 mm to 9 mm.

Furthermore, the length R4 of the filter 1610 in the same direction as the direction of the width M3 of the filter holder 1600 may be 10 mm to 13 mm. In another embodiment, the length R4 may be 11 mm to 12 mm. In still another embodiment, the length R4 may be 11.5 mm to 12 mm.

Referring to FIG. 23, for example, each of the width M1 of the first side portion 1521A and the width M2 of the second side portion 1521B of the filter holder 1600 may be 1.4 mm to 2 mm. In another embodiment, each of the widths M1 and M2 may be 1.5 mm to 1.8 mm. In still another embodiment, each of the widths M1 and M2 may be 1.6 mm to 1.7 mm.

For example, the width MI (or the width M2) may be the length of the first side portion 1521A (or the second side portion 1521B) in a direction toward the second side portion 1521B from the first side portion 1521A. Alternatively, the width M1 (or the width M2) may be the length of the first side portion 1521A (or the second side portion 1521B) in a direction perpendicular to the outer surface of the first side portion 1521A (or the second side portion 1521B). Alternatively, the width M1 (or the width M2) may be the width of the upper surface of the first side portion 1521A (or the second side portion 1521B).

For example, the width M1 of the first side portion 1521A of the filter holder 1600 and the width M2 of the second side portion 1521B of the filter holder 1600 may be the same. In another embodiment, the width M1 of the first side portion 1521A of the filter holder 1600 and the width M2 of the second side portion 1521B of the filter holder 1600 may be different from each other.

For example, each of the width M3 of the third side portion 1521C and the width M4 of the fourth side portion 1521D of the filter holder 1600 may be 0.8 mm to 1.3 mm. In another embodiment, for example, each of the width M3 and the width M4 may be 1.0 mm to 1.2 mm. In a further embodiment, for example, each of the width M3 and the width M4 may be 1.0 mm to 1.1 mm.

For example, the width M4 of the fourth side portion 1521D of the filter holder 1600 may be identical to the width M3 of the third side portion 1521C of the filter holder 1600. In another embodiment, the width M3 of the third side portion 1521C of the filter holder 1600 and the width M4 of the fourth side portion 1521B of the filter holder 1600 may be different from each other.

For example, the width M3 (or the width M4) may be the length of the third side portion 1521C (or the fourth side portion 1521D) in a direction toward the fourth side portion 1521D from the third side portion 1521C. For example, the width M3 (or the width M4) may be the length of the third side portion 1521C (or the fourth side portion 1521D) in a direction perpendicular to the outer surface of the third side portion 1521C (or the fourth side portion 1521D). Alternatively, the width M3 (or the width M4) may be the width of the upper surface of the third side portion 1521C (or the fourth side portion 1521D.

In another embodiment, the widths of the first to fourth side portions 1521A to 1521D of the filter holder 1600 may be the same.

Referring to FIGS. 22 and 23, the width M1 of the first side portion 1521A (or the width M2 of the second side portion 1521B) of the filter holder 1600 may be 15% to 20% of the length R3 of the filter 1610. In another embodiment, the width M1 (or the width M2) may be 16% to 19% of the length R3. In a further embodiment, the width M1 (or the width M2) may be 17% to 18% of the length R3.

When the width M1 is less than 15% of the length R3, the width M1 may be excessively reduced. Consequently, it is impossible to disperse impact applied to the filter holder 1600 due to collision with the lens module 1400, to obtain an effect of suppressing deformation of the filter holder 1600, and to inhibit damage or breakage of the filter 1610.

When the width M1 exceeds 20% of the length R3, the width M1 may be excessively increased. Consequently, the length of the filter holder 1600 in a direction perpendicular to the optical axis direction may be increased, and thus the size of the camera device may be increased.

In order to inhibit increase in the size of the camera device as well as to stably disperse impact caused by collision between the lens module 1400 and the filter holder 1600, the width M1 may be 17% to 19% of the length R3.

The description of the relationships between the width M1 and the length R3 may be applied to the relationships between the width M2 of the second side portion 1521B and the length R3 of the filter 1610 with or without modification.

The width M3 or M4 of the third side portion 1521C (or the fourth side portion 1521D) of the filter holder 1600 may be 7% to 12% of the length R4 of the filter 1610. In another embodiment, the width M3 or M4 may be 8% to 11% of the length R4 of the filter 1610. In a further embodiment, the width M3 or M4 may be 9% to 10% of the length R4 of the filter 1610.

When the width M3 is less than 7% of the length R4, the width M3 may be excessively reduced. Consequently, it is impossible to disperse impact applied to the filter holder 1600 due to collision with the lens module 1400, to obtain an effect of suppressing deformation of the filter holder 1600, and to inhibit damage or breakage of the filter 1610. When the width M3 exceeds 12% of the length R4, the width M3 may be excessively increased, thereby increasing the length of the filter holder 1600 in a direction perpendicular to the optical axis direction and thus increasing the size of the camera device.

In order to inhibit increase in the size of the camera device as well as to stably disperse impact force caused by collision between the lens module 1400 and the filter holder 1600, the width M3 may be 8% to 10% of the length R4.

The description of the relationships between the width M3 and the length R4 may be applied to the relationships between the width M4 of the fourth side portion 1521D and the length R4 of the filter 1610 with or without modification.

Referring to FIG. 23, the length R1 of the bore 1051A in the filter holder 1600 in the same direction as the direction of the width M1 of the first side portion 1521A of the filter holder 1600 may be 7 mm to 9 mm. In another embodiment, for example, the length R1 may be 7.5 mm to 8 mm. In a further embodiment, the length R1 may be 7.6 mm to 7.8 mm.

The length R2 of the bore 1061A in the filter holder 1600 in the same direction as the direction of the width M3 of the third side portion 1521C of the filter holder 1600 may be 8 mm to 12 mm. In another embodiment, the length R2 may be 8 mm to 11 mm. In a further embodiment, the length R2 may be 10 mm to 10.5 mm.

The width M1 of the first side portion 1521A of the filter holder 1600 may be 16% to 28% of the length R1 of the bore 1061A in the filter holder 1600. In another embodiment, the width M1 may be 18% to 24% of the length R1.

When the width M1 is less than 16% of the length R1, the width M1 may be excessively decreased. Consequently, it is impossible to disperse impact applied to the filter holder 1600 due to collision with the lens module 1400, to obtain an effect of suppressing deformation of the filter holder 1600, and to inhibit damage or breakage of the filter 1610.

When the width M1 exceeds 28% of the length R1, the width M1 may be excessively increased, thereby increasing the length of the filter holder 1600 in a direction perpendicular to the optical axis direction and thus increasing the size of the camera device.

In order to inhibit increase in the size of the camera device as well as to stably disperse impact caused by collision between the lens module 1400 and the filter holder 1600, the width M1 may be 18% to 22% of the length R1.

The description of the relationships between the width M1 and the length R1 may be applied to the relationships between the width M2 of the second side portion 1521B and the length R1 of the bore 1061A with or without modification.

The width M3 of the third side portion 1521C of the filter holder 1600 may be 7% to 16% of the length R2 of the bore 1061A in the filter holder 1600.

When the width M3 is less than 7% of the length R2, the width M3 may be excessively decreased. Consequently, it is impossible to disperse impact applied to the filter holder 1600 due to collision with the lens module 1400, to obtain an effect of suppressing deformation of the filter holder 1600, and to inhibit damage or breakage of the filter 1610. When the width M3 exceeds 16% of the length R2, the width M3 may be excessively increased, thereby increasing the length of the filter holder 1600 in a direction perpendicular to the optical axis direction and thus increasing the size of the camera device.

In order to inhibit increase in the size of the camera device as well as to stably disperse impact caused by collision between the lens module 1400 and the filter holder 1600, the width M3 may be 9% to 12% of the length R2.

The description of the relationships between the width M3 and the length R2 may be applied to the relationships between the width M4 of the fourth side portion 1521D and the length R2 of the filter 1610 with or without modification.

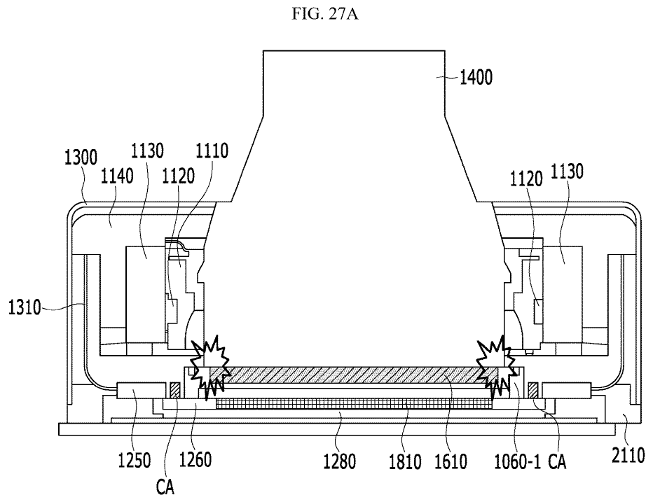

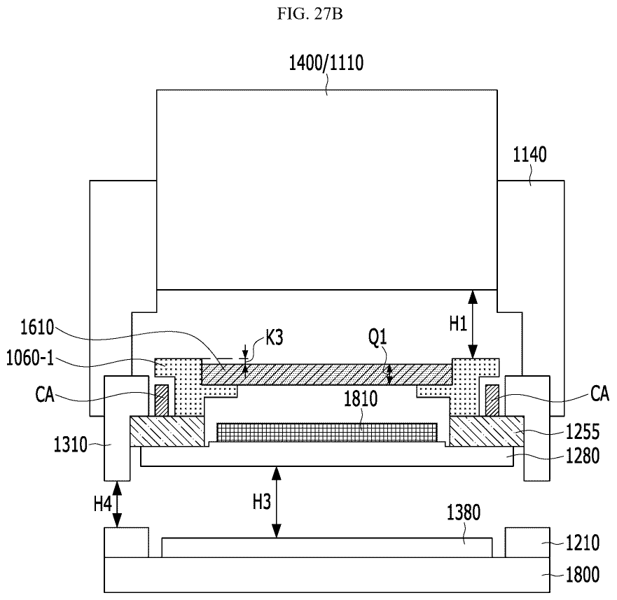

FIG. 27A is a cross-sectional view of a camera device according to a comparative example. FIG. 27B is a schematic cross-sectional view of the camera device according to the comparative example shown in FIG. 27A. The same components of the comparative example as the embodiments may be denoted by the same reference numerals, and the description of the embodiments may be applied to the same components with or without modification.

Referring to FIGS. 27A and 27B, in the camera device according to the comparative example, the length of the filter holder 1600-1 in a crosswise direction and the length of the filter holder 1600-1 in a lengthwise direction may be the same.

In the filter holder 1060-1 according to the comparative example, the circuit element CA may be disposed at one side of the filter holder 1060-1, in place of in the reception portion 1053 according to the embodiment, and the filter holder 1060-1 may not overlap the circuit element CA in the optical direction.

The distance K3 between the bottom surface of the seating portion of the filter holder 1060-1 and the upper surface of the filter holder 1060-1 in the comparative example, may be less than the distance K1 in the embodiment. The FBL of the comparative example and the FBL of the embodiment may be the same. The distance between the OIS moving unit and the stationary unit of the comparative example in the optical axis direction may be identical to the distance between the OIS moving unit and the stationary unit of the embodiment in the optical axis direction. For example, the distance H3 between the heat radiating member 1280 of the OIS moving unit and the heat radiating member 1380 of the stationary unit in the comparative example may be identical to the distance H3 between the heat radiating member 1280 of the OIS moving unit and the heat radiating member 1380 of the stationary unit in the embodiment. Furthermore, the distance H4 between the connector of the support board 1310 coupled to the holder 1270 of the OIS moving unit and the base of the stationary unit in the comparative example may be identical to the distance H4 between the connector of the support board 1310 coupled to the holder 1270 of the OIS moving unit and the base of the stationary unit in the embodiment. However, the distance H2 between the lens module 1400 and the upper surface of the holder 1600 in the embodiment may be less than the distance H1 between the lens module 1400 and the upper surface of the holder 1060-1 in the comparative example (H2<H1). For example, the distance H2 may be the distance between the lens barrel and the upper surface 1051a of the holder 1600. For example, the distance H2 may be 0.27 mm to 0.31 mm.

Referring to FIG. 27A, because the distance K3 between the upper surface of the filter holder 1060-1 and the upper surface of the filter 1610 in the comparative example is little, the lens module 1400 and the filter 1610 may contact and collide with each other due to external impact, thus causing breakage or damage to the filter 1610.

According to the embodiment, in order to inhibit damage to the filter caused by collision with the lens module, the structure of the filter holder 1600 may be changed as described above without increasing the length of the FBL as in the lens-shift-type camera device. Accordingly, the embodiment is able to perform the sensor shift function using a single lens component having the same performance as the lens of the lens-shift-type camera device, and achieves performance superior to the lens-shift-type camera device.

Furthermore, since the embodiment does not need to increase the height of the lens in order to inhibit damage to the filter caused by collision between the lens module and the filter, it is possible to inhibit increase in the height of the camera device.

In addition, since the embodiment is constructed such that the surface area of the upper surface of the filter holder 1600 is increased and the reception portion, which overlaps the circuit element and receives the circuit element therein, is formed at the peripheral portion of the filter holder 1600, it is possible to disperse impact force upon collision with the lens module 1400, to reduce stress applied to the filter holder 1600, and to assure reliability of the camera device against external impact without increasing the size of the camera device in a direction perpendicular to the optical axis.

FIG. 28A is a perspective view of the filter holder 1600 and a damper 1045. FIG. 28B is a fragmentary cross-sectional view of the camera device including the damper 1045 shown in FIG. 28A.

Referring to FIGS. 28A and 28B, the camera device 1010 may include the damper 1045 disposed on the filter holder 1600. For example, the damper 1045 may be disposed, coupled or attached to the upper surface of the filter holder 1600. The damper 1045 may alternatively be referred to as a “stopper” or a “shock absorber”.

For example, the damper 1045 may be disposed, coupled or attached to the upper surfaces 1051a of the side portions 1521A to 1521D of the filter holder 1600. The damper 1045 may have the same shape as the side portions 1521A to 1521D of the filter holder 1600. At least a portion of the damper 1045 may be disposed between the filter holder 1600 and the lens module 1400. The damper 1045 may overlap at least a portion of the lens module 1400 in the optical axis direction. Furthermore, the damper 1045 may overlap the reception portion 1053 of the filter holder 1600 in the optical axis direction. Furthermore, the damper 1045 may overlap at least a portion of the circuit element CA in the optical axis direction.

The damper 1045 may serve to inhibit or suppress deformation of the filter holder 1600 by absorbing impact caused by collision with the lens module 1400. Consequently, the damper 1045 may serve to suppress contact or collision between the lens module 1400 and the filter 1610.

Although FIG. 28A illustrates one damper 1045 covering the entire surface of the upper surface 1051a of the filter holder 1600, the damper 1045 according to another embodiment may include a plurality of dampers disposed on the upper surface of the filter holder 1600. For example, the plurality of dampers may be spaced apart from each other.

For example, the damper 1045 may include at least one damper disposed on the upper surface of at least one of the plurality of side portions 1521A to 1521D of the filter holder 1600. For example, the at least one damper may be disposed between the bore 1061A in the filter holder 1600 and the outer surfaces of the side portions 1521A to 1521D of the filter holder 1600. For example, the at least one damper may be in contact with the inner surface 1513 of the seating portion 1500. In another embodiment, the at least one damper may be spaced apart from the inner surface 1513 of the seating portion 1500. In still another embodiment, the at least one damper may be disposed in a corner region of the filter holder 1600. In yet another embodiment, the at least one damper may be in contact with the outer surface of the filter holder 1600. In still yet another embodiment, the at least one damper may be spaced apart from the outer surface of the filter holder 1600.

For example, the damper 1045 may be made of a material different from the filter holder 1600. For example, the damper 1045 may be made of a material having a lower stiffness than the filter holder 1600. For example, the damper 1045 may include a material having a lower stiffness than the filter holder 1600.

For example, the damper 1045 may include a shock absorbing material, for example, rubber, silicone, foamed rubber, POM material (for example, polyacetal, polyoxymethylene), or urethane. For example, the damper 1045 may include one of rubber, silicone, foamed rubber, POM material or urethane.

The description of the distances K1 and K2 in FIGS. 23 and 26 may be applied to the embodiment shown in FIGS. 28A and 28B with or without modification. In another embodiment, when the distances K1 and K2 described in FIGS. 23 and 26 are applied to the embodiment shown in FIGS. 28A and 28B, the distances K1 and K2 may be the distance to the upper surface of the damper 1045 rather than the distance to the upper surface of the filter holder 600A.

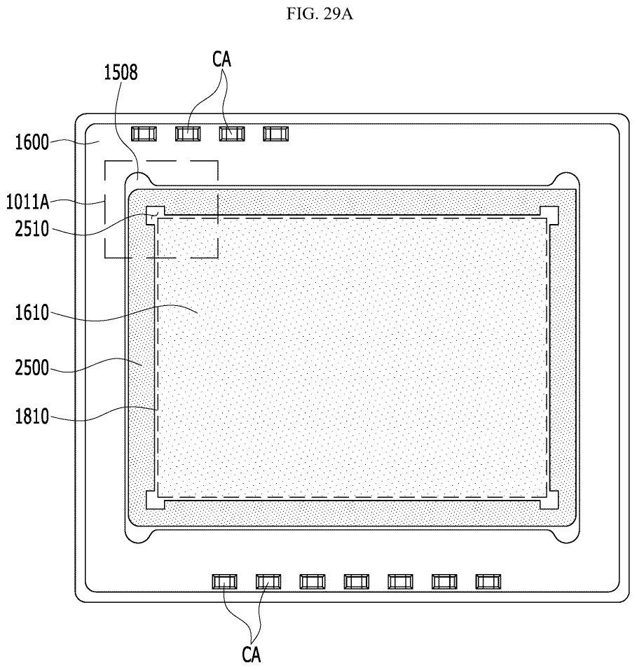

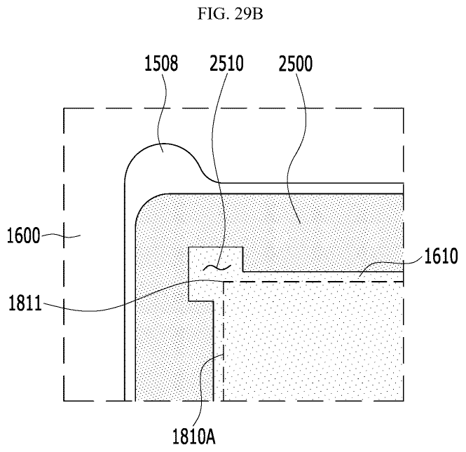

FIG. 29A is a plan view of the filter holder 1600, the filter 1610 and a shield member 2500. FIG. 29B is an enlarged view of the dotted portion 1011A in FIG. 29A.

Referring to FIGS. 29A and 29B, the camera device 1010 may further include the shield member 2500 disposed on the filter 1610. For example, the shield member 2500 may be disposed on the upper surface of the filter 1610. The shield member 2500 may alternatively be referred to as an “absorbing member” or a “masking portion”.

For example, the shield member 2500 may be disposed in the peripheral region of the upper surface of the filter 1610, and may serve to shield or absorb the light, which has passed through the lens module 1400 and is directed toward the peripheral region of the filter 1610, such that at least a portion of the light cannot pass through the filter 1610. For example, the shield member 2500 may be coupled or attached to the upper surface of the filter 1610.

For example, when viewed from above, the filter 1610 may have a quadrilateral shape, and the shield member 2500 may be symmetrically disposed along the individual sides of the upper surface of the filter 1610. For example, the shield member 2500 may be formed so as to have a constant width at the individual sides of the upper surface of the filter 1610. For example, the shield member 2500 may be made of an opaque material. For example, the shield member may be made of an opaque adhesive material applied to the filter 1610 or a film attached to the filter 1610.

The filter 1610 and the active area of the image sensor 1810 may face or overlap each other in the optical axis direction. For example, the shield member 2500 may not overlap the active area 1810A (see FIG. 29B) of the image sensor 1810 in the optical axis direction. For example, the active area 1810A of the image sensor 1810 may include an effective pixel array. Furthermore, for example, the active area 1810A of the image sensor 1810 may include an effective pixel array and a dummy pixel array.

For example, the shield member 2500 may have a bore through which a portion of the upper surface of the filter 1610 is exposed or open. For example, the shield member 2500 may not overlap the active area 1810A of the image sensor 1810 in the optical axis direction. For example, when viewed in the optical axis direction or from above, the active area 1810A of the image sensor 1810 may be positioned inside the bore in the shield member 2500.

For example, at least a portion of the shield member 2500s may overlap the wire connecting the image sensor 1810 to the second circuit board 1260. Consequently, the shield member 2500 may shield a portion of the light which has passed through the lens module 1400 and is then directed toward the terminal and/or the wire of the second circuit board 1260, thereby inhibiting a flare phenomenon and thus inhibiting distortion of the image formed on the image sensor 1810. For example, the shield member 2500 may overlap the bottom surface 1511 of the filter holder 610 in the optical axis direction.

When viewed from above, the inner surface (or the inner circumferential surface) of the shield member 2500 that is defined by the bore in the shield member 2500 may have a quadrilateral shape. Furthermore, the shield member 2500 may include a recess 2510 formed in the corner (or the corner region) of the inner surface (or the inner circumferential surface) of the shield member 2500. The recess 2510 may extend or be depressed in the direction of the corner of the outer surface of the shield member 2500. For example, the recess 2510 may include recesses disposed on two or more of the four corners of the filter 1610.

When viewed from above, the recess 2510 may be formed so as to avoid the corner (or the corner region) of the image sensor 1810 (for example, the corner 1811 of the active area 1810A of the image sensor 1810).

In order to conduct an active alignment process between the lens module 1400 and the image sensor 1810, it is necessary to detect positions of the four corners 1811 of the image sensor 1810. Because the active alignment process is conducted in the state in which the shield member 2500 is attached to the filter 1610, the active alignment process cannot be easily conducted if the shield member 2500 shields the corners of the active area of the image sensor 1810 due to error of the process of attaching the shield member 2500. The recesses 2510 may serve to allow the four corners 1811 of the image sensor 1810 to be easily recognized in the active alignment process.

The recess 2510 may have any shape as long as the recess 2510 has a structure capable of avoiding the corner 1811 of the image sensor 1810. When viewed in the optical axis direction or from above, the recess 2510 may be formed so as to have, for example, an arc shape, a curve shape or a polygonal shape.

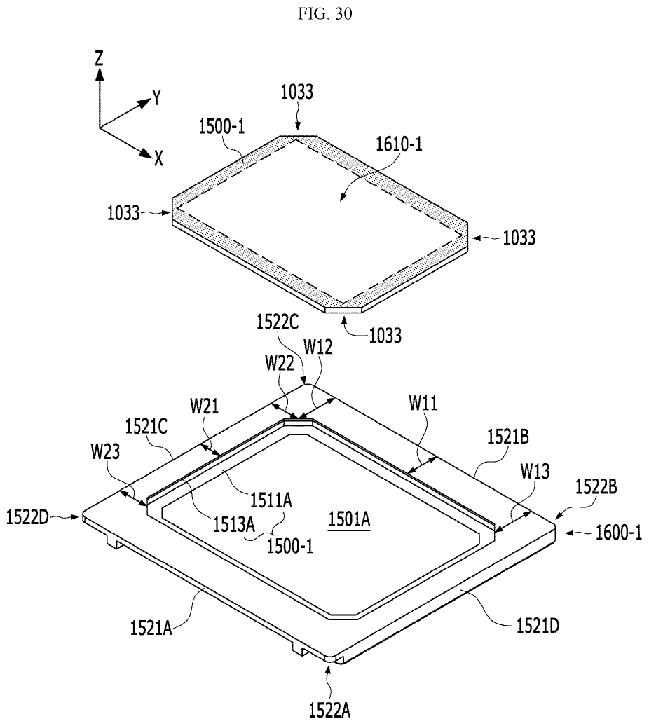

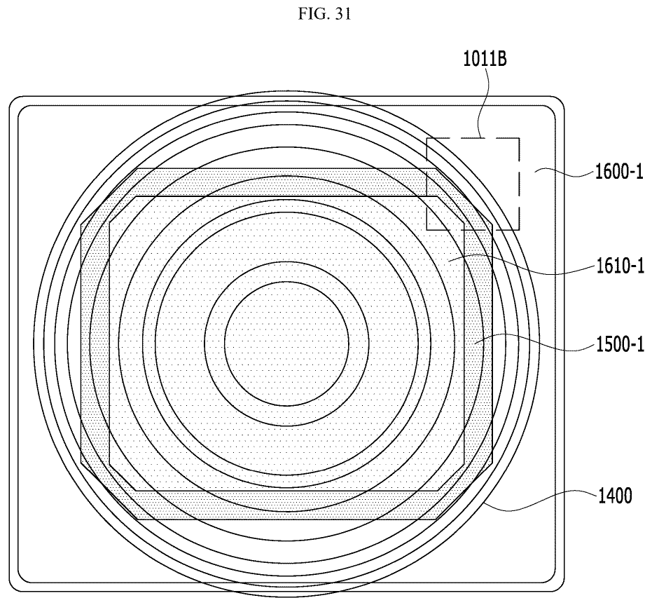

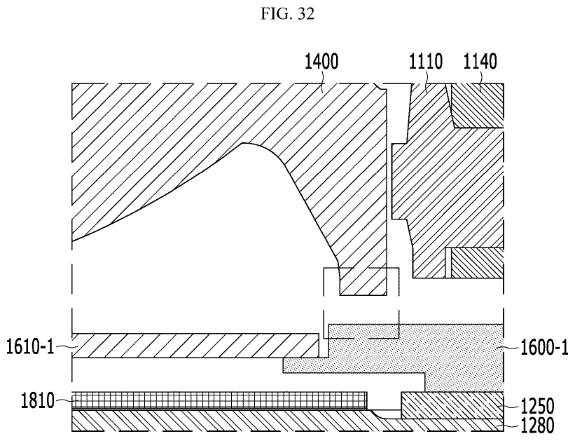

FIG. 30 is a perspective view of the filter holder 1600-1, the filer 1610-1 and the shield member 1500-1 according to another embodiment. FIG. 31 is a plan view of the filter holder 1600-1, the filter 1610-1, the shield member 1500-1 and the lens module 1400 shown in FIG. 30. FIG. 32 is a cross-sectional view of the filter holder 1600-1, the filter 1610-1 and the lens module 1400 in the dotted portion 11B in FIG. 31.

Referring to FIGS. 30 to 32, in order to avoid spatial interference between the filter 1610-11 and the lens module 1400, the filter 1610-1 may include an escape portion 1033 provided at the corner or the corner region. For example, the escape portion 1033 may have a shape which is formed by deleting the corner or the corner region from the filter 1610-1. For example, the corner of the filter 1610-1 may be a corner at which two adjacent outer surfaces of the filter 1610-1 meet each other. For example, the corner region of the filter 1610-1 may be a predetermined range region of the filter 1610-1 connecting two adjacent outer surfaces.

For example, the escape portion 1033 may have a shape which is formed by chamfering the corner or the corner region of the filter 1610-1. For example, the escape portion 1033 may be formed at at least one of the four corners (or corner regions) of the filter 1610-1.

For example, the escape portion 1033 may overlap the lower portion or the lower end of the lens module 1400 in the optical axis direction. For example, because the escape portion 1033 overlaps the lower portion or the lower end of the lens module 1400 in the optical axis direction, the corner (or the corner region) of the filter 1610-1 may not overlap the lens module 1400 in the optical axis direction.

When viewed from above, the outer circumferential surface of the filter 1610-1 may have an octagonal shape. For example, when viewed from above, the outer circumferential surface of the filter 1610-1 may include four long sides and four short sides. Each of the four short sides may be positioned between two adjacent long sides and may connect the two adjacent long sides to each other.

The seating portion 1500-1 of the filter holder 1600-1 may include a bottom surface 1511A and an inner surface 1513A. The seating portion 1500-1 may have a shape which coincides with or is identical to the filter 1610-1 such that the filter 1610-1 is seated or disposed on the seating portion 1500-1. For example, the seating portion 1500-1 may have a shape which is fitted with the filter 1610-1.

When viewed from above, the inner surface 1513A of the seating portion 1500-1 may have an octagonal shape. The inner surface 1513A of the seating portion 1500-1 may include a long inner surface corresponding to the long outer surface of the filter 1610-1 and a short inner surface corresponding to the short outer surface of the filter 1610-1.

Although the shape of the seating portion shown in FIG. 30 is different from the shape of the seating portion 1500 shown in FIG. 23, the description of the seating portion 1500 shown in FIG. 23 may be applied to the seating portion 1500-1 shown in FIG. 30 with or without modification.

The filter holder 1600-1 may include a bore 1501A. When viewed from above, the shape of the bore 1501A may coincide with or be identical to the shape of the outer surface of the filter holder 1610-1. For example, the bore 1501A may have an octagonal shape. Although the shape of the bore 1501A shown in FIG. 30 is different from the shape of the bore 1061A of the filter 1610 shown in FIG. 23, the description of the bore 1061A shown in FIG. 23 may be applied to the bore 1501A shown FIG. 30 with or without modification.

The corner or the corner region of the upper surface 1051a1 of the filter holder 1600-1 may overlap the lower portion of the lens module 1400 (for example, the lens barrel) in the optical axis direction.

Although the widths of side portions 1521A to 1521D of the filter holder 1600 may be constant, at least one end of the side portions 1521A to 1521D of the filter holder 1600-1 shown in FIG. 30 may include a portion which increases in width toward the corners 1522A to 1522D of the filter holder 1600-1.

For example, the end of the side portion 1521B of the filter holder 1600 adjacent to the corner (for example, 1522C) of the filter holder 1600 may include a portion which increases in width W12. Here, the width W12 may be a length between the inner surface 1513A and the outer surface of the side portion 1521B. Alternatively, the width W12 may be a length of the side portion in a width direction perpendicular to the longitudinal direction of the side portion.

For example, the width W12 or W22 may be a width of one end of the side portion (for example, 1521B or 1521C) of the filter holder 1600-1 adjacent to the corner region of the filter holder 1600-1.

For example, the width W12 may be a length of the end of the side portion 1521B of the filter holder 1600-1 in the first horizontal direction (in the Y-axis direction). For example, the width W13 may be a length of the end of the side portion 1521C of the filter holder 1600-1 in the second horizontal direction (in the X-axis direction).

For example, a first portion of the side portion (for example, 1521B of the filter holder 1600-1 adjacent to one corner (for example, 1522C) of the filter holder 1600-1 may increase in width W12, and a second portion of the side portion (for example, 1521B) of the filter holder 1600-1 adjacent to another corner (for example, 1522B) of the filter holder 1600-1 may increase in width W13.

For example, the width W12 of the first portion of the side portion (for example, 1521B) of the filter holder 1600-1 may be greater than the width W11 of the third portion of the filter holder 1600-1. For example, the third portion of the filter holder 1600-1 may be positioned between the first portion and the second portion and may connect the first portion and the second portion to each other.

In another embodiment, the width (or the length) W12 or W13 of the corner region of the filter holder 1600-1 in the first horizontal direction (in the Y-axis direction) may be greater than the width W11 (or the length) of the side portion 1521A or 1521B (or the central region of the side portion) of the filter holder 1600-1 (W12>W11). For example, width W11 may be a length of the central portion of the side portion 1521A or 1521B of the filter holder 1600-1 in a direction toward the second side portion 1521B.

For example, the width (or the length) W22 or W23 of the corner region of the filter holder 1600-1 in the second horizontal direction (in the X-axis direction) may be greater than the width (or the length) W21 of the side portion 1521C or 1521D (or the central region of the side portion) of the filter holder 1600-1 in the second horizontal direction (in the X-axis direction) (W22>W21). For example, the width W21 may be a length of the central portion of the side portion 1521C or 1521D of the filter holder 1600-1 in a direction toward the fourth side portion 1521D from the third side portion 1521C.

For example, the shield member 1500-1 may be disposed in the peripheral area of the upper surface of the filter 1610-1 having an octagonal shape. When viewed from above, the shape of the outer circumferential surface of the shield member 1500-1 may coincide with or be identical to the shape of the outer circumferential surface of the filter 1610-1.

For example, the shield member 1500-1 may have a shape from which the corner or the corner region is cut away or removed. For example, the outer circumferential surface of the shield member 1500-1 may include four long sides and four short sides. For example, the outer circumferential surface of the shield member 1500-1 may have an octagonal shape.

For example, the corner or the corner region of the shield member 1500-1 may not overlap the lens module 1400 (for example, the lens barrel) in the optical axis direction.

The lower portion of the lens module may collide with the filter holder and/or the filter due to external impact. Because the corner portion of the filter has a small contact area, the corner portion is apt to be damaged or broken upon collision with the lens module. In the embodiment shown in FIG. 30, the escape portion 1033 may be formed at the corner or the corner region of the filter 1610-1 such that the corner or the corner region of the filter 1610 does not overlap the lens module in the optical axis direction, thereby restricting or attenuating collision between the lens module 1400 and the filter 1610-1. By virtue of the escape portion 1033, a collision area may increase, with the result that impact or stress applied to the corner region of the filter 1610-1 due to collision with the lens module 1400 may be reduced, thereby inhibiting breakage of or damage to the filter 1610-1.

Furthermore, in the embodiment shown in FIG. 30, the width of the corner or the corner regions of the upper surface of the filter holder 1600-1 may be increased, thereby increasing the stiffness of the corner or the corner region of the filter holder 1600-1 and improving an effect of dispersing impact force or stress caused by impact. By virtue of the effect of dispersing impact force or stress applied to the corner (or the corner region) of the upper surface of the filter holder 1600-1, it is possible to inhibit damage to or breakage of the corner (or the corner region) of the filter 1610 upon collision.

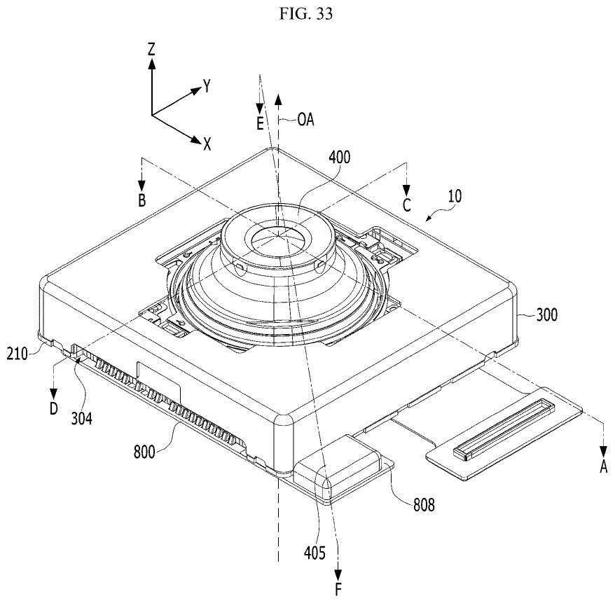

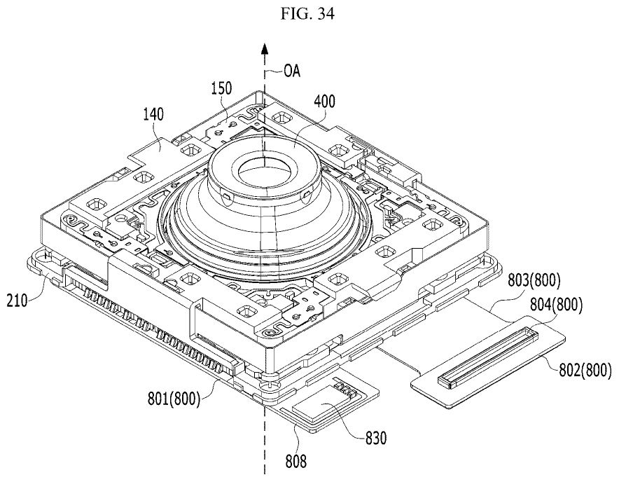

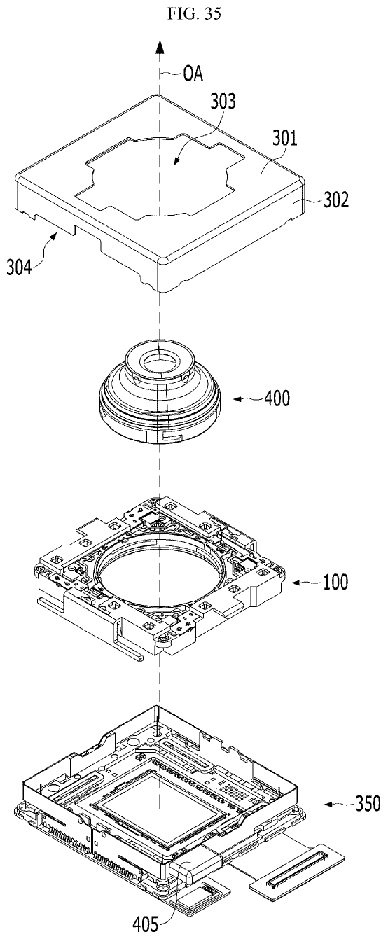

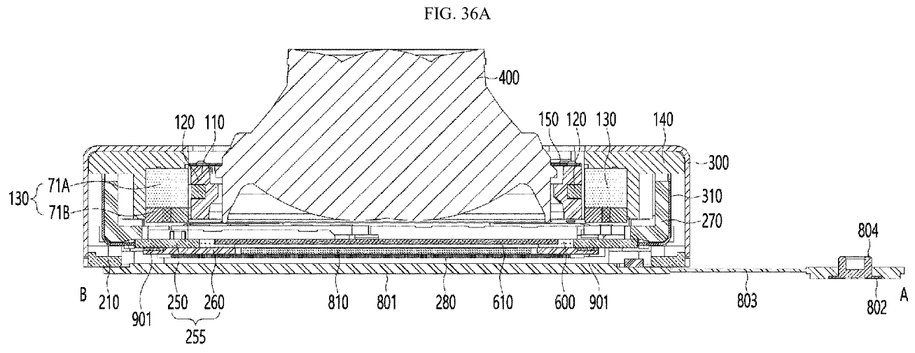

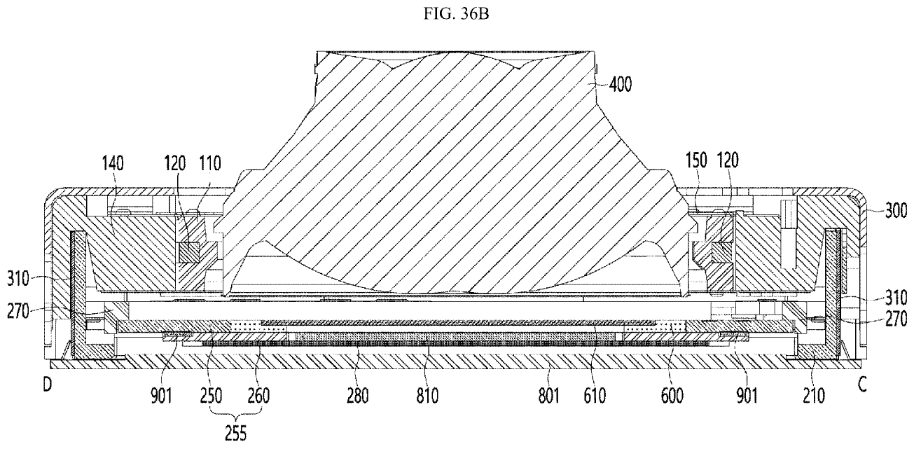

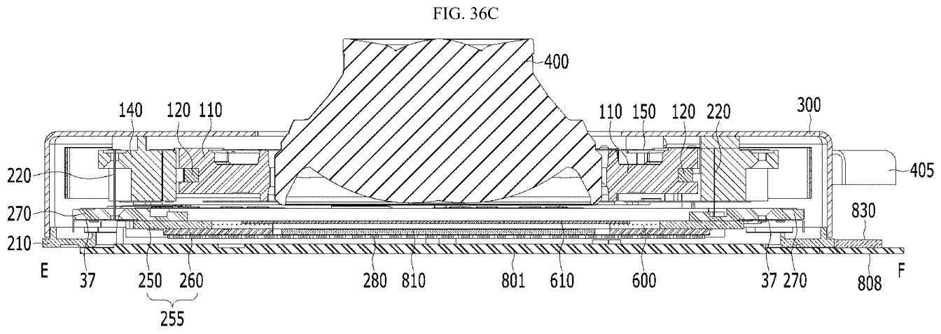

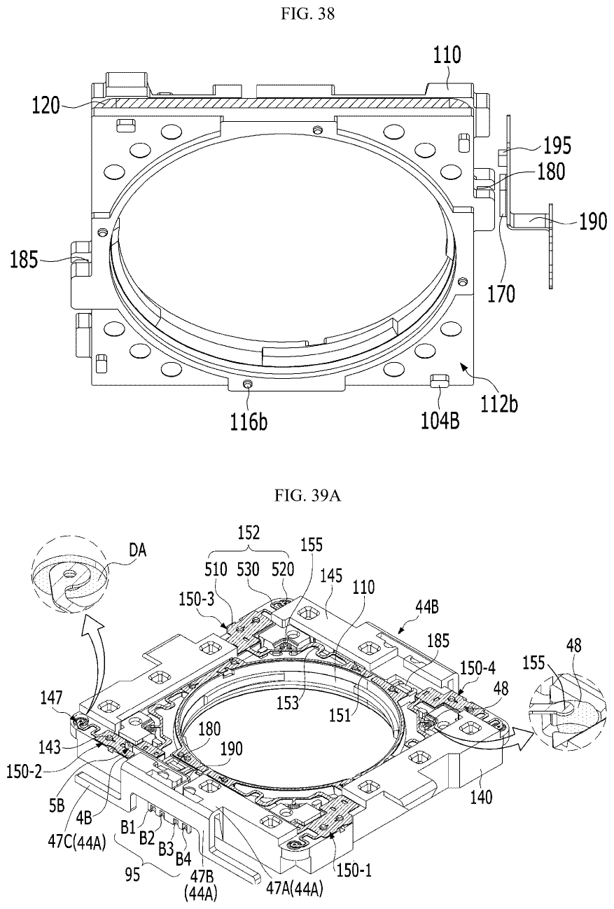

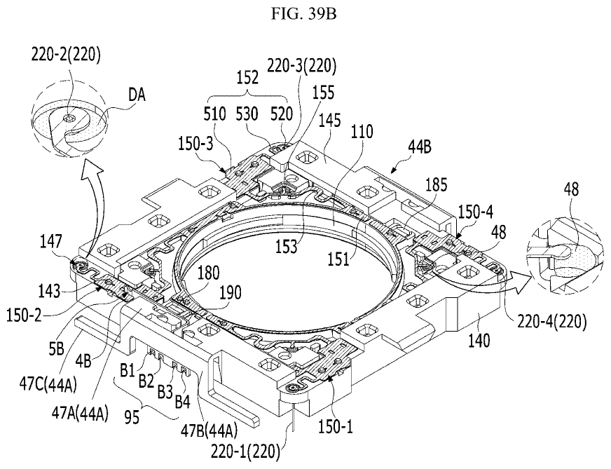

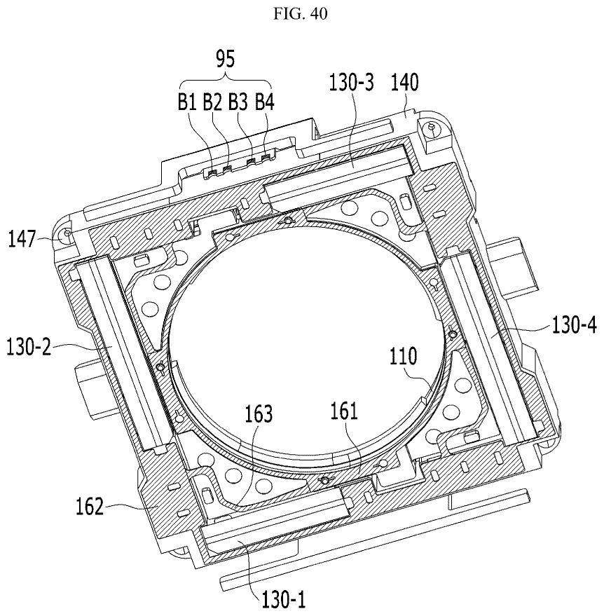

FIG. 33 is a perspective view of the camera device 10 according to an embodiment. FIG. 34 is a perspective view of the camera device 10 shown in FIG. 33 from which the cover member 300 is removed. FIG. 35 is an exploded perspective view of the camera device 10 shown in FIG. 33. FIG. 36A is a cross-sectional view of the camera device 10 taken along line A-B in FIG. 33. FIG. 36B is a cross-sectional view of the camera device 10 taken along line C-D in FIG. 33. FIG. 36C is a cross-sectional view of the camera device 10 taken along line E-F in FIG. 33. FIG. 37 is an exploded perspective view of the AF operation unit 100 shown in FIG. 35. FIG. 38 is a perspective view of the bobbin 110, the sensing magnet 180, the balancing magnet 185, the first coil 120, the circuit board 190, the first position sensor 170, and the capacitor 195. FIG. 39A is a perspective view of the bobbin 110, the housing 140, the circuit board 190, the upper elastic member 150, the sensing magnet 180, and the balancing magnet 185. FIG. 39B is a perspective view of the structure shown in FIG. 39A to which the wire 220 is additionally provided. FIG. 40 is a bottom perspective view of the housing 140, the bobbin 110, the lower elastic member 160, the magnet 130, and the circuit board 190.

Referring to FIGS. 33 to 40, the camera device 10 may include an AF operation unit 100 and an image sensor unit 350. The AF operation unit 100 may include an AF moving unit. The image sensor unit 350 may include an OIS moving unit. One of the AF moving unit and the OIS moving unit may be a first moving unit, and the other of the AF moving unit and the OIS moving unit may be a second moving unit.

The camera device 10 may further include at least one of the cover member 300 and a lens module 400. The cover member 300 and the base 210 to be described later may define the case.

The AF operation unit 100 may be coupled to the lens module 400, and may move the lens module 400 in the direction of the optical axis OA or in a direction parallel to the optical axis in order to perform an autofocus function of the camera device 10.

The image sensor unit 350 may include an image sensor 810. For example, the image sensor unit 350 (or the OIS operation unit) may include an OIS moving unit including the image sensor 810. For example, the image sensor unit 350 may move the OIS moving unit (for example, the image sensor 810) in a direction perpendicular to the optical axis. Furthermore, the image sensor unit 350 may cause tilting or rotation (or rolling) relative to or about the optical axis. The image sensor unit 350 may perform hand tremor correction for the camera device 10.

For example, the image sensor 810 may include an imaging area configured to detect light having passed through the lens module 400. Here, the imaging area may alternatively be referred to as an effective area, a light-receiving area, an active area, or a pixel area. For example, the imaging area of the image sensor 810 may be an area on which an image included in light that has passed through a filter 610 and is then incident on the imaging area, and may include at least one unit pixel. For example, the imaging area may include a plurality of unit pixels.

The AF operation unit 100 may alternatively be referred to as a “lens moving unit” or a “lens moving apparatus”. Alternatively, the AF operation unit 100 may alternatively be referred to as a “first moving unit (or a second moving unit)”, a “first actuator (or a second actuator)” or an “AF operation unit”.

The image sensor unit 350 may alternatively be referred to as an “image-sensor moving unit” or an “image-sensor shift unit”, a “sensor moving unit” or a “sensor shift unit”. Alternatively, the image sensor unit 350 may alternatively be referred to as a “second moving unit (or a first moving unit) or a “second actuator (or a first actuator)”.

Referring to FIGS. 37 and 38, the AF operation unit 100 may move the lens module 400 in the optical axis direction. For example, the AF operation unit 100 may move the bobbin 110 in the optical axis direction. For example, the AF operation unit 100 may include the bobbin 110, the first coil 120, the magnet 130, and the housing 140. The AF operation unit 100 may further include the upper elastic member 150 and the lower elastic member 160.

The AF operation unit 100 may further include a first position sensor 170, the circuit board 190, and the sensing magnet 180 for AF feedback operation. The AF operation unit 100 may further include at least one of the balancing magnet 185 and the capacitor 195.

The bobbin 110 may be disposed in the housing 140 so as to be movable in the optical axis direction OA or the first direction (for example, the Z-axis direction) by the electromagnetic interaction between the first coil 120 and the magnet 130.

The bobbin 110 may have a bore to which a lens module 400 is coupled or mounted. For example, the bore in the bobbin 110 may be a through hole formed through the bobbin 110 in the optical axis direction, and may have a circular shape, an elliptical shape or a polygonal shape, without being limited thereto.

The lens module 400 may include at least one lens and/or a lens barrel. For example, the lens module 400 may include at least one lens and a lens barrel receiving the at least one lens. However, the configuration of the lens module is not limited to the lens barrel, and the lens module may have any configuration, as long as the configuration is capable of supporting the at least one lens.

For example, the lens module 400 may be threadedly engaged with the bobbin 110. Alternatively, the lens module 400 may be coupled to the bobbin 110 using, for example, an adhesive (not shown). The light that has passed through the lens module 400 may be radiated to the image sensor 810 through a filter 610.

The bobbin 110 may include one or more projections 111A and 111B provided on the outer surface thereof. For example, although the one or more projections 111A and 111B may project in a direction that is parallel to a line perpendicular to the optical axis OA, the disclosure is not limited thereto. For example, the bobbin 110 may include two projections 111A and 111B, which are positioned opposite each other.

The projections 111A and 111B of the bobbin 110 may correspond to grooves 25A and 25B in the housing 140, and may be disposed in the grooves 25A and 25B in the housing 140 so as to minimize or inhibit rotation of the bobbin 110 about the optical axis beyond a predetermined range.

The bobbin 110 may include a projection 146A which projects in a direction perpendicular to the optical axis. For example, the projection 146A of the bobbin 110 may be disposed on a corner portion of the bobbin 110.

The housing 140 may include a groove 146b which corresponds, faces, or overlaps the projection 146A of the bobbin 110. At least a portion of the projection 146A of the bobbin 110 may be disposed in the groove 146B in the housing 140.

Furthermore, the projection 146A of the bobbin 110 may serve as a stopper configured to cause the bobbin 110 to move within a predetermined range in the optical axis direction (for example, in a direction toward the lower elastic member 160 from the upper elastic member 150) in response to an external impact or the like.

The bobbin 110 may have formed in the upper surface thereof a first escape groove 112a for avoiding spatial interference with a first frame connector 153 of the upper elastic member 150. The bobbin 110 may have formed in the lower surface thereof a second escape groove 112b for avoiding spatial interference with a second frame connector 163 of the lower elastic member 160.

The bobbin 110 may include a first coupler 116a, configured to be coupled and fixed to the upper elastic member 150. For example, although the first coupler 116a of the bobbin 110 may have the form of a protrusion, the disclosure is not limited thereto. In another embodiment, the first coupler 116a of the bobbin 110 may have the form of a flat surface or a groove. Furthermore, the bobbin 110 may include a second coupler 116b configured to be coupled and fixed to the lower elastic member 160. Although the second coupler 116b may have, for example, the form of a protrusion, the disclosure is not limited thereto. In another embodiment, the second coupler 116b may have the form of a flat surface or a groove.

Referring to FIG. 37, the outer surface of the bobbin 110 may have formed therein a groove 105 in which the first coil 120 is seated, fitted or disposed. For example, the groove 105 in the bobbin 110 may have a shape corresponding to the shape of the first coil 120, that is, a closed curve shape (for example, a ring shape).

The bobbin 110 may be provided therein with a first seating groove 26a in which the sensing magnet 180 is seated, fitted, fixed, or disposed. Furthermore, the bobbin 110 may be provided in the outer surface thereof with a second seating groove 26b in which the balancing magnet 185 is seated, fitted, fixed or disposed.

For example, the first and second seating grooves 26a and 26b in the bobbin 110 may be formed in outer surfaces of the bobbin 110, which are opposed to each other. For example, the first seating groove 26a may be formed in the first projection 111A of the bobbin 110, and the second seating groove 26b may be formed in the second projection 111B of the bobbin 110.

The bobbin 110 may include a guide protrusion 104A configured to guide a portion of the first frame connector 153 of the upper elastic member 150. For example, the guide protrusion 104A may project from the bottom surface of the escape portion 112a in the bobbin 110.

Referring to FIGS. 37 and 38, a damper 48 may be disposed between the bobbin 110 and the upper elastic member 150. For example, the damper 48 may be disposed between the bobbin 110 and the first frame connector 153 of the upper elastic member 150, and may be in contact therewith or be coupled or attached thereto.

For example, the upper elastic member 150 may include an extension (or a projection) which extends from the first frame connector 153. The extension 155 may be spaced apart from both the outer frame 152 and the inner frame 151. Furthermore, the extension 155 may be spaced apart from both one end of the first frame connector 153 connected to the inner frame 151 and the other end of the first frame connector 153 connected to the outer frame 152. For example, the extension 155 may extend beyond the upper surface of the bobbin 110.

For example, a portion (or the end) of the extension 155 may be disposed on the damper 48 disposed on the upper surface of the bobbin 110 so as to overlap the damper 48. For example, the bobbin 110 may include a reception portion 104B in which the damper 48 is received or disposed. For example, the reception portion 104B may be a groove. The reception portion 104B may have a structure that is depressed from the bottom surface of the escape portion 112a in the bobbin 110.

For example, the damper 48 may be disposed between the reception portion 104B and the extension 155 of the upper elastic member 150, and may be in contact therewith or be coupled or attached thereto. The damper 48 may be in contact with or attached to the extension 155 and the reception portion 104B in the bobbin 110 so as to serve to damper or absorb vibration of the bobbin 110. For example, the damper 48 may be made of a damping member (for example, silicone).

The first coil 120 may be disposed on or coupled to the bobbin 110. For example, the first coil 120 may be disposed on or coupled to the outer surface of the bobbin 110. For example, the first coil 120 may surround the outer surface of the bobbin 110 about the optical axis OA in a winding direction, without being limited thereto.

Although the first coil 120 may be directly wound around the outer surface of the bobbin 110, the disclosure is not limited thereto. In another embodiment, the first coil 120 may be embodied as a coil ring, which is wound around the bobbin 110, or as a coil block having an angled shape.

A power or drive signal may be supplied to the coil 120. The power or drive signal supplied to the first coil 120 may be a DC signal, an AC signal or a signal containing both DC and AC components, and may be of a voltage type or a current type.

When a drive signal (for example, drive current) is supplied to the first coil 120, it is possible to create electromagnetic force resulting from the electromagnetic interaction with the first magnet, thereby moving the bobbin 110 in the direction of the optical axis OA by virtue of the created electromagnetic force.

At the initial position of the AF operation unit, the bobbin 110 may be moved upwards or downwards, which is referred to as bidirectional driving of the AF operation unit. Alternatively, at the initial position of the AF operation unit, the bobbin 110 may be moved upwards, which is referred to as unidirectional driving.

At the initial position of the AF operation unit, the first coil 120 may be disposed so as to correspond to the magnet 130 disposed on the housing 140 in a direction parallel to a line which is perpendicular to the optical axis OA and extends through the optical axis.

For example, the AF operation unit may include the bobbin 110 and the components (for example, the first coil 120, the sensing magnet 180 and the balancing magnet 185) coupled to the bobbin 110. The AF operation unit may further include the lens module 400.

The initial position of the AF operation unit may be the original position of the AF operation unit in the state in which no electric power is applied to the first coil 120 or the position at which the AF operation unit is located as the result of the upper and lower elastic members 150 and 160 being elastically deformed due only to the weight of the AF operation unit. In addition, the initial position of the bobbin 110 may be the position at which the AF operation unit is located when gravity acts in the direction from the bobbin 110 to the base 210 or when gravity acts in the direction from the base 210 to the bobbin 110.

The sensing magnet 180 may provide a magnetic field, which is detected by the first position sensor 170, and the balancing magnet 185 may serve to cancel out the influence of the magnetic field of the sensing magnet 180, and establishes weight equilibrium with respect to the sensing magnet 180.

The sensing magnet 180 may alternatively be referred to as a “sensor magnet” or a “second magnet”. The sensing magnet 180 may be disposed on the bobbin 110, or may be coupled to the bobbin 110. The sensing magnet 180 may be disposed so as to face the first position sensor 170.
The balancing magnet 185 may be disposed on the bobbin 110, or may be coupled to the bobbin 110. For example, the balancing magnet 185 may be disposed opposite the sensing magnet 180

Although each of the sensing magnet and the balancing magnet 180 and 185 may be a monopolar magnetized magnet having one N pole and one S pole, the disclosure is not limited thereto. In another embodiment, each of the sensing magnet and the balancing magnet 180 and 185 may be a bipolar magnetized magnet, which has two N poles and two S poles, or a tetrapolar magnetized magnet.

The sensing magnet 180 may be moved together with the bobbin 110 in the optical axis direction, and the first position sensor 170 may detect the intensity or magnetic force of the magnetic field of the sensing magnet 180, which is moved in the optical axis direction, and may output an output signal corresponding to the result of the detection.

For example, in accordance with displacement of the bobbin 110 in the optical axis direction, the intensity or magnetic force of the magnetic field detected by the first position sensor 170 may vary. Consequently, the first position sensor 170 may output an output signal proportional to the detected intensity of the magnetic field, and the displacement of the bobbin 110 in the optical axis direction may be detected using the output signal from the first position sensor 170.

The housing 140 may be disposed in the cover member 300. For example, the housing 140 may be disposed on the image sensor unit 350.

The housing 140 may accommodate therein the bobbin 110, and may support the magnet 130, the first position sensor 170, and the circuit board 190.

Referring to FIGS. 37, 38 and 40, the housing 140 may be configured to have a hollow column shape. For example, the housing 140 may have a polygonal (for example, a rectangular or octagonal) or circular bore, and the bore in the housing 140 may be a through hole, which is formed through the housing 140 in the optical axis direction.

The housing 140 may include side portions, which correspond to or face the side plate 302 of the cover member 300, and corners, which correspond to or face the corners of the cover member 300.

In order to inhibit a direct collision with the inner surface of the upper plate 301 of the cover member 300, the housing 140 may include a stopper 145 provided at the upper portion, the upper surface or the upper end thereof.

Referring to FIG. 37, the housing 140 may have a mounting groove (or a seating groove) 14A configured to receive the circuit board 190 therein. The mounting groove 14A may have a shape corresponding to the shape of the circuit board 190.

Referring to FIGS. 39A and 39B, the housing 140 may include projections 44A and 44B which surround at least one of the circuit board 190 and a support board 310. For example, the projections 44A and 44B may be disposed or formed on the outer surface of the housing 140. For example, the projections 44A and 44B may be disposed or formed on the outer surface of the side portion of the housing 140. The projections 44A and 44B may alternatively be referred to as “protection portions”, “support portions”, “extension portions”, or “guide portions”.

The projections 44A and 44B of the housing 140 may surround at least a portion of the circuit board 190 and at least a portion of the support board 310. For example, the housing 140 may include a first projection 44A disposed on the first side portion of the housing and a second projection 44B disposed on the second side portion of the housing 140. The first projection 44A and the second projection 44B may be positioned opposite each other relative to the optical axis OA or the bobbin 110. In another embodiment, the second projection 44B may be omitted.

For example, the circuit board 190 may be disposed in the first projection 44A. For example, the mounting groove 14A may be formed in the first projection 44A.

For example, each of the first projection 44A and the second projection 44B may include a first portion 47A connected to the upper surface of the housing 140 and a second portion 47B which is connected to the first portion 47A and is spaced apart from the side portion of the housing 140. For example, the first portion 47A of the first projection 44A may be connected to the upper surface of the first side portion of the housing 140, and the first portion 47A of the second projection 44B may be connected to the upper surface of the second side portion of the housing 140. For example, the first portion 47A may project in the optical axis direction or toward the inner surface of the upper plate 301 of the cover member 300 from the upper surface of the second side portion of the housing 140.

For example, at least a portion of the circuit board 190 may be positioned between the first portion 47A and the second portion 47B of the first projection 44A. Furthermore, for example, at least a portion of the support board 310 may be positioned between the first portion 47A and the second portion 47B of the first projection 44A.

The housing 140 may have an opening through which terminals B1 to B4 of a terminal portion 95 are exposed. The opening may be formed in the side portion of the housing 140.

Each of the first projection 44A and the second projection 44B of the housing 140 may include a third portion 37C which extends from the second portion 47B. For example, the third portion 37C may extend or project in a direction (for example, a second horizontal direction) parallel to the outer surface of the first side portion (or the second side portion) of the housing 140 from the lower portion or lower end of the second portion 47B.

For example, the third portion 37C may include a third-first portion, which extends from one end of the second portion 47B, and a third-second portion, which extends from the other end of the second portion. The third-first portion and the third-second portion may extend or project in opposite directions.

An adhesive or a sealing member may be disposed between the projections 44A and 44B of the housing 140 and the cover member 300. For example, the adhesive (or the sealing member) may be disposed between the projections 44A and 44B of the housing 140 and the side plate 302 of the cover member 300, and may couple both portions to each other. The projections 44A and 44B may increase a surface area in which the projections 44A and 44B are coupled to the cover member 300, and may stably couple the housing 140 to the cover member 300 without interference with the support board 310.

The upper portion, the upper end or the upper surface of the housing 140 may be provided with at least one first coupler 143, which is to be coupled to a first outer frame 152 of the upper elastic member 150. The lower portion, the lower end or the lower surface of the housing 140 may be provided with a second coupler, which is to be coupled and fixed to a second outer frame 162 of the lower elastic member 160. For example, each of the first and second couplers of the housing 140 may have the shape of a flat surface, a protrusion, or a groove.

The corner of the housing 140 may have formed therein a hole 147 which is a path through which the wire 220 extends. The hole 147 may be a through hole which is formed through the housing 140 in the optical axis direction. In another embodiment, the hole may have a structure that is depressed from the outer surface of the corner portion of the housing 140, and at least a portion of the hole may be exposed from the outer surface of the corner portion. The hole 147 in the housing 140 may include the same number of holes as the number of support members.

The magnet 130 may be disposed on, coupled to or fixed to the housing 140, which is a stationary component. For example, the magnet 130 may be disposed on, coupled to or fixed to the side portion of the housing 140. The magnet 130 may include an AF operation magnet 71A for AF operation. The magnet 130 may include an OIS operation magnet 71B for OIS operation. Hereinafter, the AF operation magnet 71A may be referred to as one of first and second magnets, and the OIS operation magnet 71B may be referred to as the other of the first and second magnets.

In another embodiment, the magnet 130 may be disposed, coupled or fixed to the corner portion of the housing.

For example, the magnet 130 may include a plurality of magnet units. For example, the magnet 130 may include first to fourth magnet units 130-1 to 130-4 which are disposed on the housing 140. In another embodiment, the magnet 130 may include two or more magnet units.

The magnet 130 may be disposed on at least one of the side portion or the corner of the housing 140. For example, at least a portion of the magnet 130 may be disposed on the side portion or the corner of the housing 140. Alternatively, for example, at least a portion of the magnet 130 may be disposed on the side portion of the housing 140, and the remaining portion of the magnet 130 may be disposed at the corner of the housing 140.

For example, each of the magnet units 130-1 to 130-4 may include a first portion which is disposed on a corresponding one of the four corners of the housing 130. Furthermore, each of the magnet units 130-1 to 130-4 may include a second portion which is disposed on a side portion of the housing 140 adjacent to the one corner of the housing 140.

For example, the first magnet unit 130-1 and the third magnet unit 130-3 may be positioned at opposite sides of the housing 140 in the first horizontal direction (for example, the y-axis direction). For example, the second magnet unit 130-2 and the fourth magnet unit 130-4 may be positioned at opposite sides of the housing 140 in the second horizontal direction (for example, the x-axis direction).

For example, the first magnet unit 130-1 and the third magnet unit 130-3 may be disposed parallel to each other in the second horizontal direction (for example, the x-axis direction), and the second magnet unit 130-2 and the fourth magnet unit 130-4 may be disposed parallel to each other in the first horizontal direction (for example, the y-axis direction).

At the initial position of the AF operation unit, the magnet 130 may be disposed on the housing so as to partially overlap the first coil 120 in a direction parallel to a line which is perpendicular to the optical axis OA and extends through the optical axis OA.

The magnet 130 may include a monopolar magnetized magnet or a dipole magnet, which includes one N pole and one S pole. In another embodiment, the magnet 130 may include a bipolar magnetized magnet or a quadrupole magnet, which includes two N poles and two S poles. In a further embodiment, the magnet 130 may include both a monopolar magnetized magnet and a bipolar magnetized magnet.

For example, the magnet 130 may include an AF magnet (or an AF operation magnet) for AF operation and an OIS magnet (or an OIS operation magnet) for OIS operation. In another embodiment, for example, the magnet 130 may be a common magnet for AF operation and OIS operation.

The description of the magnet 1130, which has been previously described above, may be applied to the magnet 130 with or without modification.

The circuit board 190 may be disposed on the housing 140, and the first position sensor 170 may be disposed on or mounted to the circuit board 190 and may be electrically connected to the circuit board 190. For example, the circuit board 190 may be disposed in the mounting groove 14A in the housing 140, and the terminals 95 of the circuit board 190 may be exposed to the outside of the housing 140.

The circuit board 190 may include the terminal member (or terminal unit) 95 including the plurality of terminals B1 to B4, which are to be electrically connected to external terminals or external devices. The plurality of terminals B1 to B4 of the circuit board 190 may be electrically connected to the first position sensor 170.

The first position sensor 170 may be disposed on the housing 140 and/or the circuit board 190. The first position sensor 170 may be disposed on a first surface of the circuit board 190, and the plurality of terminals B1 to B4 may be disposed on a second surface of the circuit board 190. Here, the second surface of the circuit board 190 may be the surface opposite the first surface of the circuit board 190. For example, the first surface of the circuit board 190 may be the surface of the circuit board 190 that faces the bobbin 110 or the sensing magnet 180. For example, the circuit board 190 may be a printed circuit board or a flexible printed circuit board (FPCB).

The first position sensor 170 may be electrically connected to the circuit board 190. For example, the first position sensor 170 may be electrically connected to the first to fourth terminals B1 to B4 of the circuit board 190. The circuit board 190 may include a circuit pattern or a wire (not shown) for electrically connecting the first to fourth terminals B1 to B4 to the first position sensor 170.

For example, at the initial position of the AF operation unit, at least a portion of the first position sensor 170 may face or overlap the sensing magnet 180 in a direction parallel to a straight line which is perpendicular to the optical axis OA and extends through the optical axis OA. In another embodiment, at the initial position of the AF operation unit, the first position sensor may not face or overlap the sensing magnet.

The first position sensor 170 may serve to detect movement, displacement or position of the bobbin 110 in the optical axis direction. The first position sensor 170 may detect the magnetic field or the intensity of the magnetic field of the sensing magnet 180 mounted on the bobbin 110 during movement of the bobbin 110, and may output an output signal corresponding to the result of the detection. Consequently, it is possible to detect movement, displacement or position of the bobbin 110 in the optical axis direction using the output of the first position sensor 170.

The first position sensor 170 may be a driver IC including a Hall sensor and a driver. The position sensor 170 may include first to fourth terminals for transmitting and receiving data to and from an external device through data communication using a protocol, such as I2C communication, and fifth and sixth terminals for directly supplying a drive signal to the coil 120.

For example, each of the first to fourth terminals of the first position sensor 170 may be electrically connected to a corresponding one of the first to fourth terminals B1 to B4 of the circuit board 190 using solder or a conductive adhesive.

For example, the fifth and sixth terminals of the first position sensor 170 may be electrically connected to the first coil 120. For example, the first position sensor 170 may be electrically connected to the first coil 120 via at least one of the upper elastic member 150 and the lower elastic member 160 so as to supply a drive signal to the first coil 120.

For example, a portion of the first upper elastic unit 150-1 may be connected to one end of the first coil 120, and another portion of the first upper elastic unit 150-1 may be electrically connected to the circuit board 190. A portion of the second upper elastic unit 150-2 may be connected to the other end of the first coil 120, and another portion of the second upper elastic unit 150-2 may be electrically connected to the circuit board 190. The circuit board 190 may include a first pad 5A, which is electrically connected to another portion of the first upper elastic unit 150-1, and a second pad 5B, which is electrically connected to another portion of the second upper elastic unit 150-2. Each of the fifth and sixth terminals of the first position sensor 170 may be electrically connected to a corresponding one of the first and second pads 5A and 5B of the circuit board 190.

In another embodiment, the first coil 120 may be electrically connected to the circuit board 190 and the fifth and sixth terminals of the first position sensor 170 via two lower elastic members.

For example, in an embodiment in which the first position sensor 170 is a driver IC, the first and second terminals B1 and B2 of the circuit board 190 may be power terminals for supplying power, the third terminal B3 may be a terminal for transmitting and receiving a clock signal, and the fourth terminal B4 may be a terminal for transmitting and receiving a data signal.

In another embodiment, the first position sensor 170 may be a Hall sensor. Here, the first position sensor 170 may include two input terminals, to which drive signals or power are supplied, and two output terminals, through which a sensing voltage (or an output voltage) is output. For example, drive signals may be supplied to the first position sensor 170 through the first and second terminals B1 and B2 of the circuit board 190, and the output of the first position sensor 170 may be output to the outside through the third and fourth terminals B3 and B4. Furthermore, the first coil 120 may be electrically connected to the circuit board 190. The circuit board 190 may further include two additional terminals in addition to the first to fourth terminals B1 to B4 such that an external drive signal may be supplied to the first coil 120 via the two additional terminals.

For example, a ground terminal among the power terminals of the first position sensor 170 may be electrically connected to the cover member 300.

The capacitor 195 may be disposed or mounted on the first surface of the circuit board 190. The capacitor 195 may be configured to have a chip shape. Here, the chip may include a first terminal, which corresponds to one end of the capacitor 195, and a second terminal, which corresponds to the other end of the capacitor 195. The capacitor 195 may alternatively be referred to as a “capacitive element” or “condenser”.

The capacitor 195 may be electrically connected in parallel to first and second terminals B1 and B2 of the circuit board 190 through which power (or a drive signal) is supplied to the first position sensor 170 from the outside. Alternatively, the capacitor 195 may be electrically connected in parallel to the terminals of the first position sensor 170, which is electrically connected to the first and second terminals B1 and B2 of the circuit board 190.

Since the capacitor 195 is electrically connected in parallel to the first and second terminals B1 and B2 of the circuit board 190, the capacitor 195 is capable of serving as a smoothing circuit for eliminating ripple components included in the power signals GND and VDD, which are supplied to the first position sensor 170 from the outside, and is thus capable of supplying stable and consistent power signals to the first position sensor 170.

In another embodiment, the sensing magnet 180 may be disposed on the housing 140, and the first position sensor 170 may be disposed on the bobbin 110. In another embodiment, the balancing magnet 185 may be omitted.

The upper elastic member 150 and the lower elastic member 160 may be coupled to the bobbin 110 and the housing 140. For example, the upper elastic member 150 may be coupled to the upper portion, the upper end or the upper surface of the bobbin 110 and the upper portion, the upper end or the upper surface of the housing 140, and the lower elastic member 160 may be coupled to the lower portion, the lower end or the lower surface of the bobbin 110 or the upper portion, the upper end or the upper surface of the housing 140. The upper elastic member 150 and the lower elastic member 160 may elastically support the bobbin 110 relative to the housing 140.

The upper elastic member 150 may include a plurality of upper elastic units (for example, 150-1 to 150-4) which are electrically separated or spaced apart from each other. Although the lower elastic member 160 is embodied as a single elastic unit, the lower elastic member 160 may include a plurality of lower elastic units which are electrically separated or spaced apart from each other in another embodiment. In another embodiment, at least one of the upper elastic member and the lower elastic member may be embodied as a single unit or a single structure.

The upper elastic member 150 may further include a first inner frame 151 coupled or fixed to the upper portion, the upper surface or the upper end of the bobbin 110, a second inner frame 152 coupled or fixed to the upper portion, the upper surface or the upper end of the housing 140, and a first frame connector 153 connecting the first inner frame 151 to the first outer frame 152. Furthermore, the upper elastic member 150 may include the above-mentioned extension 155.

The lower elastic member 160 may include a second inner frame 161 coupled or fixed to the lower portion, the lower surface or the lower end of the bobbin 110, a second outer frame 162 coupled or fixed to the lower portion, the lower surface or the lower end of the housing 140, and a second frame connector 163 connecting the second inner frame 161 to the second outer frame 162. The inner frame may alternatively be referred to as an inner portion, the outer frame may alternatively be referred to as an outer portion, and the frame connector may alternatively be referred to as a connecting portion.

Each of the first and second frame connectors 153 and 163 may be bent or curved (or may be formed into a curved line) at least once so as to define a predetermined pattern.

Each of the upper elastic member 150 and the lower elastic member 160 may be made of a conductive material, for example, a metal material. Furthermore, each of the upper elastic member 150 and the lower elastic member 160 may be made of an elastic member, for example, a leaf spring or the like.

Referring to FIGS. 5 and 7, for example, the second outer frame 152 of the first upper elastic unit 150-1 may include a first bonding portion 4A coupled or electrically connected to the first pad 5A of the circuit board 190, and the second outer frame 152 of the second upper elastic unit 150-2 may include a second bonding portion 4B electrically connected to the second pad 5B of the circuit board 190.

In another embodiment, at least one of the upper elastic member 150 or the lower elastic member 160 may include two elastic members. For example, each of the two lower elastic members of one of the upper elastic member 150 and the lower elastic member 160 may be coupled or electrically connected to a corresponding one of the first and second pads 5a and 5b of the circuit board 190. The first coil 120 may be electrically connected to the two elastic members.

The first outer frame 152 of the upper elastic member 150 may include a first coupler 510 coupled to the housing 140, a second coupler 520 coupled to the wire 220, and a connector 530 connecting the first coupler 510 to the second coupler 520. The first coupler 510 may have a through hole or a hole to be coupled to the first coupler 143 of the housing 140. The second coupler 520 may have a through hole or a hole to be coupled to the wire 220. For example, the second coupler 520 may be coupled to the wire 220 using a conductive adhesive or solder. For example, although the connector 530 may include a bent portion, which is bent at least once, or a curved portion, which is curved at least once, the disclosure is not limited thereto. In another embodiment, the connector 530 may have a linear shape.

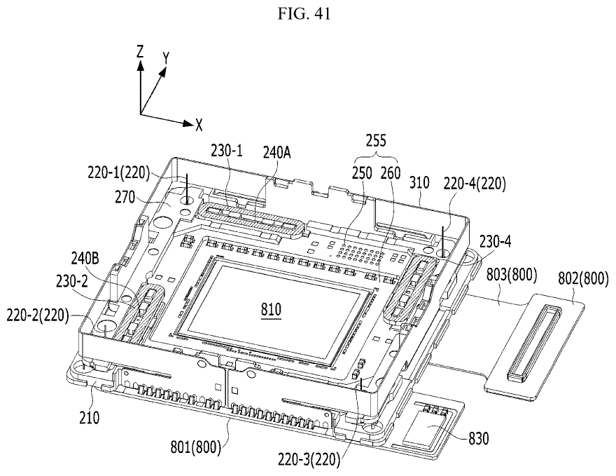

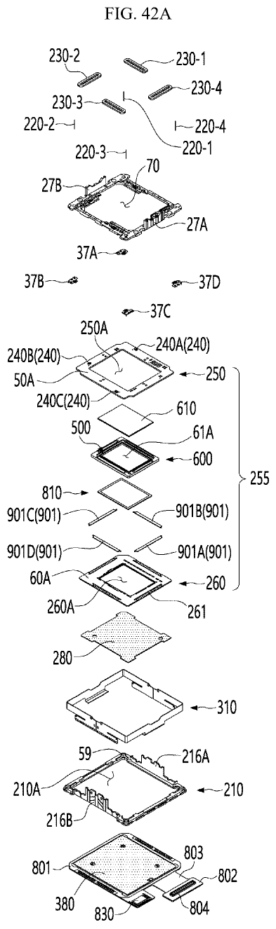

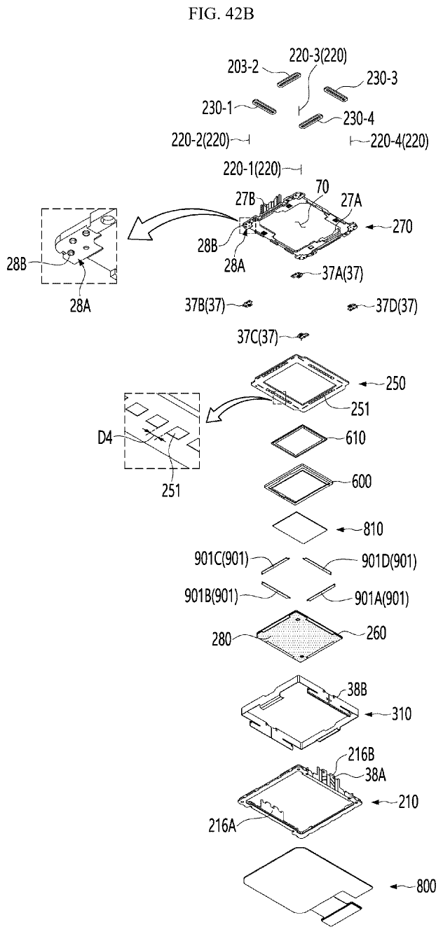

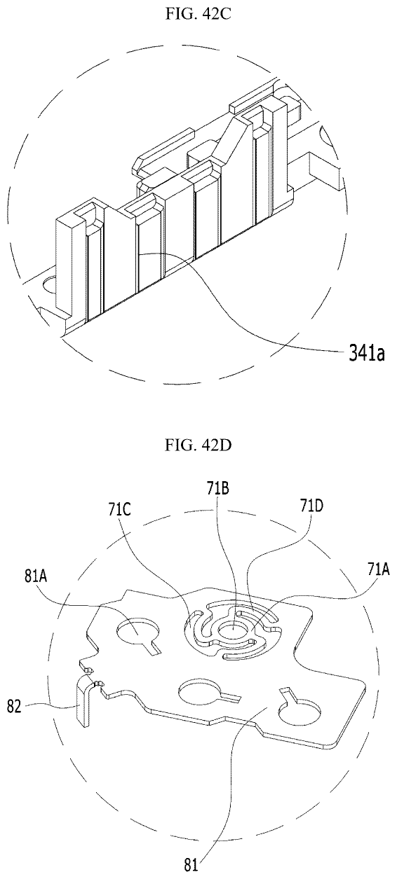

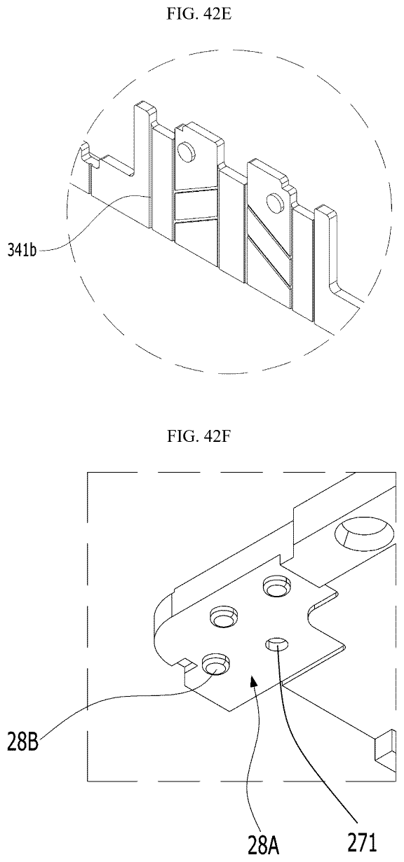

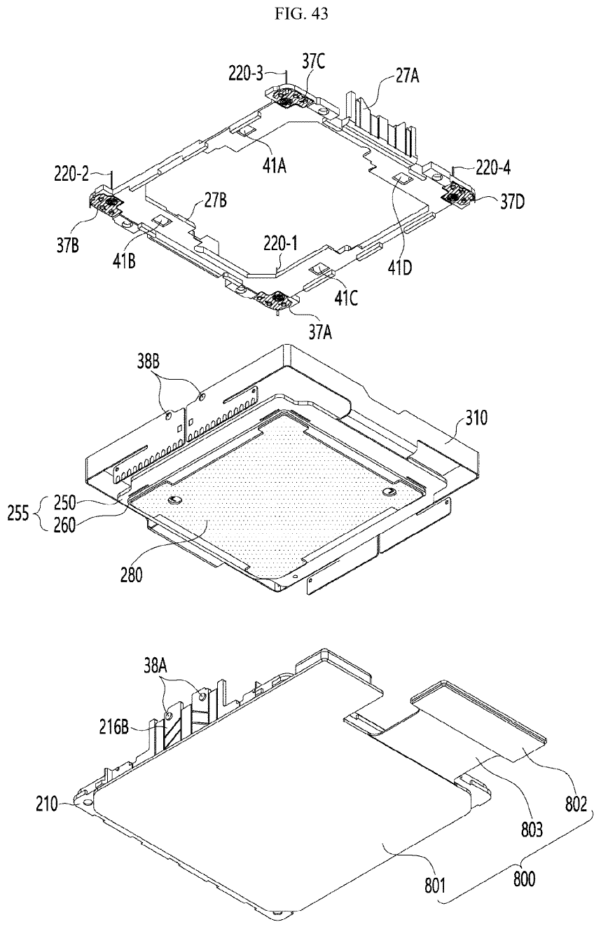

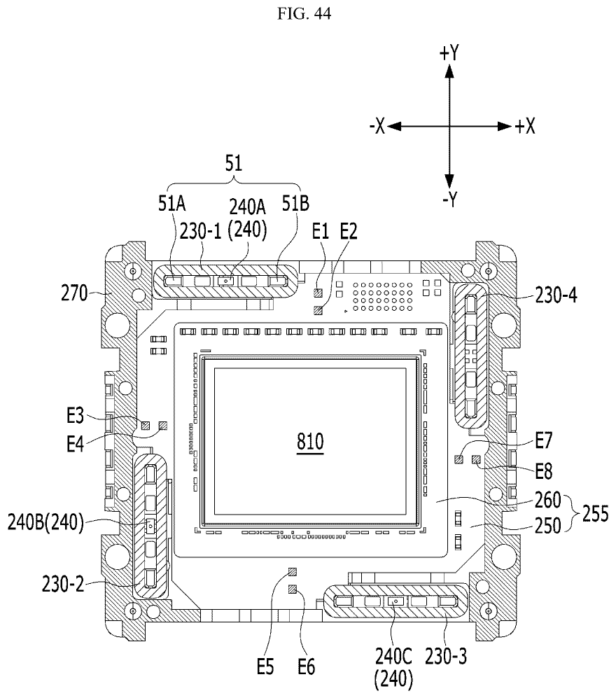

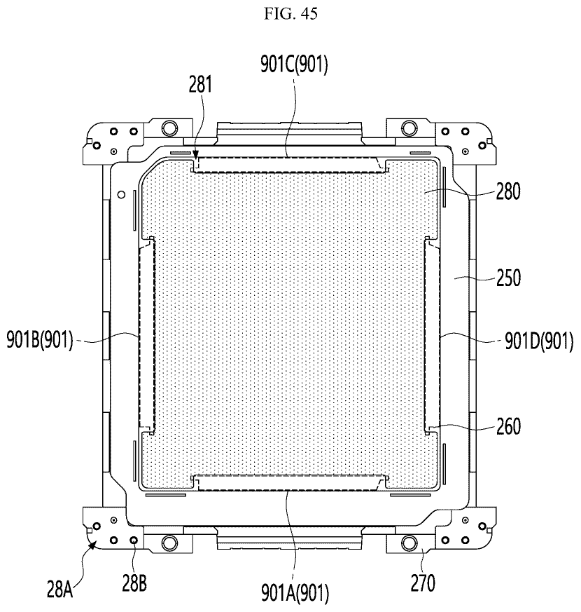

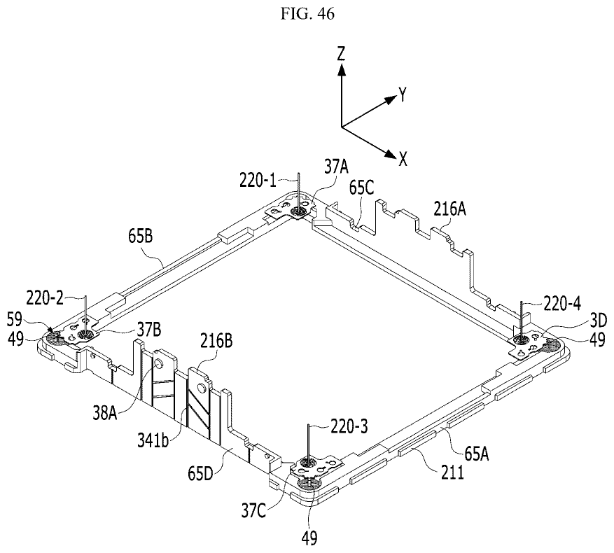

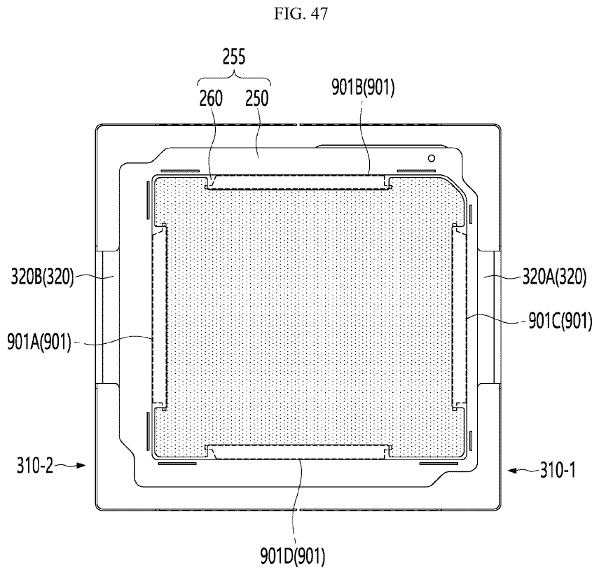

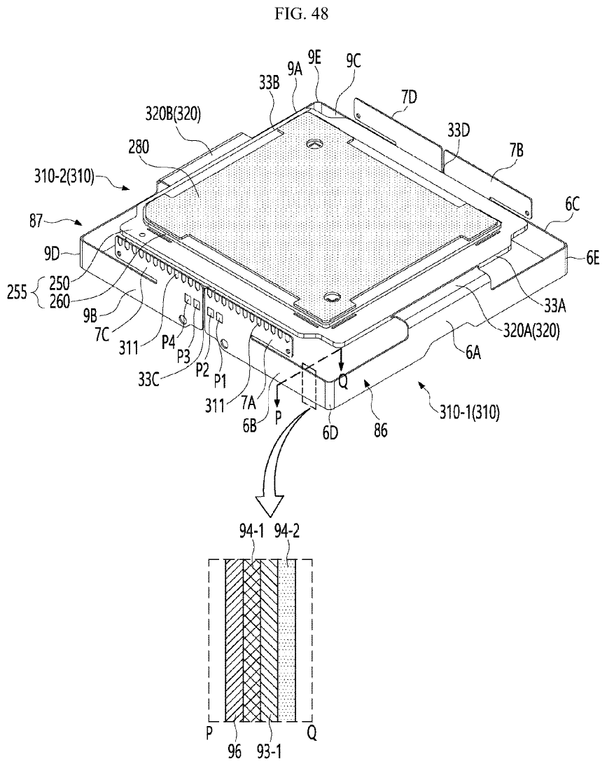

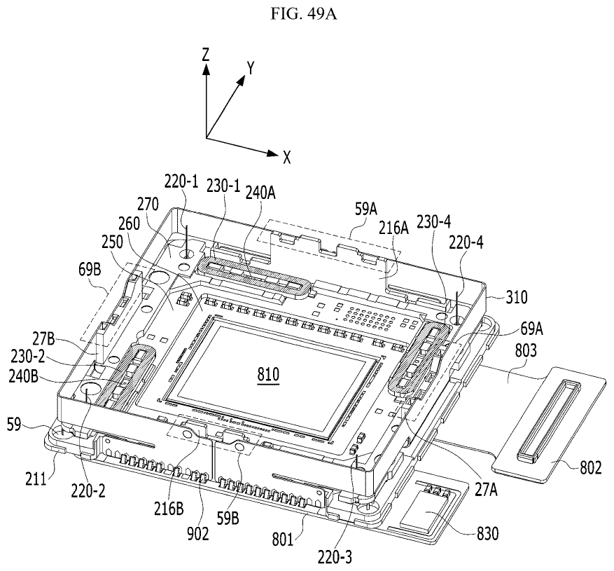

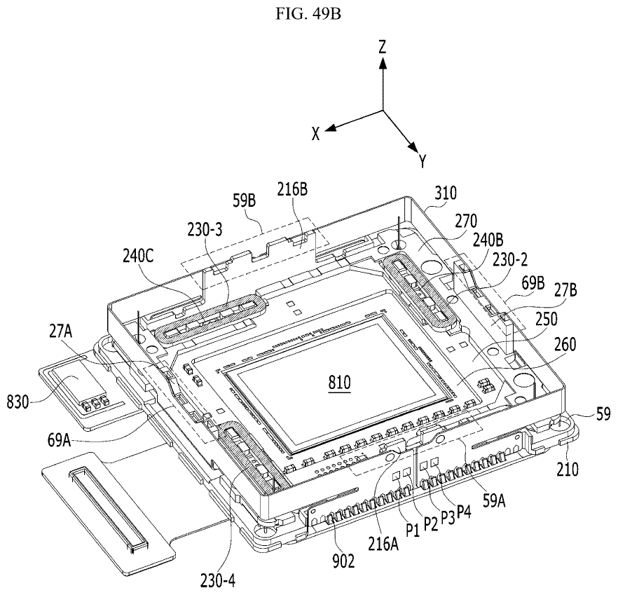

FIG. 41 is a perspective view of the image sensor unit 350 shown in FIG. 35. FIG. 42A is a first exploded perspective view of the image sensor unit 350 shown in FIG. 41. FIG. 42B is a second exploded perspective view of the image sensor unit 350 shown in FIG. 41. FIG. 42C is an enlarged view of the hole 341a in the holder shown in 42A. FIG. 42D is an enlarged view of the terminal member 37 shown in FIG. 42A. FIG. 42E is an enlarged view of the groove 341b in the base 210 shown in FIG. 42A. FIG. 42F is an enlarged view of the groove in the groove 28A in the holder 270 in which the terminal member 37 shown in FIG. 42B is disposed. FIG. 43 is a bottom perspective view of the holder 270, the terminal member 37, the first board unit 255, the support board 310, the heat radiating member 280, the base 210, and the second board unit 800, which are shown in FIG. 42A. FIG. 44 is a plan view of the holder 270, the first board unit 255, the image sensor 810, the second coil 230, and the OIS position sensor 240. FIG. 45 is a rear perspective view of the holder 270 and the first board unit 255. FIG. 46 is a perspective view of the base 210, the terminal member 37, and the wire 220. FIG. 47 is a bottom view of the first board unit 255, the support board 310, and the heat radiating member 280. FIG. 48 is a perspective view of the first board unit 255, the support board 310, and the heat radiating member 280. FIG. 49A is a first perspective view of the support board 310 coupled to the holder 270 and the base 210. FIG. 49B is a second perspective view of the support board 310 coupled to the holder 270 and the base 210.

Referring to FIGS. 41 to 49B, the image sensor unit 350 may include a stationary unit and the OIS moving unit which is disposed so as to be spaced apart from the stationary unit. The image sensor unit 350 may include a support unit connecting the stationary unit to the OIS moving unit.

For example, the support unit may include the support board 310. Alternatively, for example, the support unit may be the support board 310. In another embodiment, the support unit may include an elastic member, for example, a leaf spring or a suspension wire in place of the support board 310.

The stationary unit may be a portion of the camera device 10 which is immovable during OIS operation. For example, the stationary unit may include the board unit 800. For example, the stationary unit may include a component coupled to the second board unit 800. The board unit 255 or 800 may alternatively be referred to as a “board” or a “circuit board”.

For example, the stationary unit may include the base 210 coupled to the second board unit 800. For example, the stationary unit may include the housing 140 of the AF operation unit, and components disposed on the housing 140, for example, the magnet 130, the first position sensor 170 and the circuit board 180. Furthermore, the stationary unit may include the cover member 300 coupled to the base 210. The OIS moving unit may be disposed in the cover member 300. For example, the cover member 300 may accommodate therein the OIS moving unit and the support board 310.

The OIS moving unit may include the image sensor 810. The OIS moving unit may further include the first board unit 255, which is spaced apart from the second board unit 800 and is electrically connected to the second board unit 800. For example, the OIS moving unit may include components disposed on the first board unit 255, for example, at least one of the heat radiating member 280, the holder 270, the second coil 230, and the second position sensor 340. The holder 270 may alternatively be referred to as a “spacer member”. In another embodiment, the holder 270 may be omitted, and the second coil 230 may be disposed on the first board unit 255, for example, the first circuit board 250.

For example, the camera device 10 may include the stationary unit, the moving unit including the first heat radiating member 280 disposed on the stationary unit and the image sensor 810 disposed in the first heat radiating member 280, and the support unit (for example, 310) configured to support the moving unit while allowing the moving unit to be movable in a direction perpendicular to the optical axis direction. The support unit (for example, 310) may be connected between the moving unit and the stationary unit.

The moving unit may include the first board unit 255 on which the image sensor 810 is disposed, the stationary unit may include the second board unit 800 which is disposed so as to be spaced apart from the first board unit 255, and the support unit may connect the first board unit 255 to the second board unit 800.

The support unit may include a conductive layer 93-1, a first insulating layer 94-1 disposed below the conductive layer 93-1, and a second insulating layer 94-2 disposed on the conductive layer 93-1. The support unit may be constructed such that a portion of the first insulating layer 94-1 is removed so as to expose an area of the conductive layer 93-1 through the removed portion.

The first board unit 255 may include the first circuit board 250, a second circuit board 260 electrically connected to the image sensor 810, and a solder 901 electrically connecting the first circuit board 250 to the second circuit board 260.

The camera device 10 may include an elastic member 220 (referred to hereinafter as a “wire”) configured to flexibly support the OIS moving unit. The elastic member 220 may have the form of a wire or a spring.

For example, one end of the wire 220 may be coupled to the upper elastic member 150 (or the housing 140), and the other end of the wire 220 may be coupled to the holder 270. For example, one end of the wire 220 may be coupled to the first outer frame 152 (for example, the second coupler 520) of the upper elastic member 150 using solder or a conductive adhesive. For example, the other end of the wire 220 may be coupled to the terminal member 37, and the terminal member 37 may be disposed on or coupled to the holder 270 using solder or a conductive adhesive.

Referring to FIGS. 39A and 39B, a damper DA may be disposed between one end of the wire 220, which extends through the hole 147 in the housing 140, and the hole 147 in the housing 140. For example, at least a portion of the damper DA may be disposed in the hole 147 in the housing 140, and may be couple or attached both to at least a portion of the wire 220 and to the housing 140.

For example, the wire 220 may be disposed parallel to the optical axis direction. For example, the wire 220 may be disposed at the corner of the housing 140 and/or the corner of the holder 270. For example, the wire 220 may include four wires 220-1 to 220-4. Each of the four wires 220-1 to 220-4 may be disposed on a corresponding one of the four corners of the housing 140 and/or the four corners of the holder 270.

Referring to FIGS. 42A to 42F, the holder 270 may have formed therein a hole 271 through which at least a portion of the wire 220 extends. For example, the corner of the holder 270 may have formed therethrough the hole 271 through which the other end of the wire 220 extends. For example, each of the four corners of the holder 270 may have formed therein the hole 271. For example, although the hole 271 may be a through hole which is formed through the holder 270 in the optical axis direction, the hole 271 may have the form of an escape groove in another embodiment.

For example, the terminal member 37 may be disposed on or coupled to the upper surface or the lower surface of the holder 270. For example, the terminal member 37 may be disposed or coupled to the lower surface of the corner of the holder 270. The holder 270 may have formed therein a groove 28A in which the terminal member 37 is disposed. For example, the groove 28A may be formed in the lower surface of the corner of the holder 270.

The holder 270 may include at least one protrusion 28B, and the terminal member 37 may have at least one hole 81A to be coupled to the at least one protrusion 28B of the holder 270. The terminal member 37 and the holder 270 may be coupled to each other using an adhesive or through heat fusion. The terminal member 37 may have a hole 71B to which the other end of the wire 220 is inserted or coupled. For example, each of the holes 81A and 71B may be a through hole.

For example, the terminal member 37 may include a body 81 coupled to the holder 270. The body 81 may include a coupler 71 coupled to the wire 220. The coupler 71 may include a coupling region 71A coupled to the wire 220 and a hole 71B formed in the first coupling region 71A. The coupling region 71A may be a region of the body 81 which is coupled to the wire 220 using solder or a conductive adhesive. For example, the other end of the wire 220 that has passed through the hole 71B may be coupled to the lower portion or the lower surface of the coupling region 71A using solder or a conductive adhesive.

For example, the body 81 may have at least one hole 71C formed around the coupling region 71A. For example, the body 81 may have a plurality of holes 71C surrounding the coupling region 71A. For example, the plurality of holes 71C may be spaced apart from the hole 71B.

The body 81 may include a support portion which is positioned between the plurality of holes 71C so as to support the coupling region 71A. The support portion 71D may alternatively be referred as a “connector” or a “bridge”. The support portion 71D may include a plurality of support portions that are spaced apart from each other. The support portion 71D may be connected to the coupling region 71A.

The at least one hole 71C may serve to enable solder to be mainly formed only in the coupling region 71A by virtue of interfacial tension (for example, surface tension) at the peripheral area of the coupling region 71A during soldering.

The coupling region 71A must be heated in order to perform soldering. Here, the at least one hole 71C may suppress or block transmission of heat of the coupling region 71A to another region while inhibiting a soldered portion from being formed in the remaining region of the body 81. In other words, the at least one hole 71C is able to improve soldering efficiency.

The terminal member 37 may include an extension 82 which extends from the body 81. The extension 82 may be bent downwards at the body 81 and may extend downwards. For example, the extension 82 may extend toward a hole 59 in the base 210. The extension 82 may alternatively be referred to as a “bent portion”.

For example, the terminal member 37 may include four terminals 37A to 37D corresponding to the four wires 220-1 to 220-4 of the terminal member 37. Each of the terminals 37A to 37D may be disposed on a corresponding one of the corners of the holder 270, and may be coupled to a corresponding one of the wires 220-1 to 220-4. The description of FIG. 42A may be applied to the structure of each of the terminals 37A to 37D with or without modification. The terminal member 37 may be made of a conductive material, for example, metal. In another embodiment, the terminal member 37 may be omitted, and the wire 220 may be directly coupled to the holder 270.

A damper or adhesive 49 may be disposed between the terminal member 37 and the base 210, and may be in contact with or coupled or attached both to the terminal member 37 and to the base 210. For example, the base 210 may have the hole 59 (or the groove) formed at a location which corresponds to or faces the terminal member 37. For example, the hole 59 (or the groove) may be formed in the corner of the base 210.

For example, the damper 59 may be disposed in the hole 59 in the base 210. Alternatively, at least a portion of the extension 82 of the terminal member 37 may be disposed in the hole 59 in the base 210, and the damper 59 may be in contact with or coupled or attached to the extension 82. The damper 59 may serve to absorb or mitigate vibration of the OIS moving unit, thereby inhibiting or suppressing oscillation of the OIS moving unit during OIS operation.

In another embodiment, the extension 82 may be omitted from the terminal member 37, and the camera device 10 may not include the damper 49 shown in FIG. 46.

The support board 310 may support the OIS moving unit with regard to the stationary unit such that the OIS moving unit is moved in a direction perpendicular to the optical axis, is tilted relative to the optical axis, or is rotated within a predetermined range.

For example, one end of the support board 310 may be connected or coupled to the first board unit 255, and another end of the support board 310 may be connected or coupled to the second board unit 800.

The holder 270 may be disposed below the AF operation unit. For example, the holder 270 may be made of a non-conductive member. For example, the holder 270 may be made of an injection-moldable material which is easily shaped through an injection molding process. Furthermore, the holder 270 may be made of an insulative material. Furthermore, for example, the holder 270 may be made of resin or plastic.

The holder 270 may include an upper surface, a lower surface which is opposed to the upper surface, and a side surface (for example, an outer surface) connecting the upper surface to the lower surface. For example, the lower surface of the holder 270 may be opposed to or face the second board unit 800.

The holder 270 may support the first board unit 255, and may be coupled to the first board unit 255. For example, the first board unit 255 may be disposed below the holder 270. The lower portion, the lower surface or the lower end of the holder 270 may be coupled to the upper portion, the upper surface or the upper end of the first board unit 255. For example, the holder 270 may be coupled to the first board unit 255 using an adhesive. In another embodiment, for example, the first board unit 255 may be disposed above the holder 270.

The holder 270 may accommodate or support the second coil 230. The holder 270 may support the second coil 230 in the state of being spaced apart from the first board unit 255. For example, at least a portion of the holder 270 may be disposed between the second coil 230 and the first board unit 255.

The holder 270 may have a bore 70 corresponding to one area of the first board unit 255. For example, the bore 70 in the holder 270 may be a through hole which is formed through the holder 270 in the optical axis direction. For example, the bore 70 in the holder 270 may correspond to, face or overlap the image sensor 810 in the optical axis direction.

Although the bore 70 in the holder 270 may have a polygonal shape, for example, a quadrangular shape, a circular shape, or an elliptical shape when viewed from above, the disclosure is not limited thereto. The bore 70 may have any of various shapes.

For example, the bore 70 in the holder 270 may be configured to have such a shape or a size as to expose the image sensor 810, a portion of the upper surface of the first circuit board 250, a portion of the upper surface of the second circuit board 260, and the elements. For example, the surface area of the bore 70 in the holder 270 may larger than the surface area of the image sensor 810, and may be smaller than the surface area of the bore 250A in the first circuit board 250.

The holder 270 may have therein the holes 41A, 41B and 41C corresponding to the second position sensors 240. For example, the holder 270 may have therein the holes 41A, 41B and 41C, which are formed at positions respectively corresponding to the first to third sensors 240A, 240B and 240C.

For example, the holes 41A, 41B and 41C may be positioned adjacent to the corners of the holder 270. The holder 270 may further have a dummy hole 41D formed adjacent to the corner of the holder 270, which does not correspond to any of the second position sensors 240. The dummy hole 41D may serve to achieve weight equilibrium of the OIS moving unit during OIS operation. The dummy hole 41D may be a through hole. In another embodiment, the dummy hole 41D may not be formed. The holes 41A, 41B and 41C may be formed through the holder 270 in the optical axis direction. In another embodiment, the holes 41A, 41B and 41C in the holder 270 may be omitted.

The upper surface of the holder 270 may be provided with at least one coupling protrusion 51, configured to be coupled to the second coil 230. The coupling protrusion 51 may project from the upper surface of the holder 270 in an upward direction or in a direction toward the AF operation unit. For example, the coupling protrusion 51 may be formed adjacent to each of the holes 41A to 41D in the holder 270.

For example, two coupling protrusions 51A and 51B may be disposed or arranged at the holder 270 so as to correspond to each of the holes 41A to 41D in the holder 270. For example, each of the holes 41A, 41B, 41C and 41D in the holder 270 may be positioned between the two coupling protrusions 51A and 51B.

The holder 270 may include one or more projections 27A and 27B. The projections 27A and 27B may project from the upper surface of the holder 270. For example, the projections 27A and 27B may project from the outer surface of the holder 270 in the optical axis direction or in an upward direction.

For example, the holder 270 may include the two projections 27A and 27B which face or overlap each other in the second horizontal direction (for example, in the x-axis direction).

For example, the holder 270 may include four side portions (or side plates), and the projections 27A and 27B may be respectively formed at two side portions among the four side portions. For example, each of the projections 27A and 27B may be disposed or positioned in the center of a corresponding side portion (or side plate) of the holder 270.

The holder 270 may include a groove 341a. The groove 341a may be an adhesive-receiving groove. The groove 341a may be formed in the outer surface of each of the projections 27A and 27B. The groove 341a may be formed in the upper surface of each of the projections 27A and 27B. The groove 341a may be formed from the upper surface to the lower surface of each of the projections 27A and 27B. An adhesive for bonding the support board 310 to the holder 270 may be disposed in the groove 341a. The groove 341a may include a plurality of grooves. For example, the groove 341a may extend in the optical axis direction. In another embodiment, the groove in the holder 270 may extend in a direction perpendicular to the optical axis.

The first board unit 255 may include the first circuit board 250 and the second circuit board 260 which are electrically connected to each other. The second circuit board 260 may alternatively be referred to as a “sensor board”. In another embodiment, the heat radiating member 280 may be included in the first board unit 255.

The first board unit 255 may be disposed on the lower surface of the holder 270. For example, the first board unit 255 may be coupled to the lower surface of the holder 270. For example, the first circuit board 250 may be disposed on and/or coupled to the lower surface of the holder 270. For example, a first surface of the first circuit board 250 may be coupled or attached to the lower surface of the holder 270 using an adhesive member.

Here, the first surface of the first circuit board 250 may be opposed to or face the AF operation unit, and may be a surface on which the second position sensor 240 is disposed. The second surface of the first circuit board 250 may be a surface opposite the first surface of the first circuit board 250.

The first circuit board 250 may alternatively be referred to as a “sensor board”, a “main board”, a “main circuit board”, a “sensor circuit board”, a “moving circuit board” or the like. In all the embodiments, the first circuit board 250 may alternatively be referred to as a “second board” or a “second circuit board”, and the second circuit board 260 may alternatively be referred to as a “first board” or a “first circuit board”.

The second position sensor 240 (240A, 240B and 240C) may be disposed on the first circuit board 250 in order to detect movement of the OIS moving unit in a direction perpendicular to the optical axis and/or rotation, tilting or rolling of the OIS moving unit relative to the optical axis. Furthermore, a controller 830 and/or a circuit element (for example, a capacitor) may be disposed on the first circuit board 250.

The first circuit board 250 may include first terminals E1 to E8 to be electrically connected to the second coil 230. Here, the first terminals E1 to E8 may alternatively be referred to as “first pads” or “first bonding portions”. The first terminals E1 to E8 of the first circuit board 250 may be disposed or arranged on a first surface 60A of the first circuit board 250. For example, the first circuit board 250 may be a printed circuit board or a flexible printed circuit board (FPCB).

The first circuit board 250 may have the bore 250A which corresponds to or faces the bores of the lens module 400 and the bobbin 110. For example, the bore 250A in the first circuit board 250 may be a through hole or a cavity which is formed through the first circuit board 250 in the optical axis direction, and may be formed in the center of the first circuit board 250.

When viewed from above, the shape of the first circuit board 250, for example, the outer peripheral shape of the first circuit board 250 may have a shape which coincides with or corresponds to the holder 270, for example, a quadrilateral shape. When viewed from above, the bore 250A in the first circuit board 250 may have a polygonal shape, for example, a quadrilateral shape, a circular shape or an elliptical shape. For example, the bore 250a in the first circuit board 250 may open or expose the image sensor 810 and/or the bore 260A in the second circuit board 260.

The first circuit board 250 may include at least one terminal 251 to be electrically connected to the second circuit board 260. The terminal 251 of the first circuit board 250 may alternatively be referred to as a “pad” or a “bonding portion”. The terminal 251 of the first circuit board 250 may be disposed or arranged on the lower surface of the first circuit board 250.

For example, the terminal 251 may include a plurality of terminals, and the plurality of terminals 251 may be disposed and arranged in a region between the bore 250A in the first circuit board 250 and one side of the first circuit board 250 in a direction parallel to the one side. For example, the plurality of terminals 251 may be arranged so as to surround the bore 250A.

The second circuit board 260 may be disposed below the first circuit board 250. The second circuit board 260 may be electrically connected to the image sensor 810.

When viewed from above, although the second circuit board 260 may have a polygonal shape (for example, a quadrilateral shape, a square shape, or a rectangular shape), the disclosure is not limited thereto. In another embodiment, the second circuit board 260 may have a circular shape or an elliptical shape.

For example, the surface area of the outer periphery of the second circuit board 260 may be larger than the surface area of the bore 250A in the first circuit board 250. For example, the lower side of the bore 250A in the first circuit board 250 may be shielded or blocked by means of the second circuit board 260.

For example, when viewed from above or underneath, the outer surface (or outer side) of the second circuit board 260 may be positioned between the outer surface (or side) of the first circuit board 250 and the bore 250A in the first circuit board 250.

For example, the second circuit board 260 may have the bore 260A corresponding to the bore 250A in the first circuit board 250 and/or the image sensor 810. The bore 260A in the second circuit board 260 may be a hole or a cavity which is formed through the second circuit board 260, and may be formed in the center of the second circuit board 260.

For example, the bore 260A in the second circuit board 260 may open or expose the image sensor 810. For example, the image sensor 810 may be disposed in the bore 260A in the second circuit board 260, and may be electrically connected to the second circuit board 260. For example, the image sensor 810 may be electrically connected to the second circuit board 260 via a wire.

In another embodiment, the bore 260A may not be formed in the second circuit board 260, and the image sensor 810 may be disposed on the upper surface of the second circuit board 260.

In another embodiment, the heat radiating member 280 may be omitted. In the embodiment in which the heat radiating member 280 is omitted, the bore 260A may not be formed in the second circuit board 260 and the image sensor 810 may be disposed on the upper surface of the second circuit board 260.

In the embodiment in which the heat radiating member 280 is omitted, for example, the image sensor 810 may be disposed on the upper surface of a single board in which the first circuit board and the second circuit board are integrally formed.

The second circuit board 260 may include at least one terminal 261 which is electrically connected to the at least one terminal 251 of the first circuit board 250. For example, the terminal 261 of the second circuit board 260 may include a plurality of terminals.

When viewed from above in FIG. 51, although the shape of the terminal 261 of the second circuit board 260 is a circular shape, the shape may be a polygonal shape, for example, a quadrilateral shape in another embodiment. For example, the shape of the terminal 261 of the second circuit board 260 may be a square shape or a rectangular shape.

For example, at least one terminal 261 of the second circuit board 260 may be formed on the side surface or the outer surface of the second circuit board 260 which connects the upper surface and the lower surface of the second circuit board 260 to each other. The upper surface of the second circuit board 260 may be a surface that faces the first circuit boar 250, and the lower surface of the second circuit board 260 may be a surface opposite the upper surface of the second circuit board. For example, the terminal 261 may have the form of a groove having a structure that is depressed from the side surface of the second circuit board 260. Alternatively, for example, the terminal 261 may have the form of a circular or semielliptical via formed in the side surface of the second circuit board 260. In another embodiment, at least one terminal of the second circuit board 260 that is electrically connected to the second terminal 251 of the first circuit board 250 may be formed on the upper surface of the second circuit board 260.

For example, the terminal 261 of the second circuit board 260 may be coupled to the terminal 251 of the first circuit board 250 so as to electively connect the second circuit board 260 to the first circuit board 250 via the conduction path portion 901. As illustrated in FIGS. 13 and 15, the conduction path portion 901 may include four conduction path portions which are disposed so as to be spaced apart from one another. The conduction path portion 901 may couple the terminal 261 of the second circuit board 260 to the terminal 251 of the first circuit board 250 and may electrically connect them to each other.

For example, each of the first and second circuit boards 250 and 260 may be a printed circuit board or a flexible printed circuit board (FPCB). At least one of the first and second circuit boards 250 and 260 may be an organic substrate or a ceramic board.

The heat radiating member 280 may be disposed on or coupled to the first board unit 255. For example, the heat radiating member 280 may be disposed on or coupled to the second circuit board 260. For example, the heat radiating member 280 may be disposed below the second circuit board 260. For example, the heat radiating member 280 may be coupled or fixed to the lower surface of the second circuit board 260. For example, at least a portion of the upper surface of the heat radiating member 280 may be coupled or fixed to the lower surface of the second circuit board 260.

The term “heat radiating member” may be used interchangeably with “heat radiating sheet”, “heat radiating tape”, “heat radiating layer”, “heat radiating film”, “heat radiating board”, “heat radiating plate”, or “heat radiating body”.”

In another embodiment, the heat radiating member 280 may be included in the first board unit 255, and the image sensor 810 may be disposed on the first board unit 255.

The bore 260A in the second circuit board 260 may open or expose at least a portion of the heat radiating member 280. The image sensor 810 may be disposed on or attached or coupled to at least a portion of the heat radiating member 280 that is exposed through the bore 260A. For example, the image sensor 810 may be fixed, attached or coupled to the heat radiating member 280 using an adhesive. For example, the image sensor 810 may be disposed on the first board unit 255.

For example, at least an area of the upper surface of the heat radiating member 280 may be exposed through the bore 260A, and the image sensor 810 may be disposed on or attached or coupled to the at least an area of the upper surface of the heat radiating member 280 that is exposed through the bore 260A.

In another embodiment, the second circuit board 260 may include a groove formed in the lower surface thereof in order to receive or dispose the heat radiating member 280 therein.

In another embodiment, the second circuit board 260 may not have formed therein the bore 260A, and the heat radiating member 280 may be fixed, attached or coupled to the lower surface of the second circuit board 260. In a further embodiment, the heat radiating member 280 may be omitted.

For example, the heat radiating member 280 may be a plate-shaped member having predetermined thickness and hardness. The heat radiating member 280 may improve an effect of radiating heat, generated from the heat source of the first board unit 255, toward the outside. Here, the heat source of the first board unit 255 may be an electronic element (or a circuit element) disposed on the first board unit 255, for example, the image sensor 810, the controller 830, the second position sensor 240 and/or the capacitor.

For example, the heat radiating member 280 may include a metal material which has high thermal conductivity and high heat radiation efficiency, for example, at least one of stainless steel, aluminum, nickel, phosphorus, bronze, or copper.

The heat radiating member 280 may serve to stably support the image sensor 810, and may serve as a reinforcing material for suppressing breakage of the image sensor 810 attributable to external shock or contact.

In another embodiment, the heat radiating member 280 may be made of a heat radiating member having high thermal conductivity, for example, exothermic epoxy, exothermic plastic (for example, polyimide), or exothermic synthetic resin.

In an embodiment, for example, the term “heat radiating member” may be used interchangeably with “heat radiating body”, “heatsink”, “heat radiating plate”, “heat radiating sheet”, “plate”, “metal plate”, “reinforcing material”, or “stiffener”.

In order to improve heat radiation efficiency, the heat radiating member 280 may include a predetermined pattern having at least one groove or at least one unevenness. For example, a groove or an unevenness having a predetermined pattern may be formed in the lower surface of the heat radiating member 280.

For example, the predetermined pattern may include a plurality of grooves which are spaced apart from each other at a predetermined interval. For example, the predetermined pattern may have the shape of a stripe. In another embodiment, the predetermined pattern may have the shape of a net or a mesh. In a further embodiment, the predetermined pattern may have a shape having dots which are spaced apart from each other. For example, each of the dots may have a circular shape, an elliptical shape or a polygonal shape (for example, a quadrilateral shape).

In another embodiment, the predetermined pattern may be formed on at least one of the upper surface, the lower surface or the outer surface of the heat radiating member 280. In a further embodiment, the radiating member 280 may include a hole or a through hole in place of the groove or the unevenness. Because the heat radiating member 280 moves together with the OIS moving unit, the heat radiating member 280 may be spaced apart from the stationary unit, for example, the second board unit 800.

Although the first circuit board 250 and the second circuit board 260 are electrically coupled to each other using the conduction path portion 901 in FIG. 45, the first board and the second board may be embodied as a single integrated circuit board in another embodiment.

The second coil 230 may be disposed on or coupled to the OIS moving unit. For example, the second coil 230 may be disposed on the holder 270. The second coil 230 may be disposed on the upper surface of the holder 270. The second coil 230 may be disposed below the magnet 130.

The second coil 230 may be coupled to the holder 270. For example, the second coil 230 may be coupled or attached to the upper surface of the holder 270. For example, the second coil 230 may be coupled to the coupling protrusion 51 of the holder 270. The second coil 230 may move the OIS moving unit by virtue of the interaction with the magnet 130.

For example, the second coil 230 may correspond to, face or overlap the magnet 130 disposed on the stationary unit in the direction of the optical axis OA. In another embodiment, the stationary unit may include a dedicated OIS magnet independent of the magnet of the AF operation unit, and the second coil may correspond to, face or overlap the dedicated OIS magnet. Here, the OIS magnet may include the same number of OIS magnets as the number of coil units included in the second coil 230.

In a further embodiment, the OIS magnet may be disposed on the stationary unit of the second coil 230, and the OIS magnet 71B of the magnet 130 may be disposed on the OIS moving unit. Here, the second coil 230 may be electrically connected to the support board 310 and/or the second board unit 800 via a conductive member.

For example, the second coil 230 may include a plurality of coil units 230-1 to 230-4. For example, the second coil 230 may include four coil units 230-1 to 230-4 disposed on the four corners of the holder 270. For example, at least a portion of each of the coil units 230-1 to 230-4 may be disposed on a corresponding one of the corners of the holder 270. A portion of each of the coil units 230-1 to 230-4 may be disposed on a side portion adjacent to a corresponding one of the corners of the holder 270.

Each of the coil units 230-1 to 230-4 may have the form of a coil block having a closed loop or ring shape. For example, each of the coil units may have a cavity or a hole. For example, each of the coli units may be composed of a fine pattern (FP) coil, a wound coil or a coil block. For example, the cavity or the hole in each of the coil units 230-1 to 230-4 may be fitted over or coupled to the protrusion 51 of the holder 270.

In another embodiment, the second coil 230 may be disposed on the first circuit board 250, and may be coupled to the first circuit board 250.

The second coil 230 may be electrically connected to the first circuit board 250. For example, the first coil unit 230-1 may be conductively connected to two terminals E1 and E2 of the first circuit board 250, and the second coil unit 230-2 may be electrically connected to two other terminals E3 and E4. Furthermore, the third coil unit 230-2 may be electrically connected to two other terminals E5 and E6 of the first circuit board 250, and the fourth coil unit 230-4 may be electrically connected to the two other terminals E7 and E8 of the first circuit board 250.

Power or drive signals may be supplied to the first to fourth coil units 230-1 to 230-4 through the first circuit board 250. The power or drive signal supplied to the second coil 230 may be a DC signal, an AC signal or a signal containing both DC and AC components, and may be of a voltage type or a current type.

By virtue of the interaction between the first to fourth magnet units 130-1 to 130-4 and the first to fourth coil units 230-1 to 230-4, the OIS moving unit may be moved in the first horizontal direction or in the second horizontal direction or may be rolled relative to the optical axis.

For example, current may be independently applied to at least three coil units among the four coil units 230-1 to 230-4. In another embodiment, current may be independently applied to at least two coil units among the four coil units 230-1 to 230-4.

For example, an independent drive signal, for example, independent drive current, may be supplied to each of the four coil units 230-1 to 230-4.

The controller 830 and 70 may supply at least one drive signal to at least one of the first to fourth coil units 230-1 to 230-4, and may move the OIS moving unit in the x-axis direction and/or in the y-axis direction or may rotate the OIS moving unit within a predetermined angle range about the optical axis by controlling the at least one drive signal. Hereinafter, the “controller” may be at least one of the controller 830 of the camera device 10 or the controller 780 of the optical instrument 200A.

When the second coil 230 is driven through three channels, three independent drive signals may be supplied to the second coil 230. For example, among the four coil units, two coil units (for example, 230-2 and 230-4 or 230-1 and 230-3), which are diagonally opposed to each other, may be connected to each other in series, and one drive signal may be supplied to the two coil units, which are connected to each other in series. Independent drive signals may be respectively supplied to the two other coil units among the four coil units.

Alternatively, when the second coil 230 is driven through four channels, independent drive signals may be respectively supplied to the four coil units 230-1 to 230-4, which are separated from each other.

The description of FIGS. 18A to 18D may be applied to the embodiment shown in FIGS. 33 to 57 with or without modification. The description of the second sensor 240 shown in FIGS. 1 to 32 may be applied to the embodiment shown in FIGS. 33 to 57 with or without modification.

The base 210 may be disposed below the first board unit 255. The base 210 may be spaced apart from the first board unit 255. The base 210 may have a polygonal shape, for example, a quadrilateral shape, which coincides with or corresponds to the cover member 300 or the first board unit 255.

For example, the base 210 may have the bore 210A which corresponds to or faces the first board unit 255. The bore 210A in the base 210 may be a through hole which is formed through the base 210 in the optical axis direction. In another embodiment, the base may not have the bore.

For example, the base 210 may be coupled to the side plate 302 of the cover member 300. The side portion or the outer surface of the base 210 may include a step 211 (see FIG. 14) to which an adhesive is applied when the side portion or the outer surface is bonded to the side plate 302 of the cover member 300. Here, the step 211 may guide the side plate 302 of the cover member 300 which is coupled to the upper side thereof. The step 211 of the base 210 and the lower end of the side plate 302 of the cover member 300 may be bonded or fixed to each other using an adhesive or the like.

The base 210 may include one or more projections 216A and 216B projecting from the upper surface thereof. For example, the projections 216A and 216B may project upwards from the outer surface of the base 210. For example, the base 210 may include two projections 216A and 216B which face or overlap each other in the first horizontal direction (for example, in the y-axis direction).

For example, the base 210 may include four side portions (or side plates), and the projections 216A and 216B may be formed at two of the four side portions. For example, the projections 216A and 216B may be disposed or positioned in the center of the side portion (or the side plate) of the base 210.

The base 210 may include a groove 341B. The groove 341b may be an adhesive-receiving groove. The groove 341b may be formed in the outer surface of a corresponding one of the projections 216A and 216B of the base 210. The groove 341b may be formed in the upper surface of a corresponding one of the projections 216A and 216B of the base 210. The groove 341b may be formed from the upper surface to the lower surface of a corresponding one of the projections 216A and 216B. An adhesive may be disposed in the groove 341b in order to bond the support board 310 to the base 210. The groove 341b may include a plurality of grooves. For example, the groove 341b may extend in the optical axis direction. In another embodiment, the groove formed in a corresponding one of the projections 216A and 216B of the base 210 may extend in a direction perpendicular to the optical axis.

The second board unit 800 may be disposed below the base 210. For example, the second board unit 800 may be disposed so as to be spaced apart from the OIS moving unit, for example, the first board unit 255 and the heat radiating member 280 in the optical axis direction.

For example, the second board unit 800 may be disposed below the lower surface of the base 210. The second board unit 800 may be coupled to the base 210. The second board unit 800 may be coupled to the base 210. For example, the second board unit 800 may be coupled to the lower surface of the base 210.

The second board unit 800 may serve to supply a signal to the image sensor unit 350 from the outside or to output the signal transmitted from the image sensor unit 350 to the outside.

The second board unit 800 may include a first region 801 (or a first board), which corresponds to, faces or overlaps the AF operation unit 100 or the image sensor 810 in the optical axis direction, a second region 802 (or a second board) on which a connector 804 is disposed, and a third region 803 (or a third board) connecting the first region 801 to the second region 802. The connector 804 may include a port which is to be electrically connected both to the second region 802 of the second board unit 800 and to an external device (for example, the optical instrument 200A). The bore 210A in the base 210 may be closed or blocked by the first region 801 of the second board unit 800.

The first region 801 of the second board unit 800 may correspond to, face or overlap at least one of the cover member 300 or the base 210 in the optical axis direction. For example, the first region 801 may overlap the upper plate 301 and the side plate 302 of the cover member 300 in the optical axis direction.

Each of the first region 801 and the second region 802 of the second board unit 800 may include a rigid substrate. The third region 803 may include a flexible substrate. Each of the first region 801 and the third region 802 may further include a flexible substrate.

In another embodiment, at least one of the first to third regions 801 to 803 of the circuit board 800 may include at least one of a rigid substrate or a flexible substrate.

The second board unit 800 may be disposed behind the first board unit 255. For example, the first board unit 255 may be disposed between the AF operation unit 100 and the second board unit 800. In another embodiment, the second board unit may be disposed between the AF operation unit and the first board unit.

Although the first region 801 of the second board unit 800 may have a polygonal shape (for example, a quadrilateral shape, a square shape or a rectangular shape) when viewed from above, the disclosure is not limited thereto. In another embodiment, the first region 801 may have a circular shape or the like.

The description of FIGS. 20A and 20B may be applied to the embodiment shown in FIGS. 33 to 57 with or without modification.

The description of the support board 1310 shown in FIGS. 1 to 32 may be applied to the support board 310 according to the embodiment shown in FIGS. 33 to 57 with or without modification.

FIG. 49A is a first perspective view of the support board 310 coupled both to the holder 270 and to the base 210. FIG. 49B is a second perspective view of the support board 310 coupled both to the holder 270 and to the base 210.

Referring to FIGS. 49A and 49B, the holder 270 may include first to fourth side portions 64A to 64D (see FIG. 18A) which correspond to or face the first to fourth side portions 33A to 33D of the first circuit board 250.

The first and second side portions 64A and 64B of the holder 270 may be opposed to each other or may be disposed on opposite sides in the second horizontal direction (for example, in the x-axis direction). Furthermore, the third and fourth side portions 64C and 64D of the holder 270 may face each other or may be positioned at opposite sides in the first horizontal direction (for example, in the y-axis direction).

At least a portion of the support board 310 may be attached or coupled to the holder 270. For example, at least one of the connecting portions 320A and 320B of the support board 310 may be coupled to at least one of the first to fourth side portions 64A to 54D of the holder 270 using an adhesive. For example, the first connecting portion 320A may be coupled, attached or fixed to the first side portion 64A of the holder 270 using an adhesive, and the second connecting portion 320B may be coupled, attached or fixed to the second side portion 64B of the holder 270.

The first side portion 64A of the holder 270 may be provided with the first projection 27A, and the second side portion 64B of the holder 270 may be provided with the second projection 27B.

The support board 310 may be coupled, attached or fixed to the projections 27A and 27B of the holder 270. The support board 310 may be coupled, attached or fixed to the outer surfaces (or the inner surfaces) of the projections 27A and 27B of the holder 270.

For example, a portion of the support board 310 may be coupled, attached or fixed to the first projection 27A and the second projection 27B of the holder 270. The bodies 86 and 87 of the support board 310 may be coupled, attached or fixed to the first and second projections 27A and 27B of the holder 270.

For example, the first support board 310-1 may be coupled, attached or fixed to the first projection 27A, and the second support board 310-2 may be coupled, attached or fixed to the second projection 27B. For example, the first portion 6A of the first body 86 may be coupled, attached of fixed to the outer surface (or the inner surface) of the first projection 27A, and the first portion 9A of the second body 87 may be coupled, attached or fixed to the outer surface (or the inner surface) of the second projection 27B.

The base 210 may include first to fourth side portions 65A to 65D (see FIG. 14) which correspond to or face the first to fourth side portions 33A to 33D of the first circuit board 250. The first to fourth side portions 65A to 65D of the base 210 may correspond to or face the first to fourth side portions 64A to 64D of the holder 270.

The first and second side portions 65A and 65B of the base 210 may face each other or may be disposed on opposite sides in the first horizontal direction (for example, in the y-axis direction). Furthermore, the third and fourth side portions 65C and 65D of the base 210 may face each other or may be disposed on opposite sides in the second horizontal direction (for example, in the x-axis direction).

At least a portion of the support board 310 may be coupled, attached or fixed to the base 210. For example, the bodies 86 and 87 of the support board 310 may be coupled to the base 210 using an adhesive. For example, portions of the bodies 86 and 87 of the support board 310, which are connected to the extensions 7A to 7D, may be coupled to the base 210.

For example, at least a portion of the support board 310 may be coupled, attached or fixed to the projections 216A and 216B formed on the base 210. For example, the support board 310 may be coupled, attached or fixed to the outer surfaces (or the inner surfaces) of the projections 216A and 216B of the base 210. The first projection 216A may be formed on the third side portion 65C of the base 210, and the second projection 216B may be formed on the fourth side portion 65D of the base 210.

For example, the bodies 86 and 87 of the support board 310 may be coupled, attached or fixed to the first and second projections 216A and 216B of the base 210.

For example, one end (for example, the second portion 6B) of the first support board 310-1 may be coupled, attached or fixed to one area of the first projection 216A of the base 210, and the other end (for example, the third portion 6C) of the first support board 310-1 may be coupled, attached or fixed to one area of the second projection 216B of the base 210.

For example, one end (for example, the second portion 9B) of the second support board 310-2 may be coupled, attached or fixed to another area of the first projection 216A of the base 210, and the other end (for example, the third portion 9C) of the second support board 310-2 may be coupled, attached or fixed to another area of the second projection 216B of the base 210.

A first coupling area 69A may be defined between the first body 86 of the first support board 310-1 and the first projection 27A, and a second coupling area 69B may be defined between the second body 87 of the second support board 310-2 and the second projection 27B of the holder 270.

Furthermore, a third coupling area 59A may be defined between one end of each of the first and second support boards 310-1 and 310-2 and the first projection 216A of the base 210. A fourth coupling area 59B may be defined between the other end of each of the first and second support boards 310-1 and 310-2 and the second projection 216B of the base 210.

By virtue of the support board 310 and the first to fourth coupling areas 69A, 69B, 59A and 59B, the OIS moving unit may be flexibly supported with regard to the stationary unit. The terminals 311 of the support board 310 may be coupled to and electrically connected to the terminals 800B of the second board unit 800 using solder 902 (see FIGS. 17A and 17B) or a conductive adhesive.

In another embodiment, for example, the support member may be an elastic member excluding the board, for example, a spring, a wire, shape-memory alloy or a ball member. For example, when the support member is made of a wire, a plurality of wires may be disposed on at least one of the corners and side portions of the base 210 or the second board unit 800 in order to connect the first board unit 255 (for example, the second circuit board 260) to the second board unit 800 (or the base 210). For example, one end of each of the plurality of wires may be coupled to the first board unit 255 (for example, the second circuit board 260), and the other end of each of the plurality of wires may be coupled to the second board unit 800 (or the base 210).

The image sensor unit 350 may include at least one of the controller 830, a memory 512 or a capacitor 514.

The controller 830 may be disposed so as to be spaced apart from the first board unit 255. For example, the controller 830 may be disposed on the second board unit 800.

The memory 512 may be disposed on one of the first board unit 255 and the second board unit 800. For example, the memory 512 may be disposed or mounted on the first region 801 of the second board unit 800. For example, the memory 512 may avoid spatial interference with the heat radiating member 380 or may be spaced apart from the heat radiating member 380. For example, the heat radiating member 380 may include an escape groove or opening for avoiding spatial interference with the memory 512, and the memory 512 may be disposed in the escape groove or opening in the heat radiating member 380. The capacitor 514 may be disposed on at least one of the first board unit 255 or the second board unit 800.

The memory 512 may store a first data value (or a code value) corresponding to the output of the second position sensor 240 according to displacement (or stroke) of the OIS moving unit in a direction perpendicular to the optical axis (for example, in the x-axis direction or in the y-axis direction) for OIS feedback operation. Furthermore, the memory 512 may store a first data value (or a code value) corresponding to the output of the first position sensor 170 according to displacement (or stroke) of the bobbin 110 in the first direction (for example, in the optical axis direction or in the z-axis direction) for AF feedback operation.

For example, each of the first and second data values may be stored in the memory 512 in a look-up table format. Furthermore, the memory 512 may store a mathematical formula, an algorithm or a program for operation of the controller 830. For example, the memory 512 may be a non-volatile memory, for example, an electrically erasable programmable read-only memory (EEPROM).

The controller 830 may be positioned outside of the cover member 300 or may be disposed on one region of the second board unit 800 which is positioned outside the cover member 300.

The second board unit 800 may include the extension region 808 which is connected to the first region 801 and extends therefrom. The extension region 808 may extend from the first side portion 85A of the first region 801. For example, the extension region 808 may project from the outer surface of the first side portion 85A of the first region. For example, the extension region 808 may project from the outer surface of the first side portion 85A of the first region. For example, the extension region 808 may extend or project in the second horizontal direction (for example, in the x-axis direction).

The extension region 808 may be positioned outside the cover member 300 or may be positioned at an outer side of the cover member 300.

The extension region 808 may alternatively be referred to as a “fourth region”, a “projecting region”, an “extension portion”, or a “projecting portion”. The extension region 808 may not overlap the AF moving unit and the OIS moving unit in the optical axis direction. For example, the extension region 808 may extend in the same direction (for example, in the second horizontal direction) as the third region 803.

The controller 830 may be disposed in the extension region 808 of the second board unit 800. For example, the controller 830 may be disposed or mounted on the upper surface of the extension region 808 of the second board unit 800. In another embodiment, the controller 830 may be disposed or mounted on the lower surface of the extension region 808. For example, the controller 830 may not overlap the cover member 300 in the optical axis direction. For example, the extension region 808 may not overlap the cover member 800 in the optical axis direction. For example, the surface area of the upper surface of the extension region 808 may be equal to or larger than the surface area of the lower surface of the controller 830.

Because the extension region 808 and the third region 803 are connected to the first side portion 85A of the second board unit 800, it is possible to reduce the surface area that is occupied by the camera device 10 in a direction perpendicular to the optical axis. Therefore, the embodiment is able to reduce increase in the size of the camera device 10 attributable to the extension region 808.

In another embodiment, the extension region may be connected to one of second to fourth side portions 85B, 85C and 85D of the first region 801 of the second board unit 800, and may project from one of the second to fourth side portions 85B, 85C and 85D of the first region 801.

The controller 830 may be positioned outside the cover member 300 or may be positioned at the outer side of the cover member 300. For example, the controller 830 may be positioned outside the space defined between the cover member 300, the base 210 and the first region 801 of the second board unit 800.

For example, the controller 830 may not overlap the lens module 400, the AF moving unit, the OIS moving unit, and the first region 801 of the second board unit 255 in the optical axis direction. At least one capacitor 514 may be disposed or mounted on the upper surface of the extension region 808.

Because the OIS moving unit including the image sensor and the first board unit is disposed so as to be spaced apart from the stationary unit including the second board unit in a sensor-shift-type camera device in which the image sensor is moved for hand tremor correction, it may be insufficient to radiate heat generated by the OIS moving unit to the outside through the stationary unit. In addition, the sensor-shift-type camera device may have a structure in which the AF operation unit and the OIS operation unit are confined in the cover member in order to inhibit malfunction caused by foreign substances, and thus it may not be easy to radiate heat to the outside of the camera device.

The image sensor, the second coil, and the controller may correspond to the heat-generating source. Here, the “controller” may be a driver IC configured to control AF operation and/or OIS operation.

The camera device 10 may include a radiating member 870 which is disposed, coupled or attached to the extension region 808 in order to improve efficiency of heat radiation. The radiating member 870 may be in contact with the extension region 808. For example, the radiating member 870 may be disposed below the extension region 808. For example, the radiating member 870 may be disposed, coupled or fixed to the lower surface of the extension region 808. The radiating member 870 may be a plate-shaped member, and the description of the material of the heat radiating member 280 may be applied to the radiating member 870 with or without modification. At least a portion of the radiating member 870 may overlap the controller 830 in the optical axis direction.

The camera device 10 may include a cover can 405 which is disposed in the extension region 808 and accommodates the controller 830 therein in order to protect the controller 830 from external shock. The cover can 405 may include an upper plate 405A and a side plate 405B which is connected to the upper plate 405A and extends toward the extension region 808 from the upper plate 405A.

The cover can 405 may be disposed, coupled or fixed to the upper surface of the extension region 808. For example, the lower portion, the lower end or the lower surface of the side plate 405B of the cover can 405 may be coupled, attached or fixed to the upper surface of the extension region 808.

Because the cover can 405 accommodates the controller 830 therein, it is possible to inhibit the heat generated by the controller 830 from being radiated to the outside and being transmitted to the image sensor. The description of the material of the heat radiating member 280 or the cover member 300 may be applied to the cover can 405 with or without modification.

The camera device 10 may further include a heat radiating layer 860 disposed on the controller 830. The heat radiating layer 860 may cover the surface of the controller 830. For example, the heat radiating layer 860 may be disposed so as to surround the surface of the controller 830. For example, the heat radiating layer 860 may be in contact with the upper surface and the side surface of the controller 830 so as to surround the surfaces. The heat radiating layer 860 may be made of exothermic plastic or radiating resin, for example, exothermic epoxy. The heat radiating layer 860 may improve efficiency and performance of heat radiation of the controller 830.

In another embodiment, the radiating layer may be disposed on at least one of the upper surface or the side surface of the controller 830. For example, the radiating layer may expose at least a portion of the controller 830.

The controller 830 may be electrically connected to the second position sensor 240. The controller 830 may adjust or control the drive signal supplied to the second coil 230 and may perform feedback OIS operation using the output signal received from the sensors 240A, 240B and 240C of the second position sensor 240 and the first data value stored in the memory 512.

Furthermore, the controller 830 may be electrically connected to the first position sensor 170. For example, when the first position sensor 170 is embodied as a Hall sensor alone, the first position sensor 170 may be electrically connected to the controller 830. Here, the controller 830 may control the drive signal supplied to the first coil 120 and thus perform feedback autofocusing operation using the output signal of the first position sensor 170 and the second data value stored in the memory 512.

Although the controller 830 may be embodied as a driver IC, the disclosure is not limited thereto. For example, the controller 830 may be electrically connected to the terminals 800B of the second board unit 800.

The controller 830 may control the first position sensor, which is embodied as a Hall sensor alone, and the second position sensor, which is embodied as a Hall sensor alone. For example, the controller 830 may supply a drive signal to the first position sensor, which is embodied as a Hall sensor alone, and/or the second position sensor, which is embodied as a Hall sensor alone, and may receive the output signal of the first position sensor and/or the output signal of the second position sensor.

In another embodiment, the first position sensor may be embodied as a Hall sensor alone, and the second position sensor may be embodied as a drive IC including a Hall sensor. Here, the controller 830 may be electrically connected to the first position sensor, may supply a drive signal to the first position sensor, and may receive the output signal from the first position sensor.

For example, the controller 830 may include a driver configured to drive at least one of the first position sensor or the second position sensor.

The image sensor unit 350 may further include a motion sensor (not shown) which is disposed on one of the first board unit 255 and the second board unit 800. The motion sensor may be electrically connected to the controller 830. The motion sensor may output rotational angular velocity information corresponding to movement of the camera device 10. For example, the motion sensor may be embodied as a biaxial or triaxial gyro sensor or an angular velocity sensor. For example, the motion sensor may output information on amount of movement in the x-axis direction and the y-axis direction and an amount of rotation caused by movement of the camera device 10.

In another embodiment, the motion sensor may be omitted from the camera device 10. In the case in which the motion sensor is omitted from the camera device, the camera device 10 may receive position information about movement of the camera device 10 from the motion sensor provided at the optical instrument 200A.

The image sensor 350 may further include the filter 610 disposed between the lens module 400 and the image sensor 810. The image sensor unit 350 may further include a filter holder 600 in which the filter is disposed, seated or received. The filter holder 600 may alternatively be referred to as a “sensor base”.

The filter 610 may serve to block or allow light of a specific frequency band in the light passing through the lens barrel 400 entering the image sensor 810. For example, the filter 610 may be an infrared-shielding filter. For example, the filter 610 may be disposed parallel to the x-y plane perpendicular to the optical axis OA. The filter 610 may be disposed below the lens module 400.

The filter holder 600 may be disposed under the AF operation unit 100. For example, the filter holder 600 may be disposed on the first board portion 255. For example, the filter holder 600 may be disposed on the upper surface of the second circuit board 260 of the first board unit 255.

The filter holder 600 may be coupled to one area of the second circuit board 260 around the image sensor 810 using an adhesive, and may be exposed through the bore 250A in the first circuit board 250. For example, the bore 250A in the circuit board 250 may expose the filter holder 600 disposed on the second circuit board 260 and the filter 610 disposed on the filter holder 600 therethrough. The filter holder 600 may have therein a bore 61A, which is formed in a region thereof in which the filter 610 is mounted or disposed, so as to allow the light that has passed through the filter 610 to enter the image sensor 810. The bore 61A in the filter holder 600 may be configured to have the form of a through hole, which is formed through the filter holder 600 in the optical axis direction. For example, the bore 61A in the filter holder 600 may be formed through the center of the filter holder 600, and may be positioned so as to correspond to or face the image sensor 810.

The filter holder 600 may have a seating portion 500, in which the filter 610 is seated. The filter 610 may be disposed, seated or mounted in the seating portion 500. The seating portion 500 may be formed so as to surround the bore 61A. In another embodiment, the seating portion 500 of the filter holder 600 may be configured to have the form of a projection, which projects from the upper surface of the filter 610.

The image sensor unit 350 may further include an adhesive disposed between the filter 610 and the seating portion 500, and the filter 610 may be coupled or attached to the filter holder 600 via the adhesive.

In another embodiment, the filter holder may be coupled to the holder 270 or the AF operation unit 100.

The cover member 300 may have the form of a box which is open at the lower portion thereof and includes the upper plate 301 and the side plate 302. The lower portion of the side plate 302 of the cover member 300 may be coupled to the base 210. The upper plate 301 of the cover member 300 may have a polygonal shape, for example, a quadrilateral shape or an octagonal shape. For example, the side plate 302 may include four side plates which are connected to each other. The upper plate 301 of the cover member 300 may have formed therein a bore 303 through which the lens of the lens module 400 coupled to the bobbin 110 is exposed to external light.

The side plate 302 of the cover member 300 may have formed therein a groove 304 through which the terminal 95 of the circuit board 190 and the terminal 800B of the second board unit corresponding to the terminal 95 are exposed.

For example, the cover member 300 may be made of metal. For example, the cover member 300 may be made of SUS (steel use stainless, for example, SUS4 series). Furthermore, the cover member 300 may be made of steel plate cold commercial (SPC). For example, the cover member 300 may be made of SUS containing 50% or more of Fe. In order to inhibit oxidization, antioxidizing metal, for example, nickel may be plated on the surface of the cover member 300. In another embodiment, for example, the cover member 300 may be made of a magnetic material or magnetic metal.

In a further embodiment, the cover member 300 may be made of an injection molding material, for example, plastic or resin. Furthermore, the cover member 300 may be made of an insulative material or a material capable of shielding electromagnetic waves.

The cover member 300 and the base 210 may accommodate therein the AF operation unit 100 and the OIS moving unit. The cover member 300 and the base 210 may protect the AF operation unit 100 and the OIS moving unit from external shock, and may inhibit introduction of foreign substances from the outside.

For example, at the initial position of the OIS moving unit, the outer surface of the holder 270 may be spaced apart from the inner surface of the base 210 by a predetermined distance. For example, at the initial position of the OIS moving unit, the lower surfaces of the holder 270 and the first board unit 255 may be spaced apart from the base 210 by a predetermined distance.

The controller 830 may supply at least one drive signal to at least one of the first to fourth coil units 230-1 to 230-4, and may control the at least one drive signal to move the OIS moving unit in the x-axis direction and/or in the y-axis direction or to rotate, tilt or roll the OIS moving unit relative to the optical axis within a predetermined angle range.

The description of FIG. 21 may be applied to the embodiment shown in FIGS. 33 to 57 with or without modification.

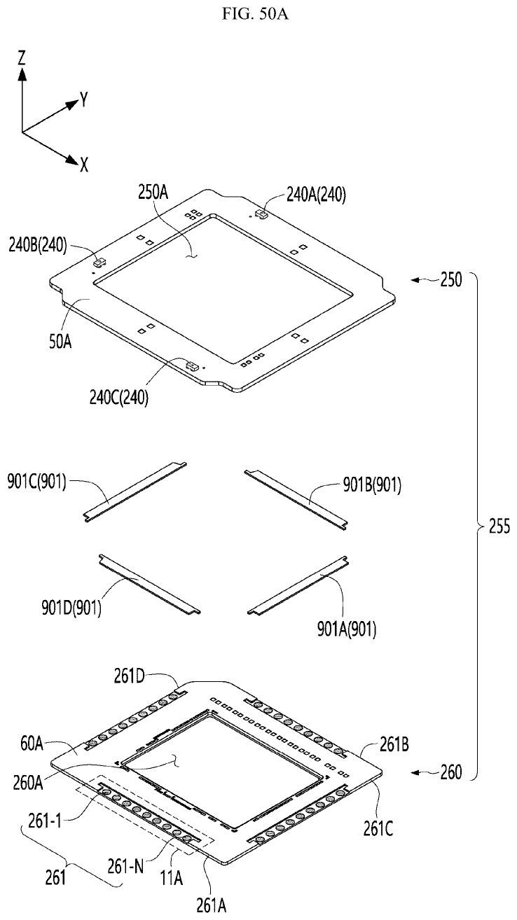

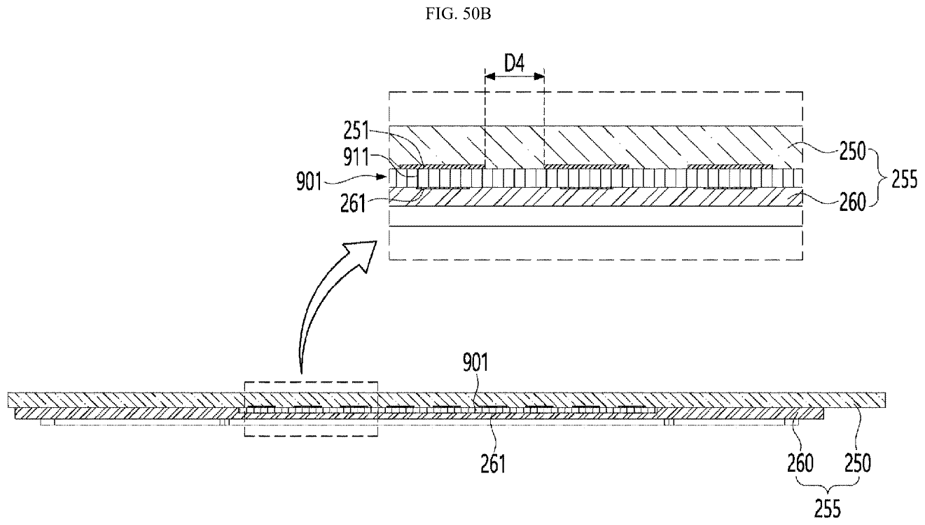

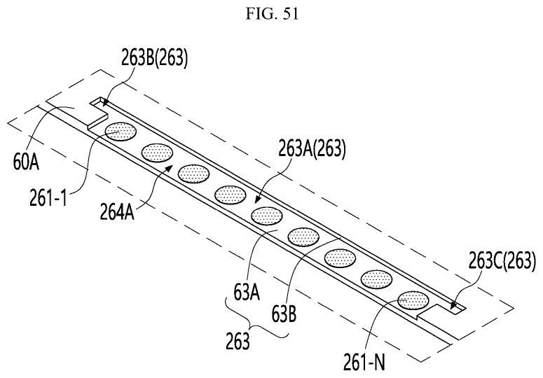

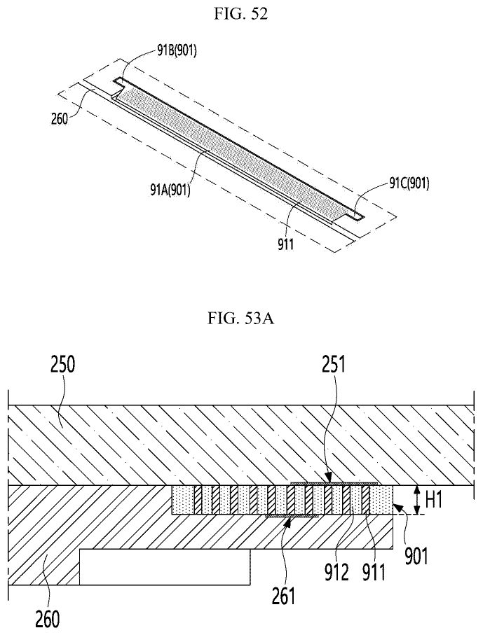

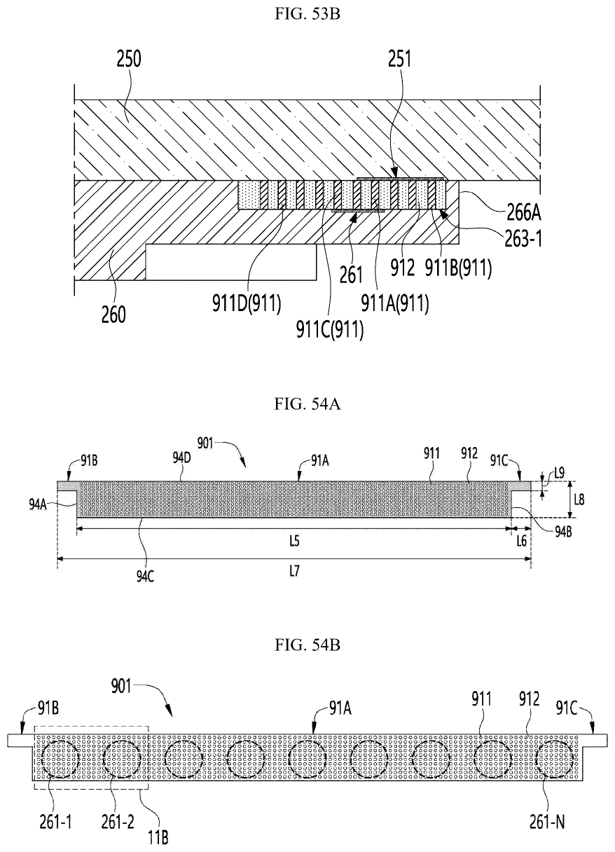

FIG. 50A is an exploded perspective view of the first circuit board 250, the second circuit board 260, and the conduction path portion 901. FIG. 50B is a cross-sectional view the terminal 251 of the first circuit board 250, the terminal 261 of the second circuit board 260, and the conduction path portion 901 in the optical axis direction. FIG. 51 is an enlarged view of the dotted portion 11A in FIG. 50A. FIG. 52 illustrates the conduction path portion 901 disposed in the reception portion 263 of the second circuit board 260. FIG. 53A is a cross-sectional view of the first circuit board 250, the second circuit board 260, and the conduction path portion 901 in the optical axis direction. FIG. 54A is a plan view of the conduction path portion 901. FIG. 54B illustrates the conduction path portion 901 and the terminal 261 of the second circuit board 260. FIG. 54C is an enlarged view of the dotted portion 11B in FIG. 54B.

Referring to FIGS. 50A to 54C, the conduction path portion 901 may include a plurality of conduction path portions 901A to 901D. For example, the plurality of conduction path portions 901A to 901D may be disposed so as to be spaced apart from each other. For example, the conduction path portion 901 may be disposed adjacent to the outer surface (or the outer side) 261A of the second circuit board 260. For example, the conduction path portion 901 may be disposed between the bore 260A in the second circuit board 260 and the outer surface (or the outer side) 261A of the second circuit board 260. For example, each of the plurality of conduction path portions 901A to 901D may be disposed adjacent to a corresponding one of the outer surfaces (or the sides) 261A to 261D of the second circuit board 260. For example, each of the plurality of conduction path portions 901A to 901D may be disposed between the bore 260A in the second circuit board 260 and a corresponding one of the outer surface (or the outer side) of the second circuit board 260.

The second circuit board 260 may include the reception portion 263 in which the conduction path portion 901 is received, seated or disposed. For example, the reception portion 263 may be disposed or formed on the upper surface 60A of the second circuit board 260. For example, the upper surface 60A may be a surface that faces the lower surface of the first circuit board 250, and the lower surface of the first circuit board 250 may be the opposite surface of the upper surface 50A of the first circuit board 250.

For example, the second circuit board 260 may include the reception portion 263 corresponding to the conduction path portion 901. For example, the number of reception portions of the second circuit board 260 may equal the number of conduction path portions 901.

For example, the reception portion 263 may be disposed adjacent to the side (or the outer surface) of the second circuit board 260. For example, the reception portions 263 may be disposed between the bore 260A in the second circuit board 260 and the outer surfaces (or the sides) of the second circuit board 260. For example, each of the plurality of reception portions may be disposed adjacent to a corresponding one of the outer surfaces (or the sides) of the second circuit board 260. For example, each of the plurality of reception portions may be disposed between the bore 260A in the second circuit board 260 and a corresponding one of the outer surfaces (or the sides) of the second circuit board 260.

The reception portion 263 may be a groove depressed from the upper surface 60A of the second circuit board 260. For example, the reception portion 263 may be a groove which is open at the upper surface 60A of the second circuit board 260.

For example, the reception portion 263 may include a bottom surface 63A, which defines a height difference with respect to the upper surface 60A of the second circuit board 260 in the optical axis direction, and a side surface 63B connecting the bottom surface 63A to the upper surface 60A. For example, the bottom surface 63A may be positioned lower than the upper surface 60A of the second circuit board 260, and the lower surface of the second circuit board 260 may be positioned closer to the bottom surface 63A than the upper surface 60A of the second circuit board 260. For example, the reception portion 263 may have a shape identical to the shape of the conduction path portion 901.

For example, the reception portion 263 may include a first region 263A in which a first portion 91A of the conduction path portion 901 including the conduction path portions 911 and second regions 263B and 263C in which second portions 91B and 91B91C of the conduction path portion 901 including couplers are disposed.

The reception portion 263 may have an opening 264a which is open at the side surface (or the outer surface) of the second circuit board 260. When the conduction path portion 901, which is positioned between the second circuit board 260 and the first circuit board 250, is pressed, the opening 264A is able to provide a space capable of releasing stress applied to the conduction path portion 901 and of inhibiting distortion and breakage of the conduction path portion 901 caused by pressing.

The terminal 261 may be disposed in the reception portion 263. For example, the terminal 261 may be disposed in the first region 263A of the reception portion 263. For example, the terminal 261 may be disposed on the bottom surface 63A of the reception portion 253.

For example, the terminal 261 may include a plurality of terminals 261-1 to 261-N disposed in the reception portion 263. For example, the plurality of terminals 261-1 to 261-N may be disposed so as to be spaced apart from each other in a direction parallel to the outer surface (or the side) of the second circuit board 260. For example, the plurality of terminals 261-1 to 261-N may be arranged in a line.

The conduction path portion 901 disposed in the reception portion 263 may not project from the outer surface of the second circuit board 260. In another embodiment, at least a portion of the conduction path portion 901 disposed in the reception portion 263 may project from the outer surface of the second circuit board 260.

The conduction path portion 901 may include an insulating portion 912 and a plurality of conductive portions 911 disposed in the insulating portion 912 so as to be spaced apart from each other. For example, the insulating portion 912 may be an insulative material, for example, rubber or silicone. For example, the insulating portion 912 may include an insulative material having elasticity.

For example, the conductive portion 911 may be a long and thin fiber or wire. Alternatively, the conductive portion 911 may be a wire which is elongated in a direction parallel to the optical axis direction. For example, the conductive portion 911 may be a wire which has a greater length in the optical axis direction than a length (or a diameter) in a direction perpendicular to the optical axis. In another embodiment, the conductive portion 911 may have a ball shape.

For example, the conductive portion 911 may include a conductive body, for example, a metal or a metal alloy. For example, the conductive portion 011 may include at least one of gold, copper, silver, iron, bronze, chrome (Cr), beryllium (Be), zinc or aluminum, or may be made of an alloy including at least one thereof.

For example, the conductive portions 911 may be arranged so as to include a plurality of rows. Furthermore, the conductive portions 911 may be arranged so as to include a plurality of columns. Furthermore, the conductive portions may be arranged so as to include a plurality of rows and a plurality of columns.

For example, the conductive portions 911 may be disposed so as to be spaced apart from each other a predetermined interval. For example, the conductive portions 911 may be disposed or arranged in a matrix. For example, the conductive portions 911 may be disposed in the first region 91A of the conduction path portion 901. For example, the conductive portions 911 may be regularly disposed or arranged in the first portion 91A of the conduction path portion 901.

The conduction path portion 901 may include the first portion 91A including the conductive portions 911, and the second portions 91B and 91C which are connected to the first portion 91A and are coupled to at least one of the first circuit board 250 or the second circuit board 260.

For example, the first portion 91A of the conduction path portion 901 may alternatively be referred to as a “body”, and the second portions 91B and 91C of the conduction path portion 901 may alternatively be referred to as “coupling portions”, “extending portions” or “projecting portions”.

For example, when viewed from above, the first portion 91A of the conduction path portion 901 may have a polygonal shape (for example, a quadrilateral shape) or a circular shape. For example, the first portion 91A may have a polygonal plate shape.

The second portions 91B and 91C may be connected to the first portion 91A. For example, the second portions 91B and 91C may extend or project from the side surfaces of the first portion 91A.

For example, the second portion of the conduction path portion 901 may include a first coupler (or a first extension) 91B, which extends or projects from a first side surface 94A of the first portion 91A, and a second coupler (or a first extension) 91C, which extends or projects from a second side surface 94B of the first portion 91A. For example, the second side surface of the first portion 91A may be positioned opposite the first side surface of the first portion 91A.

Although FIG. 52 illustrates two couplers or extensions, the conduction path portion 901 may include one coupler (or extension) or three or more couplers (or extensions) in another embodiment.

For example, the first portion 91A of the conduction path portion 901 may further include a third side surface 94C and a fourth side surface 94D which are disposed between the first side surface 94A and the second side surface 94B. Here, the third side surface 94A and the fourth side surface 94D may be positioned opposite each other.

For example, the third side surface 94C may be disposed adjacent to the opening 264A of the reception portion 263 or the outer surface 261A of the second circuit board 260.

For example, the second portions 91B and 91C may be positioned closer to the fourth side surface 94D than to the third side surface 94C of the first portion 91A. For example, the second portions 91B and 91C may abut the fourth side surface 92D of the first portion 91A. In another embodiment, the second portions 91B and 91C may be spaced apart from at least one of the third or fourth side surfaces 94C or 94D of the first portion 91A. In another embodiment, the first coupler 91B may be positioned in the center of the first side surface 94A of the first portion 91A, and the second coupler 91C may be positioned in the center of the second side surface 94B of the first portion 91A. In a further embodiment, for example, the second portions 91B and 91C may be positioned closer to the third side surface 94C than to the fourth side surface 92D of the first portion 91A.

Although FIG. 52 illustrates the second portions 91B and 91C each having a quadrilateral shape, each of the second portions may have a semicircular shape, a semi-elliptical shape or a polygonal shape.

For example, the second portions 91B and 91C may extend in a direction parallel to the outer surface of the second circuit board 260. In another embodiment, the second portions 91B and 91C may extend in a direction which is not parallel to the outer surface of the second circuit board 260, for example, in a direction perpendicular to the outer surface.

The conductive portions may not be disposed or formed at the second portions 91B and 91C, and the second portions 91B and 91C may be coupled to at least one of the first circuit board 250 or the second circuit board 260 by means of a coupler. For example, the coupler may be an adhesive. For example, a first adhesive may be disposed between the second portions 91B and 91C of the conduction path portion 901 and the first circuit board 250. Accordingly, the second portions 91B and 91C and the first circuit board 250 may be coupled or attached to each other by means of the first adhesive. Furthermore, a second adhesive may be disposed between the second portions 91B and 91C of the conduction path portion 901 and the second circuit board 260. Accordingly, the second portions 91B and 91C and the second circuit board 260 may be coupled or attached to each other by means of the second adhesive. For example, the second adhesive may be disposed in the reception portion 263 of the second circuit board 260. For example, the second adhesive may be disposed between the reception portion 263 of the second circuit board 260a and the second portions 91B and 91C.

In another embodiment, the coupler may be a pin or a screw which passes through the first circuit board 250 and the second circuit board 260. In another embodiment, the conduction path portion 901 may also be coupled to the reception portion 263 of the second circuit board 260 through interference fitting or male-female fitting.

The term “conduction path portion 901” may be used interchangeably with “elastic conduction path portion”, “connector”, “conductive connector”, “electrical connector”, “rubber sheet”, “wire rubber sheet”, “wire sheet” or “conductive elastic sheet”.

The conduction path portion 901 may have a structure which includes conductive portions which electrically connects a plurality of terminals to each other. Alternatively, for example, the conduction path portion 901 may have a structure in which conductive portions connecting a plurality of terminals to each other are embedded in an insulating portion.

The length L5 of the first portion 91A of the conduction path portion 901 may be greater than the length L6 of each of the second portions 91B and 91C of the conduction path portion 901 (L5>L6). In another embodiment, the length L5 may be equal to the length L6. For example, the length of the first coupler 91B may be equal to the length of the second coupler 91C. In another embodiment, the length of the first coupler 91B and the length of the second coupler 91C may be different from each other.

For example, the length L5 (or the length L6) may be a length of the first portion 91A (or each of the second portions 91B and 91C) in a longitudinal direction. For example, the length L5 (or L6) may be a length of the first portion 91A (or each of the second portions 91B and 91C) in a crosswise direction. For example, the length L5 (or L6) may be a length of the first portion 91A (or each of the second portions 91B and 91C) in a direction parallel to the outer surface of the second circuit board 260. Furthermore, for example, the length L5 (or L6) may be a length of the first portion 91A (or each of the second portions 91B and 91C) in a direction in which the terminals 261 of the second circuit board 260 are arranged.

The total length L7 of the conduction path portion 901 may be the sum of the length L5 of the first portion 91A, the length L6 of the first coupler 91B and the length L6 of the second coupler 91C.

The length L5 of the first portion 91A of the conduction path portion 901 may be greater than the width L8 of the first portion 91A (L5>L8). In another embodiment, the length L5 and the width L8 may be equal to each other.

For example, the width L5 of the first portion 91A may be greater than the width of each of the second portions 91B and 91C. In another embodiment, the width L8 and the width L9 may be equal to each other.

For example, L8 (or L9) may be the length of the first portion 91A (or each of the second portions 91b and 91C) in a width direction. For example, the width direction may be perpendicular to the length direction. For example, width L8 (or L9) may be the length of the first portion 91A (or each of the second portions 91B and 91C) in a longitudinal direction. For example, the width L8 (or L9) may be the length of the first portion 91A (or each of the second portions 91B and 91C) in a longitudinal direction. For example, the width L8 (or L9) may be the length of the first portion 91A (or each of the second portions 91B and 91C) in a direction perpendicular to the outer surface of the second circuit board 260. Furthermore, for example, the width L8 (or L9) may be the length of the first portion 91A (or each of the second portions 91B and 91C) in a direction perpendicular to a direction in which the terminals 261 of the second circuit board 260 are arranged.

For example, the length L6 may be 3% to 15% of the length L5. In another embodiment, the length L6 may be 4% to 10% of the length L5. In a further embodiment, the length L6 may be 4% to 8% of the length L5.

When the length L6 is less than 3% of the length L5, the surface area of each of the second portions 91B and 91C may be excessively decreased, thereby reducing the adhesive force between the conduction path portion 901 and the first and second circuit boards 250 and 260 and causing separation of the conduction path portion 901.

When the length L6 exceeds 15% of the length L5, the surface area of each of the second portions 91B and 91C may be excessively increased, thereby having an influence on design of the circuit pattern of the second circuit board 260 and thus deteriorating freedom of design of the second circuit board 260.

Furthermore, for example, the width L9 may be 20% to 80% of the width L8. In another embodiment, for example, the width L9 may be 25% to 50% of the width L8. In a further embodiment, for example, the width L9 may be 25% to 40% of the width L8.

When the width L9 is less than 20% of the width L8, the surface area of each of the second portions 91B and 91C may be excessively decreased, thereby decreasing the adhesive force between the conduction path portion 901 and the first and second circuit boards 250 and 260 and causing separation of the conduction path portion 901.

When the width L9 exceeds 80% of the width L8, the surface area of each of the second portions 91B and 91C may be excessively increased, thereby having an influence on design of the circuit pattern of the second circuit board 260 and thus deteriorating freedom of design of the second circuit board 260.

Referring to FIG. 53A, the length H1 of the conduction path portion 901 in the optical axis direction may be less than the width L8 of the first portion 91A (H1<L8). For example, the length H1 of the conduction path portion 901 in the optical axis direction may be equal to the length of the conductive portion 911 in the optical axis direction.

The insulating portion 912 may be disposed between the lower surface of the first circuit board 250 and the upper surface of the second circuit board 260. The insulating portion 912 may be in contact with one area of the lower surface of the first circuit board 250 and one area of the upper surface of the second circuit board 260.

For example, the insulating portion 912 may be disposed in the reception portion 263 of the second circuit board 260. The insulating portion 912 may be in contact with at least one of the bottom surface 63A and the side surface 63B of the reception portion 263. For example, the insulating portion 912 may be disposed in the first region 263A and the second region 263B of the reception portion 263.

For example, the length of the insulating portion 912 in the optical axis direction may be equal to the length of the conductive portion 911 in the optical axis direction. In another embodiment, the length of the conductive portion 911 in the optical axis direction may be greater than the length of the insulating portion 912 in the optical axis direction. In a further embodiment, the length of the conductive portion 911 in the optical axis direction may be less than the length of the insulating portion 912 in the optical axis direction.

For example, the length L5 may be 7.8 mm to 11.8 mm, the length L6 may be 0.21 mm to 0.6 mm, and the length H1 may be 0.8 mm to 1.2 mm. In another embodiment, for example, the length L5 may be 0.8 mm to 10.8 mm, the length L6 may be 0.3 mm to 0.5 mm, and the length H1 may be 0.9 mm to 1.1 mm.

For example, the distance D2 between two adjacent conductive portions 911, which are arranged in a row direction may be less than the distance D1 between two adjacent terminals 261 of the second circuit board 260 (D2<D1). For example, the distance D2 may be less than the distance D4 between two adjacent terminals 251 of the first circuit board 250.

The distance D3 between two adjacent conductive portions 911, which are arranged in a row direction, may be less than the distance D1 between two adjacent terminals of the second circuit board 260 (D3<D1). Furthermore, the distance D3 may be less than the distance D4 between two adjacent terminals 251 of the first circuit board 250. For example, each of the distance D1 and the distance D2 may be the shortest distance.

The diameter R1 of the conductive portion 911 may be equal to or less than the distances D2 and D3 between two adjacent conductive portions 911. In another embodiment, the diameter R1 may be greater than the distance D2 or D3. For example, the row direction may be parallel to the length direction of the first portion 91A of the conduction path portion 901. For example, the column direction may be parallel to the width direction of the first portion 91A of the conduction path portion 901.

Because D2, D3 and/or R1 is less than the shortest distance D1 between two adjacent terminals 261 of the second circuit board 260, electrical short between two adjacent terminals of the second circuit board 260 may not occur. Furthermore, because D2, D3 and/or R1 is less than the shortest distance D4 between two adjacent terminals 251 of the first circuit board 250, electrical short between two adjacent terminals 251 of the first circuit board 250 may not occur.

The diameter R1 of the conductive portion 911, for example, the wire may be 20 μm to 50 μm. In another embodiment, the diameter R1 may be 20 μm to 30 μm.

The distance D2 between two adjacent terminals 911, which are arranged in the row direction, may be 0.02 mm to 0.1 mm. In another embodiment, the distance D2 may be 0.025 mm to 0.06 mm. The distance D3 between two adjacent conductive portions 911, which are arranged in the column direction), may be 0.02 mm to 0.1 mm. In another embodiment, the distance D3 may be 0.035 mm to 0.06 mm.

For example, the description of R1, D2 and D3 may also be applied to first to fourth conductive portions 911A to 911D.

At least a portion of the terminal 251 of the first circuit board 250 may face or overlap at least a portion of the terminal of the second circuit board 260 in the optical axis direction.

The conduction path portion 901 may include at least one first conductive portion 911A connecting the terminal 251 of the first circuit board 290 to the terminal 261 of the second circuit board 260. For example, the first conductive portion 911A may include a plurality of conductive portions.

For example, the first conductive portion 911A may overlap at least a portion of the terminal 251 of the first circuit board 250 and at least a portion of the terminal 261 of the second circuit board 260 in the optical axis direction.

For example, one end of the first conductive portion 911A may be in contact with the terminal 251 of the first circuit board 250, and may be conductively connected to the terminal 251. For example, a conductive adhesive or a solder may not be disposed between one end of the first conductive portion 911A and the terminal 251.

Furthermore, for example, the other end of the first conductive portion 911A may be in contact with the terminal 261 of the second circuit board 260, and may be conductively connected to the terminal 261. For example, a conductive adhesive or a solder may not be disposed between the other end of the first conductive portion 911A and the terminal 261.

The conduction path portion 901 may include at least one second conductive portion 911B which is not conductively or electrically connected to the terminal 261 of the second circuit board 260. For example, the second conductive portion 911B may include a plurality of second conductive portions. For example, the second conductive portion 911B may be spaced apart from the terminal 261 of the second circuit board 260.

For example, the second conductive portion 911B may not face or overlap the terminal 261 of the second circuit board 260 in the optical axis direction. The second conductive portion 911B may not be in contact with the terminal 261 of the second circuit board 260. For example, the second conductive portion 911B may face or overlap at least portion of the terminal 251 of the first circuit board 250 in the optical axis direction. For example, the second conductive portion 911B may be in contact with the terminal 251 of the first circuit board 250.

For example, the conduction path portion 901 may further include at least one third conductive portion 911C which is not conductively or electrically connected to the terminal 251 of the first circuit board 250. For example, the third conductive portion 911C may include a plurality of third conductive portions. For example, the third conductive portion 911C may be spaced apart from the terminal 251 of the first circuit board 250.

For example, the third conductive portion 911C may not face or overlap the terminal 251 of the first circuit board 250 in the optical axis direction. The third conductive portion 911C may be in contact with the terminal 251 of the first circuit board 250. For example, the third conductive portion 911C may face or overlap at least a portion of the terminal 261 of the second circuit board 260 in the optical axis direction. For example, the third conductive portion 911C may be in contact with the terminal 261 of the second circuit board 260.

For example, conduction path portion 901 may further include at least one fourth conductive portion 911D which is not conductively or electrically connected to the terminal 251 of the first circuit board 250 and the terminal 261 of the second circuit board 260. For example, the fourth conductive portion 911D may include a plurality of conductive portions. For example, the fourth conductive portion 911D may be spaced apart from the terminal 251 of the first circuit board 250 and the terminal 261 of the second circuit board 260.

For example, the fourth conductive portion 911C may not face or overlap the terminal 251 of the first circuit board 250 and the terminal 261 of the second circuit board 260 in the optical axis direction. The fourth conductive portion 911D may not be in contact with the terminal 251 of the first circuit board 250 and the terminal 261 of the second circuit board 260.

For example, each of the second to fourth conductive portions 911B to 911D may not electrically connect the terminal 251 of the first circuit board 250 to the terminal 261 of the second circuit board 260.

For example, the conductive portion 911 may include the first conductive portion 911A. For example, the conductive portion 911 may further include at least one of the second to fourth conductive portions 911B to 911D.

For example, at least one of the second to fourth conductive portions 911B to 911D may be disposed at a position corresponding to two adjacent terminals of the second circuit board 260.

Since the embodiment includes at least one of the second to fourth conductive portions 911B to 911D, it is possible to increase the stiffness of the conduction path portion 901 and thus to inhibit breakage or damage to the conduction path portion 910 caused by external impact or press.

The conductive portion 911 according to another embodiment may not include at least one of the second to fourth conductive portions 911B to 911D.

FIG. 53B is a cross-sectional view illustrating the reception portion 263-1 of the second circuit board 260 according to another embodiment. The reception portion 263-1 shown in FIG. 53B may include a partition wall (or a side surface) 266A in place of the opening 264A shown in FIG. 53A. Although a portion (or one side surface) of the conduction path portion 901 may be exposed through the opening 264A in FIG. 53A, the conduction path portion 901 may be positioned inside the partition wall 266A and may not be exposed from the outer surface of the second circuit board 260 by virtue of the partition wall 266A in FIG. 53B. The reception portion 263-1 shown in FIG. 53B is capable of inhibiting outward separation of the conduction path portion 901 from the reception portion 263-1 by virtue of the partition wall 266A, and the embodiment is able to stably receive the conduction path portion 901 therein.

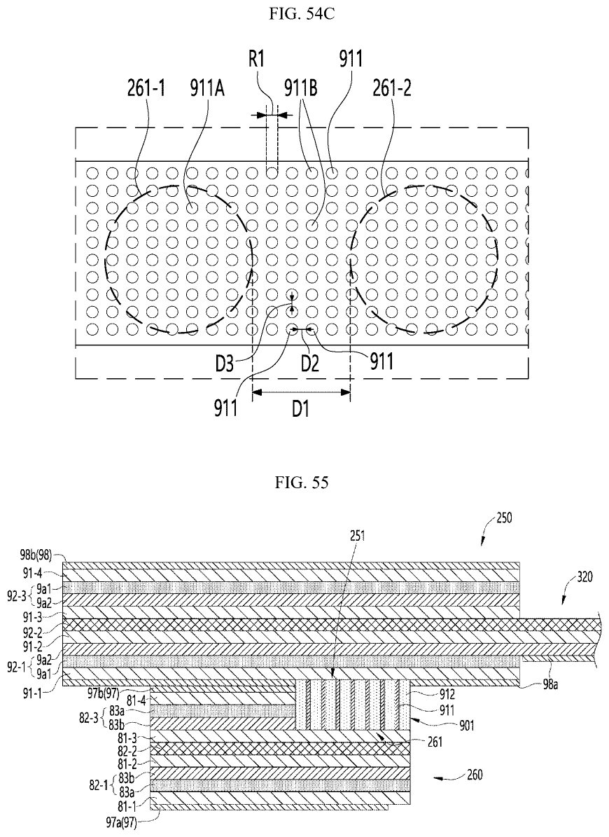

FIG. 55 is a cross-sectional view illustrating the layered structure of the first circuit board 250, the second circuit board 260 and the conduction path portion 901.

Referring to FIG. 55, the first circuit board 250 may include a plurality of conductive layers 91-1 to 91-m (m being a natural number greater than 1). Although FIG. 42B illustrates four conductive layers 91-1 to 91-4 which are sequentially layered or disposed in the optical axis direction, the disclosure is not limited thereto. In another embodiment, the number of conductive layers of the first circuit board 250 may be two or more. At least one of the plurality of conductive layers of the first circuit board 250 may include a piece of copper film, a wire, a terminal or a conductive pattern layer for transmitting an electrical signal or may include a ground layer.

For example, the conductive layers 91-1 to 91-4 may be made of conductive metal, for example, copper, aluminum, gold, silver or an alloy including at least one thereof. For example, the conductive layers 91-1 to 91-4 may include at least one of a pattern layer, a wire, or a terminal (or a pad).

For example, the first circuit board 250 may include insulating layers 92-1 to 92-3 disposed between the plurality of conductive layers 91-1 to 91-4. The insulating layers 92-1 to 92-3, which are intended to provide electrical insulation between the conductive layers 91-1 to 91-4, are capable of inhibiting electrical short between the conductive layers 91-1 to 91-4.

FIG. 55 illustrates three insulating layers disposed between the conductive layers 91-1 to 91-4. In another embodiment, the number of insulating layers may be determined depending on the number of conductive layers, and may be one of more. The insulating layer may alternatively be referred to as “insulating foil” or “insulating film”.

For example, the conductive layer 91-2 may correspond to the above-mentioned conductive layer 1093-1 or may be the same layer as the conductive layer 1093-1, and the insulating layer 92-1 may correspond to the above-mentioned first insulating layer 1094-1 or may be the same layer as the first insulating layer 1094-1. The insulating layer 92-2 may correspond to the above-mentioned second insulating layer 1904-2 or may be the same layer as the second insulating layer 1904-2, and the cover layer 98a may correspond to the above-mentioned protective layer 1096 or may be the same layer as the protective layer 1096.

The first circuit board 250 may include at least one of a rigid insulating layer made of a rigid material or a flexible insulating layer made of a flexible material. Here, the flexible insulating layer may have a property of being bendable, and the rigid insulating layer may have a higher strength or hardness than the flexible insulating layer.

For example, the flexible insulating layer may include a flexible resin, for example, polyimide. For example, the rigid insulating layer may include rigid resin, for example, prepreg. For example, the rigid insulating layer may include at least one of prepreg and coverlay. For example, the coverlay may include resin. Furthermore, for example, the coverlay may include resin and an adhesive. For example, the resin may be polyimide. For example, the coverlay may be formed into a film or a sheet.

For example, at least one of the plurality of insulating layers 92-1 to 92-3 of the first circuit board 250 may be a rigid insulating layer, and at least one of the plurality of insulating layers 92-1 to 92-3 may be a flexible insulating layer. For example, the first circuit board 250 may include the first insulating layer 92-1 disposed between the first conductive layer 91-1 and the second conductive layer 91-2, the second insulating layer 92-2 disposed between the second conductive layer 91-2 and the third conductive layer 91-3, and the third insulating layer 92-3 disposed between the third conductive layer 91-3 and the fourth conductive layer 91-4.

Each of the first insulating layer 92-1 and the third insulating layer 92-3 may be a rigid insulating layer. For example, each of the first insulating layer 92-1 and the third insulating layer 92-3 may include prepreg. For example, each of the first insulating layer 92-1 and the third insulating layer 92-3 may include a prepreg 9a1 and a coverlay 9a2. The second insulating layer 92-2 may be a flexible insulating layer. For example, the second insulating layer 92-2 may include polyimide.

The first circuit board 250 may include a cover layer which is positioned at the outermost conductive layers (for example, 91-1 and 91-4) in order to protect the conductive layers 91-1 to 91-4 from external shock or the like. For example, the cover layer 98 may include a first cover layer 98a disposed on the lower surface of the first conductive layer 91-1 which is the lowermost conductive layer, and a second cover layer 98b disposed on the upper surface of the fourth conductive layer 91-4 which is the uppermost conductive layer.

The cover layer 98 may be made of an insulating material, for example, solder resist (SR). For example, the cover layer 98 may be made of photo solder resist (PSR) or dry-film type solder resist (DFSR). The cover layer 98 may be formed by an opaque ink material or a translucent film material. The cover layer 98 may serve to protect the internal conductive layers of the first circuit board 250.

For example, the terminal 251 of the first circuit board 250 may be disposed or formed on the lowermost conductive layer (for example, 91-1) among the plurality of conductive layers 91-1 to 91-4 of the first circuit board 250. For example, the conductive layer 91-1 of the first circuit board 250 may include a portion or a region which is open or exposed at the first cover layer 98a. Here, the portion (or the region) of the conductive layer 91-1, which is open or exposed at the first cover layer 98a, may be formed as the terminal 251. For example, the conductive layer 91-1 of the first circuit board 250 may include the terminal 251.

The side surface between the upper surface and the lower surface of the first circuit board 250 may be insulated by means of the insulating layer, for example, the cover layer. For example, the insulating layer (for example, the cover layer) may be disposed or formed on the outer surfaces of the outermost portions of the conductive layers 91-1 to 91-4 and the insulating layers 92-1 to 92-3 of the first circuit board 250.

In another embodiment, for example, the terminal 251 may be disposed or formed on another conductive layer (for example, 91-2) disposed on the lowermost conductive layer (for example, 91-1) of the first circuit board 250. In another embodiment, for example, the terminal 251 may be positioned higher than the lowermost conductive layer (for example, 91-1) of the first circuit board 250. In another embodiment, for example, the terminal 251 may not be formed on the lowermost conductive layer (for example, 91-1) of the first circuit board 250. In another embodiment, for example, the terminal 251 may be formed on the conductive layer (for example, 91-2) corresponding to the layer immediately above the lowermost conductive layer (for example, 91-1) of the first circuit board 250. In another embodiment, for example, the terminal 251 may be formed on the second lowermost conductive layer (for example, 91-2) of the first circuit board 250. In another embodiment, the terminal 251 may be formed on the third lowermost conductive layer (for example, 91-3) of the first circuit board 250.

In another embodiment, the terminal 251 may be formed on a conductive layer positioned between the lowermost conductive layer (for example, 91-1) and the uppermost conductive layer (for example, 91-4) of the first circuit board 250. In another embodiment, the terminal 251 may be formed on the uppermost conductive layer (for example, 91-4) of the first circuit board 250.

The second circuit board 260 may include a rigid board. For example, the second circuit board 260 may include a plurality of conductive layers 81-1 to 81-m (m being a natural number greater than 1). For example, the second circuit board 260 may include four conductive layers 81-1 to 81-4 which are sequentially layered or disposed in the optical axis direction. In another embodiment, the number of conductive layers of the second circuit board 260 may be two or more. At least one of the plurality of conductive layers of the second circuit board 260 may include a piece of copper film, a wire, a terminal, a conductive pattern layer or a ground layer for transmitting an electrical signal.

For example, the conductive layers 81-1 to 81-4 may be made of conductive metal, for example, copper, aluminum, gold, silver or an alloy including at least one thereof. For example, the conductive layers 81-1 to 81-4 may include at least one of a pattern layer, a wire, or a terminal (or a pad).

The second circuit board 260 may include a plurality of insulating layers 82-1 to 82-3. For example, the second circuit board 260 may include the insulating layers 82-1 to 82-3 disposed between the plurality of conductive layers 81-1 to 81-4. The insulating layers 82-1 to 82-3, which are intended to provide electrical insulation between the conductive layers 81-1 to 81-4, are capable of inhibiting electrical short between the conductive layers 81-1 to 81-4.

Although the second circuit board 260 is illustrated as including three insulating layers disposed between the conductive layers 81-1 to 81-4, the number of second insulating layers 260 may be determined depending on the number of conductive layers, and may be one of more in another embodiment. The insulating layer may alternatively be referred to as “insulating foil” or “insulating film”.

For example, the second circuit board 260 may include at least one of a rigid insulating layer made of a rigid material or a flexible insulating layer made of a flexible material. The description of the rigid insulating layer and the flexible insulating layer of the first circuit board 250 may be applied to the second circuit board 260 with or without modification. For example, at least one of the plurality of insulating layers 82-1 to 82-3 of the second circuit board 260 may be a rigid insulating layer, and at least one of the plurality of insulating layers 82-1 to 82-3 may be a flexible insulating layer.

For example, the second circuit board 260 may include the first insulating layer 82-1 disposed between the first conductive layer 81-1 and the second conductive layer 81-2, the second insulating layer 82-2 disposed between the second conductive layer 81-2 and the third conductive layer 81-3, and the third insulating layer 82-3 disposed between the third conductive layer 81-3 and the fourth conductive layer 81-4.

Each of the first insulating layer 82-1 and the third insulating layer 82-3 may be a rigid insulating layer. For example, each of the first insulating layer 82-1 and the third insulating layer 82-3 may include a prepreg 83a. For example, each of the first insulating layer 82-1 and the third insulating layer 82-3 may include the prepreg 83a and a coverlay 83b. The second insulating layer 82-2 may be a flexible insulating layer. For example, the second insulating layer 82-2 may include polyimide.

The second circuit board 260 may include an insulating layer 97 positioned at the outermost conductive layers (for example, 81-1 and 81-4) in order to protect the conductive layers 81-1 to 81-4 from external shock or the like. Here, the insulating layer 97 may alternatively be referred to as a “cover layer”, and reference number 97 denotes the cover layer.

For example, the cover layer 97 may include a first cover layer 97a disposed beneath the first conductive layer 81-1 which is the lowermost conductive layer, and a second cover layer 97b disposed on the fourth conductive layer 81-4 which is the uppermost conductive layer.

The cover layer 97 may be made of an insulating material, for example, solder resist (SR). For example, the cover layer 97 may be made of photo solder resist (PSR) or dry-film type solder resist (DFSR).

The side surface between the upper surface and the lower surface of the second circuit board 260 may be insulated by the insulating layer, for example, the cover layer. For example, the insulating layer (for example, the cover layer) may be disposed or formed on the outer surfaces of the outermost portions of the conductive layers 81-1 to 81-4 and the insulating layers 82-1 to 82-3.

For example, the lowermost layer of the second circuit board 260 may be a first insulating layer, for example, a first cover layer 97a, and the first conductive layer 81-1 may be disposed on the first insulating layer (for example, the first cover layer 87a).

The terminal 261 of the second circuit board 260 may be disposed in the reception portion 263 of the second circuit board 260.

The terminal 261 of the second circuit board 260 may be positioned lower than the uppermost conductive layer (for example, 81-4) among the plurality of conductive layers 81-1 to 81-4. For example, the terminal 261 may be disposed or formed on another conductive layer (for example, 81-3) disposed beneath the uppermost conductive layer (for example, 81-4) of the second circuit board 260. For example, the terminal 261 may be positioned lower than the uppermost conductive layer (for example, 81-4) of the second circuit board 260. For example, the terminal 261 may not be formed on the uppermost conductive layer (for example, 81-4) of the second circuit board 260. For example, the terminal 261 may be formed on a conductive layer (for example, 81-3) corresponding to the layer immediately below the uppermost conductive layer (for example, 81-4) of the second circuit board 260.

In another embodiment, the terminal 261 may be formed on one of the conductive layers 81-2 and 81-1 of the second circuit board 260.

In another embodiment, the terminal 261 may be formed on a conductive layer positioned between the lowermost conductive layer (for example, 81-1) and the uppermost conductive layer (for example, 81-4) of the second circuit board 260. In another embodiment, the terminal 261 may be formed on the lowermost conductive layer (for example, 81-1) of the second circuit board 260.

The conduction path portion 901 may be disposed between the first terminal 251 and the second terminal 261. One end (or the upper end) of the conductive portion 911 of the conduction path portion 901 may be in contact with the terminal 251 of the first circuit board 250, and the other end (or the lower end) of the conductive portion 911 may be in contact with the terminal 261 of the second circuit board 260. For example, one end (or the upper end) of the conductive portion 911 may be in contact with the conductive layer (for example, 91-1) of the first circuit board 250 on which the terminal 251 is formed, and the other end (or the lower end) of the conductive portion 911 may be in contact with the conductive layer (for example, 81-3) of the second circuit board 260 on which the terminal 261 is formed.

For example, the lower end of the conductive portion 911 may be positioned lower than the uppermost conductive layer 81-4 of the second circuit board 260, and the upper end of the conductive portion 911 may be positioned higher than the uppermost conductive layer 81-4 of the second circuit board 260.

For example, the upper end of the conductive portion 911 may be positioned lower than the conductive layer of the first circuit board 250 on which the terminal 251 is formed, and the lower end of the conductive portion 911 may be positioned higher than the conductive layer of the second circuit board 260 on which the terminal 261 is formed.

In the comparative example in which the terminal 251 of the first circuit board 250 and the terminal 261 of the second circuit board 260 are coupled to each other via a solder, when impact is applied to the solder, the solder coupled to the terminals 251 and 261 cannot overcome the impact and thus a crack may occur at the solder. The crack may deteriorate reliability of electrical connection between the terminal 251 of the first circuit board 250 and the terminal 261 of the second circuit board 260.

Furthermore, in the comparative example, foreign substances may be generated during a soldering process, and the foreign substances may deteriorate performance of the camera device. In addition, because a plurality of terminals are provided in the comparative example, process time may increase. Furthermore, when the distance between the terminals is decreased in the comparative example, electrical short may occur between the terminals due to the soldering process.

In the embodiment, the terminal 251 of the first circuit board 250 is electrically connected to the terminal 261 of the second circuit board 260 using the conduction path portion 901 in place of the solder, it is possible to solve the above-mentioned problems caused by a soldering process. In other words, because the conductive portion 911 is enveloped or sealed by the insulating portion 912 in the embodiment, the insulating portion is capable of protecting the conductive portion 911 from external impact and thus of inhibiting defective electrical connection caused by the external impact. Furthermore, according to the embodiment, there is no generation of foreign substances caused by the soldering process. In addition, because each of the conductive portions 911 is enveloped or sealed and thus insulated by the insulating portion 912 in the embodiment, it is possible to inhibit electrical short between the terminals. Furthermore, because the conduction path portion 901 is disposed between the first circuit board 250 and the second circuit board 260 and is attached to the first circuit board 250 and the second circuit board 260 using an adhesive or the like in the embodiment, it is possible to realize simplification of the process and reduction in process time.

In addition, because the conduction path portion 901 is disposed in the reception portion 263 of the second circuit board 250 in the embodiment, it is possible to inhibit increase in the length of the first board unit 255 in the optical axis direction and the length of the camera device in the optical axis direction caused by the conduction path portion 901.

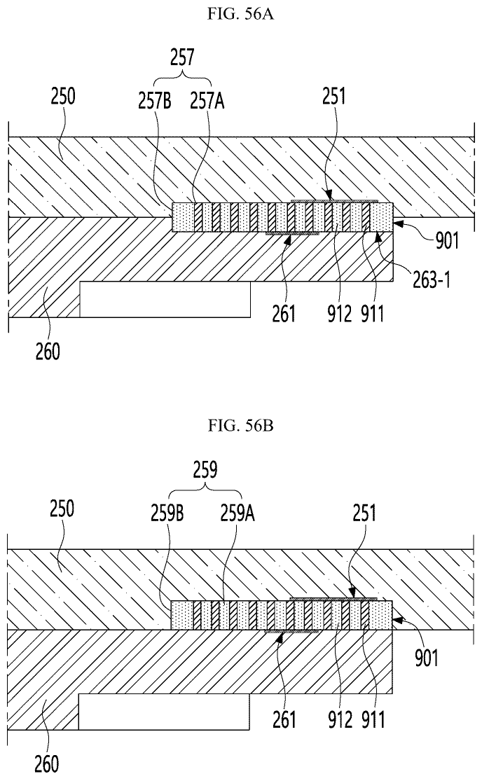

FIG. 56A is a cross-sectional view of the terminal 251 of the first circuit board 250, the terminal 261 of the second circuit board 260, and the conduction path portion 901 according to another embodiment.

Referring to FIG. 56A, the second circuit board 260 may include a first reception portion 263-1 configured to receive a portion (for example, a lower portion) of the conduction path portion 901 therein. For example, although the first reception portion 263-1 of the second circuit board 260 may have the same shape as the reception portion 263 shown in FIG. 23, the height difference of the bottom surface of the first reception portion 263-1 in the optical axis direction may be less than the height difference of the bottom surface 63A of the reception portion 263 shown in FIG. 51. In other words, the depth of the groove in the first reception portion 263-1 may be less than the depth of the groove in the reception portion 263 shown in FIG. 23. The description of the reception portion 263 may be applied to the first reception portion 263-1 shown in FIG. 56A with or without modification.

The first circuit board 250 shown in FIG. 56A may include a second reception portion 257 configured to receive another portion (for example, an upper portion) of the conduction path portion 901. The second reception portion 257 may be formed on the lower surface of the first circuit board 250. For example, the second reception portion 257 of the first circuit board 250 may correspond to, face or overlap the first reception portion 263-1 of the second circuit board 260 in the optical axis direction.

For example, the shape of the second reception portion 257 may coincide with or be identical to the shape of the first reception portion 263-1. For example, the second reception 257 may be a groove depressed from the lower surface of the first circuit board 250. For example, the second reception portion 257 may include a bottom surface 257A, which defines a height difference with respect to the lower surface of the first circuit board 250 in the optical axis direction, and a side surface (or a side wall) 257B connecting the bottom surface 257 to the lower surface of the first circuit board 250.

In the embodiment shown in FIG. 56A, the reception portion configured to receive the conduction path portion 901 therein may be formed both at the first circuit board 250 and at the second circuit board 260, thereby making it possible to further increase the coupling force between the conduction path portion 901 and the first circuit board 250 and the coupling force between the conduction path portion 901 and the second circuit board 260.

In the embodiment shown in FIG. 56A, an adhesive may be disposed between the first reception portion 263-1 (for example, the second portions 263B and 263C of the first reception portion 263-1) and the couplers 91B and 91C of the conduction path portion 901 and between the second reception portion 257 (for example, the second regions 263B and 263C of the second reception portion 257) and the couplers 91B and 91C of the conduction path portion 901.

By virtue of the adhesive, the first reception portion 263-1 of the second circuit board 260 may be coupled or attached to the couplers 91B and 91C of the conduction path portion 901, and the second reception portion 257 of the first circuit board 250 may be coupled or attached to the couplers 91B and 91C of the conduction path portion 901.

For example, the description of the conductive layer and the insulating layer of each of the first and second circuit boards 250 and 260 may be applied to the embodiment shown in FIG. 28A with or without modification. In the embodiment shown in FIG. 28A, the terminal 251 may be formed on the conductive layer 91-2, 91-3 or 91-4 positioned higher than the lowermost conductive layer 91-1 of the first circuit board 250. For example, the terminal 261 may be formed on the conductive layer 81-3, 81-2 or 81-1 positioned lower than the uppermost conductive layer 81-4 of the second circuit board 250. For example, one end (the upper end) of the conductive portion 911 of the conduction path portion 901 shown in FIG. 56A may be positioned higher than the lowermost conductive layer 91-1 of the first circuit board 250, and the other end (the lower end) of the conductive portion 911 of the conduction path portion 901 may be positioned lower than the uppermost conductive layer 81-4 of the second circuit board 260.

FIG. 56B is a cross-sectional view of the terminal 251 of the first circuit board 250, the terminal 261 of the second circuit board 260, and the conduction path portion 901 according to a further embodiment.

In the embodiment shown in FIG. 56B, the second circuit board 260 may not be provided with the reception portion configured to receive at least a portion of the conduction path portion 901 therein, and the first circuit board 250 may be provided with the reception portion 259 configured to receive the conduction path portion 901 therein.

The reception portion 259 may be formed on the lower surface of the first circuit board 250. For example, the reception portion 259 may have the same shape as the reception portion 263 shown in FIG. 23, and the description of the reception 263 shown in FIG. 23 may be applied to the reception portion 259 shown in FIG. 28B with or without modification.

For example, the reception portion 259 may be a groove depressed from the lower surface of the first circuit board 250. For example, the reception portion 259 may include a bottom surface 259, which defines a height difference with respect to the lower surface of the first circuit board 250 in the optical axis direction, and a side surface (or a side wall) 259B connecting the bottom surface 259A to the lower surface of the first circuit board 250.

For example, the description of the conductive layers and insulating layers of each of the first and second circuit boards 250 and 260 shown in FIG. 55 may be applied to the embodiment shown in FIG. 28B with or without modification.

In the embodiment shown in FIG. 56B, an adhesive may be disposed between the reception portion 257 (for example, the second regions 263B and 263C of the reception portion 257) and the couplers 91B and 91C of the conduction path portion 901. By virtue of the adhesive, the reception portion 259 of the first circuit board 250 may be coupled or attached to the couplers 91B and 91C of the conduction path portion 901.

In the embodiment shown in FIG. 56B, for example, the terminal 251 may be formed on the conductive layer 91-2, 91-3 or 91-4 positioned higher than the lowermost conductive layer 91-1 of the first circuit board 250. For example, the terminal 261 may be formed on the uppermost conductive layer 81-4 of the second circuit board 260. In FIG. 56B, for example, one end (the upper end) of the conductive portion 911 of the conduction path portion 901 may be positioned higher than the lowermost conductive layer 91-1 of the first circuit board 250, and the other end (the lower end) of the conductive portion 911 of the conduction path portion 901 may be positioned higher than the uppermost conductive layer 81-4 of the second circuit board 260.

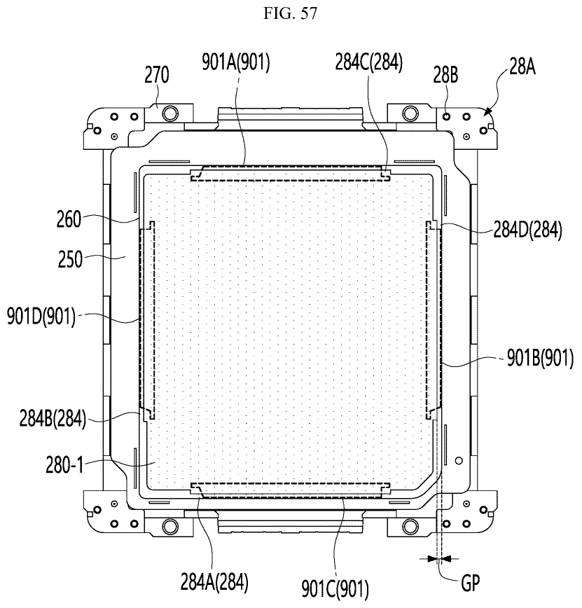

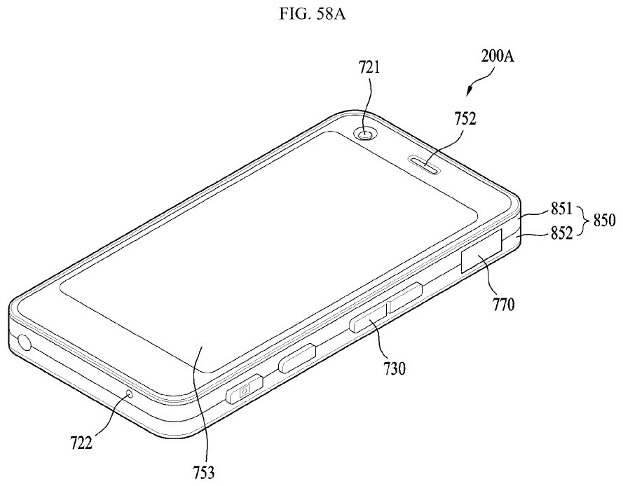

FIG. 57 illustrates the heat radiating member 280-1 according to another embodiment.

The heat radiating member 280 shown in FIG. 45 may not overlap the first portion 91A of the conduction path portion 901 in the optical axis direction. For example, the heat radiating member 280 shown in FIG. 45 may not overlap the conductive portions 911 of the conduction path portion 901. For example, the heat radiating member 280 shown in FIG. 45 may include the escape portion 281 so as not to overlap the first portion 91A of the conduction path portion 901 in the optical axis direction. For example, the escape portion 281 may have the form of a groove depressed from the outer surface of the heat radiating member 280.

At least a portion of the heat radiating member 280-1 according to the embodiment shown in FIG. 57 may overlap the conduction path portion 901 in the optical axis direction. For example, at least a portion of the heat radiating member 280-1 may overlap the first portion 91A of the conduction path portion 901 in the optical axis direction. For example, at least a portion of the heat radiating member 280-1 may overlap the conductive portion 911 of the conduction path portion 901 in the optical axis direction.

For example, the heat radiating member 280-1 may include at least one projection 284 which projects from the outer surface of the heat radiating member 280-1 in a direction perpendicular to the optical axis. For example, the heat radiating member 280-1 may include the projection 284 which overlaps the conduction path portion 901 in the optical axis direction. For example, the projection 284 may include a plurality of projections 284A to 284D. For example, each of the plurality of projections 284A to 284D may correspond to, face or overlap a corresponding one of the plurality of conduction path portions 901A to 901D in the optical axis direction.

In the embodiment shown in FIG. 56B, because the heat radiating member 280-1 overlaps the conduction path portion 901 in the optical axis direction, the heat radiating member 280-1 may serve as a stiffener configured to stably support the conduction path portion 901.

Furthermore, because the heat radiating member 280-1 overlaps the conduction path portion 901 in the optical axis direction in the embodiment, it is possible to efficiently radiate heat transmitted through the conduction path portion and thus to improve efficiency of heat radiation of the OIS moving unit.

In FIG. 56B, the distance (or the gap) between the outer surface of the projection 284 of the heat radiating member 280-1 and the outer surface of the second circuit board 260 in a direction perpendicular to the optical axis may be 0.1 mm to 3 mm. For example, when viewed in the optical axis direction or from below, the outer surface of the projection 284 of the heat radiating member 280-1 may be positioned inside the outermost portion (or the outer surface) of the heat radiating member 280-1. The reason for this is to compensate for erection tolerance in assembly of the heat radiating member 280-1 with the second circuit board 260.

The description given with reference to FIGS. 22 to 32 may be applied to the embodiment shown in FIGS. 33 to 57 with or without modification. Furthermore, the description given with reference to FIGS. 50A to 57 may be applied to the embodiment shown in FIGS. 1 to 32 with or without modification.

Furthermore, the camera device according to the embodiment may be included in an optical instrument, which is designed to form the image of an object in a space using reflection, refraction, absorption, interference, diffraction or the like, which are characteristics of light, to extend eyesight, to record an image obtained through a lens or to reproduce the image, to perform optical measurement, or to propagate or transmit an image. For example, although the optical instrument according to the embodiment may be a mobile phone, a cellular phone, a smart phone, a portable smart instrument, a digital camera, a laptop computer, a digital broadcasting terminal, a PDA (Personal Digital Assistant), a PMP (Portable Multimedia Player), navigation device, or the like, the disclosure is not limited thereto. Furthermore, any device capable of capturing images or taking photographs is possible.

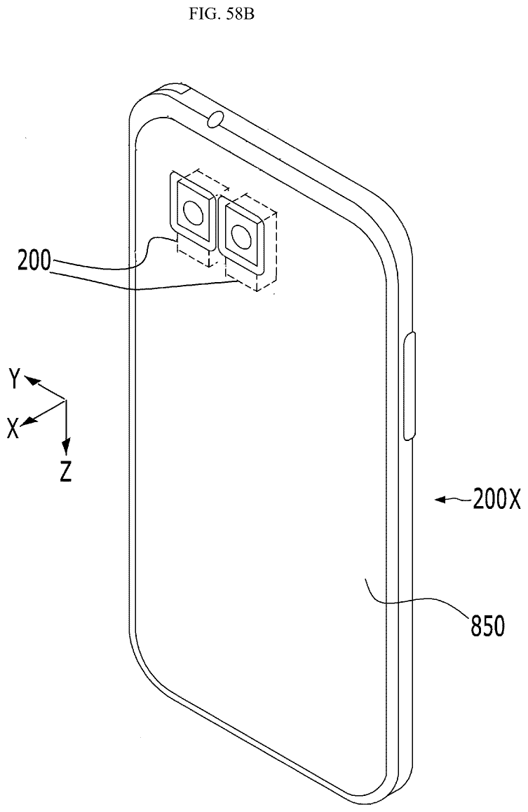

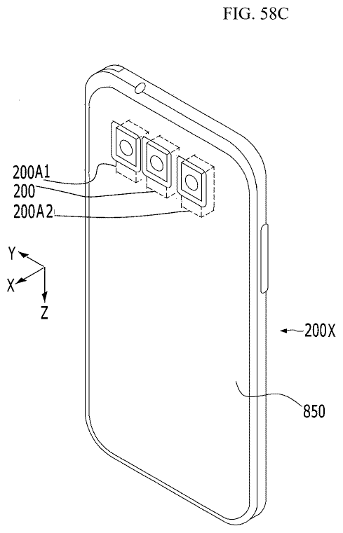

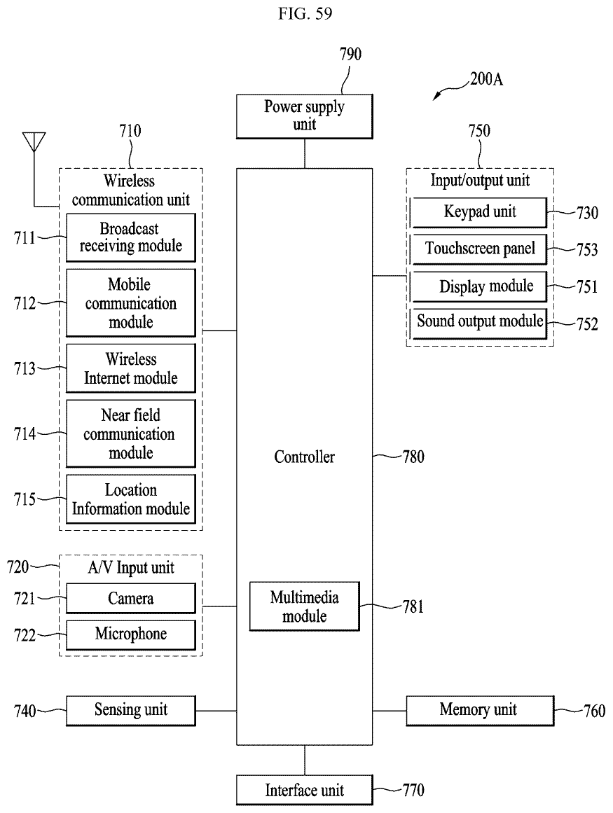

FIG. 58A is a perspective view of an optical instrument 200A according to an embodiment. FIG. 58B is a perspective view of an optical instrument 200X according to another embodiment. FIG. 58C is a perspective view of an optical instrument 200X according to a further embodiment. FIG. 59 is a view illustrating the configuration of the optical instrument 200A or 200X illustrated in FIGS. 58A to 58C.

For example, the embodiment shown FIG. 58A may be a front camera of an optical instrument 200A in which the lens module 400 of the camera device 10 is disposed so as to face in a forward direction of the body 850, and the embodiment shown FIGS. 58B and 58C may be a rear camera of an optical instrument 200A in which the lens module 400 of the camera device 10 faces in a backward direction of the body 850.

The optical instrument 200X shown in FIG. 58B may include two rear camera devices 200, and the optical instrument 200X shown in FIG. 58C may include three rear camera devices. Here, at least one of the two rear camera devices shown in FIG. 58B or at least one of the three camera devices shown in FIG. 58C may be the camera device 10 according to the embodiment. The two camera devices or the three camera devices may be camera devices which have different angles of view. For example, one of the rear camera devices may be one of an AF camera device, an OIS camera device or a zooming camera device, and another of the three camera devices may be another of an AF camera device, an OIS camera device or a zooming camera device. Here, the AF camera device may be a camera device configured to perform an autofocus function, the OIS camera device may be a camera device configured to perform autofocus and OIS functions, and the zooming camera device may be a camera device configured to perform a zooming function or to perform both zooming function and OIS function.

In another embodiment, two or four or more rear camera devices may be provided. For example, although the rear camera devices is disposed or arranged in a line in a direction in which the short sides of the optical instrument 200X face each other, the rear camera devices may be disposed or arranged in a line in a direction in which the long sides of the optical instrument 200X face each other in another embodiment. In a further embodiment, the rear camera devices may be disposed or arranged in a triangular shape.

In another embodiment, the camera devices 200 may correspond to the front camera device and the rear camera device of the optical instrument 200A.

The optical device 200A may include a body 850, a wireless communication unit 710, an audio/video (A/V) input unit 720, a sensing unit 740, an input/output unit 750, a memory unit 760, an interface unit 770, a controller 780, and a power supply unit 790.

The body 850 has a bar shape, without being limited thereto, and may be any of various types, such as, for example, a slide type, a folder type, a swing type, or a swivel type, in which two or more sub-bodies are coupled so as to be movable relative to each other.

The body 850 may include a case (a casing, housing, cover or the like) defining the external appearance of the terminal. For example, the body 850 may be divided into a front case 851 and a rear case 852. Various electronic components of the terminal may be accommodated in the space defined between the front case 851 and the rear case 852.

The wireless communication unit 710 may include one or more modules, which enable wireless communication between the optical device 200A and a wireless communication system or between the optical device 200A and a network in which the optical device 200A is located. For example, the wireless communication unit 710 may include a broadcast-receiving module 711, a mobile communication module 712, a wireless Internet module 713, a nearfield communication module 714, and a location information module 715.

The A/V input unit 720 serves to input audio signals or video signals, and may include, for example, a camera 721 and a microphone 722.

The camera 721 may include the camera device 100 according to the embodiment.

The sensing unit 740 may sense the current state of the optical device 200A, such as, for example, opening or closing of the optical device 200A, the location of the optical device 200A, the presence of a user's touch, the orientation of the optical device 200A, or the acceleration/deceleration of the optical device 200A, and may generate a sensing signal to control the operation of the optical device 200A. When the optical device 200A is, for example, a slide-type cellular phone, the sensing unit 740 may sense whether the slide-type cellular phone is opened or closed. Furthermore, the sensing unit 740 may sense the supply of power from the power supply unit 790, coupling of the interface unit 770 to an external device, and the like.

The input/output unit 750 serves to generate, for example, visual, audible, or tactile input or output. The input/output unit 750 may generate input data to control the operation of the optical device 200A, and may display information processed in the optical device 200A.

The input/output unit 750 may include a keypad unit 730, a display module 751, a sound output module 752, and a touchscreen panel 753. The keypad unit 730 may generate input data in response to input to a keypad.

The display module 751 may include a plurality of pixels, the color of which varies depending on the electrical signals applied thereto. For example, the display module 751 may include at least one among a liquid crystal display, a thin-film transistor liquid crystal display, an organic light-emitting diode display, a flexible display and a 3D display.

The sound output module 752 may output audio data received from the wireless communication unit 710 in, for example, a call-signal reception mode, a call mode, a recording mode, a voice recognition mode, or a broadcast reception mode, or may output audio data stored in the memory unit 760.

The touchscreen panel 753 may convert variation in capacitance, caused by a user's touch on a specific region of a touchscreen, into electrical input signals.

The memory unit 760 may temporarily store programs for the processing and control of the controller 780, and input/output data (for example, telephone numbers, messages, audio data, still images, moving images and the like). For example, the memory unit 760 may store images captured by the camera 721, for example, pictures or moving images. For example, the memory unit 760 may store therein software, algorithm or mathematical formulae for the above-mentioned hand tremor correction.

The interface unit 770 serves as a path through which the lens moving apparatus is connected to an external device connected to the optical device 200A. The interface unit 770 may receive power or data from the external component, and may transmit the same to respective constituent elements inside the optical device 200A, or may transmit data inside the optical device 200A to the external component. For example, the interface unit 770 may include a wired/wireless headset port, an external charger port, a wired/wireless data port, a memory card port, a port for connection to a device equipped with an identification module, an audio input/output (I/O) port, a video input/output (I/O) port, an earphone port and the like.

The controller 780 may control the general operation of the optical device 200A. For example, the controller 780 may perform control and processing related to, for example, voice calls, data communication, and video calls.

The controller 780 may include a multimedia module 781 for multimedia playback. The multimedia module 781 may be embodied in the controller 180, or may be embodied separately from the controller 780.

The controller 780 may perform a pattern recognition process capable of recognizing writing input or drawing input carried out on a touchscreen as a character and an image, respectively.

The power supply unit 790 may supply power required to operate the respective constituent elements upon receiving external power or internal power under the control of the controller 780.

The features, configurations, effects and the like described above in the embodiments are included in at least one embodiment, but the invention is not limited only to the embodiments. In addition, the features, configurations, effects and the like exemplified in the respective embodiments may be combined with other embodiments or modified by those skilled in the art. Accordingly, content related to these combinations and modifications should be construed as falling within the scope of the disclosure.

### INDUSTRIAL APPLICABILITY

The embodiments are applicable to camera devices and optical instruments including the same, which are capable of inhibiting breakage or damage to a filter holder accommodating a filter therein caused by impact.

Furthermore, the embodiments are applicable to camera devices and optical instruments including the same, which are capable of inhibiting defective electrical connection caused by impact and of inhibiting generation of foreign substances and electrical short between terminals caused by a soldering process.

1. A camera device comprising:
a stationary unit comprising a lens module;
a moving unit comprising a circuit board, a circuit element disposed on the circuit board, a filter holder disposed on the circuit board, a filter opposed to the lens module in an optical axis direction, and an image sensor opposite the filter; and
a support unit configured to support the moving unit with respect to the stationary unit,
wherein the filter holder comprises a first portion, which overlaps the lens module but does not overlap the circuit element in the optical axis direction, and a second portion, which overlaps the circuit element but does not overlap the lens module in the optical axis direction,
wherein the second portion is positioned higher than the circuit element but lower than the lens module.

2. The camera device according to claim 1, wherein the filter holder comprises a third portion that does not overlap the lens module and the circuit element in the optical axis direction.

3. The camera device according to claim 2, wherein the third portion is positioned between the first portion and the second portion.

4. The camera device according to claim 1, wherein the first portion has an upper surface positioned higher than an upper surface of the filter.

5. The camera device according to claim 1, wherein the circuit board comprises a first circuit board having a bore and a second circuit board disposed below the first circuit board, and
wherein at least a portion of the circuit element and at least a portion of the filter holder are disposed in the bore in the first circuit board.

6. The camera device according to claim 5, wherein the second portion is disposed in the bore in the first circuit board and does not overlap the first circuit board in the optical axis direction.

7. The camera device according to claim 5, wherein the filter holder comprises a fourth portion that does not overlap the lens module and the circuit element in the optical axis direction and is disposed between the second portion and the first circuit board.

8. The camera device according to claim 1, wherein the filter holder comprises:
a side portion comprising first and second side portions, which are positioned opposite each other in a first direction, and third and fourth side portions, which are positioned opposite each other in a second direction perpendicular to the first direction, and
a seating portion comprising a bottom surface positioned lower than an upper surface of the side portion of the filter holder in the optical axis direction, the filter being disposed in the seating portion.

9. The camera device according to claim 8, wherein a length of the first side portion in the first direction is 15% to 20% of a length of the filter in the first direction.

10. The camera device according to claim 8, wherein a length of the third side portion in the second direction is 7% to 12% of a length of the filter in the second direction.

11. The camera device according to claim 10, wherein a distance between an upper surface of the filter and an upper surface of the side portion of the filter holder is 19% to 50% of a length of the filter in the optical axis direction.

12. A camera device comprising:
a stationary unit;
a moving unit comprising a circuit board, a circuit element disposed on the circuit board, a filter holder disposed on the circuit board, a filter disposed on the filter holder, and an image sensor opposite the filter; and
a support unit configured to support the moving unit with respect to the stationary unit,
wherein the filter holder comprises a reception portion in which at least a portion of the circuit element is disposed, and the circuit element overlaps at least a portion of the filter holder in the optical axis direction.

13. The camera device according to claim 12, comprising a lens module disposed on the filter so as to be spaced apart from the filter in the optical axis direction.

14. The camera device according to claim 13, wherein the circuit element does not overlap the lens module in the optical axis direction.

15. The camera device according to claim 12, wherein the filter holder comprises a seating portion having a bottom surface that defines a height difference with respect to an upper surface of the filter holder in the optical axis direction, and the filter is disposed on the bottom surface of the seating portion.

16. The camera device according to claim 15, wherein the upper surface of the filter is positioned lower than the upper surface of the filter holder.

17. The camera device according to claim 15, wherein the reception portion comprises a groove depressed from a lower surface of the filter holder, and at least a portion of the circuit element is disposed in the groove.

18. The camera device according to claim 15, wherein the filter holder comprises a first region coupled to the circuit board and a second region positioned outside the first region,
wherein the reception portion is disposed in the second region.

19. The camera device according to claim 12, wherein the circuit board comprises a first circuit board having a bore and a second circuit board disposed below the first circuit board,
wherein the circuit element and the filter holder are disposed on the second circuit board, and at least a portion of the circuit element and at least a portion of the filter holder are disposed in the bore in the first circuit board.

20. The camera device according to claim 19, wherein an upper surface of the filter holder is positioned higher than an upper surface of the first circuit board.
